(19) United States
(12) Patent Application Publication
(10) Pub. No.: US 2026/0099989 A1
(43) Pub. Date: Apr. 9, 2026

(54) INTEGRATION OF VIDEO DATA INTO IMAGE-BASED DENTAL TREATMENT PLANNING AND CLIENT DEVICE PRESENTATION

(71) Applicant: Align Technology, Inc., San Jose, CA (US)

(72) Inventors: Michael Seeber, Zurich (CH); Doruk Cetin, Zurich (CH); Jakub Lucki, Zurich (CH); Philipp Kopp, Zurich (CH); Niko Benjamin Huber, Zug (CH); Ritika Chakraborty, Kirchdorf (CH); Sinan Ibrahim Bayraktar, Zürich (CH); Nicolas Wicki, Zürich (CH)

(21) Appl. No.: 19/179,909

(22) Filed: Apr. 15, 2025

Related U.S. Application Data
(60) Provisional application No. 63/634,795, filed on Apr. 16, 2024.
(60) Provisional application No. 63/655,285, filed on Jun. 3, 2024.

(51) Int. Cl. G06T 15/10; A61C 7/00; A61C 13/34; G06T 7/00; G06T 7/50; G06T 13/40; G06T 17/00

(52) U.S. Cl. CPC G06T 15/10; A61C 7/002; A61C 13/34; G06T 7/0012; G06T 7/50; G06T 13/40; G06T 17/00; G06T 2207/10016; G06T 2207/20081; G06T 2207/30036; G06T 2207/30168; G06T 2207/30201; G06T 2210/41

(57) ABSTRACT

A method includes obtaining video data of a dental patient. The method further includes obtaining an indication of selection criteria in association with the video data. The selection criteria includes conditions related to a target dental treatment of the dental patient. The method further includes performing an analysis procedure on the video data. Performing the analysis procedure includes determining a first score for each frame of the video data based on the selection criteria. Performing the analysis procedure further includes determining that a frame satisfies a first threshold condition based on the first score. The method further includes providing the first frame as output of the analysis procedure.

### CROSS-REFERENCE TO RELATED APPLICATION(S)

This application claims the benefit of priority of U.S. Provisional Patent Application No. 63/634,795, filed Apr. 16, 2024, and U.S. Provisional Patent Application No. 63/655,285, filed Jun. 3, 2024, the disclosures of which are hereby incorporated by reference herein in their entireties.

### TECHNICAL FIELD

Embodiments of the present invention relate to the field of dentistry, and in particular to the generation of dental patient images and/or extraction of dental patient images from video data.

### BACKGROUND

When a dentist or orthodontist is engaging with current and/or potential patients, it is often helpful to generate data indicative of dental arches of the patients. For example, it may be helpful to show those patients images of pre-treatment dentition and predictive images of post-treatment dentition of the patients or potential patients. Often, there are many types of operations that may be helpful for dental treatment, which may benefit from input images with different requirements, conditions, etc.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one aspect of the present disclosure, a method includes receiving a video comprising a face of an individual that is representative of a current condition of a dental site of the individual. The method further includes segmenting each of a plurality of frames of the video to detect the face and the dental site of the individual to generate segmentation data. The method further includes inputting the segmentation data into a machine learning model trained to predict an altered condition of the dental site. The method further includes generating, from the machine learning model, a segmentation map corresponding to the altered condition of the dental site.

In another aspect of the present disclosure, a method includes receiving a video comprising a face of an individual that is representative of a current condition of a dental site of the individual. The method further includes segmenting each of a plurality of frames of the video to detect the face and a dental site of the individual. The method further includes identifying, within a 3D model library, an initial 3D model representing a best fit to the detected face in each of the plurality of frames according to one or more criteria; identifying, within the 3D model library, a final 3D model associated with the initial 3D model, the final 3D model corresponding to a version of the initial 3D model representing an altered condition of the dental site. The method further includes generating replacement frames for each of the plurality of frames based on the final 3D model.

In another aspect of the present disclosure, a method includes receiving an image or sequence of images comprising a face of an individual that is representative of a current condition of a dental site of the individual. The method further includes estimating tooth shape of the dental site from the image or sequence of images to generate a 3D model representative of the dental site. The method further includes generating a predicted 3D model corresponding to an altered representation of the dental site. The method further includes modifying the image or sequence of images by rendering the dental site to appear as the altered representation based on the predicted 3D model.

In another aspect of the present disclosure, a method includes receiving an image comprising a face of an individual. The method further includes receiving a driver sequence comprising a plurality of animation frames, each frame comprising a representation of facial landmarks of a face and an orientation of the face. The method further includes generating a video by mapping the image to the driver sequence.

In another aspect of the present disclosure, a method includes receiving a video comprising a face of an individual that is representative of a current condition of a dental site of the individual. The method further includes generating a 3D model representative of the head of the individual based on the video. The method further includes estimating tooth shape of the dental site from the video, wherein the 3D model comprises a representation of the dental site based on the tooth shape estimation.

In another aspect of the present disclosure, a method includes obtaining video data of a dental patient. The video data includes multiple frames. The method further includes obtaining an indication of selection criteria in association with the video data. The selection criteria includes conditions related to a target dental treatment of the dental patient. The method further includes performing an analysis procedure on the video data. Performing the analysis procedure includes determining a first score for each frame of the video data based on the selection criteria. Performing the analysis procedure further includes determining that a frame satisfies a threshold condition based on the first score. The method further includes selecting the frame responsive to determining that the first frame satisfies the threshold condition.

In another aspect of the present disclosure, a method includes obtaining a plurality of data including images of dental patients. The method further includes obtaining a plurality of classifications of the images based on selection criteria. The method further includes training a machine learning model to generate a trained machine learning model, using the images and the selection criteria. The trained machine learning model is configured to determine whether an input image of a dental patient satisfies a first threshold condition in connection with the first selection criteria.

In another aspect of the present disclosure, a method includes obtaining video data of a dental patient including a plurality of frames. The method further includes obtaining an indication of selection criteria in association with the video data. The selection criteria include one or more conditions related to a target dental treatment of the dental patient. The method further includes performing an analysis procedure on the video data. Performing the analysis procedure includes determining a set of scores for each of the plurality of frames based on the selection criteria. Performing the analysis procedure further includes determining that a first frame satisfies a first condition based on the set of scores, and does not satisfy a second condition based on the first set of scores. Performing the analysis procedure further includes providing the first frame as input to an image generation model. Performing the analysis procedure further includes providing instructions based on the second condition to the image generation model. Performing the analysis procedure further includes obtaining, as output from the image generation model, a first generated image that satisfies the first condition and the second condition. The method further includes providing the first generated image as output of the analysis procedure.

### BRIEF DESCRIPTION OF THE DRAWINGS

The present disclosure is illustrated by way of example, and not by way of limitation in the figures of the accompanying drawings.

FIG. 1A is a block diagram illustrating an exemplary system architecture, according to some embodiments.

FIG. 1B illustrates videos of a patient's dentition before and after dental treatment, according to some embodiments.

FIG. 2 illustrates a system for treatment planning and/or video generation, according to some embodiments.

FIG. 3A illustrates a workflow for a video processing module that generates modified videos showing altered conditions of dentition of a subject, according to some embodiments.

FIG. 3B illustrates a model training workflow and a model application workflow, according to some embodiments.

FIG. 4 illustrates images of a face after performing landmarking, in accordance with an embodiment of the present disclosure.

FIG. 5A illustrates images of a face after performing mouth detection, in accordance with an embodiment of the present disclosure.

FIG. 5B illustrates a cropped video frame of a face that has been cropped around a boundary region that surrounds an inner mouth area, in accordance with an embodiment of the present disclosure.

FIG. 5C illustrates an image of a face after landmarking and mouth detection, in accordance with an embodiment of the present disclosure.

FIG. 6 illustrates segmentation of a mouth area of an image of a face, in accordance with an embodiment of the present disclosure.

FIG. 7A illustrates fitting of a 3D model of a dental arch to an image of a face, in accordance with an embodiment of the present disclosure.

FIG. 7B illustrates a comparison of the fitting solution for a current frame and a prior fitting solution for a previous frame, in accordance with an embodiment of the present disclosure.

FIG. 7C illustrates fitting of a 3D model of a dental arch to an image of a face, in accordance with an embodiment of the present disclosure.

FIG. 7D illustrates fitting of a 3D model of an upper dental arch to an image of a face, in accordance with an embodiment of the present disclosure.

FIG. 7E illustrates fitting of 3D model of a lower dental arch to an image of a face, in accordance with an embodiment of the present disclosure.

FIG. 7F illustrates fitting of a lower dental arch to an image of a face using a jaw articulation model, in accordance with an embodiment of the present disclosure.

FIG. 8A illustrates a trained machine learning model that outputs teeth contours of an estimated future condition of a dental site and normals associated with the teeth contours, in accordance with an embodiment of the present disclosure.

FIG. 8B shows a cropped frame of a face being input into a segmenter, in accordance with an embodiment of the present disclosure.

FIG. 8C illustrates feature extraction of an inner mouth area of a frame from a video of a face, in accordance with an embodiment of the present disclosure.

FIG. 9 illustrates generation of a modified image of a face using a trained machine learning model, in accordance with an embodiment of the present disclosure.

FIG. 10A illustrates training of a machine learning model to perform segmentation, in accordance with an embodiment of the present disclosure.

FIG. 10B illustrates training of a machine learning model to perform generation of modified images of faces, in accordance with an embodiment of the present disclosure.

FIG. 10C illustrates training of a machine learning model to perform generation of modified images of faces, in accordance with an embodiment of the present disclosure.

FIG. 10D illustrates training of a machine learning model to perform generation of modified images of faces, in accordance with an embodiment of the present disclosure.

FIG. 10E is a diagram depicting data flow for generation of an image of a dental patient, according to some embodiments.

FIG. 11A is a flow diagram of a method for generating a dataset for a machine learning model, according to some embodiments.

FIG. 11B is a flow diagram of a method for extracting a dental image, according to some embodiments.

FIG. 11C is a flow diagram of a method for training a machine learning model for generating a dental patient image, according to some embodiments.

FIG. 11D is a flow diagram of a method for generating an image in association with an analysis procedure, according to some embodiments.

FIG. 11E is a flow diagram of a method for generating an output frame from video data based on a system prompt to a user, according to some embodiments.

FIG. 11F illustrates a flow diagram for a method of generating a video of a dental treatment outcome, in accordance with an embodiment.

FIG. 12 illustrates a flow diagram for a method of generating a video of a dental treatment outcome, in accordance with an embodiment.

FIG. 13 illustrates a flow diagram for a method of fitting a 3D model of a dental arch to an inner mouth area in a video of a face, in accordance with an embodiment.

FIG. 14 illustrates a flow diagram for a method of providing guidance for capture of a video of a face, in accordance with an embodiment.

FIG. 15 illustrates a flow diagram for a method of editing a video of a face, in accordance with an embodiment.

FIG. 16 illustrates a flow diagram for a method of assessing quality of one or more frames of a video of a face, in accordance with an embodiment.

FIG. 17 illustrates a flow diagram for a method of generating a video of a subject with an estimated future condition of the subject, in accordance with an embodiment.

FIG. 18 illustrates a flow diagram for a method of generating a video of a subject with an estimated future condition of the subject, in accordance with an embodiment.

FIG. 19 illustrates a flow diagram for a method of generating images and/or video having one or more subjects with altered dentition using a video or image editing application or service, in accordance with an embodiment.

FIG. 20 illustrates a flow diagram for a method of selecting an image or frame of a video comprising a face of an individual based on an orientation of one or more 3D models of one or more dental arches, in accordance with an embodiment.

FIG. 21 illustrates a flow diagram for a method of adjusting an orientation of one or more 3D models of one or more dental arches based on a selected image or frame of a video comprising a face of an individual, in accordance with an embodiment.

FIG. 22 illustrates a flow diagram for a method of modifying a video to include an altered condition of a dental site, in accordance with an embodiment.

FIG. 23 illustrates mapping of an input segmented image to an output segmented image, in accordance with an embodiment.

FIG. 24 illustrates a flow diagram for a method of modifying a video based on a 3D model fitting approach to include an altered condition of a dental site.

FIG. 25 illustrates a flow diagram for a method of modifying a video based on a non-rigid 3D model fitting approach to include an altered condition of a dental site, in accordance with an embodiment.

FIG. 26 illustrates encoding of 3D models and 2D images into latent vectors and decoding into 3D models, in accordance with an embodiment.

FIG. 27 illustrates an pipeline for predicting treatment outcomes of a 3D dentition model, in accordance with an embodiment.

FIG. 28 illustrates an approach for optimizing latent space vectors, in accordance with at least one embodiment.

FIG. 29 illustrates a differentiable rendering pipeline for generating photorealistic renderings of a predicted dental site, according to an embodiment.

FIG. 30 illustrates an exemplary pipeline for generating photorealistic and deformable NeRF models, in accordance with at least one embodiment.

FIG. 31 illustrates the components of an exemplary NeRF architecture, in accordance with at least one embodiment.

FIG. 32 illustrates a flow diagram for a method of animating a 2D image, in accordance with an embodiment.

FIG. 33 illustrates frames of a driver sequence, in accordance with an embodiment.

FIG. 34 illustrates a flow diagram for a method of estimating altered condition of a dental site from a video of a face of an individual, in accordance with an embodiment.

FIG. 35A illustrates a tooth repositioning system including a plurality of appliances, in accordance with some embodiments.

FIG. 35B illustrates a method of orthodontic treatment using a plurality of appliances, in accordance with some embodiments.

FIG. 36 illustrates a method for designing an orthodontic appliance to be produced by direct fabrication, in accordance with some embodiments.

FIG. 37A illustrates a method for digitally planning an orthodontic treatment and/or design or fabrication of an appliance, in accordance with some embodiments.

FIG. 37B illustrates a method 3750 for generating predicted 3D model based on an image or sequence of images, in accordance with embodiments. The method 3750 can be applied to any of the treatment procedures described herein and can be performed by any suitable data processing system.

FIG. 38 is a block diagram illustrating a computer system, according to some embodiments.

### DETAILED DESCRIPTION

Described herein are technologies related to extracting and/or generating an image and/or video for use in dental treatment operations (e.g., from video data and/or image data of a dental patient). Included embodiments include extracting an image from a video for use in further operations, generation of an image based on input video data, and generation of video data with one or more altered characteristics compared to the input video data. An extracted or generated image may be of use for one or more operations, such as treatment predictions, treatment tracking, treatment planning, or the like. The image may conform to a set of selection criteria, for example, a set of selection criteria related to the intended use of the image. A generated video may differ from a captured video of current conditions of an individual's face, smile, dentition, or the like, by providing an estimated future condition of the individual.

One or more images of a dental patient may be utilized for various treatment and treatment-related operations. For example, images of a face-on view including teeth may be utilized for determining procedures in a dental treatment plan, images of a profile including teeth may be utilized in tracking progress of a dental treatment plan, images of a social smile may be utilized in predicting results of a proposed treatment plan, or the like.

In some systems, a variety of image types may be collected for corresponding purposes. A treatment provider (e.g., practitioner, physician, doctor, etc.) may capture a series of images each corresponding to a different goal, different tool, different use case for a treatment package, or the like. In some systems, this may incur significant cost in terms of practitioner time, patient time, etc. For example, several different types of images may be required, which many include several iterations of taking photos of the patient, consulting a list of target photos, providing updated instructions to the patient, taking more photos, etc., until all target images of the dental patient have been captured. Performing all image capture operations to generate all images, ensure the images are of high enough quality to be used for their intended purposes, etc., may be expensive, time consuming, inconvenient, involve input or screening by a practitioner (e.g., cannot be performed by a dental patient alone), may include additional expense to a patient to travel to the practitioner, etc.

Further, it may be useful to generate video data depicting an estimated future condition of a dental patient, e.g., after their dental or orthodontic treatment. In some systems, predictive images and video may be generated based on a three-dimensional model of the patient's dentition. In conventional systems, such models may be generated based on a scan of the patient's dentition, such as an intraoral scan. Intraoral scans often include expensive equipment, additional cost of a patient traveling to a practitioner, time by a practitioner to perform the scanning, as well as expensive data transfer for potentially large model files for manipulation to generate predictive images or video.

In some systems, a doctor, technician or patient may generate one or more images of their smile, teeth, etc. The image or images may then be processed by a system that modifies the images to generate post-treatment version images. However, such a modified image shows a limited amount of information. From such a modified image the doctor, technician, and/or patient is only able to assess what the patient's dentition will look like under a single facial expression and/or head pose. Single images are not as immersive as a video because the single images don't capture multiple natural poses, smiles, movements, and so on that are all captured from a video showing a patient's smile. Additionally, single images don't provide coverage of the patient's smile from multiple angles. Such systems that generate post treatment versions of images of patient smiles are not able to generate post treatment versions of videos. Even if a video of a patient's face were to be captured, the frames of the video were to be separated out, and a system that generates post-treatment versions of each of the frames were to be generated, such post treatment frames would not have temporal continuity or stability. Accordingly, a subject in such a modified video would be jerky, and the modified information in the video would change from frame to frame, rendering the video unusable for assessing what the patient's dentition would look like after treatment.

Systems and methods of the current disclosure may address one or more shortcomings of conventional methods. In some embodiments, a video of a dental patient is captured. The video may include a series of frames. The video may include various motions, actions, gestures, facial expressions, etc., of the dental patient. A system (e.g., a processing device executing instructions) may extract or generate one or more images (e.g., frames) based on a video of the dental patient for use in further dental treatments.

In some embodiments, video data of a dental patient (which may include a potential patient, a person exploring dental or orthodontic treatment, or the like) is generated using a device for capturing video. The video data may be used to extract, select, and/or generate images of the dental patient. Individual frames may be extracted from the video. The frames may be provided for frame analysis. Frame analysis may result in a scoring, ordering, and/or classification of frames. A frame may be selected or generated (e.g., based on portions of images of multiple frames) to be output as an image of the dental patient.

Frame analysis may include a number of operations. Analysis may include detecting features present in an image, such as body parts, facial key points, or the like. Features detected in a frame may be analyzed. Analysis may include determining metrics or measurements of interest based on the feature detection. For example, detected features such as facial features or facial key points may be used to determine characteristics of interest such as gaze direction, eye opening, mouth or bite opening, teeth visibility, facial expression or emotion, etc. The metrics of interest may be used, in combination with selection criteria related to a target set of characteristics in connection with intended use of an output dental patient image, to generate scores of various components of the frames. For example, a social smile picture may score facial expression, gaze direction, tooth visibility, and head rotation to enable selection of a frame including a social smile. Component scores may be composed to build an evaluation function. The scoring function may be evaluated for each analyzed frame. Output of the analysis procedure may include one or more frames that have the highest score in association with the selection requirements, one or more frames that meet a threshold condition in association with the selection requirements, or the like.

In some embodiments, no frame may satisfy a threshold condition to be utilized for dental treatment. For example, no frame may include all of the target characteristics for an image of the dental patient. A video generated to extract a social smile, for example, may not include any frames that include adequate tooth exposure, correct gaze direction, and head rotation. Multiple frames of the video may be utilized to generate an image of the dental patient that does include all (or an increased portion) of target characteristics for the output dental patient image. In some embodiments, an inpainting technique or another image combination technique may be used to combine frames that each include a different set of one or more target characteristics to generate an image of the dental patient including all (or an increased portion) of the target characteristics. In some embodiments, one or more images (e.g., frames of video data) may be provided to a trained machine learning model to generate the image of the dental patient. In some embodiments, images may be provided to a generative adversarial network (GAN), along with instructions to adjust characteristics of the images, to form the target image of the dental patient. In some embodiments, a three-dimensional reconstruction of the dental patient's face may be formed based on the video data. An image may be rendered from the three-dimensional reconstruction, with adjustments made to characteristics (e.g., gaze direction, head rotation, expression, etc.), such that a resulting rendered image includes target characteristics to enable use of the image for further dental treatment operations and/or other operations.

In some embodiments, scoring of frames may be performed by a scoring function, such as a function that weights various characteristics of a generated image based on their relative importance to a target image of a dental patient. In some embodiments, scoring, frame output, image generation, or the like may be performed by one or more trained machine learning models. In some embodiments, a frame may be extracted by a trained machine learning model based on training data including classification of images for suitability for one or more target dental treatment operations. In some embodiments, an image may be generated by one or more trained machine learning models in accordance with the selection criteria for a target image type.

In some embodiments, selection criteria may be provided by providing a reference image. A reference image including one or more target characteristics may be provided, along with video data of the dental patient, to one or more trained machine learning models. For example, for generation or extraction of an image including a social smile, a reference image including a social smile may be provided. The model may be trained to select a frame, and/or generate an image based on frames of the video data including characteristics exhibited by the reference image.

In some embodiments, live guidance may be provided during capture of a video of a dental patient. For example, frames generated during video capture may be provided to one or more analysis functions (e.g., scoring functions, trained machine learning models configured to score or classify frames, or the like). Upon analysis, target characteristics, target sets of characteristics (e.g., in a single frame), or the like may be checked to determine whether adequately included in the video data. Guidance may be provided (e.g., live guidance, via the video capture device, etc.) directing a user as to characteristics and/or target images that have been captured, that have yet to be captured, etc.

In addition to frame extraction operations, video modifying operations may be utilized for producing predictive results of a patient's dentition based on video input of the patient (e.g., pre-treatment video). In some embodiments, video modification may be performed by a user device of the individual patient (e.g., a mobile device may be used to capture and image and/or video, perform some or all of the processing, and display output), by the mobile device with a server device, a device of a treatment provider, etc.

Also described herein a methods and systems for an image or video editing application, plugin and/or service that can alter dentition of one or more individuals in one or more images and/or a video. Also described herein are methods and systems for generating videos of an estimated future condition of other types of subjects based on modifying a captured video of a current condition of the subjects, in accordance with embodiments of the present disclosure. Also described herein are methods and systems for guiding an individual during video capture of the individual's face to ensure that the video will be of sufficient quality to process that video in order to generate a modified video with an estimated future condition of the individual's dentition, in accordance with embodiments of the present disclosure. Also described herein are methods and systems for selecting images and/or frames of a video based on a current orientation (e.g., view angle) of one or more 3D models of dental arches of an individual. In at least one embodiment, an orientation of a jaw of the individual in the selected image(s) and/or frame(s) matches or approximately matches an orientation of a 3D model of a dental arch of the individual. Also described herein are methods and systems for updating an orientation of one or more 3D models of an individual's dental arch(es) based on a selected image and/or frame of a video. In at least one embodiment, a selected frame or image includes a jaw of the individual having a specific orientation, and the orientation of the one or more 3D models of the dental arch(es) is updated to match or approximately match the orientation of the jaw(s) of the individual in the selected image or frame of a video.

Certain embodiments of the present disclosure allow for visualization of dental treatment results based on images or videos of the individual's face and teeth without the requirement for intraoral scan data as input. A simulated output video may be generated for which the individual's current dentition is replaced with a predicted dentition, which may simulate a possible treatment outcome and can be rendered in a photo-realistic or near-photo-realistic manner. One or more of the present embodiments provide the following advantages over current methods including, but not limited to visualizing dental treatment outcomes without utilizing intraoral scan data as input, and generating dental treatment prediction based on actual historical treatment data rather than based on two-dimensional filter overlays.

In at least one embodiment, image features can be extracted from video captured by a client device operated by an individual (e.g., patient), using, for example, segmentation and contour identification in a frame-by-frame manner. A machine learning model can be trained to learn a mapping of pre-treatment segmentation of the dental site to a post-treatment segmentation of a predicted image. For embodiments that utilize a video as input, the methodologies may utilize various criteria to compute the mapping in a temporally stable and consistent manner. In an end-to-end approach, for example, a neural network can be trained to disentangle the pose (camera angle and lip position) and dental site information (teeth position and optional shape).

Certain embodiments utilize 3D model fitting to estimate the individual's dentition. In at first embodiment, a rigid fitting algorithm may be applied using 3D model data sourced from a library of 3D models. Rigid pose parameters during the fitting may be optimized, for example, based on a set of cost functions. For example, when implemented locally with client device, a plurality of 3D models may be fit to one or more frames of captured video based on the cost functions, and the 3D model corresponding to the smallest fitting error may be selected and used as the basis for prediction of post-treatment.

In a further embodiment that utilizes non-rigid fitting, the fitting would involve optimization of jaw parameters to generate a 3D model of the individual's jaw that best matches with the input images or video obtained by the client device. The captured image or one or more video frames can be used to identify teeth shape, which are then used to estimate and generate tooth shape to create a personalized 3D model of the individual's dentition. This 3D model can then be modified to simulate a dental treatment plan, and a predicted video of the post-treatment dentition can be generated by rendering the modified 3D model and presented for display by the client device. Various methodologies useful for estimation of the dental site include, without limitation: optimization-based approaches for estimating the 3D dentition include extracting contour and image features that can be used to optimize the shape and position of 3D teeth to match the image for all frames of the video; differentiable rendering approaches that utilize volumetric rendering techniques; and learning-based approaches that map from image to model space where a 2D latent encoder can be trained to extract 3D shape information from a 2D image.

A further embodiment may start with a single current image, or multiple current images, of the individual's face or a predicted post-treatment image as input, from which an animation can be generated using a driver sequence.

A further embodiment may start with a video as input and utilize a differentiable rendering pipeline to compute a 3D model representative of the user's head and dentition. The model may be modified to predict post-treatment outcomes, and then rendered to generate a predicted video of post-treatment results.

The methods and systems described herein may perform a sequence of operations to identify areas of interest in frames of a video (e.g., such as a mouth area of a facial video) and/or images, determine a future condition of the area of interest, and then modify the frames of the video and/or images by replacing the current version of the area of interest with an estimated future version of the area of interest or other altered version of the area of interest. In at least one embodiment, the other altered version of the area of interest may not correspond to a normally achievable condition. For example, an individual's dentition may be altered to reflect vampire teeth, monstrous teeth such as tusks, filed down pointed teeth, enlarged teeth, shrunken teeth, and so on. In other examples, an individual's dentition may be altered to reflect unlikely but possible conditions, such as edentulous dental arches, dental arches missing a collection of teeth, highly stained teeth, rotted teeth, and so on. In at least one embodiment, a video may include faces of multiple individuals, and the methods and systems may identify the individuals and separately modify the dentition of each of the multiple individuals. The dentition for each of the individuals may be modified in a different manner in embodiments.

In at least one embodiment, a 3D model of a patient's teeth is provided or determined, and based on the 3D model of the patient's teeth a treatment plan is created that may change teeth positions, shape and/or texture. A 3D model of the post-treatment condition of the patient's teeth is generated as part of the treatment plan. The 6D position and orientation of the pre-treatment teeth in 3D space may be tracked for frames of the video based on fitting performed between frames of the video and the 3D model of the current condition of the teeth.

Features of the video or image may be extracted from the video or image, which may include color, lighting, appearance, and so on. One or more deep learning models such as generative adversarial networks and/or other generative models may be used to generate a modified video or image that incorporates the post-treatment or other altered version of the teeth with the remainder of the contents of the frames of the received video or the remainder of the image. With regards to videos, these operations are performed in a manner that ensures temporal stability and continuity between frames of the video, resulting in a modified video that may be indistinguishable from a real or unmodified video. The methods may be applied, for example, to show how a patient's teeth will appear after orthodontic treatment and/or prosthodontic treatment (e.g., to show how teeth shape, position and/or orientation is expected to change), to alter the dentition of one or more characters in and/or actors for a movie or film (e.g., by correcting teeth, applying one or more dental conditions to teeth, removing teeth, applying fantastical conditions to teeth, etc.), and so on. For example, the methods may be applied to generate videos showing visual impact to tooth shape of restorative treatment, visual impact of removing attachments (e.g., attachments used for orthodontic treatment), visual impact of performing orthodontic treatment, visual impact of applying crowns, veneers, bridges, dentures, and so on, visual impact of filing down an individual's teeth to points, visual impact of vampire teeth, visual impact of one or more missing teeth (e.g., of edentulous dental arches), and so on.

Embodiments are capable of pre-visualizing a variety of dental treatments and/or dental alterations that change color, shape, position, quantity, etc. of teeth. Examples of such treatments include orthodontic treatment, restorative treatment, implants, dentures, teeth whitening, and so on. The system described herein can be used, for example, by orthodontists, dental and general practitioners, and/or patients themselves. In at least one embodiment, the system is usable outside of a clinical setting, and may be an image or video editing application that executes on a client device, may be a cloud-based image or video editing service, etc. For example, the system may be used for post-production of movies to digitally alter the dentition of one or more characters in and/or actors for the movie to achieve desired visual effects. In at least one embodiment, the system is capable of executing on standard computer hardware (e.g., that includes a graphical processing unit (GPU)). The system can therefore be implemented on normal desktop machines, intraoral scanning systems, server computing machines, mobile computing devices (e.g., such as a smart phone, laptop computer, tablet computer, etc.), and so forth.

In at least one embodiment, a video processing pipeline is applied to images and/or frames of a video to transform those images/frames from a current condition into an estimated future condition or other altered condition. Machine learning models such as neural networks may be trained for performing operations such as key point or landmark detection, segmentation, area of interest detection, fitting or registration, and/or synthetic image generation in the image processing pipeline. Embodiments enable patients to see what their smile will look like after treatment. Embodiments also enable modification of teeth of one or more individuals in images and/or frames of a video (e.g., of a movie) in any manner that is desired.

In at least one embodiment, because a generated video can show a patient's smile from various angles and sides, it provides a better understanding of the 3D shape and position changes to their teeth expected by treatment and/or other dentition alterations. Additionally, because the generated video can show a patient's post-treatment smile and/or other dentition alterations under various expressions, it provides a better understanding of how that patient's teeth will appear after treatment and/or after other changes.

In at least one embodiment, the system may be run in real time or near-real time (e.g., on-the-fly) to create an immersive augmented reality (AR) experience. For example, a front or back camera of a smartphone may be used to generate a video, and the video may be processed by logic on the smartphone to generate a modified video or may be sent to a cloud server or service that may process the video to generate a modified video and stream the modified video back to the smartphone. In either instance, the smartphone may display the modified video in real time or near-real time as a user is generating the video. Accordingly, the smartphone may provide a smart mirror functionality or augmented reality functionality in embodiments.

The same techniques described herein with reference to generating videos and/or images showing an estimated future condition of a patient's dentition also applies to videos and/or images of other types of subjects. For example, the techniques described herein with reference to generating videos of a future dentition may be used to generate videos showing a person's face and/or body at an advanced age (e.g., to show the effects of aging, which may take into account changing features such as progression of wrinkles), to generate videos showing a future condition of the patient's face and/or body. For example, the future condition may correspond to other types of treatments or surgeries (e.g., plastic surgery, addition of prosthetics, etc.), and so on. Accordingly, it should be understood that the described examples associated with teeth, dentition, smiles, etc. also apply to any other type of object, person, living organism, place, etc. whose condition or state might change over time. Accordingly, in embodiments the techniques set forth herein may be used to generate, for example, videos of future conditions of any type of object, person, living organism, place, etc.

In some embodiments, a system and/or method operate on a video to modify the video in a manner that replaces areas of interest in the video with estimated future conditions or other altered conditions of the areas of interest such that the modified video is temporally consistent and stable between frames. One or more operations in a video processing pipeline are designed for maintaining temporal stability and continuity between frames of a video, as is set forth in detail below. Generating modified versions of videos showing future conditions and/or other altered conditions of a video subject is considerably more difficult than generating modified images showing a future condition and/or other altered condition of an image subject, and the design of a pipeline capable of generating modified versions of video that are temporally stable and consistent between frames is a non-trivial task.

Consumer smile simulations are simulated images or videos generated for consumers (e.g., patients) that show how the smiles of those consumers will look after some type of dental treatment (e.g., such as orthodontic treatment). Clinical smile simulations are generated simulated images or videos used by dental professionals (e.g., orthodontists, dentists, etc.) to make assessments on how a patient's smile will look after some type of dental treatment. For both consumer smile simulations and clinical smile simulations, a goal is to produce a mid-treatment or post-treatment realistic rendering of a patient's smile that may be used by a patient, potential patient and/or dental practitioner to view a treatment outcome. For both use cases, the general process of generating a simulated video showing a post-treatment smile includes taking a video of the patient's current smile, simulating or generating a treatment plan for the patient that indicates post-treatment positions and orientations for teeth and gingiva, and converting data from the treatment plan back into a new simulated video showing the post-treatment smile. Embodiments generate smile videos showing future conditions of patient dentition in a manner that is temporally stable and consistent between frames of the video. This helps doctors to communicate treatment results to patients, and helps patients to visualize treatment results and make a decision on dental treatment. After a smile simulation video is generated, the patient and doctor can easily compare the current condition of the patient's dentition with the post-treatment condition of the dentition and make a treatment decision. Additionally, if there are different treatment options, then multiple post-treatment videos may be generated, one for each treatment option. The patient and doctor can then compare the different post-treatment videos to determine which treatment option is preferred. Additionally, for doctors and dental labs, embodiments help them to plan a treatment from both an aesthetic and functional point of view, as they can see the patient acting naturally in post-processed videos showing their new teeth. Embodiments also generate videos showing future conditions of other types of subjects based on videos of current conditions of the subjects.

In at least one embodiment, videos should meet certain quality criteria in order for the videos to be candidates to be processed by a video processing pipeline that will generate a modified version of such videos that show estimated future conditions of one or more subjects in the videos. It is much more challenging to capture a video that meets several quality constraints or criteria than it is to capture a still image that meets several quality constraints or criteria, since for the video the conditions should be met by a temporally continuous video rather than by a single image. In the context of dentistry and orthodontics, a video of an individual's face should meet certain video and/or image quality criteria in order to be successfully processed by a video processing pipeline that will generate a modified version of the video showing a future condition of the individual's teeth or dentition. Accordingly, in embodiments a method and system provide guidance to a doctor, technician and/or patient as to changes that can be made during video capture to ensure that the captured video will be of adequate quality. Examples of changes that can be made include moving the patient's head, rotating the patient's head, slowing down movement of the patient's head, changing lighting, reducing movement of a camera, and so on. The system and method may determine one or more image quality metric values associated with a captured video, and determine whether any of the image quality metric values fail to satisfy one or more image quality criteria.

Once a video is captured that satisfies quality criteria, some frames of the video may still fail to satisfy the quality criteria even though the video as a whole satisfies the quality criteria. Embodiments are able to detect frames that fail to meet quality standards and determine what actions to take for such frames. In at least one embodiment, such frames that fail to satisfy the quality criteria may be removed from the video. In at least one embodiment, the removed frames may be replaced with interpolated frames that are generated based on surrounding frames of the removed frame (e.g., one or more frames prior to the removed frame and one or more frames after the removed frame). In at least one embodiment, additional synthetic frames may also be generated between existing frames of a video (e.g., to upscale the video). Instead of or in addition to removing one or more frames of the video that fail to meet quality standards, processing logic may show such frames with a different visualization than frames that do meet the quality standards in some embodiments. Embodiments increase the success and effectiveness of video processing systems that generate modified versions of videos showing future conditions of one or more subjects of the videos.

In dental treatment planning and visualization, a 3D model of an upper dental arch and a 3D model of a lower dental arch of a patient may be generated and displayed. The 3D models of the dental arches may be rotated, panned, zoomed in, zoomed out, articulated (e.g., where the relationship and/or positioning between the upper dental arch 3D model and lower dental arch 3D model changes), and so on. Generally, the tools for manipulating the 3D models are cumbersome to use, as the tools are best suited for adjustments in two dimensions, but the 3D models are three dimensional objects. As a result, it can be difficult for a doctor or technician to adjust the 3D models to observe areas of interest on the 3D models. Additionally, it can be difficult for a doctor or patient to visualize how their dental arch might appear in an image of their face.

In at least one embodiment, the system includes a dentition viewing logic that selects images and/or frames of a video based on a determined orientation of one or more 3D models of a patient's dental arch(es). The system may determine the current orientation of the 3D model(s), determine a frame or image comprising the patient's face in which an orientation of the patient's jaw(s) match the orientation of the 3D model(s), select the frame or image, and then display the selected frame or image along with the 3D model(s) of the patient's dental arches. This enables quick and easy selection of an image or frame showing a desired jaw position, facial expression, and so on.

In at least one embodiment, the system includes a dentition viewing logic that receives a selection of a frame or image, determines an orientation of an upper and/or lower jaw of a patient in the selected frame or image, and then updates an orientation of 3D models of the patient's upper and/or lower dental arches to match the orientation of the upper and/or lower jaws in the selected image or frame. This enables quick and easy manipulation of the 3D models of the dental arch(es) of the patient.

Embodiments are discussed with reference to generating modified videos that show future conditions of one or more subjects (e.g., such as future patient smiles). Embodiments may also use the techniques described herein to generate modified videos that are from different camera angles from the originally received video(s). Additionally, embodiments may use a subset of the techniques described herein to generate modified images that are not part of any video. Additionally, embodiments may use the techniques described herein to perform post production of movies (e.g., by altering the dentition of one or more characters in and/or actors for the movies), to perform image and/or video editing outside of a clinical setting, and so on.

Embodiments are discussed with reference to generating modified videos that show modified versions of dental sites such as teeth. The modified videos may also be generated in such a manner to show predicted or estimated shape, pose and/or appearance of the tongue and/or other parts of the inner mouth, such as checks, palate, and so on.

Embodiments are discussed with reference to identifying and altering the dentition of an individual in images and/or video. Any of these embodiments may be applied to images and/or video including faces of multiple individuals. The methods described for modifying the dentition of a single individual in images and video may be applied to modify the dentition of multiple individuals. Each individual may be identified, the updated dentition for that individual may be determined, and the image or video may be modified to replace an original dentition for that individual with updated dentition. This may be performed for each of the individuals in the image or video whose dentition is to be modified.

Methods and systems of the present disclosure provide advantages over conventional methods. A single video may be used to generate or extract images corresponding to any number of selection criteria, any number of intended uses of the image(s), to facilitate any treatment operations, or the like. Significant time may be spared by avoiding taking multiple pictures, checking each picture for quality and/or compliance with target characteristics, etc. Further, video data may be stored and utilized at a later date for generation of further images, e.g., for providing for treatment operations anticipated after initial generation of the video data. As further advantages of the present disclosure, video indicative of predictive adjustments may be generated based on simple measurement techniques (e.g., input video), improving throughput, convenience, and cost of generating predictive video data, and improving a user experience compared to 3D model predictive data or still image predictive data.

In one aspect of the present disclosure, a method includes receiving a video comprising a face of an individual that is representative of a current condition of a dental site of the individual. The method further includes segmenting each of a plurality of frames of the video to detect the face and the dental site of the individual to generate segmentation data. The method further includes inputting the segmentation data into a machine learning model trained to predict an altered condition of the dental site. The method further includes generating, from the machine learning model, a segmentation map corresponding to the altered condition of the dental site.

In another aspect of the present disclosure, a method includes receiving a video comprising a face of an individual that is representative of a current condition of a dental site of the individual. The method further includes segmenting each of a plurality of frames of the video to detect the face and a dental site of the individual. The method further includes identifying, within a 3D model library, an initial 3D model representing a best fit to the detected face in each of the plurality of frames according to one or more criteria; identifying, within the 3D model library, a final 3D model associated with the initial 3D model, the final 3D model corresponding to a version of the initial 3D model representing an altered condition of the dental site. The method further includes generating replacement frames for each of the plurality of frames based on the final 3D model.

In another aspect of the present disclosure, a method includes receiving an image or sequence of images comprising a face of an individual that is representative of a current condition of a dental site of the individual. The method further includes estimating tooth shape of the dental site from the image or sequence of images to generate a 3D model representative of the dental site. The method further includes generating a predicted 3D model corresponding to an altered representation of the dental site. The method further includes modifying the image or sequence of images by rendering the dental site to appear as the altered representation based on the predicted 3D model.

In another aspect of the present disclosure, a method includes receiving an image comprising a face of an individual. The method further includes receiving a driver sequence comprising a plurality of animation frames, each frame comprising a representation of facial landmarks of a face and an orientation of the face. The method further includes generating a video by mapping the image to the driver sequence.

In another aspect of the present disclosure, a method includes receiving a video comprising a face of an individual that is representative of a current condition of a dental site of the individual. The method further includes generating a 3D model representative of the head of the individual based on the video. The method further includes estimating tooth shape of the dental site from the video, wherein the 3D model comprises a representation of the dental site based on the tooth shape estimation.

In another aspect of the present disclosure, a method includes obtaining video data of a dental patient. The video data includes multiple frames. The method further includes obtaining an indication of selection criteria in association with the video data. The selection criteria includes conditions related to a target dental treatment of the dental patient. The method further includes performing an analysis procedure on the video data. Performing the analysis procedure includes determining a first score for each frame of the video data based on the selection criteria. Performing the analysis procedure further includes determining that a frame satisfies a threshold condition based on the first score. The method further includes selecting the frame responsive to determining that the first frame satisfies the threshold condition.

In another aspect of the present disclosure, a method includes obtaining a plurality of data including images of dental patients. The method further includes obtaining a plurality of classifications of the images based on selection criteria. The method further includes training a machine learning model to generate a trained machine learning model, using the images and the selection criteria. The trained machine learning model is configured to determine whether an input image of a dental patient satisfies a first threshold condition in connection with the first selection criteria.

In another aspect of the present disclosure, a method includes obtaining video data of a dental patient including a plurality of frames. The method further includes obtaining an indication of selection criteria in association with the video data. The selection criteria include one or more conditions related to a target dental treatment of the dental patient. The method further includes performing an analysis procedure on the video data. Performing the analysis procedure includes determining a set of scores for each of the plurality of frames based on the selection criteria. Performing the analysis procedure further includes determining that a first frame satisfies a first condition based on the set of scores, and does not satisfy a second condition based on the first set of scores. Performing the analysis procedure further includes providing the first frame as input to an image generation model. Performing the analysis procedure further includes providing instructions based on the second condition to the image generation model. Performing the analysis procedure further includes obtaining, as output from the image generation model, a first generated image that satisfies the first condition and the second condition. The method further includes providing the first generated image as output of the analysis procedure.

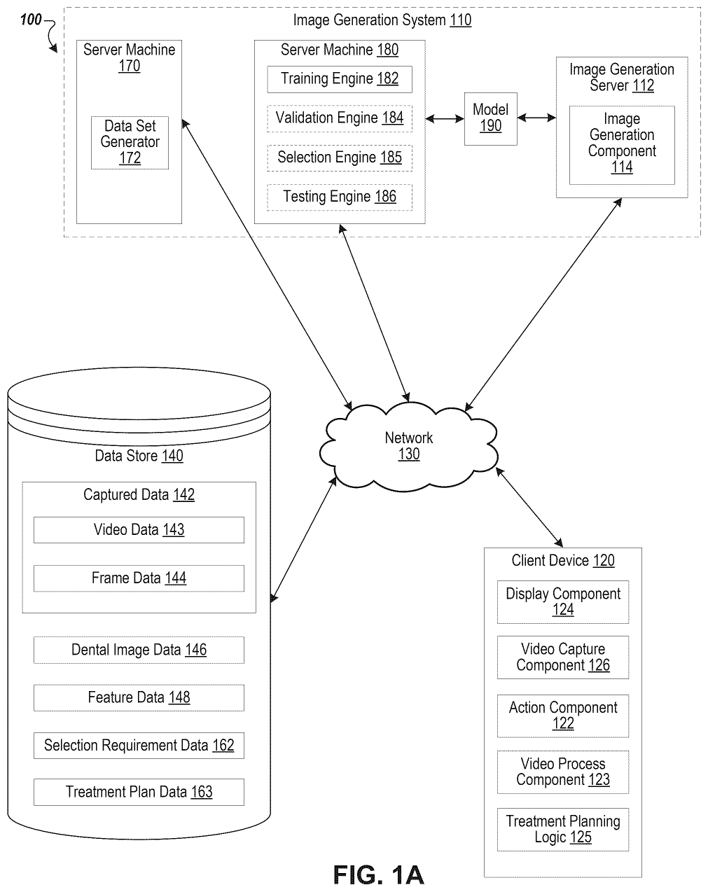

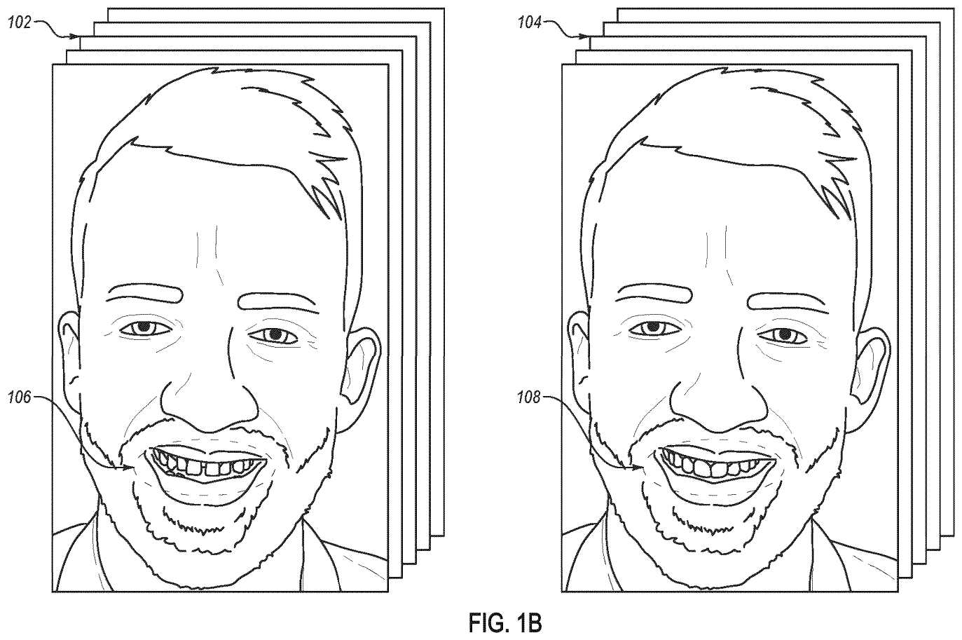

FIG. 1A is a block diagram illustrating an exemplary system 100 (exemplary system architecture), according to some embodiments. The system 100 includes a client device 120, image generation server 112, and data store 140. The image generation server 112 may be part of image generation system 110. Image generation system 110 may further include server machines 170 and 180. Various components of system 100 may communicate with each other via network 130.

Client device 120 may be a device utilized by a dental practitioner (e.g., a dentist, orthodontist, dental treatment provider, or the like). Client device 120 may be a device utilized by a dental patient (as use herein, a potential dental patient, previous dental patient, or the like are also described as dental patients, in the context of data in association with the individual's teeth, gums, jaw, dental arches, or the like). Client device 120 includes data display component 124, e.g., for a user to be presented information, such as prompts related to generating images for use in dental treatments and/or predictions. Client device 120 includes video capture component 126, e.g., a camera and microphone for capturing video data of a dental patient. Client device 120 includes action component 122, which may manipulate data, provide or receive data to or from network 430, provide video data to image generation component 114, or the like. Client device 120 includes video process component 123. Video process component 123 may be used, together with treatment planning logic 125, to modify one or more video files to indicate what a patient's face, smile, etc., may look like post-treatment, e.g., from multiple angles, views, expressions, etc. Client device 120 includes treatment planning logic 125. Treatment planning logic 125 may be responsible for generating a treatment plan that facilitates a target treatment outcome for a patient, e.g., dental or orthodontic treatment outcome. In some embodiments, more devices may be responsible for operations associated in FIG. 1A with client device 120, e.g., some functions may be performed by a first client device, other functions by a second client device, still further functions by a server device, etc. Treatment planning data, including input to treatment planning operations (e.g., indications of disorders, constraints, image data, etc.) and output of treatment planning operations (e.g., three-dimensional models of dentition, instructions for appliance manufacturing, etc.) may be stored in data store 140 as treatment plan data 163.

Client device 120 may include computing devices such as Personal Computers (PCs), laptops, mobile phones, smart phones, tablet computers, netbook computers, network connected televisions (“smart TV”), network-connected media players (e.g., Blu-ray player), a set-top-box, Over-the-Top (OTT) streaming devices, operator boxes, intraoral scanning systems (e.g., including an intraoral scanner and associated computing device), etc. Client device 120 may include an action component 122. Action component 122 may receive user input (e.g., via a Graphical User Interface (GUI) displayed via the client device 120) of an indication associated with dental data. In some embodiments, action component 122 transmits data to the image generation system 110, receives output (e.g., dental image data 146) from the image generation system 110, and provides that data to a further system for a dental treatment action to be implemented. In some embodiments, action component 122 obtains dental image data 146 and provides the data to a user via data display component 124.

Video capture component 126 may provide captured data 142 (e.g., including video data 143 and frame data 144). Video capture component 126 may include, one or more two-dimensional (2D) cameras and/or one or more three-dimensional (3D) cameras. Each 2D and/or 3D camera of video capture component 126 may include one or more images sensors, such as charge coupled devices (CCDs) and complementary metal oxide semiconductor (CMOS) sensors. Captured data 142 may include data provided by generating a video of a dental patient, e.g., including various poses, postures, expressions, head angles, tooth visibility, or the like. Captured data 142 may include data of one or more teeth. Captured data 142 may include data of a group or set of teeth. Captured data 142 may include data of a dental arch (e.g., an arch including or not including one or more teeth). Captured data 142 may include data of one or more jaws. Captured data 142 may include data of a jaw pair including an upper dental arch and a lower dental arch. Captured data 142 may include data of an upper arch and lower arch, comprising a jaw pair. Frame data 144 may include extracted frames from video data 143, as well as accompanying contextual data such as time stamps associated with the frames, which may be used for example to ensure that if multiple frames are requested, they are sufficiently different from each other by separating the frames in time.

In some embodiments, captured data 142 may be processed (e.g., by the client device 120 and/or by the image generation server 112). Processing of the captured data 142 may include generating features. In some embodiments, the features are a pattern in the captured data 142 (e.g., patterns related to pixel colors or brightnesses, perceived structures of images such as object edges, etc.) or a combination of values from the captured data 142. Captured data 142 may include features and the features may be used by image generation component 114 for performing signal processing and/or for obtaining dental image data 146, e.g., for implementing a dental treatment, for predicting results of a dental treatment, or the like.

In some embodiments, features from captured data 142 may be stored as feature data 148. Feature data 148 may be generated by providing captured data 142 (e.g., video data 143, frame data 144, images extracted from video data 143, or the like) to one or more models (e.g., model 190) for feature generation. Feature data 148 may be generated by providing data to a trained machine learning model, a rule-based model, a statistical model, or the like. Feature data 148 may include data based on multiple layers of data processing. For example, video data 143 may be provided to a first one or more models which detect facial key points. The facial key points may be included in feature data 148. The facial key points may further be provided to a model configured to determine facial metrics, such as head angle, facial expression, or the like. The facial metrics may also be stored as part of feature data 148. One or more of the features of feature data 148 may be utilized in extracting images of dental patients (e.g., as dental image data 146) from video data 143.

Each instance (e.g., set) of captured data 142 may correspond to an individual (e.g., dental patient), a group of similar dental arches, or the like. Data from an individual dental patient may be segmented in embodiments. For example, data from a single tooth or group of teeth of a jaw pair or dental arch may be identified, may be separated from data for other teeth, and/or may be stored, along with data of the complete jaw pair or dental arch. In some embodiments, segmentation is performed on frames of a video using a trained machine learning model. Segmentation may be performed to separate the contents of a frame into individual teeth, gingiva, lips, eyes, key points, and so on. The data store may further store information associating sets of different data types, e.g., information indicative that a tooth belongs to a certain jaw pair or dental arch, that a sparse three-dimensional intraoral scan belongs to the same jaw pair or dental arch as a two-dimensional image, or the like. In some embodiments, frame data 144 is segmented, and the segmentation information of the frame data 144 is processed by one or more trained machine learning models to generate one or more scores for the frame data. For example, for each frame a separate score may be determined for each of multiple criteria, and a combined score may be determined based on a combination of the separate scores. The combined score may be a score that is representative of the frame satisfying all indicated criteria. The criteria may be input into the trained machine learning model along with a frame in embodiments to enable the machine learning model to generate the one or more scores for the frame.

In some embodiments, image generation system 110 may generate dental image data 146 using supervised machine learning (e.g., dental image data 146 includes output from a machine learning model that was trained using labeled data, such as labeling frames of a video with attributes of the frames, including head angle, facial expression, teeth exposure, gaze direction, teeth area, etc.). In some embodiments, image generation system 110 may generate dental image data 146 using unsupervised machine learning (e.g., dental image data 146 includes output from a machine learning model that was trained using unlabeled data, output may include clustering results, principle component analysis, anomaly detection, groups of similar frames, etc.). In some embodiments, image generation system 110 may generate dental image data 146 using semi-supervised learning (e.g., training data may include a mix of labeled and unlabeled data, etc.).

In some embodiments, image generation system 110 may generate dental image data 146 in accordance with one or more selection requirements, which may be stored as selection requirement data 162 of data store 140. Selection requirements may include selections of various attributes for a target image as input by a user, e.g., for use with a target dental treatment or dental prediction application. Selection requirements may include a reference image, e.g., an image of a person including one or more features of interest, which image generation system 110 may capture in one or more generated images. In some embodiments, selection requirement data 162 may include selection requirements generated by a large language model (LLM), natural language processing model (NLP), or the like. A user may request (e.g., in natural language) one or more features for a generated image (e.g., a social smile including at least a selection of teeth), and a model may translate this natural language request into selection requirement data 162 for generation of one or more images for use in dental treatment. The determined selection requirement data may correspond to the one or more criteria that may be input into a trained ML model along with a frame to enable the ML model to determine whether the frame satisfies the one or more criteria (e.g., based on generating a score indicating a degree to which the frame satisfies the one or more criteria).

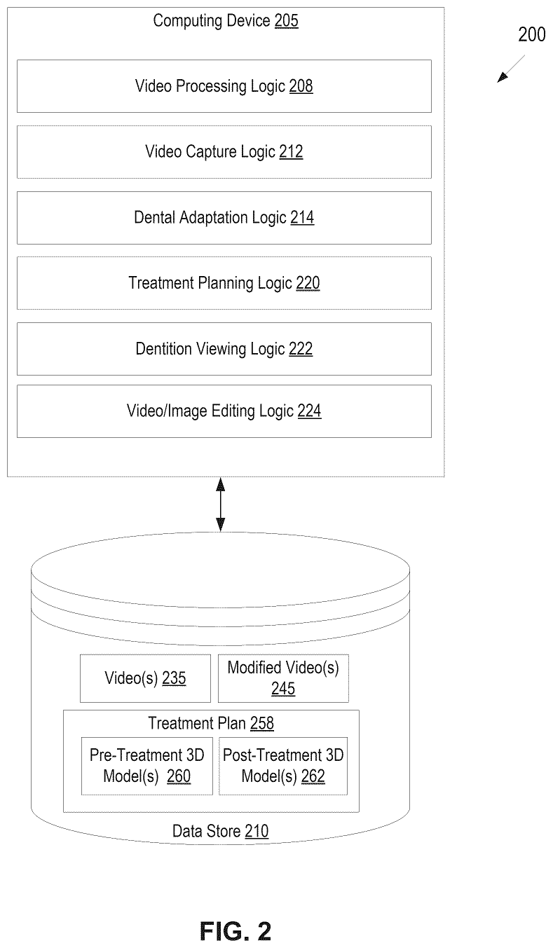

Image generation system 110 may generate video data, e.g., a series of corresponding images. The video data may be based on input video data, and may include adjusted or altered images. The altered video data may also be stored in a data store, as described in more detail in connection with FIG. 2.

Client device 120, image generation server 112, data store 140, server machine 170, and server machine 180 may be coupled to each other via network 130 for generating dental image data 146, e.g., to extract images of a dental patient in accordance with selection requirements, to generate images of a dental patient based on video data 143 in accordance with selection requirements, etc. In some embodiments, network 130 may provide access to cloud-based services. Operations performed by client device 120, image generation system 110, data store 140, etc., may be performed by virtual cloud-based devices.

In some embodiments, network 130 is a public network that provides client device 120 with access to the image generation server 112, data store 140, and other publicly available computing devices. In some embodiments, network 130 is a private network that provides client device 120 access to data store 140, components of image generation system 110, and other privately available computing devices. Network 130 may include one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

In some embodiments, action component 122 receives an indication of an action to be taken from the image generation system 110 and causes the action to be implemented. Each client device 120 may include an operating system that allows users to one or more of generate, view, provide, or edit data (e.g., captured data 142, dental image data 146, selection requirement data 162, etc.).

Actions to be taken via client device 120 may be associated with design of a treatment plan, updating of a treatment plan, providing an alert associated with a treatment plan to a user, predicting results of a treatment plan, requesting input from the user (e.g., of additional video data to satisfy one or more selection requirements), or the like.

Image generation server 112, server machine 170, and server machine 180 may each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc. Operations of image generation server 112, server machine 170, server machine 180, data store 140, etc., may be performed by a cloud computing service, cloud data storage service, etc.

Image generation server 112 may include an image generation component 114. In some embodiments, the image generation component 114 may receive captured data 142, (e.g., receive from the client device 120, retrieve from the data store 140) and generate output (e.g., dental image data 146) based on the input data. In some embodiments, captured data 142 may include one of more video clips of a dental patient, to be used in generating images of the dental patient conforming to one or more target selection requirements. In some embodiments, output of image generation component 114 may include altered video, e.g., video predicting post-treatment properties of a patient, video including target poses or expressions of the patient, or the like. In some embodiments, image generation component 114 may use one or more trained machine learning models 190 to output an image based on the input data. Alternatively, the trained ML model(s) 190 may output scores for images/frames, and one or more images/frames may be selected based on the scores. In some embodiments, one or more functions of image generation server 112 (e.g., operations of image generation component 114) may be executed by a different device, such as client device 120, a combination of devices, or the like.

System 100 may include one or more models, including machine leaning models, statistical models, rule-based models, or other algorithms for manipulating data, e.g., model 190. Models included in model(s) 190 may perform many tasks, including mapping dental arch data to a latent space, segmentation, extracting feature data from video frames, analyzing features extracted from video frames, scoring various components of video frames based on selection requirements, evaluating scoring, recommending one or more frames as being in compliance with selection requirements (or being closest aligned to selection requirements of the available frames), generating one or more images (e.g., synthetic frames) based on the input captured data 142, or the like. Model 190 may be trained using captured data 142, e.g., historically captured data that is provided with labels indicating compliance with target selection requirements. Model 190, once trained, may be provided with current captured data 142 as input for performing one or more operations, generating dental image data 146, or the like.

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs).

A recurrent neural network (RNN) is another type of machine learning model. A recurrent neural network model is designed to interpret a series of inputs where inputs are intrinsically related to one another, e.g., time trace data, sequential data, etc. Output of a perceptron of an RNN is fed back into the perceptron as input, to generate the next output.

A graph convolutional network (GCN) is a type of machine learning model that is designed to operate on graph-structured data. Graph data includes nodes and edges connecting various nodes. GCNs extend CNNs to be applicable to graph-structured data which captures relationships between various data points. GCNs may be particularly applicable to meshes, such as three-dimensional data.

Many other types and varieties of machine learning models may be utilized for one or more embodiments of the present disclosure. Further types of machine learning models that may be utilized for one or more aspects include transformer-based architectures, generative adversarial networks, volumetric CNNs, etc. Selection of a specific type of machine learning model may be performed responsive to an intended input and/or output data, such as selecting a model adapted to three-dimensional data to perform operations on three-dimensional models of dental arches, a model adapted to two-dimensional image data to perform operations based on images of a patient's teeth, etc.

Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize a scanning role. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

In some embodiments, image generation component 114 receives captured data 142, performs signal processing to break down the current data into sets of current data, provides the sets of current data as input to a trained model 190, and obtains outputs indicative of dental image data 146 from the trained model 190.

In some embodiments, the various models discussed in connection with model 190 (e.g., supervised machine learning model, unsupervised machine learning model, etc.) may be combined in one model (e.g., a hierarchical model), or may be separate models.

In some embodiments, data may be passed back and forth between several distinct models included in model 190 and image generation component 114. In some embodiments, some or all of these operations may instead be performed by a different device, e.g., client device 120, server machine 170, server machine 180, etc. It will be understood by one of ordinary skill in the art that variations in data flow, which components perform which processes, which models are provided with which data, and the like, are within the scope of this disclosure.

Data store 140 may be a memory (e.g., random access memory), a drive (e.g., a hard drive, a flash drive), a database system, a cloud-accessible memory system, or another type of component or device capable of storing data. Data store 140 may include multiple storage components (e.g., multiple drives or multiple databases) that may span multiple computing devices (e.g., multiple server computers). The data store 140 may store captured data 142, dental image data 146, feature data 148, treatment plan data 163, and selection requirement data 162.

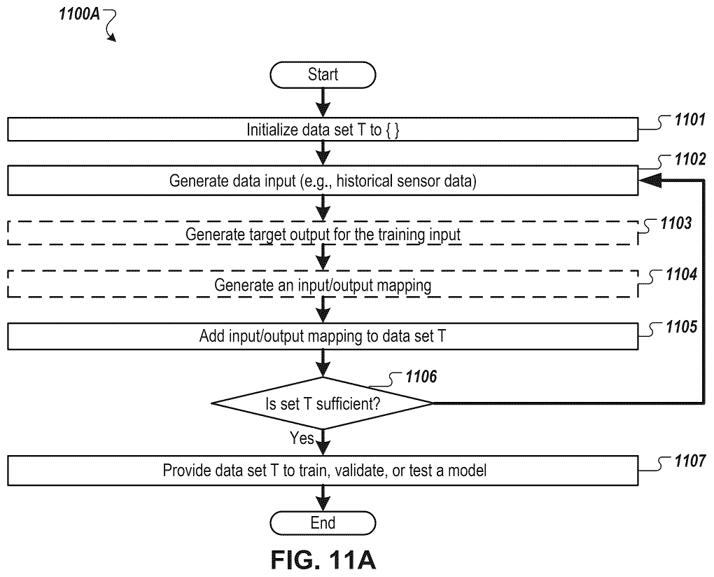

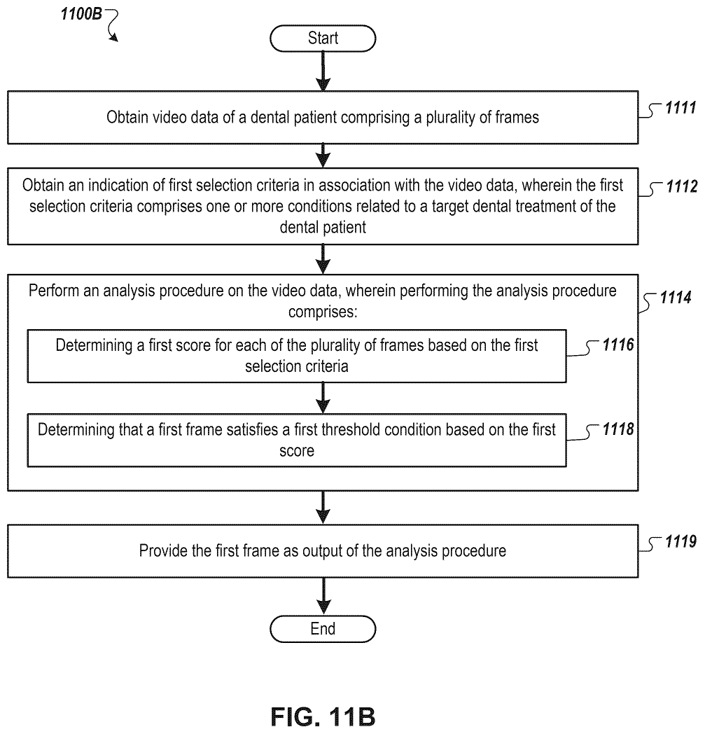

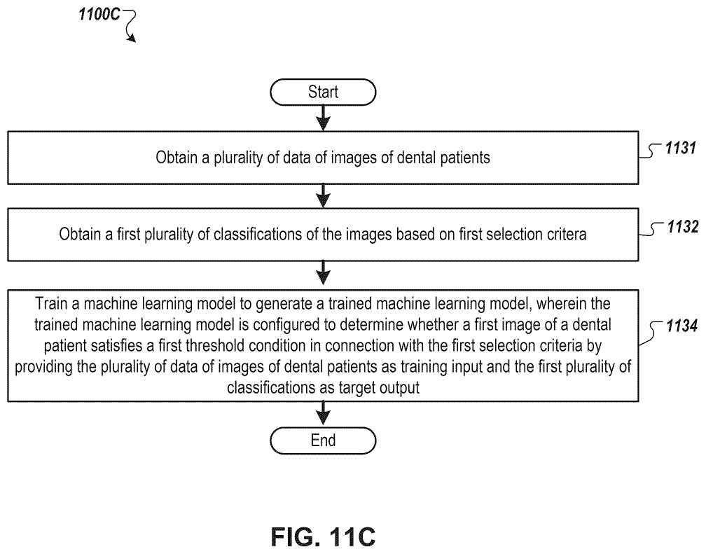

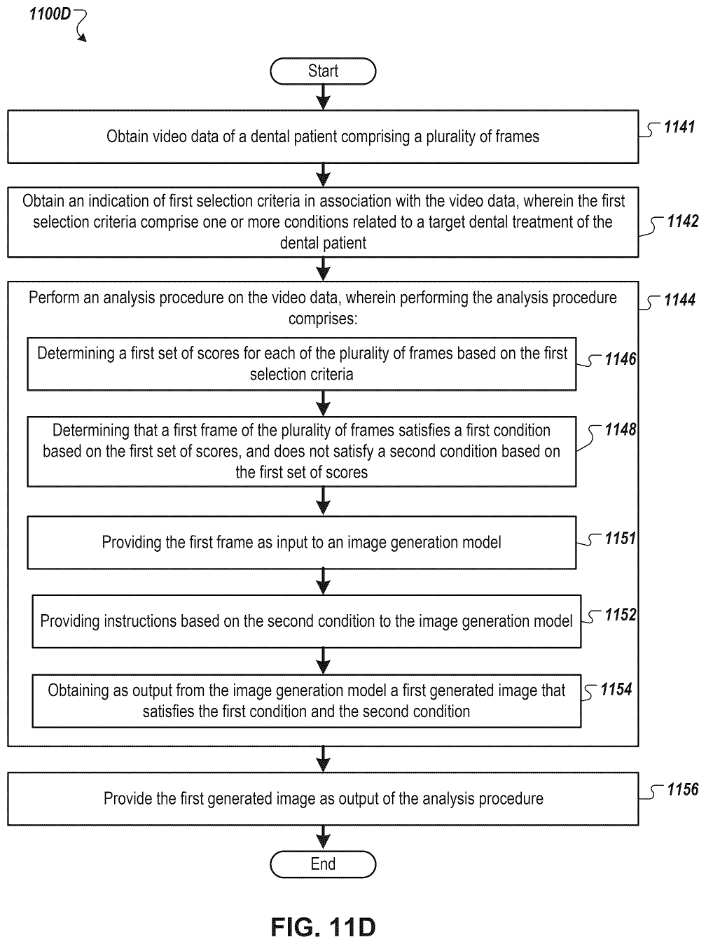

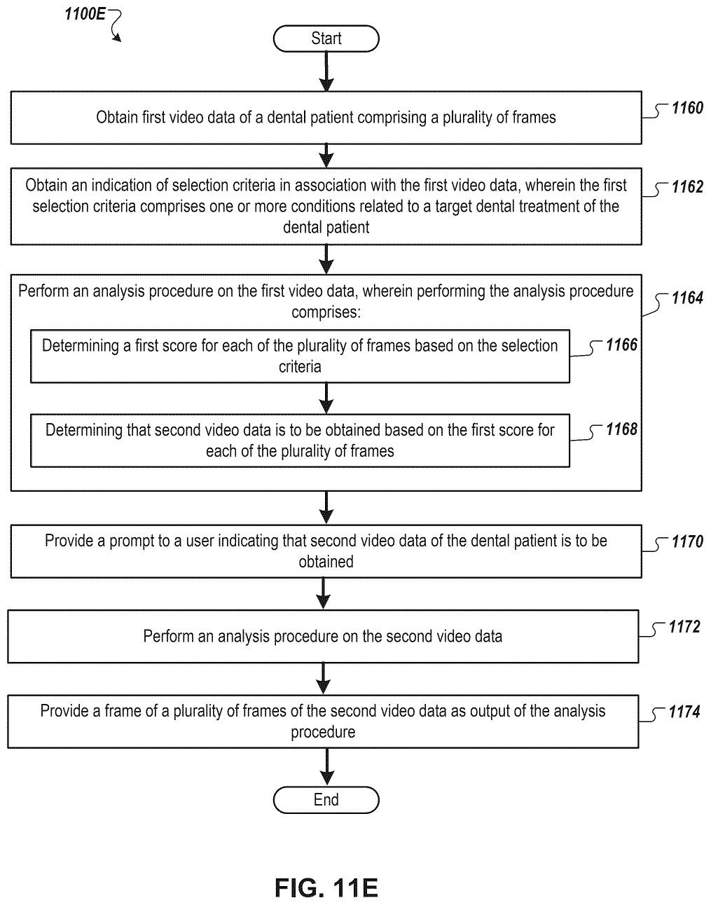

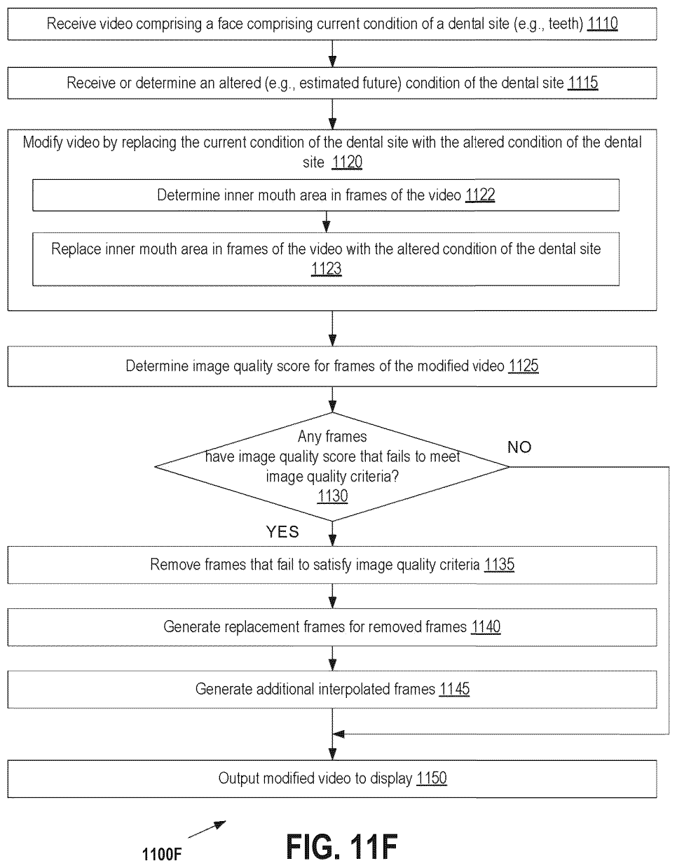

In some embodiments, image generation system 110 further includes server machine 170 and server machine 180. Server machine 170 includes a data set generator 172 that is capable of generating data sets (e.g., a set of data inputs and a set of target outputs) to train, validate, and/or test model(s) 190, including one or more machine learning models. Some operations of data set generator 172 are described in detail below with respect to FIG. 11A. In some embodiments, data set generator 172 may partition the historical data into a training set (e.g., sixty percent of the historical data), a validating set (e.g., twenty percent of the historical data), and a testing set (e.g., twenty percent of the historical data).

In some embodiments, image generation system 110 (e.g., via image generation component 114) generates multiple sets of features. For example a first set of features may correspond to a first subset of dental arch data (e.g., from a first set of teeth, first combination of teeth, first arch of a jaw pair, or the like) that correspond to each of the data sets (e.g., training set, validation set, and testing set) and a second set of features may correspond to a second subset of dental arch data that correspond to each of the data sets.

In some embodiments, machine learning model 190 is provided historical data as training data. The type of data provided will vary depending on the intended use of the machine learning model. For example, the machine learning model 190 may be configured to extract and/or generate an image of a dental patient conforming to one or more target selection criteria. A machine learning model may be provided with images labelled with selection requirements that they conform to as training data. Such a machine learning model may be trained to discern selection requirements that images (e.g., video frames) exhibit for extraction of relevant dental patient images.

In one embodiment, server machine 180 includes a training engine 182, a validation engine 184, a selection engine 185, and/or a testing engine 186. An engine (e.g., training engine 182, a validation engine 184, selection engine 185, and a testing engine 186) may refer to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine 182 may be capable of training a model 190 using one or more sets of features associated with the training set from data set generator 172. The training engine 182 may generate multiple trained models 190, where each trained model 190 corresponds to a distinct set of features of the training set (e.g., sensor data from a distinct set of sensors). For example, a first trained model may have been trained using all features (e.g., X1-X5), a second trained model may have been trained using a first subset of the features (e.g., X1, X2, X4), and a third trained model may have been trained using a second subset of the features (e.g., X1, X3, X4, and X5) that may partially overlap the first subset of features. Data set generator 172 may receive the output of a trained model (e.g., features detecting in a frame of a video), collect that data into training, validation, and testing data sets, and use the data sets to train a second model (e.g., a machine learning model configured to output an analysis of the features for evaluating a scoring function based on selection requirements, etc.).

Validation engine 184 may be capable of validating a trained model 190 using a corresponding set of features of the validation set from data set generator 172. For example, a first trained machine learning model 190 that was trained using a first set of features of the training set may be validated using the first set of features of the validation set. The validation engine 184 may determine an accuracy of each of the trained models 190 based on the corresponding sets of features of the validation set. Validation engine 184 may discard trained models 190 that have an accuracy that does not meet a threshold accuracy. In some embodiments, selection engine 185 may be capable of selecting one or more trained models 190 that have an accuracy that meets a threshold accuracy. In some embodiments, selection engine 185 may be capable of selecting the trained model 190 that has the highest accuracy of the trained models 190.

Testing engine 186 may be capable of testing a trained model 190 using a corresponding set of features of a testing set from data set generator 172. For example, a first trained machine learning model 190 that was trained using a first set of features of the training set may be tested using the first set of features of the testing set. Testing engine 186 may determine a trained model 190 that has the highest accuracy of all of the trained models based on the testing sets.

In the case of a machine learning model, model 190 may refer to the model artifact that is created by training engine 182 using a training set that includes data inputs and corresponding target outputs (correct answers for respective training inputs). Patterns in the data sets can be found that map the data input to the target output (the correct answer), and machine learning model 190 is provided mappings that capture these patterns. The machine learning model 190 may use one or more of Support Vector Machine (SVM), Radial Basis Function (RBF), clustering, supervised machine learning, semi-supervised machine learning, unsupervised machine learning, k-Nearest Neighbor algorithm (k-NN), linear regression, random forest, neural network (e.g., artificial neural network, recurrent neural network, CNN, graph neural network, GCN), etc. In some embodiments, model 190 may be or comprise an image generation model, such as a generative adversarial network (GAN). A GAN or other image generation model may include a first model, for generating images, and a second model, for discriminating between generated images and “true” images. The two models may each improve their predictive power by utilizing output of the opposite model in their training. The image generation part of a GAN may then be used to generate images of a dental patient meeting one or more selection requirements.

Image generation component 114 may provide current data to model 190 and may run model 190 on the input to obtain one or more outputs. For example, image generation component 114 may provide captured data 142 of interest to model 190 and may run model 190 on the input to obtain one or more outputs. Image generation component 114 may be capable of determining (e.g., extracting) dental image data 146 from the output of model 190. Image generation component 114 may determine (e.g., extract) confidence data from the output that indicates a level of confidence that predictive data (e.g., dental image data 146) is an accurate predictor of dental arch data associated with the input data for dental arches. Image generation component 114 or action component 122 may use the confidence data to decide whether to cause an action to be enacted associated with the dental arch, e.g., whether to recommend an image (e.g., generated image or extracted frame) as an image conforming to input selection requirements.

The confidence data may include or indicate a level of confidence that the dental image data 146 conforms with the selection requirements for a target dental image. In one example, the level of confidence is a real number between 0 and 1 inclusive, where 0 indicates no confidence that the dental image data 146 is an accurate representation for the input data and 1 indicates absolute confidence that the dental image data 146 accurately represents properties of a dental patient associated with the input data. Responsive to the confidence data indicating a level of confidence below a threshold level for a predetermined number of instances (e.g., percentage of instances, frequency of instances, total number of instances, etc.) image generation component 114 may cause trained model 190 to be re-trained (e.g., based on more or updated training data, etc.). In some embodiments, retraining may include generating one or more data sets (e.g., via data set generator 172) utilizing historical data.

For purpose of illustration, rather than limitation, aspects of the disclosure describe the training of one or more machine learning models 190 using historical data and inputting current data into the one or more trained machine learning models to determine dental image data 146. In other embodiments, a heuristic model, physics-based model, or rule-based model is used to determine dental image data 146 (e.g., without or in addition to using a trained machine learning model). Any of the information described with respect to data inputs to one or more models for manipulating jaw pair data may be monitored or otherwise used in the heuristic, physics-based, or rule-based model. In some embodiments, combinations of models, including any number of machine learning, statistical, rule-based, etc., models may be used in determining dental image data 146.

In some embodiments, the functions of client device 120, image generation server 112, server machine 170, and server machine 180 may be provided by a fewer number of machines. For example, in some embodiments server machines 170 and 180 may be integrated into a single machine, while in some other embodiments, server machine 170, server machine 180, and image generation server 112 may be integrated into a single machine. In some embodiments, client device 120 and image generation server 112 may be integrated into a single machine. In some embodiments, functions of client device 120, image generation server 112, server machine 170, server machine 180, and data store 140 may be performed by a cloud-based service.

In general, functions described in one embodiment as being performed by client device 120, image generation server 112, server machine 170, and server machine 180 can also be performed on image generation server 112 in other embodiments, if appropriate. In addition, the functionality attributed to a particular component can be performed by different or multiple components operating together. For example, in some embodiments, the image generation server 112 may determine a corrective action based on the dental image data 146. In another example, client device 120 may determine the dental image data 146 based on output from the trained machine learning model.

In addition, the functions of a particular component can be performed by different or multiple components operating together. One or more of the image generation server 112, server machine 170, or server machine 180 may be accessed as a service provided to other systems or devices through appropriate application programming interfaces (API).

In embodiments, a “user” may be represented as a single individual. However, other embodiments of the disclosure encompass a “user” being an entity controlled by a plurality of users and/or an automated source. For example, a set of individual users federated as a group of administrators may be considered a “user.”

FIG. 1B illustrates videos of a patient's dentition before and after dental treatment, in accordance with an embodiment. FIG. 1B shows modification of a video by correcting a patient's teeth in the video. However, it should be understood that the same principles described with reference to correcting the patient's teeth in the video also apply to other types of changes to the patient's dentition, such as removing teeth, staining teeth, adding caries to teeth, adding cracks to teeth, changing the shape of teeth (e.g., to fantastical proportions and/or conditions that are not naturally occurring in humans), and so on. An original video 102 of the patient's dentition 106 is shown on the left of FIG. 1B. The video 102 may show the patient's teeth in various poses and expressions. The original video 102 may be processed by a video processing logic that generates a modified video 104 that includes most of the data from the original video but with changes to the patient's dentition. The video processing logic may receive frames of the original video 102 as input, and may generate modified versions of each of the frames, where the modified versions of the frames show a post-treatment version of the patient's dentition 108. The post-treatment dentition 108 in the modified video is temporally stable and consistent between frames of the modified video 104. Accordingly, a patient or doctor may record a video. The video may then be processed by the video processing logic to generate a modified video showing an estimated future condition or other altered condition of the patient's dentition, optionally showing what the patient's dentition would look like if an orthodontic and/or restorative treatment were performed on the patient's teeth, what the patient's dentition would look like if they fail to undergo treatment (e.g., showing tooth wear, gingival swelling, tooth staining, caries, missing teeth, etc.). In at least one embodiment, the video processing logic may operate on the video 102 in real time or near-real time as the video is being captured of the patient's face. The patient may view the modified video during the capture of the original video, serving as a virtual mirror but with a post-treatment or other altered condition of the patient's dentition shown instead of the current condition of the patient's dentition.

FIG. 2 illustrates one embodiment of a treatment planning, image/video editing and/or video generation system 200 that may assist in capture of a high quality original video (e.g., such as the original video 102 of FIG. 1B) and/or that may modify an original video to generate a modified video showing an estimated future condition and/or other altered condition of a subject in the video (e.g., modified video 104 of FIG. 1B). In one embodiment, the system 200 includes a computing device 205 and a data store 210. The system 200 may additionally include, or be connected to, an image capture device such as a camera and/or an intraoral scanner. The computing device 205 may include physical machines and/or virtual machines hosted by physical machines. The physical machines may be traditionally stationary devices such as rackmount servers, desktop computers, or other computing devices. The physical machines may also be mobile devices such as mobile phones, tablet computers, game consoles, laptop computers, and so on. The physical machines may include a processing device, memory, secondary storage, one or more input devices (e.g., such as a keyboard, mouse, tablet, speakers, or the like), one or more output devices (e.g., a display, a printer, etc.), and/or other hardware components. In one embodiment, the computing device 205 includes one or more virtual machines, which may be managed and provided by a cloud provider system. Each virtual machine offered by a cloud service provider may be hosted on one or more physical machine. Computing device 205 may be connected to data store 210 either directly or via a network. The network may be a local area network (LAN), a public wide area network (WAN) (e.g., the Internet), a private WAN (e.g., an intranet), or a combination thereof.

Data store 210 may be an internal data store, or an external data store that is connected to computing device 205 directly or via a network. Examples of network data stores include a storage area network (SAN), a network attached storage (NAS), and a storage service provided by a cloud provider system. Data store 210 may include one or more file systems, one or more databases, and/or other data storage arrangement.

The computing device 205 may receive a video or one or more images from an image capture device (e.g., from a camera), from multiple image capture devices, from data store 210 and/or from other computing devices. The image capture device(s) may be or include a charge-coupled device (CCD) sensor and/or a complementary metal-oxide semiconductor (CMOS) sensor, for example. The image capture device(s) may provide video and/or images to the computing device 205 for processing. For example, an image capture device may provide a video 235 and/or image(s) to the computing device 205 that the computing device analyzes to identify a patient's mouth, a patient's face, a patient's dental arch, or the like, and that the computing device processes to generate a modified version of the video and/or images with a changed patient mouth, patient face, patient dental arch, etc. In at least one embodiment, the videos 235 and/or image(s) captured by the image capture device may be stored in data store 210. For example, videos 235 and/or image(s) may be stored in data store 210 as a record of patient history or for computing device 205 to use for analysis of the patient and/or for generation of simulated post-treatment videos such as a smile video. The image capture device may transmit the video and/or image(s) to the computing device 205, and computing device 205 may store the video 235 and/or image(s) in data store 210. In at least one embodiment, the video 235 and/or image(s) includes two-dimensional data. In at least one embodiment, the video 235 is a three-dimensional video (e.g., generated using stereoscopic imaging, structured light projection, or other three-dimensional image capture technique) and/or the image(s) are 3D image(s).

In at least one embodiment, the image capture device is a device located at a doctor's office. In at least one embodiment, the image capture device is a device of a patient. For example, a patient may use a webcam, mobile phone, tablet computer, notebook computer, digital camera, etc. to take a video and/or image(s) of their teeth, smile and/or face. The patient may then send those videos and/or image(s) to computing device 205, which may then be stored as video 235 and/or image(s) in data store 210. Alternatively, or additionally, a dental office may include a professional image capture device with carefully controlled lighting, background, camera settings and positioning, and so on. The camera may generate a video of the patient's face and may send the captured video 235 and/or image(s) to computing device for storage and/or processing.

In one embodiment, computing device 205 includes a video processing logic 208, a video capture logic 212, and a treatment planning module 220. In at least one embodiment, computing device 205 additionally or alternatively includes a dental adaptation logic 214, a dentition viewing logic 222 and/or a video/image editing logic 224. The treatment planning module 220 is responsible for generating a treatment plan 258 that includes a treatment outcome for a patient. The treatment plan may be stored in data store 210 in embodiments. The treatment plan 258 may include and/or be based on one or more 2D images and/or intraoral scans of the patient's dental arches. For example, the treatment planning module 220 may receive 3D intraoral scans of the patient's dental arches based on intraoral scanning performed using an intraoral scanner. One example of an intraoral scanner is the iTero® intraoral digital scanner manufactured by Align Technology, Inc. Another example of an intraoral scanner is set forth in U.S. Publication No. 2019/0388193, filed Jun. 19, 2019, which is hereby incorporated by reference herein in its entirety.

During an intraoral scan session, an intraoral scan application receives and processes intraoral scan data (e.g., intraoral scans) and generates a 3D surface of a scanned region of an oral cavity (e.g., of a dental site) based on such processing. To generate the 3D surface, the intraoral scan application may register and “stitch” or merge together the intraoral scans generated from the intraoral scan session in real time or near-real time as the scanning is performed. Once scanning is complete, the intraoral scan application may then again register and stitch or merge together the intraoral scans using a more accurate and resource intensive sequence of operations. In one embodiment, performing registration includes capturing 3D data of various points of a surface in multiple scans (views from a camera), and registering the scans by computing transformations between the scans. The 3D data may be projected into a 3D space for the transformations and stitching. The scans may be integrated into a common reference frame by applying appropriate transformations to points of each registered scan and projecting each scan into the 3D space.

In one embodiment, registration is performed for adjacent or overlapping intraoral scans (e.g., each successive frame of an intraoral video). Registration algorithms are carried out to register two or more adjacent intraoral scans and/or to register an intraoral scan with an already generated 3D surface, which essentially involves determination of the transformations which align one scan with the other scan and/or with the 3D surface. Registration may involve identifying multiple points in each scan (e.g., point clouds) of a scan pair (or of a scan and the 3D model), surface fitting to the points, and using local searches around points to match points of the two scan (or of the scan and the 3D surface). For example, an intraoral scan application may match points of one scan with the closest points interpolated on the surface of another image, and iteratively minimize the distance between matched points. Other registration techniques may also be used. The intraoral scan application may repeat registration and stitching for all scans of a sequence of intraoral scans and update the 3D surface as the scans are received.

Treatment planning module 220 may perform treatment planning in an automated fashion and/or based on input from a user (e.g., from a dental technician). The treatment planning module 220 may receive and/or store the pre-treatment 3D model 260 of the current dental arch of a patient, and may then determine current positions and orientations of the patient's teeth from the virtual 3D model 260 and determine target final positions and orientations for the patient's teeth represented as a treatment outcome (e.g., final stage of treatment). The treatment planning module 220 may then generate a post-treatment virtual 3D model or models 262 showing the patient's dental arches at the end of treatment and optionally one or more virtual 3D models showing the patient's dental arches at various intermediate stages of treatment. The treatment planning module 220 may generate a treatment plan 258, which may include one or more of pre-treatment 3D models 260 of upper and/or lower dental arches and/or post-treatment 3D models 262 of upper and/or lower dental arches. For a multi-stage treatment such as orthodontic treatment, the treatment plan 258 may additionally include 3D models of the upper and lower dental arches for various intermediate stages of treatment.

By way of non-limiting example, a treatment outcome may be the result of a variety of dental procedures. Such dental procedures may be broadly divided into prosthodontic (restorative) and orthodontic procedures, and then further subdivided into specific forms of these procedures. Additionally, dental procedures may include identification and treatment of gum disease, sleep apnea, and intraoral conditions. The term prosthodontic procedure refers, inter alia, to any procedure involving the oral cavity and directed to the design, manufacture or installation of a dental prosthesis at a dental site within the oral cavity, or a real or virtual model thereof, or directed to the design and preparation of the dental site to receive such a prosthesis. A prosthesis may include any restoration such as implants, crowns, veneers, inlays, onlays, and bridges, for example, and any other artificial partial or complete denture. The term orthodontic procedure refers, inter alia, to any procedure involving the oral cavity and directed to the design, manufacture or installation of orthodontic elements at a dental site within the oral cavity, or a real or virtual model thereof, or directed to the design and preparation of the dental site to receive such orthodontic elements. These elements may be appliances including but not limited to brackets and wires, retainers, clear aligners, or functional appliances. Any of treatment outcomes or updates to treatment outcomes described herein may be based on these orthodontic and/or dental procedures. Examples of orthodontic treatments are treatments that reposition the teeth, treatments such as mandibular advancement that manipulate the lower jaw, treatments such as palatal expansion that widen the upper and/or lower palate, and so on. For example, an update to a treatment outcome may be generated by interaction with a user to perform one or more procedures to one or more portions of a patient's dental arch or mouth. Planning these orthodontic procedures and/or dental procedures may be facilitated by the AR system described herein.

A treatment plan for producing a particular treatment outcome may be generated by first generating an intraoral scan of a patient's oral cavity. From the intraoral scan a pre-treatment virtual 3D model 260 of the upper and/or lower dental arches of the patient may be generated. A dental practitioner or technician may then determine a desired final position and orientation for the patient's teeth on the upper and lower dental arches, for the patient's bite, and so on. This information may be used to generate a post-treatment virtual 3D model 262 of the patient's upper and/or lower arches after orthodontic and/or prosthodontic treatment. This data may be used to create an orthodontic treatment plan, a prosthodontic treatment plan (e.g., restorative treatment plan), and/or a combination thereof. An orthodontic treatment plan may include a sequence of orthodontic treatment stages. Each orthodontic treatment stage may adjust the patient's dentition by a prescribed amount, and may be associated with a 3D model of the patient's dental arch that shows the patient's dentition at that treatment stage.

A post-treatment 3D model or models 262 of an estimated future condition of a patient's dental arch(es) may be shown to the patient. However, just viewing the post-treatment 3D model(s) of the dental arch(es) does not enable a patient to visualize what their face, mouth, smile, etc. will actually look like after treatment. Accordingly, in at least one embodiment, computing device 205 receives a video 235 of the current condition of the patient's face, preferably showing the patient's smile. This video, if of sufficient quality, may be processed by video processing logic 208 together with data from the treatment plan 258 to generate a modified video 245 that shows what the patient's face, smile, etc. will look like after treatment through multiple angles, views, expressions, etc.

In at least one embodiment, system 200 may be used in a non-clinical setting, and may or may not show estimated corrected versions of a patient's teeth. In at least one embodiment, system 200 includes video and/or image editing logic 224. Video and/or image editing logic 224 may include a video or image editing application that includes functionality for modifying dentition of individuals in images and/or video that may not be associated with a dental or orthodontic treatment plan. Video and/or image editing logic 224 may include a stand-alone video or image editing application that adjusts dentition of individuals in images and/or dental arches. The video and/or image editing application may also be able to perform many other standard video and/or image editing operations, such as color alteration, lighting alteration, cropping and rotating of images/videos, resizing of videos/images, contrast adjustment, layering of multiple images/frames, addition of text and typography, application of filters and effects, splitting and joining of clips from/to videos, speed adjustment of video playback, animations, and so on. In at least one embodiment, video/image editing logic 224 is a plugin or module that can be added to a video or image editing application (e.g., to a consumer grade or professional grade video or image editing application) such as Adobe Premiere Pro, Final Cut Pro X, DaVinci Resolve, Avid Media Composer, Sony Vegas Pro, CyberLink Power Director, Corel Video Studio, Pinnacle Studio, Lightworks, Shotcut, iMovie, Kdenlive, Openshot, HitFilm Express, Filmora, Adobe Photoshop, GNU Image Manipulation Program, Adobe Lightroom, CorelDRAW Graphics Studio, Corel PaintShop Pro, Affinity Photo, Pixlr, Capture One, Inkscape, Paint.NET, Canva, ACDSee, Sketch, DxO PhotoLab, SumoPaint, and Photoscape.

In some applications, video/image editing logic 224 functions as a service (e.g., in a Software as a Service (SaaS) model). Other image and/or video editing applications and/or other software may use an API of the video/image editing logic to request one or more alterations to dentition of one or more individuals in provided images and/or video. Video/image editing logic 224 may receive the instructions, determine the requested alterations, and alter the images and/or video accordingly. Video/image editing logic 224 may then provide the altered images and/or video to the requestor. In at least one embodiment, a fee is associated with the performed alteration of images/video. Accordingly, video/image editing logic 224 may provide a cost estimate for the requested alterations, and may initiate a credit card or other payment. Responsive to receiving such payment, video/image editing logic 224 may perform the requested alterations and generate the modified images and/or video.

In at least one embodiment, system 200 includes dental adaptation logic 214. Dental adaptation logic 214 may determine and apply adaptations to dentition that are not part of a treatment plan. In at least one embodiment, dental adaptation logic 214 may provide a graphical user interface (GUI) that includes a palette of options for dental modifications. The palette of options may include options, for example, to remove one or more particular teeth, to apply stains to one or more teeth, to apply caries to one or more teeth, to apply rotting to one or more teeth, to change a shape of one or more teeth, to replace teeth with a fantastical tooth option (e.g., vampire teeth, tusks, monstrous teeth, etc.), to apply chips and/or breaks to one or more teeth, to whiten one or more teeth, to change a color of one or more teeth, and so on. Responsive to a selection of one or more tooth alteration options, dental adaptation logic 214 may determine a modified state of the patient's dentition. This may include altering 3D models of an upper and/or lower dental arch of an individual based on the selected option or options. The 3D models may have been generated based on 3D scanning of the individual in a clinical environment or in a non-clinical environment (e.g., using a simplified intraoral scanner not rated for a clinical environment). The 3D models may have alternatively been generated based on a set of 2D images of the individual's dentition.

In at least one embodiment, dental adaptation logic 214 includes tools that enable a user to manually adjust one or more teeth in a 3D model and/or image of the patient's dental arches and/or face. For example, the user may select and then move one or a collection of teeth, select and enlarge and/or change a shape of one or more teeth, select and delete one or more teeth, select and alter color of one or more teeth, and so on. Accordingly, in some embodiments a user may manually generate a specific target dentition rather than selecting options from a palette of options and letting the dental adaptation logic 214 automatically determine adjustments based on the selected options. Once dental adaptation logic 214 has generated an altered dentition, video processing logic 208 may use the altered dentition to update images and/or videos to cause an individual's dentition in the images and/or videos to match the altered dentition.

To facilitate capture of high-quality videos, video capture logic 212 may assess the quality of a captured video 235 and determine one or more quality metric scores for the captured video 235. This may include, for example, determining an amount of blur in the video, determining an amount and/or speed of head movement in the video, determining whether a patient's head is centered in the video, determining a face angle in the video, determining an amount of teeth showing in the video, determining whether a camera was stable during capture of the video, determining a focus of the video, and so on.

One or more detectors and/or heuristics may be used to score videos for one or more criteria. The heuristics/detectors may analyze frames of a video, and may include criteria or rules that should be satisfied for a video to be used. Examples of criteria include a criterion that a video shows an open bite, that a patient is not wearing aligners in the video, that a patient face has an angle to a camera that is within a target range, and so on. Each of the determined quality metric scores may be compared to a corresponding quality metric criterion. The quality metric scores may be combined into a single video quality metric value in embodiments. In at least one embodiment, a weighted combination of the quality metric values is determined. For example, some quality metrics may have a larger impact on ultimate video quality than other quality metrics. Such quality metric scores that have a larger impact on ultimate video quality may be assigned higher weight than other quality metric scores that have a lower weight on ultimate video quality. If the combined quality metric score and/or some threshold of the individual quality metric scores fails to satisfy one or more quality metric criteria (e.g., a combined quality metric score is below a combined quality metric score threshold), then a video may be determined to be of too low quality to be used by video processing logic 208.

If video capture logic 212 determines that a captured video 235 fails to meet one or more quality criteria or standards, video capture 212 may determine why the captured video failed to meet the quality criteria or standards. Video capture logic 212 may then determine how to improve each of the quality metric scores that failed to satisfy a quality metric criterion. Video capture logic 212 may generate an output that guides a patient, doctor, technician, etc. as to changes to make to improve the quality of the captured video. Such guidance may include instructions to rotate the patient's head, move the patient's head towards the camera (so that the head fills a larger portion of the video), move the patient's head toward a center of a field of view of the camera (so that the head is centered), rotate the patient's head (so that the patient's face is facing generally towards the camera), move the patient's head more slowly, change lighting conditions, stabilize the camera, and so on. The person capturing the video and/or the individual in the video may then implement the one or more suggested changes. This process may repeat until a generated video 235 is of sufficient quality.

Once a video of sufficient quality is captured, video capture logic 212 may process the video by removing one or more frames of the video that are of insufficient quality. Even for a video that meets certain quality standards, some frames of the video may still fail to meet those quality standards. In at least one embodiment, such frames that fail to meet the quality standards are removed from the video. Replacement frames may then be generated by interpolation of existing frames. In one embodiment, one or more remaining frames are input into a generative model that outputs an interpolated frame that replaces a removed frame. In one embodiment, additional synthetic interpolated frames may also be generated, such as to upscale a video.

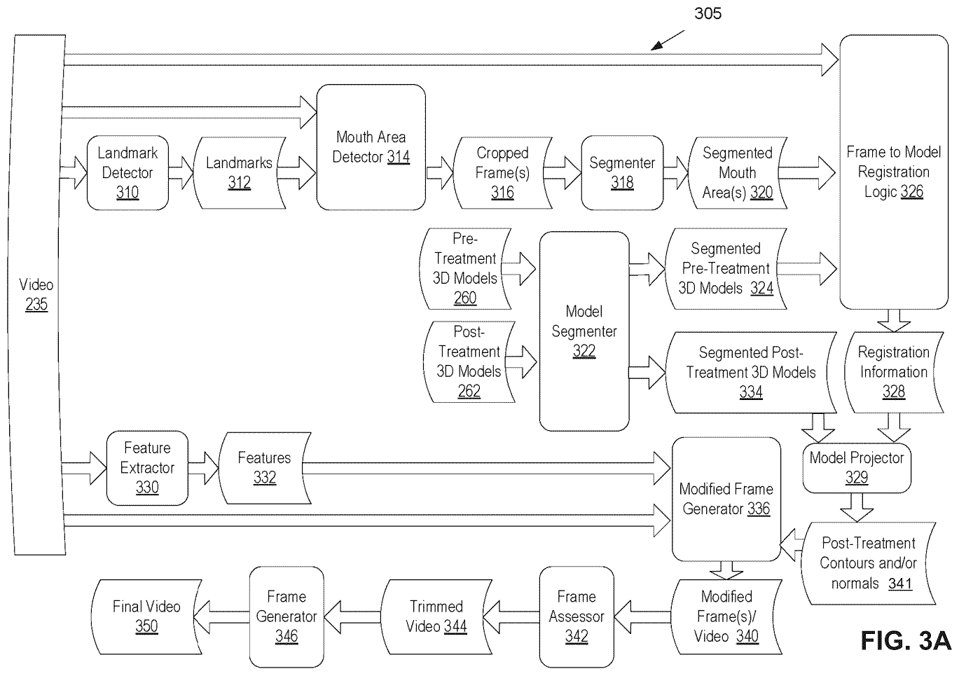

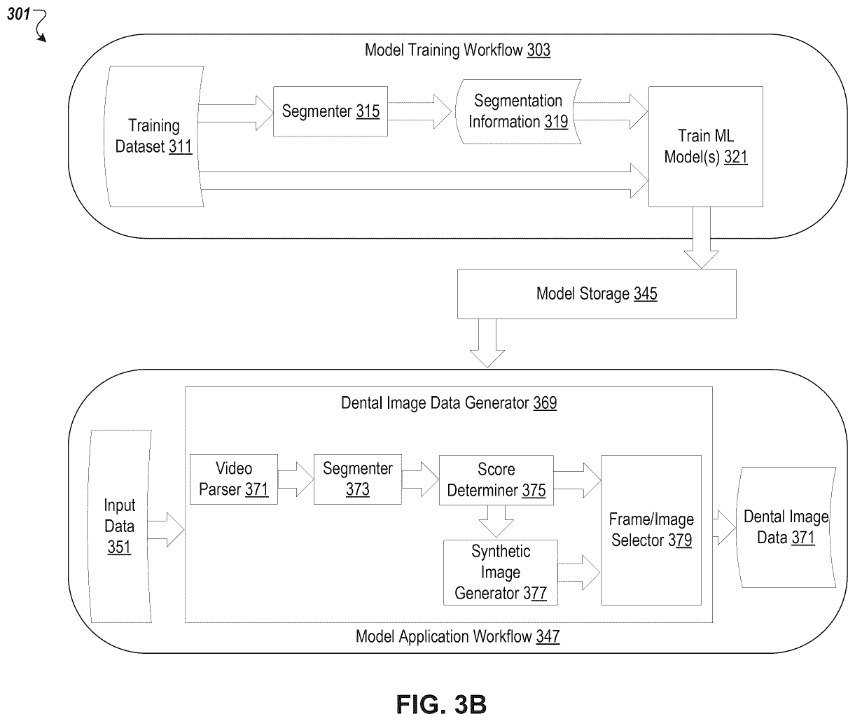

Once a video 235 is ready for processing, it may be processed by video processing logic 208. In at least one embodiment, video processing logic 208 performs a sequence of operations to identify an area of interest in frames of the video, determine replacement content to insert into the area of interest, and generate modified frames that integrate the original frames and the replacement content. The operations may at a high level be divided into a landmark detection operation, an area of interest identifying operation, a segmentation operation, a 3D model to 2D frame fitting operation, a feature extraction operation, and a modified frame generation operation. One possible sequence of operations performed by video processing logic 208 to generate a modified video 245 is shown in FIG. 3A.

Once a modified video is generated, the modified video may be output to a display for viewing by an end user, such as a patient, doctor, technician, etc. In at least one embodiment, video generation is interactive. Computing device 205 may receive one or more inputs (e.g., from an end user) to select changes to a target future condition of a subject's teeth, as described with reference to dental adaptation logic 214. Examples of such changes include adjusting a target tooth whiteness, adjusting a target position and/or orientation of one or more teeth, selecting alternative restorative treatment (e.g., selecting a composite vs. a metal filling), and so on. Based on such input, a treatment plan may be updated and/or the sequence of operations may be rerun using the updated information.

Various operations, such as the landmark detection, area of interest detection (e.g., inner mouth area detection), segmentation, feature extraction, modified frame generation, etc. may be performed using, and/or with the assistance of, one or more trained machine learning models.

In at least one embodiment, system 200 includes a dentition viewing logic 222. Dentition viewing logic 222 may be integrated into treatment planning logic 220 in some embodiments. Dentition viewing logic 222 provides a GUI for viewing 3D models or surfaces of an upper and lower dental arch of an individual as well as images or frames of a video showing a face of the individual. In at least one embodiment, the image or frame of the video is output to a first region of a display or GUI and the 3D model(s) is output to a second region of the display or GUI. In at least one embodiment, the image or frame and the 3D model(s) are overlaid on one another in the display or GUI. For example, the 3D models, or portions thereof, may be overlaid over a mouth region of the individual in the image or frame. In a further example, the mouth region of the individual in the image or frame may be identified and removed, and the image or frame with the removed mouth region may be overlaid over the 3D model(s) such that a portion of the 3D model(s) is revealed (e.g., the portion that corresponds to the removed mouth region). In another example, the 3D model(s) may be overlaid over the image or frame at a location corresponding to the mouth region.

In at least one embodiment, a user may use one or more viewing tools to adjust a view of the 3D models of the dental arch(es). Such tools may include a pan tool to pan the 3D models left, right, up and/or down, a rotation tool to rotate the 3D models about one or more axes, a zoom tool to zoom in or out on the 3D models, and so on. Dentition viewing logic 222 may determine a current orientation of the 3D model of the upper dental arch and/or the 3D model of the lower dental arch. Such an orientation may be determined in relation to a viewing angle of a virtual camera and/or a display (e.g., a plane). Dentition viewing logic 222 may additionally determine orientations of the upper and/or lower jaw of the individual in multiple different images (e.g., in multiple different frames of a video). Dentition viewing logic 222 may then compare the determined orientations of the upper and/or lower jaw to the current orientation of the 3D models of the upper and/or lower dental arches. This may include determining a score for each image and/or frame based at least in part on a difference between the orientation of the jaw(s) and of the 3D model(s). An image or frame in which the orientation of the upper and/or lower jaw most closely matches the orientation of the 3D model(s) may be identified (e.g., based on an image/frame having a highest score). The identified image may then be selected and output to a display together with the 3D model(s).

In at least one embodiment, a user may select an image (e.g., a frame of a video) from a plurality of available images comprising a face of an individual. For example, the user may scroll through frames of a video and select one of the frames in which the upper and/or lower jaw of the individual have a desired orientation. Dentition viewing logic 222 may determine an orientation of the upper and/or lower jaw of the individual in the selected image. Dentition viewing logic 222 may then update an orientation of the 3D model of the upper and/or lower dental arch to match the orientations of the upper and/or lower jaw in the selected image or frame.

In at least one embodiment, dentition viewing logic 222 determines an orientation of an upper and/or lower jaw of an individual in an image using image processing and/or application of machine learning. For example, dentition viewing logic 222 may process an image to identify facial landmarks of the individual in the image. The relative positions of the facial landmarks may then be used to determine the orientation of the upper jaw and/or the orientation of the lower jaw. In one embodiment, an image or frame is input into a trained machine learning model that has been trained to output an orientation value for the upper jaw and/or an orientation value for the lower jaw of a subject of the image. The orientation values may be expressed, for example, as angles (e.g., about one, two or three axes) relative to a vector that is normal to a plane that corresponds to a plane of the image or frame.

In at least one embodiment, dentition viewing logic 222 may process each of a set of images (e.g., each frame of a video) to determine the orientations of the upper and/or lower jaws of an individual in the image. Dentition viewing logic may then group or cluster images/frames based on the determined orientation or orientations. In one embodiment, for a video dentition viewing logic 222 groups sequential frames having similar orientations for the upper and/or lower jaw into time segments. Frames may be determined to have a similar orientation for a jaw if the orientation of the jaw differs by less than a threshold amount between the frames.

Dentition viewing logic 222 may provide a visual indication of the time segments for the video. A user may then select a desired time segment, and dentition viewing logic 222 may then show a representative frame from the selected time segment and update the orientation(s) of the 3D models for the upper/lower dental arches of the individual.

In some instances, dentition viewing logic 222 may output indications of other frames in a video and/or other images having orientations for the upper and/or lower jaw that match or approximately match the orientations of the upper and/or lower jaw in the selected image/frame or time segment. A user selects another of the images having the similar jaw orientations and/or scroll through the different frames having the similar jaw orientations.

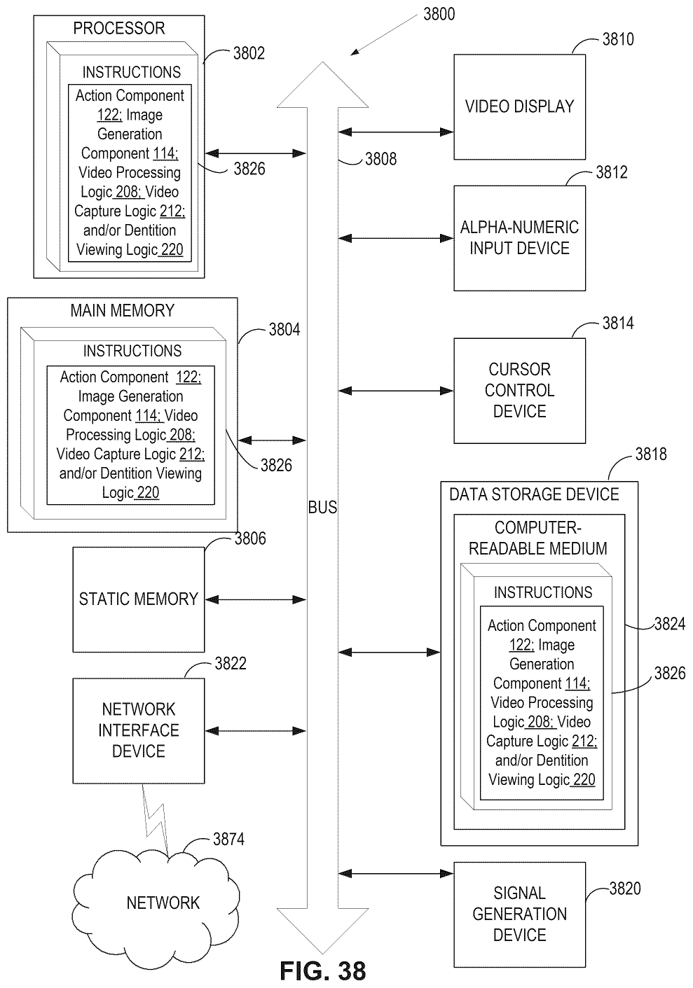

FIG. 3A illustrates a video processing workflow 305 for the video processing logic, in accordance with an embodiment of the present disclosure. In at least one embodiment, one or more trained machine learning models of the video processing workflow 305 are trained at a server, and the trained models are provided to a video processing logic 208 on another computing device (e.g., computing device 205 of FIG. 2), which may perform the video processing workflow 305. The model training and the video processing workflow 305 may be performed by processing logic executed by a processor of a computing device. The video processing workflow 305 may be implemented, for example, by one or more machine learning models implemented in video processing logic 208 or other software and/or firmware executing on a processing device of computing device 3800 shown in FIG. 38.

A model training workflow may be implemented to train one or more machine learning models (e.g., deep learning models) to perform one or more classifying, image generation, landmark detection, color transfer, segmenting, detection, recognition, etc. tasks for images (e.g., video frames) of smiles, teeth, dentition, faces, etc. The video processing workflow 305 may then apply the one or more trained machine learning models to perform the classifying, image generation, landmark detection, color transfer, segmenting, detection, recognition, etc. tasks for images of smiles, teeth, dentition, faces, etc. to ultimately generate modified videos of faces of individuals showing an estimated future condition of the individual's dentition (e.g., of a dental site).

Many different machine learning outputs are described herein. Particular numbers and arrangements of machine learning models are described and shown. However, it should be understood that the number and type of machine learning models that are used and the arrangement of such machine learning models can be modified to achieve the same or similar end results. Accordingly, the arrangements of machine learning models that are described and shown are merely examples and should not be construed as limiting. Additionally, embodiments discussed with reference to machine learning models may also be implemented using traditional rule based engines.

In at least one embodiment, one or more machine learning models are trained to perform one or more of the below tasks. Each task may be performed by a separate machine learning model. Alternatively, a single machine learning model may perform each of the tasks or a subset of the tasks. Additionally, or alternatively, different machine learning (ML) models may be trained to perform different combinations of the tasks. In an example, one or a few machine learning models may be trained, where the trained ML model is a single shared neural network that has multiple shared layers and multiple higher level distinct output layers, where each of the output layers outputs a different prediction, classification, identification, etc. The tasks that the one or more trained machine learning models may be trained to perform are as follows:
I) Dental object segmentation—this can include performing point-level classification (e.g., pixel-level classification or voxel-level classification) of different types and/or instances of dental objects from frames of a video and/or from a 3D model of a dental arch. The different types of dental objects may include, for example, teeth, gingiva, an upper palate, a preparation tooth, a restorative object other than a preparation tooth, an implant, a tongue, a bracket, an attachment to a tooth, soft tissue, a retraction cord (dental wire), blood, saliva, and so on. In at least one embodiment, images and/or 3D models of teeth and/or a dental arch are segmented into individual teeth, and optionally into gingiva.
II) Landmark detection—this can include identifying landmarks in images. The landmarks may be particular types of features, such as centers of teeth in embodiments. In at least one embodiment, landmark detection is performed before or after dental object segmentation. In at least one embodiment, these facial landmarks can be used to estimate the orientation of the facial skull and therefore the upper jaw. In at least one embodiment, dental object segmentation and landmark detection are performed together by a single machine learning model. In one embodiment, one or more stacked hourglass networks are used to perform landmark detection. One example of a model that may be used to perform landmark detection is a convolutional neural network that includes multiple stacked hourglass models, as described in Alejandro Newell et al., Stacked Hourglass Networks for Human Pose Estimation, Jul. 26, 2016, which is incorporated by reference herein in its entirety.
III) Teeth boundary prediction—this can include using one or more trained machine learning models to predict teeth boundaries and/or boundaries of other dental objects (e.g., mouth parts) optionally accompanied by depth estimation based on an input of one or more frames of a video. Teeth boundary prediction may be used instead of or in addition to landmark detection and/or segmentation in embodiments.
IV Frame interpolation—this can include generating (e.g., interpolating) simulated frames that show teeth, gums, etc. as they might look between those teeth, gums, etc. in frames at hand. Such interpolated frames may be photo-realistic images. In at least one embodiment, a generative model such as a generative adversarial network (GAN), encoder/decoder model, diffusion model, variational autoencoder (VAE), neural radiance field (NeRF), etc. is used to generate intermediate simulated frames. In one embodiment, a generative model is used that determines features of two input frames in a feature space, determines an optical flow between the features of the two frames in the feature space, and then uses the optical flow and one or both of the frames to generate a simulated frame. In one embodiment, a trained machine learning model that determines frame interpolation for large motion is used, such as is described in Fitsum Reda at al., FILM: Frame Interpolation for Large Motion, Proceedings of the European Conference On Computer Vision (ECC) (2022), which is hereby incorporated by reference herein in its entirety.
V) Frame generation—this can include generating estimated frames (e.g., 2D images) of how a patient's teeth are expected to look at a future stage of treatment (e.g., at an intermediate stage of treatment and/or after treatment is completed). Such frames may be photo-realistic images. In at least one embodiment, a generative model (e.g., such as a GAN, encoder/decoder model, etc.) operates on extracted image features of a current frame and a 2D projection of a 3D model of a future state of the patient's dental arch to generate a simulated or modified frame.
VI) Optical flow determination—this can include using a trained machine learning model to predict or estimate optical flow between frames. Such a trained machine learning model may be used to make any of the optical flow determinations described herein.
VII) Jaw orientation (pose) detection—this can include using a trained machine learning model to estimate the orientation of an upper jaw and/or a lower jaw of an individual in an image. In at least one embodiment, processing logic estimates a pose of a face, where the pose of the face may correlate to an orientation of the upper jaw. The pose and/or orientation of the upper and/or lower jaw may be determined, for example, based on identified landmarks. In at least one embodiment, jaw orientation and/or pose detection is performed together with dental object segmentation and/or landmark detection by a single machine learning model.

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs). Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize a scanning role. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

In one embodiment, a generative model is used for one or more machine learning models. The generative model may be a generative adversarial network (GAN), encoder/decoder model, diffusion model, variational autoencoder (VAE), neural radiance field (NeRF), or other type of generative model. The generative model may be used, for example, in modified frame generator 336.

A GAN is a class of artificial intelligence system that uses two artificial neural networks contesting with each other in a zero-sum game framework. The GAN includes a first artificial neural network that generates candidates and a second artificial neural network that evaluates the generated candidates. The GAN learns to map from a latent space to a particular data distribution of interest (a data distribution of changes to input images that are indistinguishable from photographs to the human eye), while the discriminative network discriminates between instances from a training dataset and candidates produced by the generator. The generative model's training objective is to increase the error rate of the discriminative network (e.g., to fool the discriminator network by producing novel synthesized instances that appear to have come from the training dataset). The generative model and the discriminator network are co-trained, and the generative model learns to generate images that are increasingly more difficult for the discriminative network to distinguish from real images (from the training dataset) while the discriminative network at the same time learns to be better able to distinguish between synthesized images and images from the training dataset. The two networks of the GAN are trained once they reach equilibrium. The GAN may include a generator network that generates artificial intraoral images and a discriminator network that attempts to differentiate between real images and artificial intraoral images. In at least one embodiment, the discriminator network may be a MobileNet.

In at least one embodiment, the generative model used in frame generator 346 is a generative model trained to perform frame interpolation-synthesizing intermediate images between a pair of input frames or images. The generative model may receive a pair of input frames, and generate an intermediate frame that can be placed in a video between the pair of frames, such as for frame rate upscaling. In one embodiment, the generative model has three main stages, including a shared feature extraction stage, a scale-agnostic motion estimation stage, and a fusion stage that outputs a resulting color image. The motion estimation stage in embodiments is capable of handling a time-wise non-regular input data stream. Feature extraction may include determining a set of features of each of the input images in a feature space, and the scale-agnostic motion estimation may include determining an optical flow between the features of the two images in the feature space. The optical flow and data from one or both of the images may then be used to generate the intermediate image in the fusion stage. The generative model may be capable of stable tracking of features without artifacts for large motion. The generative model may handle disocclusions in embodiments. Additionally the generative model may provide improved image sharpness as compared to traditional techniques for image interpolation. In at least one embodiment, the generative model generates simulated images recursively. The number of recursions may not be fixed, and may instead be based on metrics computed from the images.

In one embodiment, one or more machine learning model is a conditional generative adversarial (cGAN) network, such as pix2pix or vid2vid. These networks not only learn the mapping from input image to output image, but also learn a loss function to train this mapping. GANs are generative models that learn a mapping from random noise vector z to output image y, G: z→y. In contrast, conditional GANs learn a mapping from observed image x and random noise vector z, to y, G: {x, z}→y. The generator G is trained to produce outputs that cannot be distinguished from “real” images by an adversarially trained discriminator, D, which is trained to do as well as possible at detecting the generator's “fakes”. The generator may include a U-net or encoder-decoder architecture in embodiments. The discriminator may include a MobileNet architecture in embodiments. An example of a cGAN machine learning architecture that may be used is the pix2pix architecture described in Isola, Phillip, et al. “Image-to-image translation with conditional adversarial networks.” arXiv preprint (2017).

Video processing logic 208 may execute video processing workflow 305 on captured video 235 of an individual's face in embodiments. In at least one embodiment, the video 235 may have been processed by video capture logic 212 prior to processed by video processing logic 208 to ensure that the video is of sufficient quality.

One stage of video processing workflow 305 is landmark detection. Landmark detection includes using a trained neural network (e.g., such as a deep neural network) that has been trained to identify features or sets of features (e.g., landmarks) on each frame of a video 235. Landmark detector 310 may operate on frames individually or together. In at least one embodiment, a current frame, a previous frame, and/or landmarks determined from a previous frame are input into the trained machine learning model, which outputs landmarks for the current frame. In one embodiment, identified landmarks are one or more teeth, centers of one or more teeth, eyes, nose, and so on. The detected landmarks may include facial landmarks and/or dental landmarks in embodiments. The landmark detector 310 may output information on the locations (e.g., coordinates) of each of multiple different features or landmarks in an input frame. Groups of landmarks may indicate a pose (e.g., position, orientation, etc.) of a head, a chin or lower jaw, an upper jaw, one or more dental arch, and so on in embodiments. In at least one embodiment, the facial landmarks are used to determine a six-dimensional (6D) pose of the face based on the facial landmarks and a 3D face model (e.g., by performing fitting between the facial landmarks and a general 3D face model. Processing logic may then determine a relative position of the upper dental arch of the individual to a frame at least in part on the 6D pose.

FIG. 3B illustrates workflows 301 for training and implementing one or more machine learning models for performing operations associated with generation of dental patient images from video data, in accordance with embodiments of the present disclosure. The illustrated workflows include a model training workflow 303 and a model application workflow 347. The model training workflow 303 is to train one or more machine learning models (e.g., deep learning models, generative models, etc.) to perform one or more data segmentation tasks and/or data generation tasks (e.g., for images of smiling persons showing their teeth, images of dental patients including target attributes, etc.). The model application workflow 347 is to apply the one or more trained machine learning models to generate dental patient image data based on the input data 351, including selection requirements.

Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset. In high-dimensional settings, such as large images, this generalization is achieved when a sufficiently large and diverse training dataset is made available.

The model training workflow 303 and the model application workflow 347 may be performed by processing logic, executed by a processor of a computing device. Workflows 303 and 347 may be implemented, for example, by one or more devices depicted in FIG. 1, such as server machine 170, server machine 180, image generation server 112, etc. These methods and/or operations may be implemented by one or more machine learning modules executed on processing devices of devices depicted in FIG. 1, one or more statistical or rule-based models, one or more algorithms (e.g., for evaluating scoring functions based on model outputs), combinations of models, etc.

For the model training workflow 303, a training dataset 311 containing hundreds, thousands, tens of thousands, hundreds of thousands or more examples of input data may be provided. The properties of the input data will correspond to the intended use of the machine learning model(s). For example, a machine learning model (e.g., including a number of separate models for performing portions of a workflow) for selecting a frame of a video of a dental patient that conforms to one or more selection criteria for an image of a dental patient may be trained. Training the machine learning model for dental patient image extraction/generation may include providing a training dataset 311 of images labelled with relevant selection requirements, e.g., with a number of selection criteria given a numerical score related to how well the image conforms with the selection requirement. Training dataset 311 may include variations of data, e.g., various patient demographics, poses, expressions, image quality metrics (e.g., brightness, contrast, resolution, color correction, etc.), or the like. Training dataset 311 may include additional information, such as contextual information, metadata, etc.

Training dataset 311 may reflect the intended use of the machine learning model. Models trained to perform different tasks are trained using training datasets tailored to the intended use of the models. A model may be configured to detect features of an image. For example, the model (or models) may be configured to detect facial features such as eyes, teeth, head, etc., facial key points, or the like. The machine learning model configured to detect features from an image (e.g., a frame of a video) may be provided with data indicative of one or more facial features as part of training dataset 311. The machine learning model may be trained to output locations of facial features of an input image, which may be used for further analysis (e.g., to determine facial expression, head angle, gaze direction, tooth visibility, or the like).

As a further example, a model may be configured to generate an image of a dental patient based on selection requirements and one or more input videos. Training dataset 311 may include video data of a dental patient, and an image of the patient (e.g., an image not included in the video data) that meets selection requirements, to train the machine learning model to generate a new image of the dental patient based on video data and selection requirements.

As a further example, a model may be configured to extract selection criteria from a target image, e.g., an image of a model patient conforming to a set of selection requirements. In some embodiments, the model may be configured to receive a video of a target patient, and an image of a model patient, and either extract or generate an image of the target patient including attributes of the image of the model patient based on the image and video data. The model may be trained by receiving, as training data, a number of model images, and being provided with labeled features, such as labels indicating head angle (e.g., tipped up, profile, straight on, etc.), gaze direction, tooth visibility, expression, etc. The model may then differentiate between images (e.g., video frames) that include target attributes and images that do not.

As a further example, a model may be configured to translate natural language requests into selection requirements usable by further systems for generating one or more dental patient images. This may be performed by adapting a large language model, natural language processing model, or the like for the task of translating a natural language request into selection requirement data usable by an image generation system for extracting or generating a dental patient image satisfying the selection criteria associated with the natural language request.

In some embodiments, at least a portion of the training dataset 311 may be segmented. For example, a model may be trained to separate input data into features, and then utilize the features. The segmenter 315 may separate portions of input dental data for training of a machine learning model. For example, facial features may be separated, so each may be analyzed based on relevant selection requirements. Individual teeth, groups or sets of teeth, facial features, or the like may be segmented from dental patient data to train a model to identify attributes of an image, score an image based on selection requirements, recommend one or more images (e.g., video frames) as conforming to selection requirements (e.g., a scoring function or scoring metric satisfies a threshold condition), or the like. For example, selection requirements may include the visibility of one or more teeth (e.g., a set of teeth associated with a social smile), and segmenter 315 may separate image data for the purpose of determining whether the selection criteria are satisfied.

Data of the training dataset 210 may be processed by segmenter 315 that segments the data of training dataset 311 (e.g., jaw pair data) into multiple different features. The segmenter may then output segmentation information 319. The segmenter 315 may itself be or include one or more machine learning models, e.g., a machine learning model configured to identify individual teeth or target groups of teeth from dental arch data. Segmenter 315 may perform image processing and/or computer vision techniques or operations to extract segmentation information 319 from data of training dataset 311. In some embodiments, segmenter 315 may not include a machine learning model. In some embodiments, training dataset 311 may not be provided to segmenter 315, e.g., training dataset 311 may be provided to train ML models without segmentation.

In some embodiments, various other pre-processing operations (e.g., in addition to or instead of segmentation) may also be performed before providing input (e.g., training input or inference input) to the machine learning model. Other pre-processing operations may share one or more features with segmenter 315 and/or segmentation information 319, e.g., location in the model training workflow 303. Pre-processing operations may include image processing, brightness or contrast correction, cropping, color shifting, or other pre-processing that may improve performance of the machine learning models.

Data from training dataset 311 may be provided to train one or more machine learning models at block 321. Training a machine learning model may include first initializing the machine learning model. The machine learning model that is initialized may be a deep learning model such as an artificial neural network. An optimization algorithm, such as back propagation and gradient descent may be utilized in determining parameters of the machine learning model based on processing of data from training dataset 311.

Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many inputs in the training dataset yields a network that can produce correct output when presented with inputs that are different than the ones present in the training dataset. In high-dimensional settings, such as large images, this generalization is achieved when a sufficiently large and diverse training dataset is made available. Some types of machine learning model that may be used in connections with this disclosure, as well as descriptions of those models, may be found in connection with the discussion of FIG. 3A.

In some embodiments, portions of available training data (e.g., training dataset 311) may be utilized for different operations associated with generating a usable machine learning model. Portions of training dataset 311 may be separated for performing different operations associated with generating a trained machine learning model. Portions of training dataset 311 may be separated for use in training, validating, and testing of machine learning models. For example, 60% of training dataset 311 may be utilized for training, 20% may be utilized for validating, and 20% may be utilized for testing.

In some embodiments, the machine learning model may be trained based on the training portion of training dataset 311. Training the machine learning model may include determining values of one or more parameters as described above to enable a desired output related to an input provided to the model. One or more machine learning models may be trained, e.g., based on different portions of the training data. The machine learning models may then be validated, using the validating portion of the training dataset 311. Validation may include providing data of the validation set to the trained machine learning models and determining an accuracy of the models based on the validation set. Machine learning models that do not meet a target accuracy may be discarded. In some embodiments, only one machine learning model with the highest validation accuracy may be retained, or a target number of machine learning models may be retained. Machine learning models retained through validation may further be tested using the testing portion of training dataset 311. Machine learning models that provide a target level of accuracy in training operations may be retained and utilized for future operations. At any point (e.g., validation, testing), if the number of models that satisfy a target accuracy condition does not satisfy a target number of models, training may be performed again to generate more models for validation and testing.

Once one or more trained machine learning models are generated, they may be stored in model storage 345, and utilized for generating image data associated with dental patients, such as extracting an image from video such that the extracted image satisfies one or more selection requirements, generating an image of a dental patient based on selection requirements and one or more input videos of the dental patient, etc.

In some embodiments, model application workflow 347 includes utilizing the one or more machine learning models trained at block 321. Machine learning models may be implemented as separate machine learning models or a single combined (e.g., hierarchical or ensemble) machine learning model in embodiments.

Processing logic that applies model application workflow 347 may further execute a user interface, such as a graphical user interface. A user may select one or more options using the user interface. Options may include selecting which of the trained machine learning models to use, selecting which of the operations the trained machine learning models are configured to perform to execute, customizing input and/or output of the machine learning models, providing input related to selection requirements, or the like. The user interface may additionally provide options that enable a user to select values of one or more properties, such as a threshold level for recommending an image, a number of images to be provided for review by a user, further systems to provide extracted images to (e.g., for performing further operations in association with dental treatment), or the like.

Input data 351 is provided to a dental image data generator 369, which may include one or more machine learning models trained at block 321. The input data 351 may be new image data that is similar to the data from the training dataset 311. The new image data, for example, may be the same type of data as data from training dataset 311, data collected by the same measurement technique as training dataset 311, data that resembles data of training dataset 311, or the like. Input data 351 may include dental patient video data, dental patient data, model data, selection requirement data, etc. Input data 351 may further include ancillary information, metadata, labeling data, etc. For example, data indicative of a location, orientation, or identity of a tooth or patient, data indicative of a relationship (e.g., a spatial relationship) between two teeth, a tooth and jaw, two dental arches, or the like, or other data may be included in input data 351 (and training dataset 311).

In some embodiments, input data may be preprocessed. For example, preprocessing operations performed on the training dataset 311 may be repeated for at least a portion of input data 351. Input data 351 may include segmented data, data with anomalies or outliers removed, data with manipulated mesh data, or the like.

Input data is provided to dental image data generator 369. In some embodiments, dental image data generator 369 performs some or all of such image preprocessing. For example, dental image data generator 369 may include a video parser 371 that parses a video of input data 351 into individual frames/images, and a segmenter 373 configured to perform segmentation on the individual frames (e.g., to segment a frame into landmarks, facial features, teeth, gingiva, etc.).

Dental image data generator 369 generates dental image data (e.g., dental image data 146 of FIG. 1) based on the input data 351. In some embodiments, dental image data generator 369 includes a single trained machine learning model. In some embodiments, dental image data generator 369 includes a combination of multiple trained machine learning models and/or other logics. In some embodiments, dental image data generator 369 includes one or more models that are not machine learning models, e.g., statistical models, rule-based models, or other algorithmic models (e.g., for evaluating scoring functions based on component scores). Dental image data generator 369 may include combinations of types of logics, models and operations.

For example, a first trained machine learning model (segmenter 373) may segment facial features from an image, a second model may apply facial key points to the image, a third model may generate an indication of facial expression (which may be based on facial features and/or facial key points), etc.

An example set of machine learning models that may be included in dental image data generator 369 in some embodiments is shown in FIG. 3B. Dental image data generator 369 may include video parser 371. Video parser 371 may be or include a machine learning model or other model for performing parsing operations. Video parser 371 may be responsible for separating portions of input video. For example, video parser 371 may be responsible for identifying portions of a video corresponding to particular poses, portions of video corresponding to particular patients, boundaries between portions of video, portions of video that are not to be analyzed (e.g., portions where a person is not in frame, moving in and out of frame, or otherwise comprising image data that is suboptimal for use by dental image data generator 369), or the like. Video parser 371 may further include or be responsible for labeling video portions, e.g., labeling portions based on subject pose, expression, or the like.

Dental image data generator 369 may further include segmenter 373. Segmenter 373 may perform analogous or similar operations to segmenter 315. Segmenter 373 may be responsible for separating portions of input data 351 for inference of dental image data generator 369, score determiner 375, etc. Segmenter 373 may separate one or more parsed portions of input data 351. Segmenter 373 may separate facial features, to analyze each based on relevant selection requirements. Segmenter 373 may separate images of individual teeth, groups or sets of teeth, facial regions, or the like from input data 351.

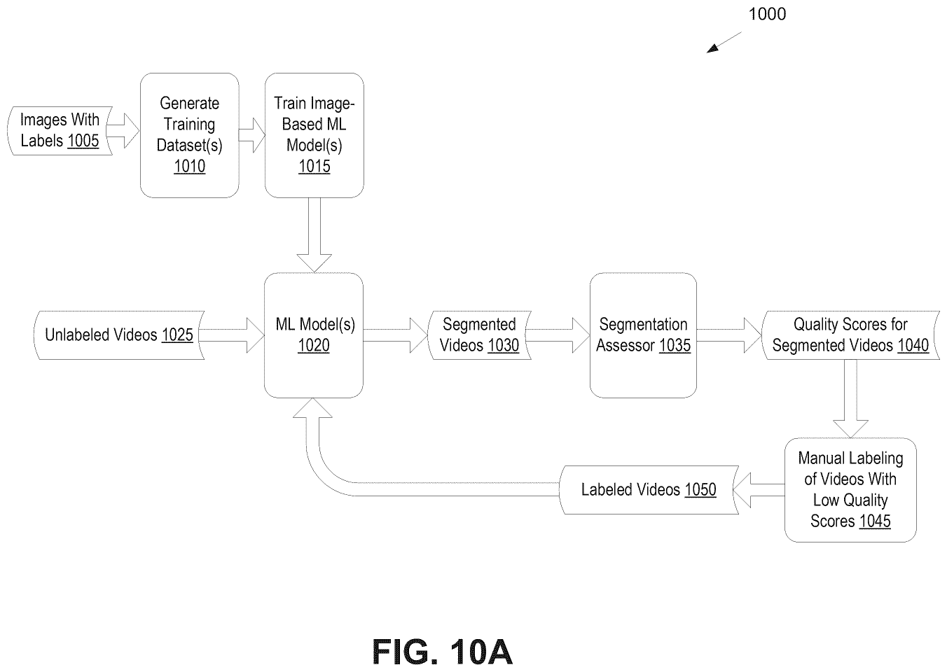

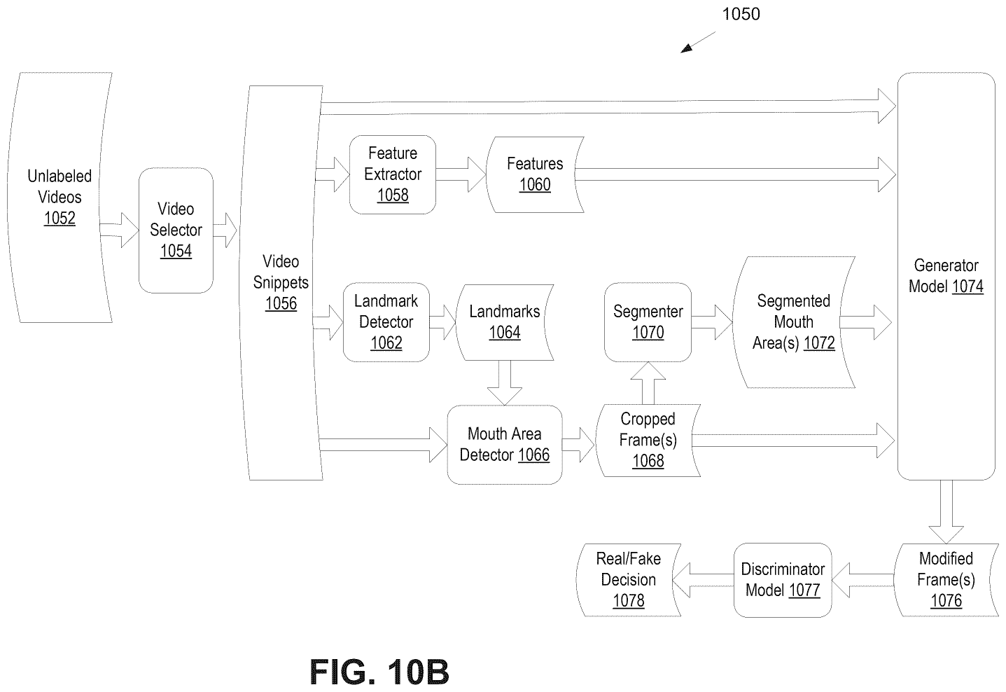

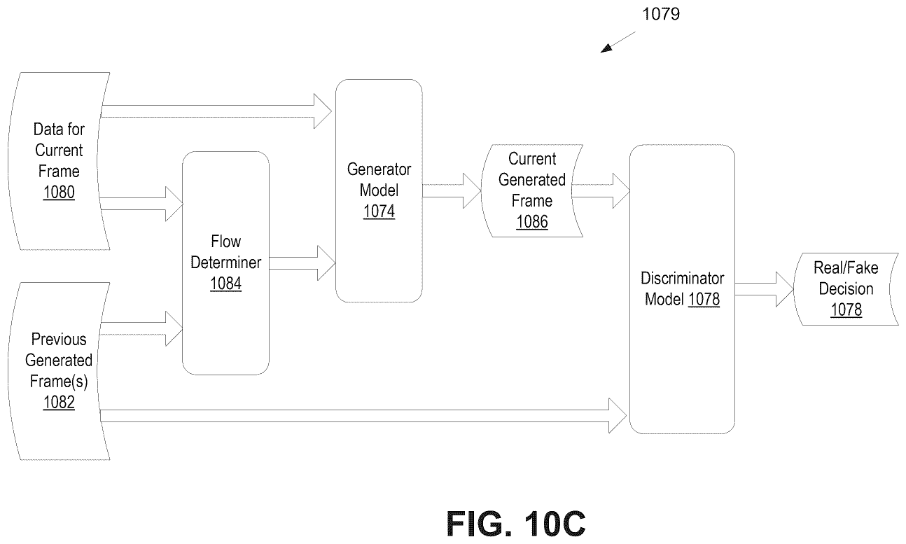

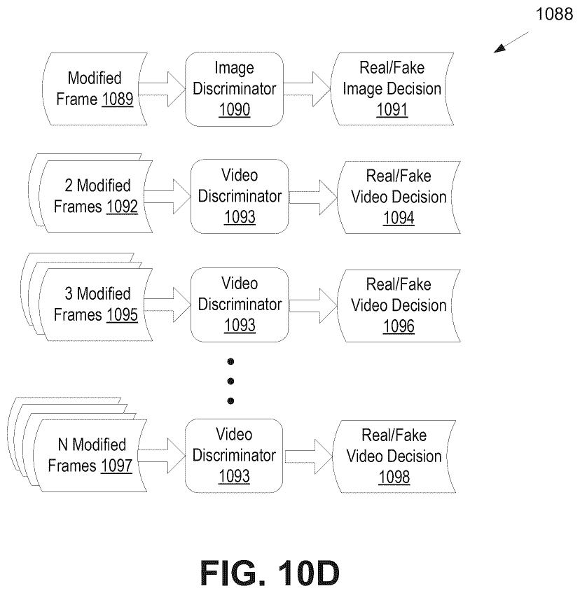

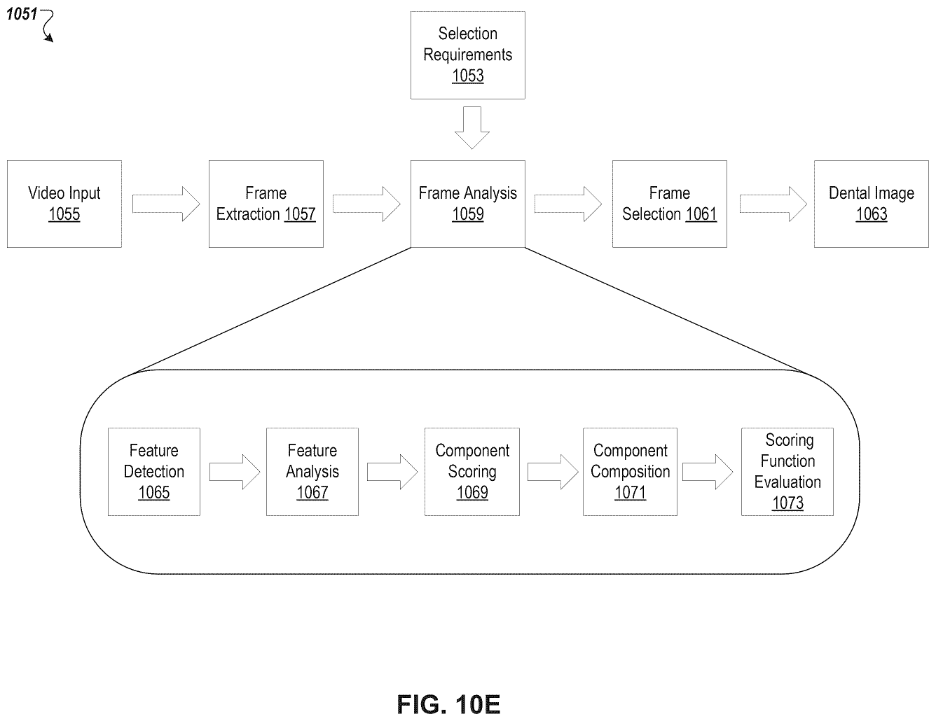

Dental image data generator 369 may further include score determiner 275. Score determiner 275 may be or include a machine learning model for evaluating various frames, portions of frames, etc., for suitability for target processes with relation to dental image data. Score determiner 275 may provide an evaluation of how well an image (e.g., frame or portion of a frame of input data 351) corresponds to target selection requirements. Score determiner 275 may perform score determination based on output of video parser 371, e.g., video parser 371 may provide labels or categorizations indicative of uses for a selection of input data 351 that may be a good fit (e.g., may evaluate or score highly based on set of selection requirements related to a particular use case or outcome). Score determiner 375 may evaluate frames within a section of video based on recommendations or labels of video parser 371, based on user selection, or the like. Score determiner 375 may include one or more scoring functions, e.g., functions for determining a total score for a frame or image in relation to a target image type, target set of selection conditions, target intended use of the image, or the like. Score determiner 375 may provide scoring for multiple attributes; may be or include feature analysis operations; may include scoring various components of an image, compositing the component scoring, and evaluating a composite scoring function, etc. Further details of operations of score determiner 375 may be found in connection with FIG. 10E.

Dental image data generator 369 may include synthetic image generator 377. In some embodiments, an image may be generated and/or adjusted (e.g., by a trained machine learning model) from image data provided in input data 351. Synthetic image generator 377 may combine portions of various images, infer or generate images, or the like, in accordance with one or more sets of selection requirements. In some embodiments, one or more target sets of selections requirements may be determined to not be well represented (e.g., scores satisfying a threshold condition) in a set of input data 351, and synthetic image generator 377 may be utilized to generate images based on the input data 351 that do represent the one or more target sets of selection requirements.

Dental image data generator 369 may include frame/image selector 376. Frame/image selector 379 may perform selection operations based on various scoring schemes in association with frames extracted from input data 351 and/or images generated by synthetic image generator 377 based on input data 351.

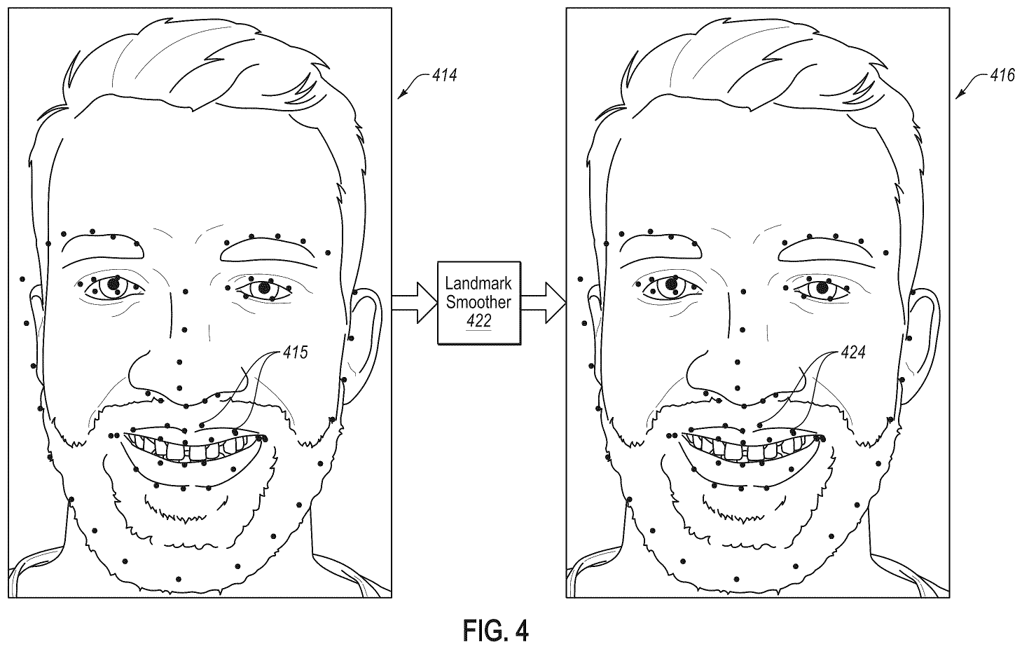

FIG. 4 illustrates images or video frames of a face after performing landmarking, in accordance with an embodiment of the present disclosure. A video frame 414 shows multiple facial landmarks 415 around eyebrows, a face perimeter, a nose, eyes, lips and teeth of an individual's face. In at least one embodiment, landmarks may be detected at slightly different locations between frames of a video, even in instances where a face pose has not changed or has only minimally changed. Such differences in facial landmarks between frames can result in jittery or jumpy landmarks between frames, which ultimately can lead to modified frames produced by a generator model (e.g., modified frame generator 336 of FIG. 3A) that are not temporally consistent between frames. Accordingly, in one embodiment landmark detector 310 receives a current frame as well as landmarks detected from a previous frame, and uses both inputs to determine landmarks of the current frame. Additionally, or alternatively, landmark detector 310 may perform smoothing of landmarks after landmark detection using a landmark smoother 422. In one embodiment, landmark smoother 422 uses a Gaussian kernel to smooth facial landmarks 415 (and/or other landmarks) to make them temporally stable. Video frame 416 shows smoothed facial landmarks 424.

Referring back to FIG. 3A, a result of landmark detector 310 is a set of landmarks 312, which may be a set of smoothed landmarks 312 that are temporally consistent with landmarks of previous video frames. Once landmark detection is performed, the video frame 235 and/or landmarks 312 (e.g., which may include smoothed landmarks) may be input into mouth area detector 314. Mouth area detector 314 may include a trained machine learning model (e.g., such as a deep neural network) that processes a frame of a video 235 (e.g., an image) and/or facial landmarks 312 to determine a mouth area within the frame. Alternatively, mouth area detector 314 may not include an ML model, and may determine a mouth area using the facial landmarks and one or more simple heuristics (e.g., that define a bounding box around facial landmarks for lips).

In at least one embodiment, mouth area detector 314 detects a bounding region (e.g., a bounding box) around a mouth area. The bounding region may include one or more offset around a detected mouth area. Accordingly, in one or more embodiments the bounding region may include lips, a portion of check, a portion of a chin, a portion of a nose, and so on. Alternatively, the bounding region may not be rectangular in shape, and/or may trace the lips in the frame so as to include only the mouth area. In at least one embodiment, landmark detection and mouth area detection are performed by the same machine learning model.

In one embodiment, mouth area detector 314 detects an area of interest that is smaller than a mouth region. For example, mouth area detector 314 detects an area of a dental site within a mouth area. The area of the dental site may be, for example, a limited area or one or more teeth that will undergo restorative treatment. Examples of such restorative treatments include crowns, veneers, bridges, composite bonding, extractions, fillings, and so on. For example, a restorative treatment may include replacing an old crown with a new crown. For such an example, the system may identify an area of interest associated with the region of the old crown. Ultimately, the system may replace only affected areas in a video and keep the current visualization of unaffected regions (e.g., including unaffected regions that are within the mouth area).

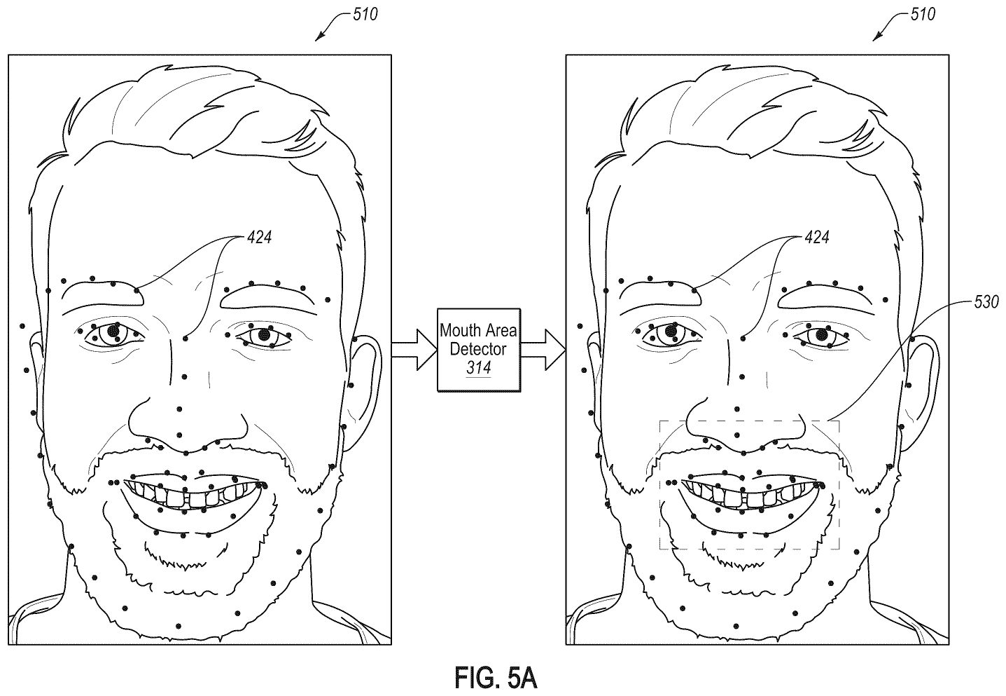

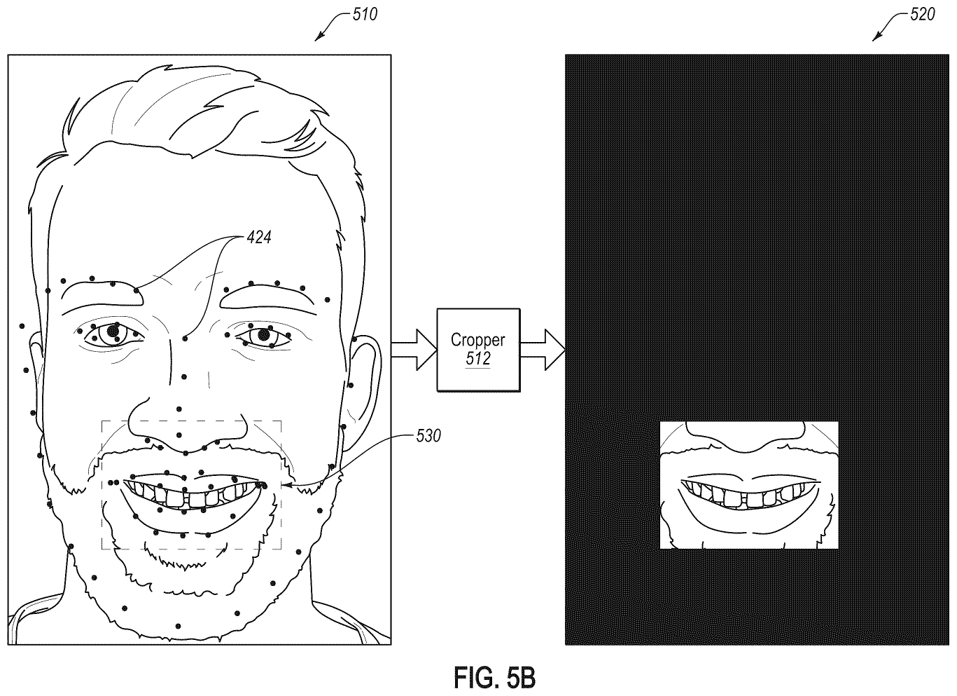

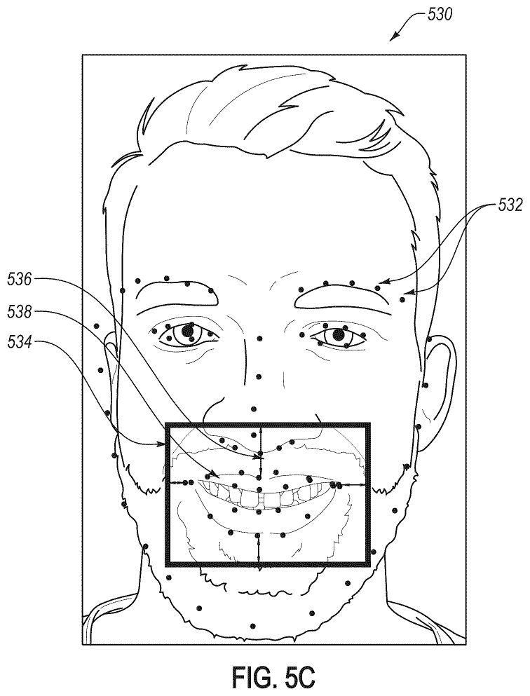

FIG. 5A illustrates images of a face after performing mouth detection, in accordance with an embodiment of the present disclosure. A video frame 510 showing a face with detected landmarks 424 (e.g., which may be smoothed landmarks) is shown. The mouth area detector 314 may process the frame 510 and landmarks 424 and output a boundary region 530 that surrounds an inner mouth area, with or without an offset around the inner mouth area.

FIG. 5B illustrates a cropped video frame 520 of a face that has been cropped around a boundary region that surrounds a mouth area by cropper 512, in accordance with an embodiment of the present disclosure. In the illustrated example, the cropped region is rectangular and includes an offset around a detected mouth area. In other embodiments, the mouth area may not include such an offset, and may instead trace the contours of the mouth area.

FIG. 5C illustrates an image 530 of a face after landmarking and mouth detection, in accordance with an embodiment of the present disclosure. As shown, multiple facial landmarks 532, a mouth area 538, and a bounding region 534 about the mouth area 538 may be detected. In the illustrated example, the bounding region 534 includes offsets 536 about the mouth area 538.

Referring back to FIG. 3A, mouth area detector 314 may crop the frame at the determined bounding region, which may or may not include offsets about a detected mouth area. In one embodiment, the bounding region corresponds to a contour of the mouth area. Mouth area detector 314 may output the cropped frame 316, which may then be processed by segmenter 318.

Segmenter 318 of FIG. 3A may include a trained machine learning model (e.g., such as a deep neural network) that processes a mouth area of a frame (e.g., a cropped frame) to segment the mouth area. The trained neural network may segment a mouth area into different dental objects, such as into individual teeth, upper and/or lower gingiva, inner mouth area and/or outer mouth area. The neural network may identify multiple teeth in an image and may assign different object identifiers to each of the identified teeth. In at least one embodiment, the neural network estimates tooth numbers for each of the identified teeth (e.g., according to a universal tooth numbering system, according to Palmer notation, according to the FDI World Dental Federation notation, etc.). The segmenter 318 may perform semantic segmentation of a mouth area to identify every tooth on the upper and lower jaw (and may specify teeth as upper teeth and lower teeth), to identify upper and lower gingiva, and/or to identify inner and outer mouth areas.

The trained neural network may receive landmarks and/or the mouth area and/or bounding region in some embodiments. In at least one embodiment, the trained neural network receives the frame, the cropped region of the frame (or information identifying the inner mouth area), and the landmarks. In at least one embodiment, landmark detection, mouth area detection, and segmentation are performed by a same machine learning model.

Framewise segmentation may result in temporally inconsistent segmentation. Accordingly, in embodiments, segmenter 318 uses information from one or more previous frames as well as a current frame to perform temporally consistent segmentation. In at least one embodiment, segmenter 318 computes an optical flow between the mouth area (e.g., inner mouth area and/or outer mouth area) of a current frame and one or more previous frames. The optical flow may be computed in an image space and/or in a feature space in embodiments. Use of previous frames and/or optical flow provides context that results in more consistent segmentation for occluded teeth (e.g., where one or more teeth might be occluded in a current frame but may not have been occluded in one or more previous frames). Use of previous frames and/or optical flow also helps to give consistent tooth numbering and boundaries, reduces flickering, improves stability of a future fitting operation, and increases stability of future generated modified frames. Using a model which takes previous frame segmentation prediction, a current image frame and the optical flow can help the model to output temporally stable segmentation masks for a video. Such an approach can ensure that teeth numbering does not flicker and that ambiguous pixels in the corner of the mouth and that occur when the mouth is partially open are segmented with consistency.

Providing past frames as well as a current frame to the segmentation model can help the model to understand how teeth have moved, and resolve ambiguities such as when certain teeth are partly occluded. In one embodiment, an attention mechanism is used for the segmentation model (e.g., ML model trained to perform segmentation). Using such an attention mechanism, the segmentation model may compute segmentation of a current frame, and attention may be applied on the features of past frames to boost performance.

Segmenting may be performed using Panoptic Segmentation (PS) instead of instance or semantic segmentation in some embodiments. PS is a hybrid segmentation approach that may ensure that every pixel is assigned only one class (e.g., no overlapping teeth instances as in instance segmentation). PS ensures that no holes or color bleeding is performed in teeth as the classification will be done at teeth level (not pixel level like in semantic segmentation), and will allow enough context of neighboring teeth for the model to predict the teeth numbering correctly. Unlike instance segmentation, PS also enables segmentation of gums and the inner mouth area. Further, PS performed in the video domain can improve temporal consistency.

The segmentation model may return for each pixel a score distribution of multiple classes that can be normalized and interpreted as a probability distribution. In one embodiment, an operation that finds the argument that gives the maximum value from a target function (e.g., argmax) is performed on the class distribution to assign a single class to each pixel. If two classes have a similar score at a certain pixel, small image changes can lead to changes in pixel assignment. These changes would be visible in videos as flicker. Taking these class distributions into account can help reduce pixel changes when class assignment is not above a certainty threshold.

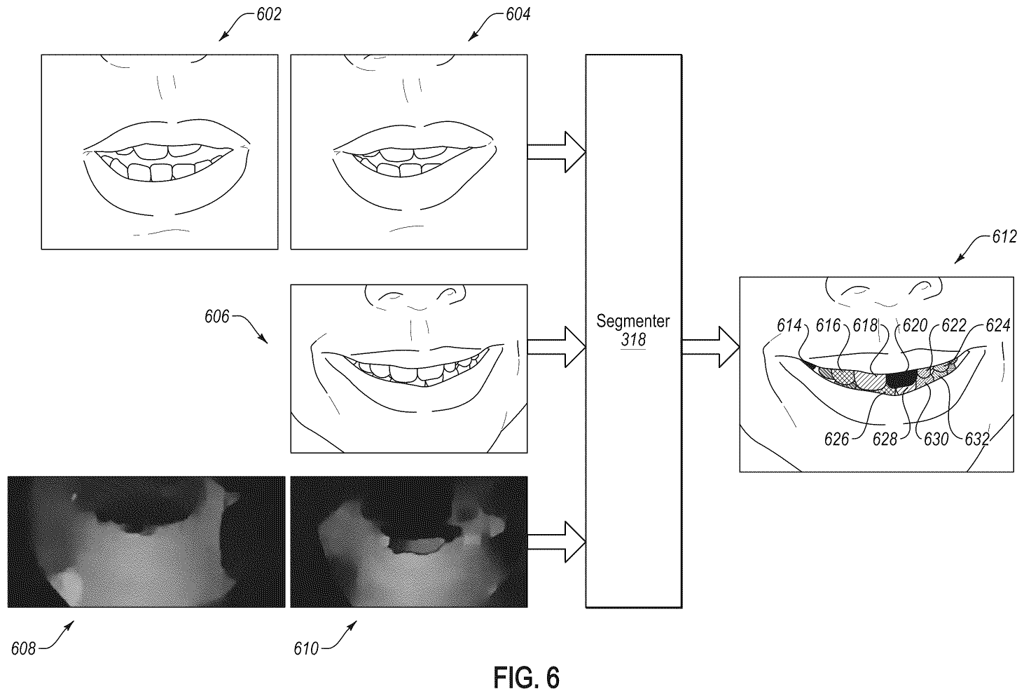

FIG. 6 illustrates segmentation of a mouth area of an image of a face, in accordance with an embodiment of the present disclosure. As shown, a cropped mouth area of a current frame 606 is input into segmenter 318 of FIG. 3A. Also input into segmenter 318 are one or more cropped mouth areas of previous frames 602, 604. Also input into segmenter 318 are one or more optical flows, including a first optical flow 608 between the cropped mouth area of previous frame 602 and the cropped mouth area of current frame 606 and/or a second optical flow 610 between the cropped mouth area of previous frame 604 and the cropped mouth area of current frame 606. Segmenter 318 uses the input data to segment the cropped mouth area of the current frame 606, and outputs segmentation information 612. The segmentation information 612 may include a mask that includes, for each pixel in the cropped mouth area of the current frame 606, an identity of an object associated with that pixel. Some pixels may include multiple object classifications. For example, pixels of the cropped mouth area of the current frame 606 may be classified as inner mouth area and outer mouth area, and may further be classified as a particular tooth or an upper or lower gingiva. As shown in segmentation information 612, separate teeth 614-632 have been identified. Each identified tooth may be assigned a unique tooth identifier in embodiments.

Referring back to FIG. 3A, segmenter 318 may output segmentation information including segmented mouth areas 320. The segmented mouth areas 320 may include a mask that provides one or more classifications for each pixel. For example, each pixel may be identified as an inner mouth area or an outer mouth area. Each inner mouth area pixel may further be identified as a particular tooth on the upper dental arch, a particular tooth on the lower dental arch, an upper gingiva or a lower gingiva. The segmented mouth area 320 may be input into frame to model registration logic 326.

In at least one embodiment, teeth boundary prediction (and/or boundary prediction for other dental objects) is performed instead of or in addition to segmentation. Teeth boundary prediction may be performed by using one or more trained machine learning models to predict teeth boundaries and/or boundaries of other dental objects (e.g., mouth parts) optionally accompanied by depth estimation based on an input of one or more frames of a video.

In addition to frames being segmented, pre-treatment 3D models (also referred to as pre-alteration 3D models) 260 of upper and lower dental arches and/or post-treatment 3D models of the upper and lower dental arches (or other 3D models of altered upper and/or lower dental arches) may be processed by model segmenter 322. Post treatment 3D models may have been generated by treatment planning logic 220 or other altered 3D models may have been generated by dental adaptation logic 214, for example. Model segmenter 322 may segment the 3D models to identify and label each individual tooth in the 3D models and gingiva in the 3D models. In at least one embodiment, the pre-treatment 3D model 260 is generated based on an intraoral scan of a patient's oral cavity. The pre-treatment 3D model 260 may then be processed by treatment planning logic 220 to determine post-treatment conditions of the patient's dental arches and to generate the post-treatment 3D models 262 of the dental arches. Alternatively, the pre-treatment 3D model 260 may be processed by dental adaptation logic 214 to determine post-alteration conditions of the dental arches and to generate the post-alteration 3D models. The treatment planning logic may receive input from a dentist or doctor in the generation of the post-treatment 3D models 262, and the post-treatment 3D models 262 may be clinically accurate. The pre-treatment 3D models 260 and post-treatment or post-alteration 3D models 262 may be temporally stable.

In at least one embodiment, 3D models of upper and lower dental arches may be generated without performing intraoral scanning of the patient's oral cavity. A model generator may generate approximate 3D models of the patient's upper and lower dental arch based on 2D images of the patient's face. A treatment estimator may then generate an estimated post-treatment or other altered condition of the upper and lower dental arches and generate post-treatment or post-alteration 3D models of the dental arches. The post-treatment or post-alteration dental arches may not be clinically accurate in embodiments, but may still provide a good estimation of what an individual's teeth can be expected to look like after treatment or after some other alteration.

In at least one embodiment, model segmenter 322 segments the 3D models and outputs segmented pre-treatment 3D models 324 and/or segmented post-treatment 3D models 334 or post-alteration 3D models. Segmented pre-treatment 3D models 324 may then be input into frame to model registration logic 326.

Frame to model registration logic 326 performs registration and fitting between the segmented mouth area 320 and the segmented pre-treatment 3D models 324. In at least one embodiment, a rigid fitting algorithm is used to find a six-dimensional (6D) orientation (e.g., including translation along three axes and rotation about three axes) in space for both the upper and lower teeth. In at least one embodiment, the fitting is performed between the face in the frame and a common face mesh (which may be scaled to a current face). This enables processing logic to determine where the face is positioned in 3D space, which can be used as a constraint for fitting of the 3D models of the dental arches to the frame. After completing face fitting, teeth fitting (e.g., fitting of the dental arches to the frame) may be performed between the upper and lower dental arches and the frame. The fitting of the face mesh to the frame may be used to impose one or more constraints on the teeth fitting in some embodiments.

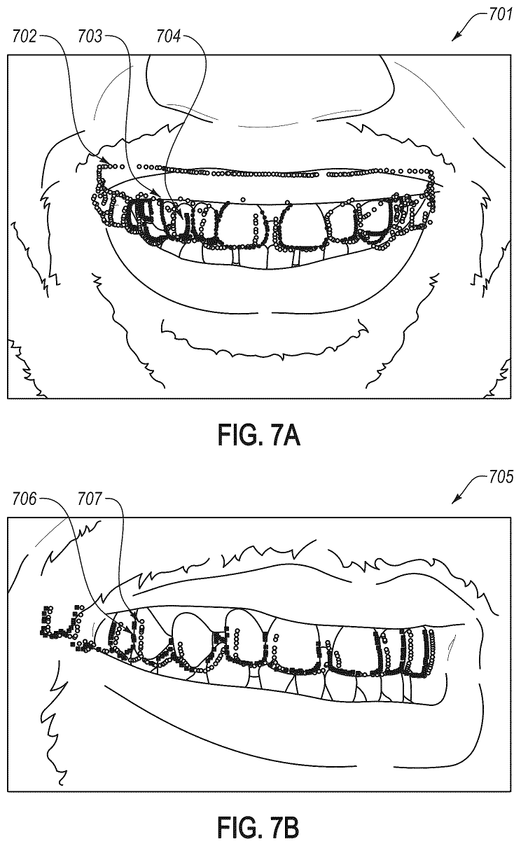

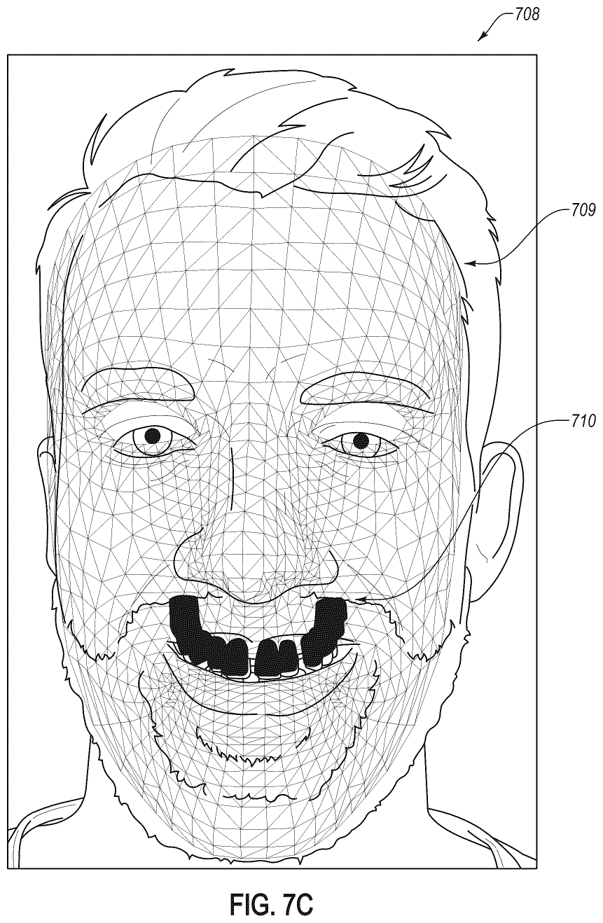

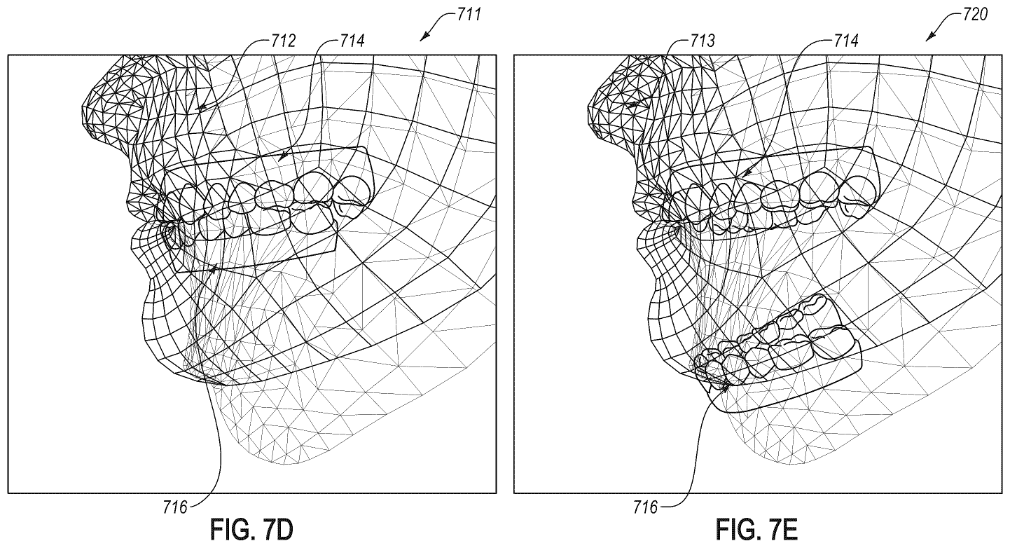

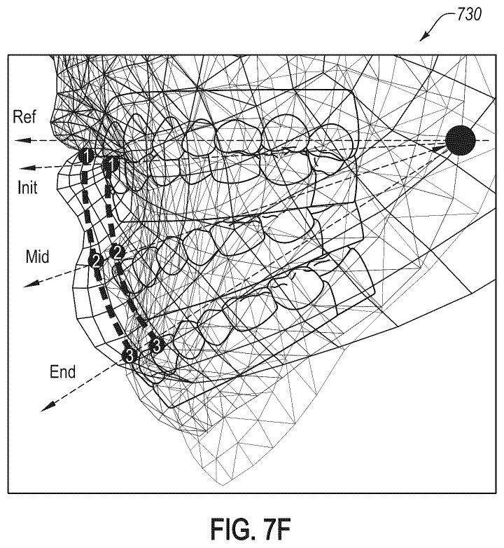

FIG. 7A illustrates fitting of a 3D model of a dental arch to an image of a face, in accordance with an embodiment of the present disclosure. A position and orientation for the 3D model is determined relative to cropped frame 701. The 3D model at the determined position and orientation is then projected onto a 2D surface (e.g., a 2D plane) corresponding to the plane of the frame. Cropped frame 316 of FIG. 3A is fit to the 3D model, where dots 702 are vertices of the 3D model projected onto the 2D image space. Lines 703 are contours around the teeth in 2D from the segmentation of the cropped frame 316. During fitting, processing logic minimizes the distance between the lines 703 and the dots 702 such that the dots 702 and lines 703 match. With each change in orientation of the 3D model the 3D model at the new orientation may be projected onto the 2D plane. In at least one embodiment, fitting is performed according to a correspondence algorithm or function. Correspondence is a match between a 2D contour point and a 3D contour vertex. With this matching, processing logic can compute the distance between a 2D contour point and 3D contour vertex in image space after projecting the 3D vertices onto the frame. The computed distance can be added to a correspondence cost term for each correspondence over all of the teeth. In at least one embodiment, correspondences are the main cost term to be optimized and so are the most dominant cost term.

Fitting of the 3D models of the upper and lower dental arches to the segmented teeth in the cropped frame includes minimizing the costs of one or more cost functions. One such cost function is associated with the distance between points on individual teeth from the segmented 3D model and points on the same teeth from the segmented mouth area of the frame (e.g., based on the correspondences between projected 3D silhouette vertices from the 3D models of the upper and lower dental arches and 2D segmentation contours from the frame). Other cost functions may also be computed and minimized. In some embodiments not all cost functions will be minimized. For example, reaching a minima for one cost function may cause the cost for another cost function to increase. Accordingly, in embodiments fitting includes reaching a global minimum for a combination of the multiple cost functions. In at least one embodiment, various cost functions are weighted, such that some cost functions may contribute more or less to the overall cost than other cost functions. In at least one embodiment, the correspondence cost between the 3D silhouette vertices and the 2D segmentation contours from the frame are given a lower weight than other cost functions because some teeth may become occluded or are not visible in some frames of the video.

In at least one embodiment, one or more constraints are applied to the fitting to reduce an overall number of possible solutions for the fitting. Some constraints may be applied, for example, by an articulation model of the jaw. Other constraints may be applied based on determined relationships between an upper dental arch and facial features such as nose, eyes, and so on. For example, the relative positions of the eyes, nose, etc. and the dental arch may be fixed for a given person. Accordingly, once the relative positions of the eyes, nose, etc. and the upper dental arch is determined for an individual, those relative positions may be used as a constraint on the position and orientation of the upper dental arch. Additionally, there is generally a fixed or predictable relationship between a position and orientation of a chin and a lower dental arch for a given person. Thus, the relative positions between the lower dental arch and the chin may be used as a further constraint on the position and orientation of the lower dental arch. A patient's face is generally visible throughout a video and therefore provides information on where the jawline should be positioned in cases where the mouth is closed or not clearly visible in a frame. Accordingly, in some embodiments fitting may be achieved even in instances where few or no teeth are visible in a frame based on prior fitting in previous frames and determined relationships between facial features and the upper and/or lower dental arches.

Teeth fitting optimization may use a variety of different cost terms and/or functions. Each of the cost terms may be tuned with respective weights so that there is full control of which terms are dominant. Some of the possible cost terms that may be taken into account include a correspondence cost term, a similarity cost term, a maximum allowable change cost term, a bite collision cost term, a chin reference cost term, an articulation cost term, and so on. In at least one embodiment, different optimizations are performed for the upper and lower 6D jaw poses. Some cost terms are applicable for computing both the upper and lower dental arch fitting, and some cost terms are only applicable to the upper dental arch fitting or only the lower dental arch fitting.

Some cost terms that may apply to upper and lower dental arch fitting includes correspondence cost terms, similarity cost terms, and maximal allowable change.

In at least one embodiment, the correspondences for each tooth are weighted depending on a current face direction or orientation. More importance may be given to teeth that are more frontal to the camera for a particular frame. Accordingly, teeth that are front most in a current frame may be determined, and correspondences for those teeth may be weighted more heavily than correspondences for other teeth for that frame. In a new frame a face pose may change, resulting in different teeth being foremost. The new foremost teeth may be weighted more heavily in the new frame.

Another cost term that may be applied is a similarity cost term. Similarity cost terms ensure that specified current optimization parameters are similar to given optimization parameters. One type of similarity cost term is a temporal similarity cost term. Temporal similarity represents the similarity between the current frame and previous frame. Temporal similarity may be computed in terms of translations and rotations (e.g., Euler angles and/or Quaternions) in embodiments. Translations may include 3D position information in X, Y and Z directions. Processing logic may have control over 3 different directions separately. Euler angles provide 3D rotation information around X, Y and Z directions. Euler angles may be used to represent rotations in a continuous manner. The respective angles can be named as pitch, yaw, and roll. Processing logic may have control over 3 different directions separately. 3D rotation information may also be represented in Quaternions. Quaternions may be used in many important engineering computations such as robotics and aeronautics.

Another similarity cost term that may be used is reference similarity. Temporal similarity represents the similarity between a current object to be optimized and a given reference object. Such optimization may be different for the upper and lower jaw. The upper jaw may take face pose (e.g., 6D face pose) as reference, while lower jaw may take upper jaw pose and/or chin pose as a reference. The application of these similarities may be the same as or similar to what is performed for temporal similarity, and may include translation, Euler angle, and/or Quaternion cost terms.

As mentioned, one or more hard constraints may be imposed on the allowed motion of the upper and lower jaw. Accordingly, there may be maximum allowable changes that will not be exceeded. With the given reference values of each 6D pose parameter, processing logic can enforce an optimization solution to be in bounds with the constraints. In one embodiment, the cost is only activated when the solution is not in bounds, and then it is recomputed by considering the hard constraint or constraints that were violated. 6D pose can be decomposed as translation and rotation as it is in other cost terms, such as with translations, Euler angles and/or Quaternions.

In addition to the above mentioned common cost terms used for fitting both the upper and lower dental arch to the frame, one or more lower jaw specific cost terms may also be used, as fitting of the lower dental arch is a much more difficult problem than fitting of the upper dental arch. In at least one embodiment, processing logic first solves for fitting of the upper jaw (i.e., upper dental arch). Subsequently, processing logic solves for fitting of the lower jaw. By first solving for the fitting of the upper jaw, processing logic may determine the pose of the upper jaw and use it for optimization of lower jaw fitting.

In one embodiment, a bite collision cost term is used for lower jaw fitting. When processing logic solves for lower jaw pose, it may strictly ensure that the lower jaw does not collide with the upper jaw (e.g., that there is not overlap in space between the lower jaw and the upper jaw since this is physically impossible). Since processing logic has solved for the pose of upper jaw already, this additional cost term may be applied on the solution for the lower jaw position to avoid bite collision.

The lower jaw may have a fixed or predictable relationship to the chin for a given individual. Accordingly, in embodiments a chin reference cost term may be applied for fitting of the lower jaw. Lower jaw optimization may take into consideration the face pose, which may be determined by performing fitting between the frame and a 3D face mesh. After solving for face pose and jaw openness, processing logic may take a reference from chin position to locate the lower jaw. This cost term may be is useful for open jaw cases.

There are a limited number of possible positions that a lower jaw may have relative to an upper jaw. Accordingly, a jaw articulation model may be determined and applied to constrain the possible fitting solutions for the lower jaw. Processing logic may constrain the allowable motion of the lower jaw in the Y direction, both for position and rotation (jaw opening, pitch angle, etc.) in embodiments. In at least one embodiment, a simple articulation model is used to describe the relationship between position and orientation in a vertical direction so that processing logic may solve for one parameter (articulation angle) instead of multiple (e.g., two) parameters. Since processing logic already constrains the motion of the lower jaw in other directions mostly with upper jaw, this cost term helps to stabilize the jaw opening in embodiments.

In at least one embodiment, information from multiple frames is used in determining a fitting solution to provide for temporal stability. A 3D to 2D fitting procedure may include correctly placing an input 3D mesh on a frame of the video using a determined 6D pose. Fitting may be performed for each frame in the video. In one embodiment, even though the main building blocks for fitting act independently, multiple constraints may be applied on the consecutive solutions to the 6D poses. This way, processing logic not only solves for the current frame pose parameters, but also considers the previous frame(s). In the end, the placement of the 3D mesh looks correct and the transitions between frames look very smooth, i.e. natural.

In at least one embodiment, before performing teeth fitting, a 3D to 2D fitting procedure is performed for the face in a frame. Processing logic may assume that the relative pose of the upper jaw to the face is the same throughout the video. In other words, teeth of the upper jaw do not move inside the face. Using this information enables processing logic to utilize a very significant source of information, which is the 6D pose of the face. Processing logic may use face landmarks as 2D information, and such face landmarks are already temporally stabilized as discussed with reference to landmark detector 310.

In at least one embodiment, processing logic uses a common 3D face mesh with size customizations. Face fitting provides very consistent information throughout a video because the face is generally visible in all frames even though the teeth may not be visible in all frames. For those cases where the teeth are not visible, face fitting helps to position the teeth somewhere close to its original position even though there is no direct 2D teeth information. This way, consecutive fitting optimization does not break and is ready for teeth visibility in the video. Additionally, processing logic may optimize for mouth openness of the face in a temporally consistent way. Processing logic may track the chin, which provides hints for optimizing the fitting of the lower jaw, and especially in the vertical direction.

The fitting process is a big optimization problem where processing logic tries to find the best 6D pose parameters for the upper and lower jaw in a current frame. In addition to the main building blocks, processing logic may consider different constraints in the optimization such that it ensures temporal consistency.

In at least one embodiment, frame to model registration logic 326 starts each frame's optimization with the last frame's solution (i.e., the fitting solution for the previous frame). In the cases where there are small movements (e.g., of head, lips, etc.), this already gives a good baseline for smooth transitions. Processing logic may also constrain the new pose parameters to be similar to the previous frame values. For example, the fitting solutions for a current frame may not have more than a threshold difference from the fitting solutions for a previous frame. In at least one embodiment, for a first frame, processing logic applies an initialization step based on an optimization that minimizes the distance between the centers of 2D tooth segmentations and the centers 2D projections of the 3D tooth models.

FIG. 7B illustrates a comparison of the fitting solution 706 for a current frame and a prior fitting solution 707 for a previous frame, in accordance with an embodiment of the present disclosure. A constraint may be applied that prohibits the fitting solution for the current frame from differing from the fitting solution for the prior frame by more than a threshold amount.

In at least one embodiment, new pose parameters (e.g., a new fitting solution for a current frame) are constrained to have a similar relative position and orientation to a specified reference as prior pose parameters. For the upper jaw optimization, one or more facial landmarks (e.g., for eyes, nose, checks, etc.) and their relationship to the upper jaw as determined for prior frames are used to constrain the fitting solution for the upper jaw in a current frame. Processing logic may assume that the pose of the upper jaw relative to the facial landmarks is the same throughout the video in embodiments.

FIG. 7C illustrates fitting of a 3D model of an upper dental arch 710 to an image of a face 708 based on one or more landmarks of the face and/or a determined 3D mesh of the face 709, in accordance with an embodiment of the present disclosure.

With regards to fitting of the 3D model of the lower dental arch, the facial landmarks and the position of the upper jaw may be used to constrain the possible solutions for the fitting. The position of teeth and face relative to each other may be defined by anatomy and expressions for the lower jaw. Tracking the face position using landmarks can help constraint the teeth positions when other image features such as a segmentation are not reliable (e.g., in case of motion blur).

In one embodiment, processing logic assumes that the pose parameters in horizontal and depth directions are the same for the lower and upper jaw relative to their initial poses. Processing logic may only allow differences in a vertical direction (relative to the face) due to the physical constraints on opening of the lower jaw. As specified above, processing logic may also constrain lower jaw position to be similar to chin position. This term guides the lower jaw fitting in the difficult cases where there is limited information from 2D.

FIGS. 7D-E illustrate fitting of 3D models of an upper and lower dental arch to an image of a face, in accordance with an embodiment of the present disclosure. In particular, FIG. 7D shows fitting of the lower jaw 716 to a frame 711 based on information on a determined position of an upper jaw 714 and on a facial mesh 712 in an instance where the lower jaw is closed. FIG. 7E shows fitting of the lower jaw 716 to a different frame 720 based on information on a determined position of an upper jaw 714 and on a facial mesh 713 in an instance where the lower jaw is open, using a chin reference cost term.

For the lower jaw, processing logic may constrain the motion in the Y direction (e.g., for both rotation and translation) to be in a predefined path. Processing logic may apply a simplified articulation model that defines the motion of the lower jaw inspired from anatomical approximations. Processing logic may also apply a constraint on similarity between articulation angle in a previous frame and articulation angle in a current frame which makes the jaw opening and closing smooth across the frames.

FIG. 7F illustrates fitting of a lower dental arch to an image of a face using a jaw articulation model and a constraint on similarity between articulation angle between frames, in accordance with an embodiment of the present disclosure. The articulation model shows a reference angle, an a minimum articulation angle (init) (e.g., in bite position), a mid-adjustment articulation angle and an end articulation angle that shows a maximum articulation of the lower jaw.

In at least one embodiment, on top of the teeth fitting optimization steps, processing logic may also apply some filtering steps to overrule some non-smooth parts of a video. In one embodiment, processing logic applies one or more state estimation methods to estimate the next frame pose parameters by combining the information retrieved from the teeth fitting optimization and a simple mathematical model of the pose changes. In one embodiment, processing logic applies a Kalman Filter with determined weighting for this purpose. In one embodiment, an optical flow is computed and used for image motion information in 2D. Optical flow and/or tracking of landmarks can give visual clues of how fast objects move in the video stream. Movements of these image features may be constrained to match with the movements of the re-projection of a fitted object. Even without connecting this information with 3D, processing logic can still add it as an additional constraint to the teeth fitting optimization. In one embodiment, simple 1D Gaussian smoothing is performed to prune any remaining outliers.

In at least one embodiment, state estimation methods such as a Kalman filter may be used to improve fitting. Using common sense, a statistical movement model of realistic movements of teeth may be built, which may be applied as constraints on fitting. The 2D-3D matching result may be statistically modeled based on the segmentation prediction as a measurement in embodiments. This may improve a position estimate to a statistically most likely position.

Returning to FIG. 3A, for each frame, frame to model registration logic 326 (also referred to as fitting logic) outputs registration information (also referred to as fitting information). The registration information 328 may include an orientation, position and/or zoom setting (e.g., 6D fitting parameters) of an upper 3D model fit to a frame and may include a separate orientation, position and/or zoom setting of a lower 3D model fit to the frame. Registration information 328 may be input into a model projector 329 along with segmented post treatment 3D models (or post-alteration 3D models) of the upper and lower dental arch. The model projector 329 may then project the post-treatment 3D models (or post-alteration 3D models) onto a 2D plane using the received registration information 328 to produce post-treatment contours 341 (or post-alteration contours) of teeth. The post-treatment contours (or post alteration contours) of the upper and/or lower teeth may be input into modified frame generator 336. In at least one embodiment, model projector 329 additionally determines normals to the 3D surfaces of the teeth, gums, etc. from the post-treatment/alteration 3D models (e.g., the segmented post-treatment/alteration 3D models) and/or the pre-treatment/alteration 3D models (e.g., the segmented pre-treatment/alteration 3D models). Each normal may be a 3D vector that is normal to a surface of the 3D model at a given pixel as projected onto the 2D plane. In at least one embodiment, a normal map comprising normals to surfaces of the post-treatment 3D model (or post alteration 3D model) may be generated and provided to the modified frame generator 336. The normal map may be a 2D map comprising one of more of the normals. In one embodiment the 2D map comprises a red, green, blue (RGB) image, wherein one or more pixels of the RGB image comprise a red value representing a component of a vector along a first axis, a green value representing a component of the vector along a second axis, and a blue value representing a component of the vector along a third axis.

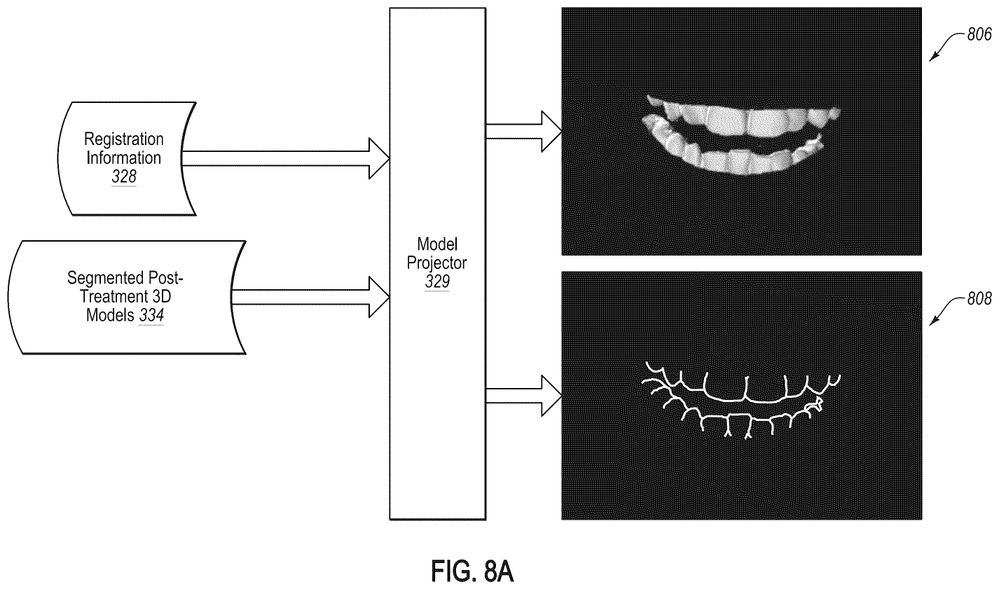

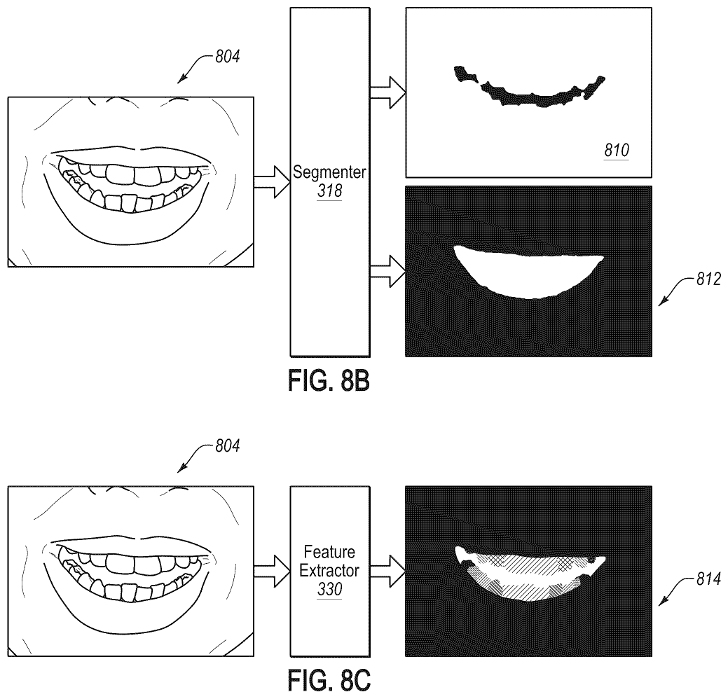

FIG. 8A illustrates model projector 329 receiving registration information 328, a segmented 3D model of an upper dental arch and a segmented 3D model of a lower dental arch, and outputting a normals map 806 for the portion of the post-treatment dentition that would occur within the inner mouth region of a frame and a contours sketch 808 for the portion of the post-treatment dentition that would occur within the inner mouth region of the frame.

FIG. 8B shows a cropped frame of a face being input into a segmenter 318 of FIG. 3A. Segmenter 318 may identify an inner mouth area, an outer mouth area, teeth, an area between teeth, and so on. The segmenter 318 may output one or more masks. In one embodiment, segmenter 318 outputs a first mask 812 that identifies the inner mouth area and a second mask 810 that identifies space between teeth of an upper dental arch and teeth of a lower dental arch. For the first mask 812, pixels that are in the inner mouth area may have a first value (e.g., 1) and pixels that are outside of the inner mouth area may have a second value (e.g., 0). For the second mask, pixels that are part of the region between the upper and lower dental arch teeth (e.g., of the negative space between teeth) may have a first value, and all other pixels may have a second value.

Returning to FIG. 3A, feature extractor 330 may include one or more machine learning models and/or image processing algorithms that extract one or more features from frames of the video. Feature extractor 330 may receive one or more frames of the video, and may perform feature extraction on the one or more frames to produce one or more feature sets 332, which may be input into modified frame generator 336. The specific features that are extracted are features usable for visualizing post-treatment teeth or other post-alteration teeth. In one embodiment, feature extractor extracts average teeth color for each tooth. Other color information may additionally or alternatively be extracted from frames.

In one embodiment, feature extractor 330 includes a trained ML model (e.g., a small encoder) that processes some or all frames of the video 235 to generate a set of features for the video 235. The set of features may include features present in a current frame being processed by video processing workflow 305 as well as features not present in the current frame. The set of features output by the encoder may be input into the modified frame generator 336 together with the other inputs described herein. By extracting features from many frames of the video rather than only features of the current frame and providing those features to modified frame generator 336, processing logic increases stability of the ultimately generated modified frames.

Different features may benefit from different handling for temporal consistency. The tooth color for example does not change throughout a video, but occlusions, shadow and lighting do. When extracting features in an unsupervised manner using for example auto-encoders, image features are not disentangled and there is no way to semantically interpret or edit such image features. This makes temporally smoothing these very hard. Accordingly, in embodiments the feature extractor 330 extracts the color values of the teeth for all frames and uses Gaussian smoothing for temporal consistency. The color values may be RGB color values in embodiments. The RGB values of a tooth depend on the tooth itself, which is constant, but also the lighting conditions that can change throughout the video. Accordingly, in some embodiments lighting may be taken into consideration, such as by using depth information that indicates depth into the plane of an image for each pixel of a tooth. Teeth that have less depth may be adjusted to be lighter, while teeth that have greater depth (e.g., are deeper or more recessed into the mouth) may be adjusted to be darker.

In one embodiment, feature extractor 330 includes a model (e.g., an ML model) that generates a color map from a frame. In one embodiment, feature extractor 330 generates a color map using traditional image processing techniques, and does not use a trained ML model for generation of the color map. In one embodiment, the feature extractor 330 determines one or more blurring functions based on a captured frame. This may include setting up the functions, and then solving for the one or more blurring functions using data from an initial pre-treatment video frame. In at least one embodiment, a first set of blurring functions is generated (e.g., set up and then solved for) with regards to a first region depicting teeth in the captured frame and a second set of blurring functions is generated with regards to a second region depicting gingiva in the captured frame. Once the blurring functions are generated, these blurring functions may be used to generate a color map.

In at least one embodiment, the blurring functions for the teeth and/or gingiva are global blurring functions that are parametric functions. Examples of parametric functions that may be used include polynomial functions (e.g., such as biquadratic functions), trigonometric functions, exponential functions, fractional powers, and so on. In one embodiment, a set of parametric functions are generated that will function as a global blurring mechanism for a patient. The parametric functions may be unique functions generated for a specific patient based on an image of that patient's smile. With parametric blurring, a set of functions (one per color channel of interest) may be generated, where each function provides the intensity, I, for a given color channel, c, at a given pixel location, x, y according to the following equation:

$${I}_{c} ( x , y ) = f ( x , y ) \qquad ( 1 )$$

A variety of parametric functions can be used for f. In one embodiment, a parametric function is used, where the parametric function can be expressed as:

$${I}_{c} ( x , y ) = {\sum }_{i = 0}^{N} {\sum }_{j = 0}^{i} w ( i , j ) {x}^{i - j} {y}^{j} \qquad ( 2 )$$

In one embodiment, a biquadratic function is used. The biquadratic can be expressed as:

$${I}_{c} ( x , y ) = {w}_{0} + {w}_{1} x + {w}_{2} y + {w}_{3} x y + {w}_{4} {x}^{2} + {w}_{5} {y}^{2} \qquad ( 3 )$$

where w₀, w₁, . . . , w₅ are weights (parameters) for each term of the biquadratic function, x is a variable representing a location on the x axis and y is a variable representing a location on the y axis (e.g., x and y coordinates for pixel locations, respectively).

The parametric function (e.g., the biquadratic function) may be solved using linear regression (e.g., multiple linear regression). Some example techniques that may be used to perform the linear regression include the ordinary least squares method, the generalized least squares method, the iteratively reweighted least squares method, instrumental variables regression, optimal instruments regression, total least squares regression, maximum likelihood estimation, rigid regression, least absolute deviation regression, adaptive estimation, Bayesian linear regression, and so on.

To solve the parametric function, a mask M of points may be used to indicate those pixel locations in the initial image that should be used for solving the parametric function. For example, the mask M may specify some or all of the pixel locations that represent teeth in the image if the parametric function is for blurring of teeth or the mask M may specify some or all of the pixel locations that represent gingiva if the parametric function is for the blurring of gingiva.

In an example, for any initial image and mask, M, of points, the biquadratic weights, w₀, w₁, . . . , w₅, can be found by solving the least squares problem:

$${Aw}^{T} = b \qquad ( 4 )$$

$$where :$$

$$w = [ {w}_{0} , {w}_{1} , {w}_{2} , {w}_{3} , {w}_{4} , {w}_{5} ] \qquad ( 5 )$$

$$A = [ \begin{matrix}1 & {x}_{0} & {y}_{0} & {x}_{0} {y}_{0} & {x}_{0}^{2} & {y}_{0}^{2} \\ 1 & {x}_{1} & {y}_{1} & {x}_{1} {y}_{1} & {x}_{1}^{2} & {y}_{1}^{2} \\ ⋮ & ⋮ & ⋮ & ⋮ & ⋮ & ⋮ \\ 1 & {x}_{n} & {y}_{n} & {x}_{n} {y}_{n} & {x}_{n}^{2} & {y}_{n}^{2}\end{matrix} ] ; ∀ {x}_{i} , {y}_{i} ∈ M \qquad ( 6 )$$

$$b = [ \begin{matrix}{I}_{c} ( {x}_{0} , {y}_{0} \\ {I}_{c} ( {x}_{1} , {y}_{1} ) \\ ⋮ \\ {I}_{c} ( {x}_{n} , {y}_{n} )\end{matrix} ] ; ∀ {x}_{i} , {y}_{i} ∈ M \qquad ( 7 )$$

By constructing blurring functions (e.g., parametric blurring functions) separately for the teeth and the gum regions, a set of color channels can be constructed that avoid any pattern of dark and light spots that may have been present in the initial image as a result of shading (e.g., because one or more teeth were recessed).

In at least one embodiment, the blurring functions for the gingiva are local blurring functions such as Gaussian blurring functions. A Gaussian blurring function in embodiments has a high radius (e.g., a radius of at least 5, 10, 20, 40, or 50 pixels). The Gaussian blur may be applied across the mouth region of the initial image in order to produce color information. A Gaussian blurring of the image involves convolving a two-dimensional convolution kernel over the image and producing a set of results. Gaussian kernels are parameterized by σ, the kernel width, which is specified in pixels. If the kernel width is the same in the x and y dimensions, then the Gaussian kernel is typically a matrix of size 6σ+1 where the center pixel is the focus of the convolution and all pixels can be indexed by their distance from the center in the x and y dimensions. The value for each point in the kernel is given as:

$$G ( x , y ) = \frac{1}{2 {πσ}^{2}} {e}^{- \frac{{x}^{2} + {y}^{2}}{2 {π}^{2}}} \qquad ( 8 )$$

In the case where the kernel width is different in the x and y dimensions, the kernel values are specified as:

$$G ( x , y ) = G ( x ) G ( y ) = \frac{1}{2 {πσ}_{x} {σ}_{y}} {e}^{- ( \frac{{x}^{2}}{2 {σ}_{x}^{2}} + \frac{{y}^{2}}{2 {σ}_{y}^{2}} )} \qquad ( 9 )$$

FIG. 8C illustrates a cropped frame of a face being input into a feature extractor 330. Feature extractor 330 may output a color map and/or other feature map of the inner mouth area of the cropped frame.

Referring back to FIG. 3A, modified frame generator 336 receives features 332, post-treatment or other post-alteration contours and/or normals 341, and optionally one or more masks generated by segmenter 318 and/or mouth area detector 314. Modified frame generator 336 may include one or more trained machine learning models that are trained to receive one or more of these inputs and to output a modified frame that integrates information from the original frame with a post-treatment or other post-alteration dental arch condition. Abstract representations such as a color map, image data such as sketches obtained from the 3D model of the dental arch at a stage of treatment (e.g., from a 3D mesh from the treatment plan) depicting contours of the teeth and gingiva post-treatment or at an intermediate stage of treatment and/or a normal map depicting normals of surfaces from the 3D model, for example, may be input into a generative model (e.g., such as a generative adversarial network (e.g., a generator of a generative adversarial network) or a variational autoencoder) that then uses such information to generate a post-treatment image of a patient's face and/or teeth. Alternatively, abstract representations such as a color map, image data such as sketches obtained from the 3D model of an altered dental arch depicting contours of the altered teeth and/or gingiva and/or a normal map depicting normals of surfaces from the 3D model may be input into a generative model that then uses such information to generate an altered image of a patient's face and/or teeth that may not be related to dental treatment. In at least one embodiment, large language models may be used in the generation of altered images of patient faces. For example, one or more large language model (LLM) may receive any of the aforementioned inputs discussed with reference to a generative model and output and output one or more synthetic images of the face and/or teeth.

In at least one embodiment, modified frame generator 336 includes a trained generative model that receives as input, features 332 (e.g., a pre-treatment and/or post treatment or post-alteration color map that may provide color information for teeth in one or more frame), pre-treatment and/or post-treatment (or post-alteration) contours and/or normals, and/or one or more mouth area masks, such as an inner mouth area mask and/or an inverted inner mouth area mask (e.g., a mask that shows the space between upper and lower teeth in the inner mouth area). In one embodiment, one or more prior modified frames are further input into the generative model. Previously generated images or frames may be input into the generative model recursively. This enables the generative model to base its output on the previously generated frame/image and create a consistent stream of frames. In one embodiment, instead of recursively feeding the previously generated frame for generation of a current modified frame, the underlying features that were used to generate the previously generated frame may instead be input into the generative model for the generation of the current modified frame. In one embodiment, the generative model may generate the modified frame in a higher resolution, and the modified frame may then be downscaled to remove higher frequencies and associated artifacts.

In one embodiment, an optical flow is determined between the current frame and one or more previous frames, and the optical flow is input into the generative model. In one embodiment, the optical flow is an optical flow in a feature space. For example, one or more layers of a machine learning model (e.g., a generative model or a separate flow model) may generate features of a current frame (e.g., of a mouth area of the current frame) and one or more previous frames (e.g., a mouth area of one or more previous frames), and may determine an optical flow between the features of the current frame and the features of the one or more previous frames. In one embodiment a machine learning model is trained to receive current and previously generated labels (for current and previous frames) as well as a previously generated frame and to compute an optical flow between the current post-treatment contours and the previous generated frame. The optical flow may be computed in the feature space in embodiments.

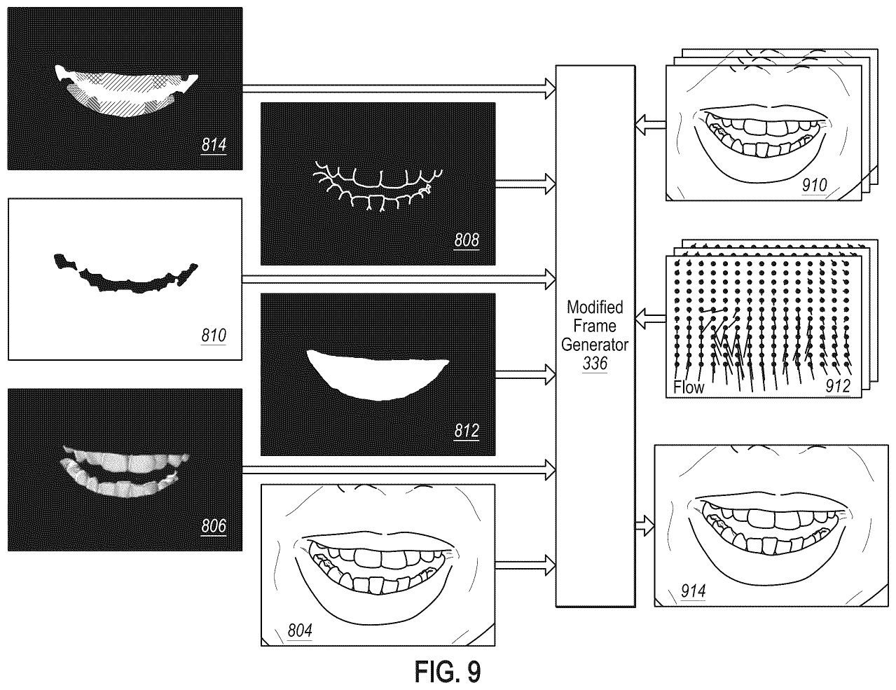

FIG. 9 illustrates generation of a modified image or frame 914 of a face using a trained machine learning model (e.g., modified frame generator 336 of FIG. 3A), in accordance with an embodiment of the present disclosure. In at least one embodiment, modified frame generator 336 receives multiple inputs. The inputs may include, for example, one or more of a color map 806 that provides separate color information for each tooth in the inner mouth area of a frame, post-treatment contours 808 (or post-alteration contours) that provides geometric information of the post-treatment teeth (or post-alteration teeth), an inner mouth area mask 812 that provides the area of image generation, an inner mouth mask 810 (optionally inverted) that together with a background of the frame provides information on a non-teeth area, a normals map 614 that provides additional information on tooth geometry that helps with specular highlights, pre-treatment (original) and/or post-treatment or post-alteration (modified) versions of one or more previous frames 910, and/or optical flow information 912 that shows optical flow between the post-treatment or post-alteration contours 808 of the current frame and the one or more modified previous frames 910. In at least one embodiment, the modified frame generator 336 performs a warp in the feature space based on the received optical flow (which may also be in the feature space). The modified frame generator 336 may generate modified frames with post-treatment or post-alteration teeth in a manner that reduces flow loss (e.g., perceptual correctness loss in feature space) and/or affine regularization loss for optical flow.

In at least one embodiment, the generative model of modified frame generator 336 is or includes an auto encoder. In at least one embodiment, the generative model of the modified frame generator 336 is or includes a GAN. The GAN may be, for example, a vid2vid GAN, a modified pix2pix GAN, a few-shot-vid2vid GAN, or other type of GAN. In at least one embodiment, the GAN uses the received optical flow information in addition to the other received information to iteratively determine loss and optimization over all generated frames in a sequence.

Returning to FIG. 3A, modified frame generator 336 outputs modified frames 340, which are modified versions of each of the frames of video 235. The above described operations of the video generation workflow or pipeline 305 may be performed separately for each frame. Once all modified frames are generated, each showing the post-treatment or other estimated future or altered condition of the individual's teeth or dentition, a modified video may ultimately be produced. In embodiments where the above described operations are performed in real time, in near-real time or on-the-fly during video capture and/or video streaming, modified frames 340 of the video 235 may be output, rendered and displayed one at a time before further frames of the video 235 have been received and/or during capture or receipt of one or more further frames.

In at least one embodiment, modified frames show post-treatment versions of teeth of an individual. In other embodiments, modified frames show other estimated future conditions of dentition. Such other estimated future conditions may include, for example, a future condition that is expected if no treatment is performed, or if a patient doesn't start brushing his or her teeth, or how teeth might move without orthodontic treatment, or if a patient smokes or drinks coffee. In other embodiments, modified frames show other selected alterations, such as alterations that remove teeth, replace teeth with fantastical teeth, add one or more dental conditions to teeth, and so on.

Modified videos may be displayed to an end user (e.g., a doctor, patient, end user, etc.) in embodiments. In at least one embodiment, video generation is interactive. Processing logic may receive one or more inputs (e.g., from an end user) to select changes to a target future condition of a subject's teeth. Examples of such changes include adjusting a target tooth whiteness, adjusting a target position and/or orientation of one or more teeth, selecting alternative restorative treatment (e.g., selecting a composite vs. a metal filling), removing one or more teeth, changing a shape of one or more teeth, replacing one or more teeth, adding restorations for one or more teeth, and so on. Based on such input, a treatment plan and/or 3D model(s) of an individual's dental arch(es) may be updated and/or one or more operations of the sequence of operations may be rerun using the updated information. In one example, to increase or decrease a whiteness of teeth, one or more settings or parameters of modified frame generator 336 may be updated. In one example, to change a position, size and/or shape of one or more post-treatment or post-alteration teeth, one or more updated post-treatment or post-alteration 3D models may be generated and input into modified frame generator 336.

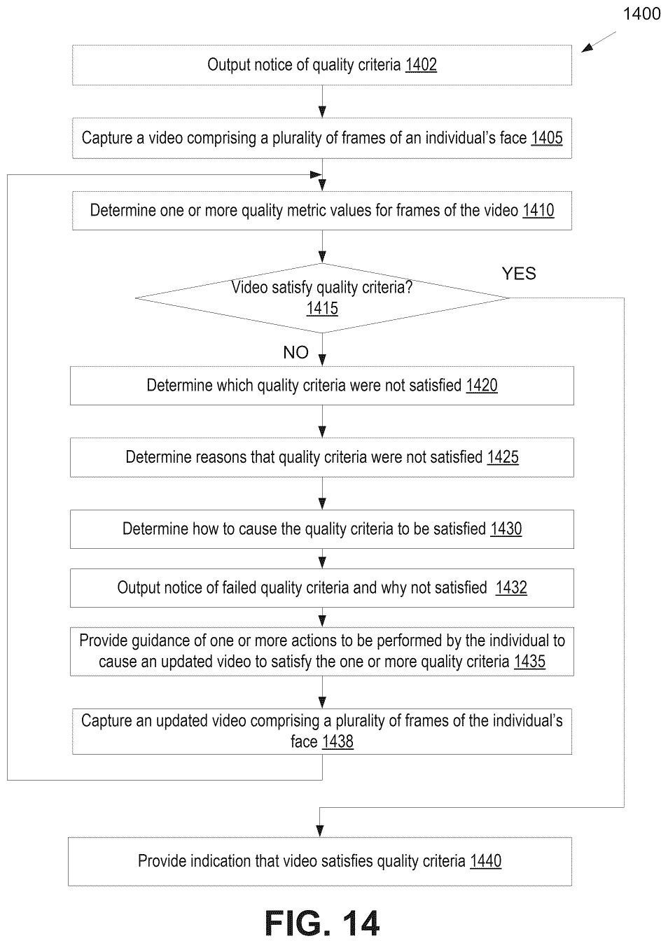

In at least one embodiment, modified frames 340 are analyzed by frame assessor 342 to determine one or more quality metric values of each of the modified frames 340. Frame assessor 342 may include one or more trained machine learning models and/or image processing algorithms to determine lighting conditions, determine blur, detect a face and/or head and determine face/head position and/or orientation, determine head movement speed, identify teeth and determine a visible teeth area, and/or determines other quality metric values. The quality metric values are discussed in greater detail below with reference to FIGS. 14-17. Processing logic may compare each of the computed quality metric values of the modified frame to one or more quality criteria. For example, a head position may be compared to a set of rules for head position that indicate acceptable and unacceptable head positions. If a determination is made that one or more quality metric criteria are not satisfied, and/or that a threshold number of quality criteria are not satisfied, and/or that one or more determined quality metric values deviate from acceptable quality metric thresholds by more than a threshold amount, frame assessor 342 may trim a modified video by removing such frame or frames that failed to satisfy the quality metric criteria. In one embodiment, frame assessor 342 determines a combined quality metric score for a moving window of modified frames. If a sequence of modified frames in the moving window fails to satisfy the quality metric criteria, then the sequence of modified frames may be cut from the modified video. Once one or more frames of low quality are removed from the modified video, a trimmed video 344 is output.

In at least one embodiment, removed frames of a modified video may be replaced using a generative model that generates interpolated frames between remaining frames that were not removed (e.g., between a first frame that is before a removed frame or frames and a second frame that is after the removed frame or frames). Frame interpolation may be performed using a learned hybrid data driven approach that estimates movement between images to output images that can be combined to form a visually smooth animation even for irregular input data. The frame interpolation may also be performed in a manner that can handle disocclusion, which is common for open bite images. The frame generator may generate additional synthetic images or frames that are essentially interpolated images that show what the dentition likely looked like between the remaining frames. The synthetic frames are generated in a manner that they are aligned with the remaining modified frames in color and space.

In at least one embodiment, frame generation can include generating (e.g., interpolating) simulated frames that show teeth, gums, etc. as they might look between those teeth, gums, etc. in frames at hand. Such frames may be photo-realistic images. In at least one embodiment, a generative model such as a generative adversarial network (GAN), encoder/decoder model, diffusion model, variational autoencoder (VAE), neural radiance field (NeRF), etc. is used to generate intermediate simulated frames. In one embodiment, a generative model is used that determines features of two input frames in a feature space, determines an optical flow between the features of the two frames in the feature space, and then uses the optical flow and one or both of the frames to generate a simulated frame. In one embodiment, a trained machine learning model that determines frame interpolation for large motion is used, such as is described in Fitsum Reda at al., FILM: Frame Interpolation for Large Motion, Proceedings of the European Conference On Computer Vision (ECC) (2022), which is incorporated by reference herein in its entirety.

In at least one embodiment, the frame generator is or includes a generative model trained to perform frame interpolation-synthesizing intermediate images between a pair of input frames or images. The generative model may receive a pair of input frames, and generate an intermediate frame that can be placed in a video between the pair of frames. In one embodiment, the generative model has three main stages, including a shared feature extraction stage, a scale-agnostic motion estimation stage, and a fusion stage that outputs a resulting color image. The motion estimation stage in embodiments is capable of handling a time-wise non-regular input data stream. Feature extraction may include determining a set of features of each of the input images in a feature space, and the scale-agnostic motion estimation may include determining an optical flow between the features of the two images in the feature space. The optical flow and data from one or both of the images may then be used to generate the intermediate image in the fusion stage. The generative model may be capable of stable tracking of features without artifacts for large motion. The generative model may handle disocclusions in embodiments. Additionally the generative model may provide improved image sharpness as compared to traditional techniques for image interpolation. In at least one embodiment, the generative model generates simulated images recursively. The number of recursions may not be fixed, and may instead be based on metrics computed from the images.

In at least one embodiment, the model generator may generate interpolated frames recursively. For example, a sequence of 10 frames may be removed from the modified video. In a first pass, frame generator 346 may generate a first interpolated frame between a first modified frame that immediately preceded the earliest frame in the sequence of removed frames and a second modified frame that immediately followed the latest frame in the sequence of removed frames. Once the first interpolated frame is generated, a second interpolated frame may be generated by using the first frame and the first interpolated frame as inputs to the generative model. Subsequently, a third interpolated frame may be generated between the first frame and the second interpolated frame, and a fourth interpolated frame may be generated between the second interpolated frame and the first interpolated frame, and so on. This may be performed until all of the removed frames have been replaced in embodiments, resulting in a final video 350 that has a high quality (e.g., for which frames satisfy the image quality criteria).

The modified video 340 or final video 350 may be displayed to a patient, who may then make an informed decision on whether or not to undergo treatment.

Many logics of video processing workflow or pipeline 305 such as mouth area detector 314, landmark detector 310, segmenter 318, feature extractor 330, frame generator 346, frame assessor 342, modified frame generator 336, and so on may include one or more trained machine learning models, such as one or more trained neural networks. Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset. In high-dimensional settings, such as large images, this generalization is achieved when a sufficiently large and diverse training dataset is made available.

For model training, a training dataset containing hundreds, thousands, tens of thousands, hundreds of thousands or more videos and/or images should be used to form a training dataset. In at least one embodiment, videos of up to millions of cases of patient dentition may be available for forming a training dataset, where each case may include various labels of one or more types of useful information. This data may be processed to generate one or multiple training datasets for training of one or more machine learning models. The machine learning models may be trained, for example, to perform landmark detection, perform segmentation, perform interpolation of images, generate modified versions of frames that show post-treatment dentition, and so on. Such trained machine learning models can be added to video processing workflow 305 once trained.

In one embodiment, generating one or more training datasets includes gathering one or more images with labels. The labels that are used may depend on what a particular machine learning model will be trained to do. For example, to train a machine learning model to perform classification of dental sites (e.g., for segmenter 318), a training dataset may include pixel-level labels of various types of dental sites, such as teeth, gingiva, and so on.

Processing logic may gather a training dataset comprising images having one or more associated labels. One or more images, scans, surfaces, and/or models and optionally associated probability maps in the training dataset may be resized in embodiments. For example, a machine learning model may be usable for images having certain pixel size ranges, and one or more image may be resized if they fall outside of those pixel size ranges. The images may be resized, for example, using methods such as nearest-neighbor interpolation or box sampling. The training dataset may additionally or alternatively be augmented. Training of large-scale neural networks generally uses tens of thousands of images, which are not easy to acquire in many real-world applications. Data augmentation can be used to artificially increase the effective sample size. Common techniques include random rotation, shifts, shear, flips and so on to existing images to increase the sample size.

To effectuate training, processing logic inputs the training dataset(s) into one or more untrained machine learning models. Prior to inputting a first input into a machine learning model, the machine learning model may be initialized. Processing logic trains the untrained machine learning model(s) based on the training dataset(s) to generate one or more trained machine learning models that perform various operations as set forth above.

Training may be performed by inputting one or more of the images or frames into the machine learning model one at a time. Each input may include data from an image from the training dataset. The machine learning model processes the input to generate an output. An artificial neural network includes an input layer that consists of values in a data point (e.g., intensity values and/or height values of pixels in a height map). The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer may be another hidden layer or an output layer. In either case, the nodes at the next layer receive the output values from the nodes at the previous layer, and each node applies weights to those values and then generates its own output value. This may be performed at each layer. A final layer is the output layer, where there is one node for each class, prediction and/or output that the machine learning model can produce. For example, for an artificial neural network being trained to perform dental site classification, there may be a first class (tooth), a second class (gums), and/or one or more additional dental classes. Moreover, the class, prediction, etc. may be determined for each pixel in the image or 3D surface, may be determined for an entire image or 3D surface, or may be determined for each region or group of pixels of the image or 3D surface. For pixel level segmentation, for each pixel in the image, the final layer applies a probability that the pixel of the image belongs to the first class, a probability that the pixel belongs to the second class, and/or one or more additional probabilities that the pixel belongs to other classes.

Accordingly, the output may include one or more prediction and/or one or more a probability map. For example, an output probability map may comprise, for each pixel in an input image/scan/surface, a first probability that the pixel belongs to a first dental class, a second probability that the pixel belongs to a second dental class, and so on. For example, the probability map may include probabilities of pixels belonging to dental classes representing a tooth, gingiva, or a restorative object.

Processing logic may then compare the generated probability map and/or other output to the known probability map and/or label that was included in the training data item. Processing logic determines an error (i.e., a classification error) based on the differences between the output probability map or prediction and/or label(s) and the provided probability map and/or label(s). Processing logic adjusts weights of one or more nodes in the machine learning model based on the error. An error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

Once the model parameters have been optimized, model validation may be performed to determine whether the model has improved and to determine a current accuracy of the deep learning model. After one or more rounds of training, processing logic may determine whether a stopping criterion has been met. A stopping criterion may be a target level of accuracy, a target number of processed images from the training dataset, a target amount of change to parameters over one or more previous data points, a combination thereof and/or other criteria. In one embodiment, the stopping criteria is met when at least a minimum number of data points have been processed and at least a threshold accuracy is achieved. The threshold accuracy may be, for example, 70%, 80% or 90% accuracy. In one embodiment, the stopping criteria is met if accuracy of the machine learning model has stopped improving. If the stopping criterion has not been met, further training is performed. If the stopping criterion has been met, training may be complete. Once the machine learning model is trained, a reserved portion of the training dataset may be used to test the model.

In one embodiment, one or more training optimizations are performed to train a machine learning model to perform landmarking (e.g., to train landmark detector 310). In one embodiment, to improve landmark stability between frames of a video, smoothing of landmarks is performed during training. Similar smoothing may then be performed at inference, as discussed above. In one embedment, smoothing is performed using Gaussian smoothing (as discussed above). In one embodiment, smoothing is performed using an optical flow between frames. In one embodiment, landmark stability is improved at training time by, instead of only using labels for fully supervised training, also including image features as unsupervised loss. In one embodiment, landmark stability is improved by smoothing face detection. In one embodiment, a trained model may ignore stability of landmark detection, but may make sure that face boxes are temporally smooth by smoothing at test time and/or by applying temporal constraints at training time.

Labelling mouth crops for full video for segmentation is computationally expensive. One way to generate a dataset for video segmentation is to annotate only every nth frame in the video. Then, a GAN may be trained based on a video prediction model, which predicts future frames based on past frames by computing motion vectors for every pixel. Such a motion vector can be used to also propagate labels from labelled frames to unlabeled frames in the video.

Segmentation models typically have a fixed image size that they operate on. In general, training should be done using a highest resolution possible. Nevertheless, as training data is limited, videos at test time might have higher resolutions than those that were used at training time. In these cases, the segmentation has to be upscaled. This upscale interpolation can take the probability distributions into account to create a finer upscaled segmentation than using nearest neighbor interpolation.

Traditionally, models are trained in a supervised manner with image labels. However, unlabelled frames in videos can also be used to fine tune a model with temporal consistency loss. The loss may ensure that for pair of a labelled frame Vᵢ and an unlabelled frame Vᵢ₊₁, the prediction for Vᵢ₊₁ is consistent with the optical flow warped label of Vᵢ.

In a test set, a video can have a large variation in terms of lighting, subject's skin color, mouth expression, number of teeth, teeth color, missing teeth, beard, lipsticks on lips, etc. Such variation might not be fully captured by limited labelled training data. To improve the generalization capabilities of a segmentation model, a semi-supervised approach (instead of fully-supervised) may be used, where along with the labelled data, a large amount of unlabelled mouth crops can be used. Methods like cross consistency training, cross pseudo supervision, self-training etc., can be performed.

FIG. 10A illustrates a workflow 1000 for training of a machine learning model to perform segmentation, in accordance with an embodiment of the present disclosure. In one embodiment, images of faces with labeled segmentation 1005 are gathered into a training dataset 1010. These labeled images may include labels for each separate tooth, an upper gingiva, a lower gingiva, and so on in the images. At block 1015, one or more machine learning models are trained to perform segmentation of still images.

Once the machine learning model(s) are trained for still images, further training may be performed on videos of faces. However, it would require vast resources for persons to manually label every frame of even a small number of videos, much less to label each frame of thousands, tens of thousands, hundreds of thousands, or millions of videos of faces. Accordingly, in one embodiment, unlabeled videos are processed by the trained ML model that was trained to perform segmentation on individual images. For each video, the ML model 1020 processes the video and outputs a segmented version of the video. A segmentation assessor 1030 then assesses the confidence and/or quality of the performed segmentation. Segmentation assessor 1035 may run one or more heuristics to identify difficult frames that resulted in poor or low confidence segmentation. For example, a trained ML model 1020 may output a confidence level for each segmentation result. If the confidence level is below a threshold, then the frame that was segmented may be marked. In one embodiment, segmentation assessor 1035 outputs quality scores 1040 for each of the segmented videos.

At block 1045, those frames with low confidence or low quality segmentation are marked. The marked frames that have low quality scores may then be manually labeled. Video with the labeled frames may then be used for further training of the ML model(s) 1020, improving the ability of the ML model to perform segmentation of videos. Such a fine-tuned model can then provide an accurate segmentation mask for video which is used in training data.

In order to train modified frame generator, a large training set of videos should be prepared. Each of the videos may be a short video cut or clip that meets certain quality criteria. Manual selection of such videos would be inordinately time consuming and would be very expensive. Accordingly, in embodiments one or more automatic heuristics are used to assess videos and select snippets from those videos that meet certain quality criteria.

FIG. 10B illustrates training of a machine learning model to perform generation of modified images of faces, in accordance with an embodiment of the present disclosure. In one embodiment, unlabeled videos 1052 are assessed by video selector 1054, which processes the videos using one or more heuristics. Examples of such heuristics include heuristics for analyzing resolution, an open mouth condition, a face orientation, blurriness, variability between videos, and so on. The videos 1052 may be inherently temporally accurate in most instances.

A first heuristic may assess video frames for resolution, and may determine a size of a mouth in frames of the video in terms of pixels based on landmarks. For example, landmarking may be performed on each frame, and from the landmarks a mouth area may be identified. A number of pixels in the mouth area may be counted. Frames of videos that have a number of pixels in the mouth area that are below a threshold may not be selected by video selector.

A second heuristic may assess frames of a video for an open mouth condition. Landmarking may be performed on the frames, and the landmarks may be used to determine locations of upper and lower lips. A delta may then be calculated between the upper and lower lips to determine how open the mouth is. Frames of videos that have a mouth openness of less than a threshold may not be selected.

A third heuristic may assess frames of a video for face orientation. Landmarking may be performed on the frames, and from the landmarks a face orientation may be computed. Frames of videos with faces that have an orientation that is outside of a face orientation range may not be selected.

A fourth heuristic may assess frames for blurriness and/or lighting conditions. A blurriness of a frame may be detected using standard blur detection techniques. Additionally, or alternatively, a lighting condition may be determined using standard lighting condition detection techniques. If the blurriness is greater than a threshold and/or the amount of light is below a threshold, then the frames may not be selected.

If a threshold number of consecutive frames pass each of the frame quality criteria (e.g., pass each of the heuristics), then a snippet containing those frames may be selected from a video. The heuristics may be low computation and/or very fast performing heuristics, enabling the selection process to be performed quickly on a large number of videos.

Video snippets 1056 may additionally or alternatively be selected for face tracking consistency (e.g., no jumps in image space), for face recognition (e.g., does the current frame depict the same person as previous frames), frame to frame variation (e.g., did the image change too much between frames), optical flow map (e.g., are there any big jumps between frames), and so on.

Video snippets 1056 that have been selected may be input into a feature extractor 1058, which may perform feature extraction on the frames of the video snippets and output features 1060 (e.g., which may include color maps).

The video snippets 1056 may also be input into landmark detector 1062, which performs landmarking on the frames of the video snippets 1056 and outputs landmarks 1064. The landmarks (e.g., facial landmarks) and/or frames of a video snippet 1056 may be input into mouth area detector 1066, which determines a mouth area in the frames. Mouth area detector 1066 may additionally crop the frames around the detected mouth area, and output cropped frames 1068. The cropped frames 1068 may be input into segmenter 1070, which may perform segmentation of the cropped frames and output segmentation information, which includes segmented mouth areas 1072. The segmented mouth areas, cropped frames, features, etc. are input into generator model 1074. Generator model 1074 generates a modified frame based on input information, and outputs the modified frame 1076. Each of the feature extractor 1058, landmark detector 1062, mouth area detector 1066, segmenter 1070, etc. may perform the same operations as the similarly named component of FIG. 3A. The generator model 1074 may receive an input that may be the same as any of the inputs described as being input into the modified frame generator 336 of FIG. 3A.

Generator model 1074 and discriminator model 1077 may be models of a GAN. Discriminator model 107 may process the modified frames 1076 of a video snippet and make a decision as to whether the modified frames were real (e.g., original frames) or fake (e.g., modified frames). The decision may be compared to a ground truth that indicates whether the image was a real or fake image. In one embodiment, the ground truth for a frame k may be the k+1 frame. The discriminator model in embodiments may learn motion vectors that transform a kth frame to a k+1th frame. For videos in which there are labels for a few frames, a video GAN model may be run to predict motion vectors and propagate labels for neighboring unlabeled frames. The results of the discriminator model's 1077 output may then be used to update a training of both the discriminator model 1077 (to train it to better identify real and fake frames and videos) and generator model 1074 (to train it to better generate modified frames and/or videos that cannot be distinguished from original frames and/or videos).

FIG. 10C illustrates a training workflow 1079 for training of a machine learning model (e.g., generator model 1074) to perform generation of modified images of faces, in accordance with an embodiment of the present disclosure. In one embodiment, data for a current frame 1080 is input into a generator model 1074. Additionally, one or more previously generated frames 1082 and the data for the current frame 1080 is input into a flow determiner 1084, which outputs an optical flow to generator model 1074. The optical flow may be in an image space and/or in a feature space. The generator model 1074 processes the data for the current frame and the optical flow to output a current generated frame 1086.

A discriminator model 1077 may receive the current generator frame 1086 and/or the one or more previously generator frames 1082, and may make a determination based on the received current and/or past generated frames as to whether the frame or sequence of frames is real or fake. Discriminator model 1078 may then output the decision 1078 of whether the frame or sequence of frames was real or fake. The generator model 1074 and discriminator model 1078 may then be trained based on whether the decision of the discriminator model was correct or not.

FIG. 10D illustrates a training workflow 1088 for training of a machine learning model to perform discrimination of modified images of faces, in accordance with an embodiment of the present disclosure. In one embodiment, the training workflow 1088 begins with training an image discriminator 1090 on individual frames (e.g., modified frame 1089). After being trained, the image discriminator 1090 may accurately discern whether a single input frame is real or fake and output a real/fake image decision 1091. A corresponding generator may be trained in parallel to the image discriminator 1090.

After the image discriminator 1090 is trained on individual frames, an instance of the image discriminator may be retrained using pairs of frames (e.g., 2 modified frames 1092) to produce aa video discriminator 1093 that can make decisions (e.g., real/fake decision 1094) as to whether pairs of frames are real or fake. A corresponding generator may be trained in parallel to the video discriminator 1093.

After the video discriminator 1093 is trained on pairs of frames, the video discriminator may be retrained using sets of three frames (e.g., 3 modified frames 1095). The video discriminator 1093 is thereby converted into a video discriminator that can make decisions (e.g., real/fake decision 1096) as to whether sets of three frames are real or fake. A corresponding generator may be retrained in parallel to the video discriminator 1093.

This process may be repeated up through sets of n frames. After a final training sequence, video discriminator 1093 may be trained to determine whether sequences of n modified frames 1097 are real or fake and to output real/fake decision 1098. A corresponding generator may be retrained in parallel to the video discriminator 1093. With each iteration, the generator becomes better able to generate modified video frames that are temporally consistent with other modified video frames in a video.

In at least one embodiment, separate discriminators are trained for images, pairs of frames, sets of three frames, sets of four frames, and/or sets of larger numbers of frames. Some or all of these discriminators may be used in parallel during training of a generator in embodiments.

FIG. 10E is a diagram depicting data flow 1051 for generation of an image of a dental patient, according to some embodiments. Video input 1055 is provided for frame extraction 1057. Once frames are extracted from the video input 1055, frames are provided to an analyze frames operation 1059. Upon analysis, frame selection 1061 is performed to output dental image 1063.

Frame analysis 1059 may include a sequence of operations in embodiments, including feature detection 1065, feature analysis 1067, component scoring 1069, component composition 1071, and scoring function evaluation 1073. In embodiments, frame analysis 1059 is performed on an input frame at a time, and is performed in view of one or more input selection requirements 1053.

Frame analysis 1059 includes feature detection 1065. Feature detection 1065 may include use of a machine learning model. Feature detection 1065 may detect key points of a face. Feature detection 1065 may detect eyes, teeth, head, etc. In embodiments, feature detection 1065 includes image segmentation, such as semantic segmentation and/or instance segmentation. Once features are identified in a frame, feature analysis 1067 may be performed.

Feature analysis 1067 may include analyzing detected features based on selection requirements 1053. Feature analysis 1067 may include determining characteristics that may be relevant for frame generation or selection, such as gaze direction, eye opening, visible tooth area, bite opening, etc.

Component scoring 1069 may be performed to provide scores based on selection requirements. Component scoring may include providing weighting factors or providing output of feature analysis to one or more models or functions for performing scoring, including trained machine learning models. For example, component scoring 1069 may select from different models or provide contextual data configuring the operation of the models based on selection requirements, various weights or importance of different selection requirements or target attributes, or the like.

Component composition 1071 may include composing components based on selection requirements to build an evaluation function.

Scoring function evaluation 1073 may provide scoring of each of the frames provided.

Once frame analysis 1059 has been performed on multiple frames (e.g., all frames of an input video 302, frame selection 1061 may be performed. Frame selection 1061 may be performed based on the scoring data of the frames.

Finally, a dental image 1063 is output. The selected dental image 1063 may be a frame having a highest score in embodiments, and may be a frame selected at frame selection 1061. The dental image may be used for predicting results of a dental treatment, for selecting between various treatments based on predicted results, for building a model of dentition for use in treatment, or the like.

Video input 1055 may include video data captured by a client device, e.g., client device 120 of FIG. 1A. In some embodiments, video data may be captured by a dental patient, e.g., for generation of an image for submission to a system for predicting outcomes of a dental treatment. In some embodiments, video data may be captured by a treatment provider, e.g., for generation of an image for submission to a system for assisting in designing a treatment plan for the dental patient. Video data may include frames exhibiting different combinations of attributes, including eye opening, mouth opening, tooth visibility, head angle, gaze direction, expression, image quality, etc.

In some embodiments, collection of video input 1055 may be prompted and/or guided by components of an image generation system. For example, a user may be prompted to take a video of a dental patient, to obtain one or more target images for use in further operations related to dental and/or orthodontic treatment. A user may be prompted to take a video including one or more sets of attributes, e.g., the user may be prompted to ensure that the video includes a social smile, a profile including one or more teeth, an open mouth including one or more teeth of interest, or the like. A user may be prompted during video capture. For example, a set of attributes included in a video may be tracked (e.g., by providing frames of the video to one or more machine learning models during video capture operations), and attributes, sets of attributes, or the like of interest that have not yet been captured may be indicated to a user, to instruct the dental patient or to enable the user to instruct the dental patient to pose in a target way, expose target teeth, or the like such that one or more target images (e.g., images including a target set of attributes related to selection requirements) are included or can be generated with a target level of confidence from the video captured of the dental patient.

Frame extraction 1057 may include separating frames of the video data for frame-by-frame analysis. Frame extraction 1057 may include generating frame data (e.g., numbering frames), labeling frame images with frame data, or the like. One or more frames from the video data may be provided for frame analysis 1059. In some embodiments, frame extraction 1057 may include some pre-analysis for determining whether to provide one or more frames for further analysis. For example, image quality such as sharpness, contrast, brightness, or the like may be determined during frame extraction 1057, and only frames satisfying one or more threshold conditions of image quality may be provided for frame analysis 1059.

Frame analysis 1059 includes operations for determining relevance of frames from the video input for one or more target image processing operations, for satisfying one or more sets of selection requirements, or the like. Frame analysis 1059 may be based on selection requirements 1053. Selection requirements 1053 may include sets of requirements related to one of a library of pre-set target image types. Selection requirements 1053 may include and/or be associated with one or more scoring functions, e.g., functions for determining a total score for a frame in relation to a target image type, target set of selection conditions, or the like. Selection requirements 1053 may include a system for rating a frame or image for compliance with target attributes, e.g., a function including indications of whether target conditions are satisfied, how thoroughly the conditions are satisfied, weighting factors related to how important various attributes are, etc. As an example of differently weighted target attributes, gaze direction may be a target selection requirement to ensure a natural looking image for some applications, but gaze direction may be less important than other target attributes of the image, such as selection requirements related to the mouth or teeth or other features that have a larger effect on predictive power of the image.

Selection requirements may include selections of various attributes for a target image. Selection requirements may be input by a user with respect to a particular set of input data, particular process or prediction, particular treatment or disorder, or the like. Selection requirements may include various attributes of interest in an image that is to be used for making predictions or use in other purposes in connection with a dental treatment. In some embodiments, pre-set selection requirements may be selected from, such as a set of selection requirements related to a particular treatment, disorder, target use of an image, or the like. For example, a platform for performing predictions or other operations based on video input 1055 may provide a method for a user to select a target outcome (e.g., predictive image of a smile after orthodontic treatment, predictive model of teeth after treatment of a general or particular class of malocclusion or misalignment, or the like). Selection of the target outcome may cause the platform to operate with a set of selection requirements that has been pre-determined (e.g., by the user, by the platform creator, etc.) to be applicable to the target outcome. In some embodiments, selection requirements may be input or adjusted by a user (e.g., dental treatment provider).

In some embodiments, other input methods may be used to obtain the selection requirements. For example, a practitioner may indicate via text or speech some set of target attributes of an image to be extracted from video input 1055. One or more models (e.g., artificial intelligence models, trained machine learning models, statistical or other models) may generate formal (e.g., machine-readable) selection requirements based on the natural language input. In some embodiments, selection requirements 1053 may include or be related to a reference image, with a model trained to generate selection criteria, scoring functions, or the like to extract or generate an image from video input 1055 with similar features (e.g., gaze direction, head angle, tooth visibility, facial expression, etc.) to the reference image.

Data stored as selection requirements 1053 may include one or more models (e.g., trained machine learning models) that encode selection requirements, e.g., models configured to select frames, generate images, or classify frames or images based on sets of features or attributes, target types of images, or the like. Selection requirements 1053 may include head orientation/rotation, tooth visibility, expression/emotion, gaze direction, image quality (e.g., blurriness, background objects, foreground objects, lighting conditions, saturation, occlusions, etc.), bite position, and/or other metrics of interest. Selection requirements 1053 may include a linear model of function (e.g., linear combination of factors indicating selection requirement compliance and weight), non-linear models or functions (e.g., functions including quadratic terms, cross terms, or other types of functions), may be custom-built, may be generated based on training data, etc. In some embodiments, selection requirements 1053 may be determined based on a model image (e.g., video input data may be analyzed for similar attributes to the model image). In some embodiments, selection requirements 1053 may be based on output of an LLM model, e.g., a natural language request or prompt to an LLM may be translated to selection requirements.

Frame analysis 1059 includes a number of operations for determining whether one or more frames satisfy selection requirements 1053. Frame analysis 1059 includes feature detection 1065. Feature detection may include face key point determination, labelling, etc., e.g., via a face key point detector model. Various algorithms, models (e.g., trained machine learning models), or other analytic methods may be used to for feature detection 1065. Facial features may be detected (e.g., eyes, teeth, brow, head, etc.) based on feature detection 1065. In some embodiments, dental features may be detected (e.g., an identifier of an individual tooth may be applied based on visibility of that tooth).

Feature analysis 1067 may include performing one or more operations based on features extracted from one or more frames in feature detection 1065. Feature analysis may include algorithmic methods, machine learning model methods, rule-based methods, etc. Feature analysis 1067 may include any methods of preparing features of an image (e.g., frame) for scoring in view of selection requirements 1053. Feature analysis 1067 may include assigning values or categories to one or more features that are or may be of interest. Feature analysis 1067 may include determining a numerical head rotation value, a numerical tooth visibility metric (e.g., including tooth identification, tooth segmentation, etc.), bite opening, facial expression, gaze direction, etc. Feature analysis 1067 may include a standard set of feature classifications and analytics (e.g., a set of feature numerical attributes are calculated for each image). Feature analysis 1067 may include a custom set of feature analytics based on selection requirements 1053 (e.g., only factors of relevance to a target outcome may be included). Feature analysis 1067 may include geometric analysis techniques, e.g., feature detection 1065 may provide as output an indication of locations of certain facial structures, and feature analysis 1067 may calculate a head angle based on the locations of the facial structures.

Component scoring 1069 includes providing scoring for one or more attributes of interest in view of feature analysis 1067. For example, a score may be provided related to head angle indicating a closeness of an extracted head angle from an image to a target or ideal head angle for a particular image extraction. Scoring may indicate assigning a numerical value to one or more attributes based, for example, on feature analysis, desirability of the attribute, etc. Numerical scores generated in component scoring 1069 may be in relation to numerical analysis of feature analysis 1067, e.g., related to a difference between a target value included in selection requirements 1053 and a measured or predicted value generated in feature analysis 1067. Functions that generate scores based on features may be linear, exponential, relative (e.g., related to a percent difference between a target and actual feature measurement), machine learning based, or the like. Functions may be step functions, e.g., within a threshold of a target value may return a first score (e.g., a 1), and outside that threshold may return a second score (e.g., a 0). Other functions, including piecewise functions, polynomial functions, hand-tuned functions, or the like may be used to generate scores for components of an image. Example components may include eye openness (e.g., based on left and right eyes opening), gaze direction, inner mouth area, total teeth area, upper/lower teeth area, head yaw, pitch, or roll, jaw articulation, etc. Scores may be generated for any of these by comparing the attributes determined from the video input 1055 to target attributes included in selection requirements 1053.

Component composition 1071 includes generating or utilizing a function or model for collecting component scores to indicate suitability of an image for one or more target applications, e.g., target collections of attributes, target image types, or the like. Component composition 1071 may include generating or utilizing a linear function, a more complex (e.g., hand-tuned) function, a learned function based on training data (e.g., machine learning-based), etc. In some embodiments, component composition 1071 may be considered to be a method of collection scores of individual components of interest (with respect to particular selection requirements) and determining how well those individual components contribute to various sets of target image features. In some embodiments, component scoring and component composition are performed by one or more trained ML models. In some embodiments, each different target set of attributes or target type of image may include a different function. In some embodiments, a universal function may be utilized, e.g., a machine learning model may include one or more inputs indicating a target image type or target image attributes, and the same model may be used to evaluate images for conformity with multiple different target image types. In some embodiments, component composition 1071 may determine which frames of video input 1055 are suitable for consideration for one or more sets of selection criteria (e.g., intended uses of the images).

A scoring function evaluation 1073 is then performed. Scoring function evaluation may include utilizing scoring functions to score a frame. Scoring function evaluation 1073 may include utilizing multiple scoring functions, e.g., one video input may be searched for multiple target image types or target image attributes, one frame may be evaluated for conformity with multiple sets of selection requirements, etc. Scoring function evaluation 1073 may include determining a suitability score that may be used to compare one frame to another, e.g., a scoring function of scoring function evaluation 1073 may be tuned differently from a scoring function of component composition 1071, in embodiments where component composition 1071 is directed toward determining whether or not various frames or images are suitable for target uses, and scoring function evaluation 1073 is utilized for distinguishing suitability amongst selected frames. In some embodiments, scoring function evaluation 1073 may be based on one or more of output from component composition 1071, score of individual components as determined in component scoring 1069, presence or absence of features as output by feature detection 1065 and/or feature analysis 1067, etc. In some embodiments, operations of component composition 1071 and scoring function evaluation 1073 may be combined, operations of feature analysis 1067 and component scoring 1069 may be combined, operations of component scoring 1069 and component composition 1071 may be combined, etc. Various permutations of these operations may be performed in embodiments of the present disclosure.

After frame analysis 1059, frame selection 1061 is performed. One or more frames may be selected from the video input data. In some embodiments, a number of frames may be selected for a user to select from. In some embodiments, frames may be selected in relation to multiple selection requirements, multiple target images, etc. Frame selection 1061 may include selection of multiple images with somewhat different scoring characteristics. For example, for a single selection requirement, frames that score highly during frame analysis 1059, but score highly for different reasons (e.g., frames that score highly on slightly different scoring functions, frames with fairly high total scoring function, with different combinations of values of component scoring, etc.), may be provided to a user for selection by the user for suitability for the intended use of the frames. In some embodiments, scoring characteristics to be applied may be selected by a user. In some embodiments, user selection may be used to update one or more machine learning models, e.g., as additional training data/retraining data. For example, user selection of one frame over another may be used as feedback to train one or more models of the system to produce similar results in the future. Output of frame selection 1061 may include one or more target dental images 1063. The output one or more dental images 1063 may be selected by a user from a number of options, or may be selected by the system.

Dental image 1063 may be utilized by a practitioner, patient, or system for further processing, analysis, prediction making, or the like. A practitioner may present a potential patient with an image indicative of a predicted social smile after orthodontic treatment. Further analysis tools (e.g., machine learning models) may be used based on the output image to generate predictions of various treatment stages, positions and orientations of various teeth throughout treatment, predicted dental appliance geometries and characteristics, predicted three-dimensional models of teeth, jaw pairs, or the like before, during, or after treatment, etc.

In some embodiments, frame selection 1061 may further include operations of generating an image. For example, no frame may be extracted that scores sufficiently high (e.g., scoring satisfies a threshold condition), no frame may be extracted exhibiting all target selection requirements, or the like. A GAN or other model may be utilized for generating an image of the dental patient that is not included in frames of the video input 1055. Generating the image may include combining pieces of various frames to generate an image including more target attributes than any individual frame (e.g., via inpainting), using infilling and/or machine learning to generate an image with target attributes, or the like. In some embodiments, one or more models may be utilized to generate a three-dimensional model of the dental patient, and one or more images may be extracted based on the three-dimensional model. In some embodiments, a user interface element may be generated allowing a user to adjust one or more attributes of an image of the dental patient. For example, various input methods may be provided for adjusting properties of an image, which may be used to generate an image meeting target selection criteria.

FIGS. 11A-E are flow diagrams of methods 1100A-E associated with generating images of dental patients, according to certain embodiments. Methods 1100A-E may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, methods 1100A-E may be performed, in part, by image generation system 110 of FIG. 1A. Method 1100A may be performed, in part, by image generation system 110 (e.g., server machine 170 and data set generator 172 of FIG. 1A). Image generation system 110 may use method 1100A to generate a data set to at least one of train, validate, or test a machine learning model, in accordance with embodiments of the disclosure. Methods 1100B-E may be performed by image generation server 112 (e.g., image generation component 114), client device 120, and/or server machine 180 (e.g., training, validating, and testing operations may be performed by server machine 180). In some embodiments, a non-transitory machine-readable storage medium stores instructions that when executed by a processing device (e.g., of image generation system 110, of server machine 180, of image generation server 112, etc.) cause the processing device to perform one or more of methods 1100A-E.

For simplicity of explanation, methods 1100A-E are depicted and described as a series of operations. However, operations in accordance with this disclosure can occur in various orders and/or concurrently and with other operations not presented and described herein. Furthermore, not all illustrated operations may be performed to implement methods 1100A-E in accordance with the disclosed subject matter. In addition, those skilled in the art will understand and appreciate that methods 1100A-E could alternatively be represented as a series of interrelated states via a state diagram or events.

FIG. 11A is a flow diagram of a method 1100A for generating a data set for a machine learning model, according to some embodiments. Referring to FIG. 11A, in some embodiments, at block 1101 the processing logic implementing method 1100A initializes a training set T to an empty set.

At block 1102, processing logic generates first data input (e.g., first training input, first validating input). The first data input may include data types related to an intended use of the machine learning model. The first data input may include a set of images that may be related to dental treatment operations, e.g., images of a dental patient. The first data input may include selection requirements, e.g., for training a model to process natural language requests for generating selection requirements. In some embodiments, the first data input may include a first set of features for types of data and a second data input may include a second set of features for types of data (e.g., as described with respect to FIG. 3B in segmented input data).

In some embodiments, at block 1103, processing logic optionally generates a first target output for one or more of the data inputs (e.g., first data input). In some embodiments, target output may represent an intended output space for the model. For example, a machine learning model configured to extract a video frame corresponding to target selection requirements may be provided with a set of images as training input and classification based on potential selection requirements as target output. In some embodiments, no target output is generated (e.g., an unsupervised machine learning model capable of grouping or finding correlations in input data, rather than requiring target output to be provided).

At block 1104, processing logic optionally generates mapping data that is indicative of an input/output mapping. The input/output mapping (or mapping data) may refer to the data input (e.g., one or more of the data inputs described herein), the target output for the data input, and an association between the data input(s) and the target output. In some embodiments, data segmentation may also be performed. In some embodiments, such as in association with machine learning models where no target output is provided, block 1104 may not be executed.

At block 1105, processing logic adds the mapping data generated at block 1104 to data set T, in some embodiments.

At block 1106, processing logic branches based on whether data set T is sufficient for at least one of training, validating, and/or testing a machine learning model, such as model 190 of FIG. 1A. If so, execution proceeds to block 1107, otherwise, execution continues back at block 1102. It should be noted that in some embodiments, the sufficiency of data set T may be determined based simply on the number of inputs, mapped in some embodiments to outputs, in the data set, while in some other embodiments, the sufficiency of data set T may be determined based on one or more other criteria (e.g., a measure of diversity of the data examples, accuracy, etc.) in addition to, or instead of, the number of inputs.

At block 1107, processing logic provides data set T (e.g., to server machine 180) to train, validate, and/or test machine learning model 190. In some embodiments, data set T is a training set and is provided to training engine 182 of server machine 180 to perform the training. In some embodiments, data set T is a validation set and is provided to validation engine 184 of server machine 180 to perform the validating. In some embodiments, data set T is a testing set and is provided to testing engine 186 of server machine 180 to perform the testing. In the case of a neural network, for example, input values of a given input/output mapping (e.g., numerical values associated with data inputs) are input to the neural network, and output values (e.g., numerical values associated with target outputs) of the input/output mapping are stored in the output nodes of the neural network. The connection weights in the neural network are then adjusted in accordance with a learning algorithm (e.g., back propagation, etc.), and the procedure is repeated for the other input/output mappings in data set T. After block 1107, a model (e.g., model 190) can be at least one of trained using training engine 182 of server machine 180, validated using validating engine 184 of server machine 180, or tested using testing engine 186 of server machine 180. The trained model may be implemented by image generation component 114 (of image generation server 112) to generate dental image data 146.

FIG. 11B is a flow diagram of a method 1100B for extracting a dental image, according to some embodiments. At block 1111, processing logic obtains first video data of a dental patient. The first video data includes a plurality of frames. The video data may include multiple poses, expressions, head angles, and other attributes. The video data may include multiple portions collected at different times (e.g., during the course of capturing a video). In some embodiments, frames of a later portion of a video capture may be captured based on prompts provided by a user device. For example, the user device may predict whether the captured frames have a set of target attributes (e.g., according to the process of FIG. 10E), and the user device may prompt a user to capture various additional attributes in association with selection criteria.

At block 1112, processing logic obtains an indication of first selection criteria in association with the video data. The first selection criteria may include one or more conditions related to a target dental treatment of the dental patient. The first selection criteria may be based on a reference image, e.g., generated by one or more machine learning models that extract attributes from a reference image. The first selection criteria may be based on output of a natural language processing model or large language model, e.g., related to a natural input request.

In some embodiments, indications of second selection criteria may be obtained by the processing logic. For example, multiple images may be targets for extraction from the video data, each image associated with different selection criteria. Further operations may be performed in association with both the first and second selection criteria. For example, analysis procedures of block 1114 may be performed in reference to both the first and second sets of selection criteria.

In some embodiments, selection criteria may include target values associated with one or more metrics describing features or attributes of an image of a dental patient. Selection criteria may include target metrics related to head orientation, visible tooth identities, visible tooth area, bite position, emotional expression, gaze direction, or other attributes of interest.

At block 1114, processing logic performs an analysis procedure on the video data. The analysis procedure may include one or more operations. The analysis procedure includes operations of blocks 1116 and 1118.

At block 1116, processing logic determines a respective first score for each of the plurality of frames based on the first selection criteria. Determining the first score may include parsing the video data into frames, and providing the frames (e.g., one at a time) to a trained machine learning model configured to determine the respective first score in association with the first selection criteria. Determining the first score may include obtaining, from the trained machine learning model, the first score. In some embodiments, determining the first score may further include providing the first selection criteria to the trained machine learning model, wherein the trained machine learning model is configured to generate output based on a target selection criteria of a plurality of selection criteria (e.g., a universal model). In some embodiments, multiple scores (e.g., second score, third score, etc.) may be generated for any of the plurality of frames, for example with respect to second and third sets of selection criteria.

At block 1118, processing logic determines that a first frame satisfies a first threshold condition based on the first score. The threshold condition may be based on each of a set of selection criteria, e.g., target attributes. The threshold condition may relate to an indication of how well the first frame satisfies the selection criteria generally, rather than how closely the first frame is aligned with a single selection criteria (e.g., the threshold condition may be compared or associated with a composite score based on individual scores associated with each of the selection criteria or selection requirements). The threshold condition may be a numerical value (e.g., if a first score meets or exceeds this value, the frame is provided as output). The threshold condition may be a more complex function, e.g., may be related to other frames of a video sample (only the highest scored frame may be provided), may include penalties for being similar in attributes or close in time to other frames (to provide some variety in output frames), or the like.

In some embodiments, the analysis procedure may further include generating one or more images (e.g., generating synthetic video frames based on selection criteria and the input video data). Generation of images such as synthetic video frames based on selection criteria is discussed in more detail in connection with FIG. 11D. A frame may include some attributes of interest, e.g., the frame may satisfy a first criterion but not a second criterion. Another frame may satisfy the second criterion. Processing logic may generate an output frame including target attributes of the two frames to generate an output frame including both selection criteria of interest.

In some embodiments, the analysis procedure may include adjusting one or more frames to increase conformity with target selection criteria. A machine learning model may be used to adjust properties of frames, combine properties of frames, or the like to generate a synthetic frame conforming with one or more selection criteria.

In some embodiments, the analysis procedure may include generating an output image based on a three-dimensional model of the dental patient. Based on the video data, a trained machine learning model (or other method) may be used to generate a three-dimensional model of a dental patient (e.g., of the dental patient's face and/or head). An image may be output as a frame based on the three-dimensional model. In some embodiments, various selection requirements may be satisfied by adjusting the three-dimensional model before rendering the image, e.g., head angle, facial expression, bite opening, or other features may be adjusted or specified to conform with selection requirements in a target image.

At block 1119, processing logic provides the first frame as output of the analysis procedure.

FIG. 11C is a flow diagram of a method 1100C for training a machine learning model for generating a dental patient image, according to some embodiments. At block 1131, processing logic obtains a plurality of data of images of a dental patient. The plurality of images may be frames of a video of the dental patient. The plurality of images may further be accompanied by a set of facial key points in association with each of the plurality of frames of the video data.

At block 1132, processing logic obtains a first plurality of classifications of the images based on first selection criteria. The selection criteria may include a set of conditions for a target image of a dental patient, e.g., in connection with a dental/orthodontic treatment. The selection criteria may include features such as those discussed in connection with block 1112 of FIG. 11B.

At block 1134, processing logic trains a machine learning model to generate a trained machine learning model. The trained machine learning model is configured to determine whether a first image of a dental patient satisfies a first threshold condition in connection with the first selection criteria by providing the plurality of data of images of dental patients as training input and the first plurality of classifications as target output. The target image may include one or more of a social smile, a profile including one or more teeth of interest, exposure of a target selection of teeth, or the like.

In some embodiments, a second plurality of classifications of the images based on second selection criteria may be obtained and used to train the machine learning model. The model may then be configured to determine whether one or more images satisfy one or more sets of selection criteria, e.g., the model may be trained to be a universal model.

FIG. 11D is a flow diagram of a method 1100D for generating an image in association with an analysis procedure, according to some embodiments. At block 1141, processing logic obtains video data of a dental patient. The video data includes a plurality of frames.

At block 1142, processing logic obtains an indication of first selection criteria in association with the video data. The first selection criteria may include one or more conditions related to a target dental treatment of the dental patient. The first selection criteria may be related to a reference image, e.g., extracted from a reference image that satisfies one or more conditions of interest. In some embodiments, second selection criteria are also obtained, and further operations performed in association with the first and second selection criteria.

At block 1144, an analysis procedure is performed on the video data. The analysis procedure includes a number of operations, which may include operations described in association with blocks 1146 through 1154.

At block 1146, performing the analysis procedure includes determining a first set of scores for each of the plurality of frames based on the first selection criteria. Determining the scores may include providing the video data to a trained machine learning model configured to determine the first set of scores in association with the first selection criteria, and obtaining the first set of scores from the trained machine learning model.

At block 1148, processing logic determines that a first frame of the plurality of frames satisfies a first condition based on the first set of scores. Processing logic further determines that the first frame does not satisfy a second condition based on the first set of scores. In some embodiments, a second frame may satisfy the second condition but not the first. Combinations of frames satisfying combinations of conditions (e.g., a first frame including a target head angle, second frame including a target tooth visibility, third frame including a target gaze direction, etc.) may be used together for image generation operations. In some embodiments, an attribute may be generated that is not well-represented in any input frame, or additional input frames may not be used in generating a feature in an image based on video data.

At block 1151, processing logic provides the first frame as input to an image generation model. In some embodiments, the image generation model may be part of a self-training model. In some embodiments, the image generation model may be the generator of a generative adversarial network.

At block 1152, processing logic provides instructions based on the second condition to the image generation model. The instructions may include instructions to generate an image by adjusting the first frame such that it conforms with selection criteria.

At block 1154, processing logic obtains, as output from the image generation model, a first generated image that satisfies the first condition and the second condition.

At block 1156, processing logic provides the first generated image as output of the analysis procedure. In some embodiments, the first generated image may be provided to a further system, e.g., for predicting results of dental/orthodontic treatment.

FIG. 11E is a flow diagram of a method 1100E for generating an output frame from video data based on a system prompt to a user (e.g., dental patient or practitioner), according to some embodiments. At block 1160, process logic obtains first video data of a dental patient comprising a plurality of frames. Operations of block 1160 may share one or more features with operations of block 1111 of FIG. 11B. The first video data may be captured by the dental patient (e.g., via their mobile phone, computer, or tablet), by a dental practitioner (e.g., while the patient is at a screening or other appointment), etc. In some embodiments, the first video data may be captured based on prompts provided to the user, e.g., via a mobile app, web application, or the like.

At block 1162, process logic obtains an indication of first selection criteria in association with the first video data. The selection criteria comprise one or more conditions related to a target dental treatment of the dental patient. Operations of block 1162 may share one or more features with operations of block 1112 of FIG. 11B. The selection criteria may be related to a target set of image attributes, e.g., for images to be used as input into treatment planning software, prediction software, modeling software, or the like.

At block 1164, process logic performs an analysis procedure on the first video data. The operations of block 1164 may share one or more features with operations of block 1114 of FIG. 11B. The analysis procedure of block 1164 may include operations of blocks 1166 and 1168.

At block 1166, process logic determines a first score for each of the plurality of frames based on the selection criteria. Operations of block 1166 may share one or more features with operations of block 1116 of FIG. 11B. Determining the first score may include operations described in detail with respect to FIG. 10E, for example. In some embodiments, one or more trained machine learning models may be used for determining the score. For example, the trained machine learning model(s) may be provided a frame for input, and as output may generate a score corresponding to suitability of the frame for a target usage associated with the selection criteria.

At block 1168, process logic determines that second video data is to be obtained based on the first score. Determining that second video data is to be obtained may be in view of the first score not meeting a threshold, e.g., it may be determined that none of the frames included in the first video data includes attributes in accordance with selection requirements. It may be determined that none of the frames included in the first video data includes a set of characteristics that would enable use of the frame in a target application, such as treatment planning or smile prediction. It may be determined that combinations of frames do not contain, cannot combine, or otherwise are not suited for generating an image including the target attributes. It may be determined based on user input that a second video is to be obtained, in some embodiments.

At block 1170, process logic provides a prompt to a user indicating that second video data of the dental patient is to be obtained. In some embodiments, the prompt may be provided to the user device, e.g., via the application or web browser used to obtain the video data, used to provide the video data to a server, or the like. In some embodiments, the prompt may be provided after recording of the first video. For example, a user may record the first video, submit the first video for analysis, and upon analysis determining that a second video would be of use, a prompt may be provided for the user to provide a second video. The prompt may include additional instructions, e.g., a description of attributes that are associated with selection requirements, a description of attributes missing in frames of the first vide data, etc. In some embodiments, the prompt may be provided during recording of the first video. For example, frames of video may be analyzed while further frames are being recorded. Prompts may be provided indicating to a user a change to posture, expression, or the like that may improve metrics of one or more video frames, with respect to selection criteria. In some embodiments, a subset of analysis may be performed during video recording, e.g., feature detection and feature analysis may be used to determine whether the video includes attributes of interest, while further analysis operations may be completed after recording the second video data, recording further frames including target attributes, etc.

At block 1172, process logic performs an analysis procedure on the second video data. The analysis procedure may include operations similar to blocks 1164 and/or 1166. One or more scores (e.g., in relation to one or more sets of selection requirements, one or more video frames, etc.) may be generated.

At block 1174, process logic provides a frame of a plurality of frames of the second video data at output of the analysis procedure. Operations of block 1174 may share one or more features with operations of block 1119 of FIG. 11B.

FIGS. 11F-34 below relate to methods associated with generating modified videos of a patient's smile, assessing quality of a video of a patient's smile, guiding the capture of high quality videos of a patient's smile, and so on, in accordance with embodiments of the present disclosure. Also described are methods associated with generating modified videos of other subjects, which may be people, landscapes, buildings, plants, animals, and/or other types of subjects. The methods or diagrams depicted in any of FIGS. 11F-34 may be performed by a processing logic that may comprise hardware (e.g., circuitry, dedicated logic, programmable logic, microcode, etc.), software (e.g., instructions run on a processing device), or a combination thereof. Various embodiments may be performed by a computing device 205 as described with reference to FIG. 1A and FIG. 2 and/or by a computing device 3800 as shown in FIG. 38.

FIG. 11F illustrates a flow diagram for a method 1100F of generating a video of a dental treatment outcome, in accordance with an embodiment. At block 1110 of method 1100F, processing logic receives a video of a face comprising a current condition of a dental site (e.g., a current condition of a patient's teeth). At block 1115, processing logic receives or determines an estimated future condition or other altered condition of the dental site. This may include, for example, receiving a treatment plan that includes 3D models of a current condition of a patient's dental arches and 3D models of a future condition of the patient's dental arches as they are expected to be after treatment. This may additionally or alternatively include receiving intraoral scans and using the intraoral scans to generate 3D models of a current condition of the patient's dental arches. The 3D models of the current condition of the patient's dental arches may then be used to generate post-treatment 3D models or other altered 3D models of the patient's dental arches. Additionally, or alternatively, a rough estimate of a 3D model of an individual's current dental arches may be generated based on the received video itself. Treatment planning estimation software or other dental alteration software may then process the generated 3D models to generate additional 3D models of an estimated future condition or other altered condition of the individual's dental arches. In one embodiment, the treatment plan is a detailed and clinically accurate treatment plan generated based on a 3D model of a patient's dental arches as produced based on an intraoral scan of the dental arches. Such a treatment plan may include 3D models of the dental arches at multiple stages of treatment. In one embodiment, the treatment plan is a simplified treatment plan that includes a rough 3D model of a final target state of a patient's dental arches, and is generated based on one or more 2D images and/or a video of the patient's current dentition (e.g., an image of a current smile of the patient).

At block 1120, processing logic modifies the received video by replacing the current condition of the dental site with the estimated future condition or other altered condition of the dental site. This may include at block 1122 determining the inner mouth area in frames of the video, and then replacing the inner mouth area in each of the frames with the estimated future condition of the dental site at block 1123. In at least one embodiment, a generative model receives data from a current frame and optionally one or more previous frames and data from the 3D models of the estimated future condition or other altered condition of the dental arches, and outputs a synthetic or modified version of the current frame in which the original dental site has been replaced with the estimated future condition or other altered condition of the dental site.

In one embodiment, at block 1125 processing logic determines an image quality score for frames of the modified video. At block 1130, processing logic determines whether any of the frames have an image quality score that fails to meet an image quality criteria. In one embodiment, processing logic determines whether there are any sequences of consecutive frames in the modified video in which each of the frames of the sequence fails to satisfy the image quality criteria. If one or more frames (or a sequence of frames including at least a threshold number of frames) is identified that fails to meet the image quality criteria, the method may continue to block 1135. If all of the frames meet the image quality criteria (or no sequence of frames including at least a threshold number of frames fails to meet the image quality criteria), the method proceeds to block 1150.

At block 1135, processing logic removes one or more frames (e.g., a sequence of frames) that failed to satisfy the image quality criteria. Removing a sequence of frames may cause the modified video to become jumpy or jerky between some remaining frames. Accordingly, in one embodiment at block 1140 processing logic generates replacement frames for the removed frames. The replacement frames may be generated, for example, by inputting remaining frames before and after the removed frames into a generative model, which may output one or more interpolated intermediate frames. In one embodiment, processing logic determines an optical flow between a pair of frames that includes a first frame that occurs before the removed sequence of frames (or individual frame) and a second frame that occurs after the removed sequence of frames (or individual frame). In one embodiment, the generative model determines optical flows between the first and second frames and uses the optical flows to generate replacement frames that show an intermediate state between the pair of input frames. In one embodiment, the generative model includes a layer that generates a set of features in a feature space for each frame in a pair of frames, and then determines an optical flow between the set of features in the feature space and uses the optical flow in the feature space to generate a synthetic frame or image.

In one embodiment, at block 1145 one or more additional synthetic or interpolated frames may also be generated by the generative model described with reference to block 1140. In one embodiment, processing logic determines, for each pair of sequential frames (which may include a received frame and/or a simulated frame), a similarity score and/or a movement score. Processing logic may then determine whether the similarity score and/or movement score satisfies a stopping criterion. If for any pair of frames a stopping criterion is not met, one or more additional simulated frames are generated.

At block 1150, processing logic outputs a modified video showing the individual's face with the estimated future condition of the dental site rather than the current condition of the dental site. The frames in the modified video may be temporally stable and consistent.

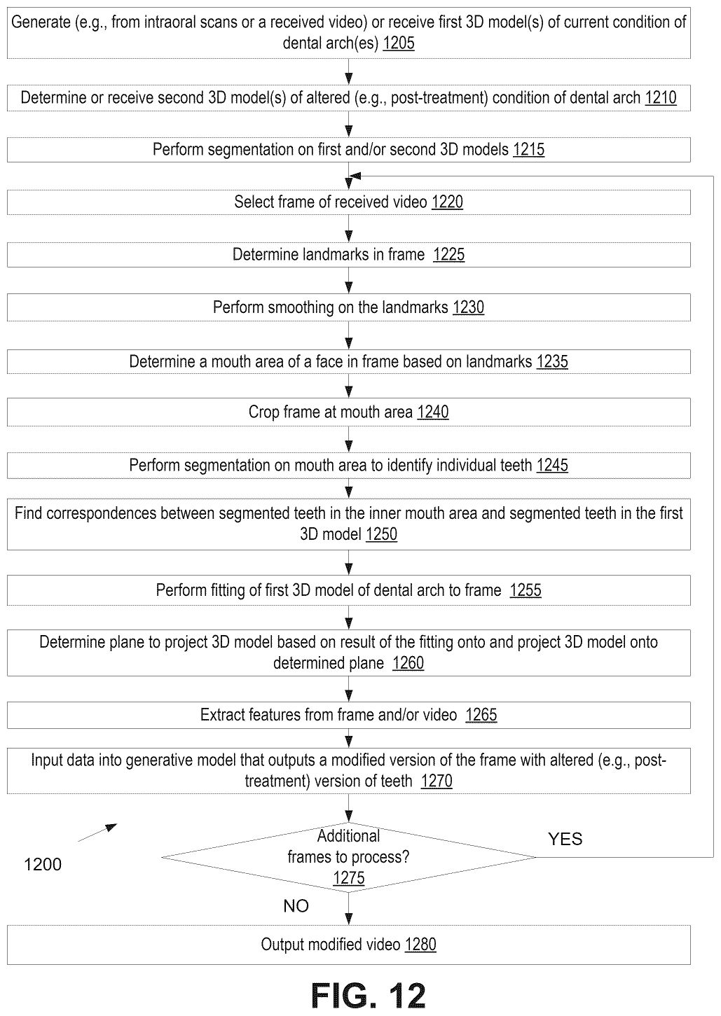

FIG. 12 illustrates a flow diagram for a method 1200 of generating a video of a dental treatment outcome, in accordance with an embodiment. Method 1200 may be performed, for example, at block 1120 of method 1100F. At block 1205 of method 1200, processing logic generates or receives first 3D models of a current condition of an individual's dental arches. The first 3D models may be generated, for example, based on intraoral scans of the individual's oral cavity or on a received 2D video of the individual's smile.

At block 1210, processing logic determines or receives second 3D models of the individual's dental arches showing a post-treatment condition of the dental arches (or some other estimated future condition or other altered condition of the individual's dental arches).

At block 1215, processing logic performs segmentation on the first and/or second 3D models. The segmentation may be performed to identify each individual tooth, an upper gingiva, and/or a lower gingiva on an upper dental arch and on a lower dental arch.

At block 1220, processing logic selects a frame from a received video of a face of an individual. At block 1225, processing logic processes the selected frame to determine landmarks in the frame (e.g., such as facial landmarks). In one embodiment, a trained machine learning model is used to determine the landmarks. In one embodiment, at block 1230 processing logic performs smoothing on the landmarks. Smoothing may be performed to improve continuity of landmarks between frames of the video. In one embodiment, determined landmarks from a previous frame are input into a trained machine learning model as well as the current frame for the determination of landmarks in the current frame.

At block 1235, processing logic determines a mouth area (e.g., an inner mouth area) of the face based on the landmarks. In one embodiment, the frame and/or landmarks are input into a trained machine learning model, which outputs a mask identifying, for each pixel in the frame, whether or not that pixel is a part of the mouth area. In one embodiment, the mouth area is determined based on the landmarks without use of a further machine learning model. For example, landmarks for lips may be used together with an offset around the lips to determine a mouth area.

At block 1240, processing logic crops the frame at the determined mouth area. At block 1245, processing logic performs segmentation of the mouth area (e.g., of the cropped frame that includes only the mouth area) to identify individual teeth in the mouth area. Each tooth in the mouth area may be identified as a separate object and labeled. Additionally, upper and/or lower gingiva may also be identified and labeled. In at least one embodiment, an inner mouth area (e.g., a mouth area between upper and lower lips of an open mouth) is also determined by the segmentation. In at least one embodiment, a space between upper and lower teeth is also determined by the segmentation. In at least one embodiment, the segmentation is performed by a trained machine learning model. The segmentation may result in the generation of one or more masks that provide useful information for generation of a synthetic image that will show an estimated future condition of a dental site together with a remainder of a frame of a video. Generated masks may include an inner mouth area mask that includes, for each pixel of the frame, an indication as to whether that pixel is part of an inner mouth area. Generated masks may include a map that indicates the space within an inner mouth area that shows the space between teeth in the upper and lower dental arch. Other maps may also be generated. Each map may include one or more sets of pixel locations (e.g., x and y coordinates for pixel locations), where each set of pixel locations may indicate a particular class of object or a type of area.

At block 1250, processing logic finds correspondences between the segmented teeth in the mouth area and the segmented teeth in the first 3D model. At block 1255, processing logic performs fitting of the first 3D model of the dental arch to the frame based on the determined correspondences. The fitting may be performed to minimize one or more cost terms of a cost function, as described in greater detail above. A result of the fitting may be a position and orientation of the first 3D model relative to the frame that is a best fit (e.g., a 6D parameter that indicates rotation about three axes and translation along three axes).

At block 1260, processing logic determines a plane to project the second 3D model onto based on a result of the fitting. Processing logic then projects the second 3D model onto the determined plane, resulting in a sketch in 2D showing the contours of the teeth from the second 3D model (e.g., the estimated future condition of the teeth from the same camera perspective as in the frame). A 3D virtual model showing the estimated future condition of a dental arch may be oriented such that the mapping of the 3D virtual model into the 2D plane results in a simulated 2D sketch of the teeth and gingiva from a same perspective from which the frame was taken.

At block 1265, processing logic extracts one or more features of the frame. Such extracted features may include, for example, a color map including colors of the teeth and/or gingiva without any contours of the teeth and/or gingiva. In one embodiment, each tooth is identified (e.g., using the segmentation information of the cropped frame), and color information is determined separately for each tooth. For example, an average color may be determined for each tooth and applied to an appropriate region occupied by the respective tooth. The average color for a tooth may be determined, for example, based on Gaussian smoothing the color information for each of the pixels that represents that tooth. The features may additionally or alternatively be smoothed across frames. For example, in one embodiment the color of the tooth is not only extracted based on the current frame but is additionally smoothed temporally.

In at least one embodiment, optical flow is determined between the estimated future condition of the teeth for the current frame and a previously generated frame (that also includes the estimated future condition of the teeth). The optical flow may be determined in the image space or in a feature space.

At block 1270, processing logic inputs data into a generative model that then outputs a modified version of the current frame with the post-treatment (or other estimated future condition or other altered condition) of the teeth. The input data may include, for example, the current frame, one or more generated or synthetic previous frames, a mask of the inner mouth area for the current frame, a determined optical flow, a color map, a normals map, a sketch of the post-treatment condition or other altered condition of the teeth, a second mask that identifies a space between teeth of an upper dental arch and teeth of a lower dental arch, and so on. A shape of the teeth in the new simulated frame may be based on the sketch of the estimated future condition or other altered condition of the teeth and a color of the teeth (and optionally gingiva) may be based on the color map (e.g., a blurred color image containing a blurred color representation of the teeth and/or gingiva).

At block 1275, processing logic determines whether there are additional frames of the video to process. If there are additional frames to process, then the method returns to block 1220 and a next frame is selected. If there are no further frames to process, the method proceeds to block 1280 and a modified video showing the estimated future condition of a dental site is output.

In at least one embodiment, method 1200 is performed in such a manner that the sequence of operations is performed one frame at a time. For example, the operations of blocks 1220-1270 in sequence for a first frame before repeating the sequence of operations for a next frame, as illustrated. This technique could be used, for example, for live processing since an entire video may not be available when processing current frames. In at least one embodiment, the operations of block 1220 are performed on all or multiple frames, and once the operation has been performed on those frames, the operations of block 1225 are performed on the frames before proceeding to block 1230, and so on. Accordingly, the operations of a particular step in an image processing pipeline may be performed on all frames before moving on to a next step in the image processing pipeline in embodiments. One advantage of this technique is that each processing step can use information from the entire video, which makes it easier to achieve temporal consistency.

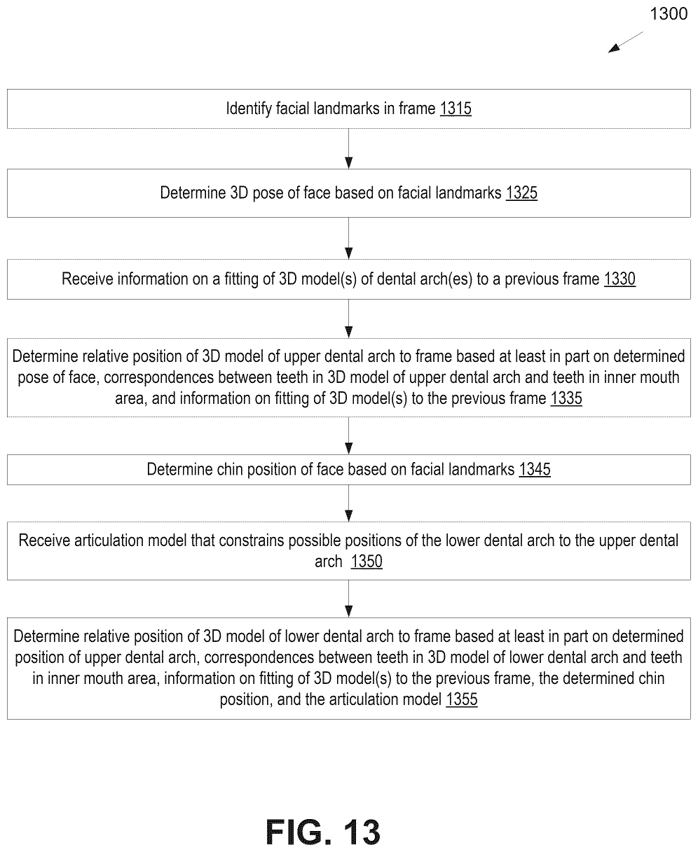

FIG. 13 illustrates a flow diagram for a method 1300 of fitting a 3D model of a dental arch to an inner mouth area in a video of a face, in accordance with an embodiment. In one embodiment, method 1300 is performed at block 1225 of method 1200.

At block 1315 of method 1300, processing logic identifies facial landmarks in a frame of a video showing a face of an individual. At block 1325, processing logic determines a pose of the face based on the facial landmarks. At block 1330, processing logic receives a fitting of 3D models of upper and/or lower dental arches to a previous frame of the video. In at least one embodiment, for a first frame, processing logic applies an initialization step based on an optimization that minimizes the distance between the centers of 2D tooth segmentations and the centers 2D projections of the 3D tooth models.

At block 1335, processing logic determines a relative position of a 3D model of the upper dental arch to the frame based at least in part on the determined pose of the face, determined correspondences between teeth in the 3D model of the upper dental arch and teeth in an inner mouth area of the frame, and information on fitting of the 3D model(s) to the previous frame or frames. The upper dental arch may have a fixed position relative to certain facial features for a given individual. Accordingly, it may be much easier to perform fitting of the 3D model of the upper dental arch to the frame than to perform fitting of the lower dental arch to the frame. As a result, the 3D model of the upper dental arch may first be fit to the frame before the 3D model of the lower dental arch is fit to the frame. The fitting may be performed by minimizing a cost function that includes multiple cost terms, as is described in detail herein above.

At block 1345, processing logic determines a chin position of the face based on the determined facial landmarks. At block 1350, processing logic may receive an articulation model that constrains the possible positions of the lower dental arch to the upper dental arch. At block 1355, processing logic determines a relative position of the 3D model of the lower dental arch to the frame based at least in part on the determined position of the upper dental arch, correspondences between teeth in the 3D model of the lower dental arch and teeth in the inner mouth area of the frame, information on fitting of the 3D models to the previous frame, the determined chin position, and/or the articulation model. The fitting may be performed by minimizing a cost function that includes multiple cost terms, as is described in detail herein above.

The above description has been primarily focused on operations that may be performed to generate a modified version of an input video that shows the estimated future condition of an individual's teeth rather than a current condition of the individual's teeth. Many of the operations include the application of machine learning, which include trained machine learning models that were trained using videos and/or images generated under certain conditions. To produce modified videos having a highest possible quality, it can be useful to ensure that a starting video meets certain quality criteria. For example, it can be useful to ensure that a starting video includes as many conditions as possible that overlap with conditions of videos and/or images that were included in a training dataset used to train the various machine learning models used to generate a modified video.

Capturing videos constrained to specific scenarios is several magnitudes more complicated than for images. Image capturing systems can wait until all constraints are met, and capture an image in the correct moment. For videos this is not possible as it would cut the video into several parts. For example, if two constraints are face angle and motion blur, a subject should follow a defined movement but in a manner that avoids motion blur. The constraints may be contradictory in nature, and it may be very difficult to satisfy both constraints at the same time. However, stopping the recording of a video when one or more constraints stop being met would create a very unfriendly user experience and result in choppy videos that do not flow well.

Generation of a video that meets certain quality criteria is much more difficult than generation of an image that meets quality criteria because the video includes many frames, and a user moves, changes expressions, etc. during capture of the video. Accordingly, even when some frames of a video do satisfy quality criteria, other frames of the video may not satisfy quality criteria. In some embodiments a video capture logic (e.g., video capture logic 212 of FIG. 2) analyses received video and provides guidance on how to improve the video. The video capture logic may perform such analysis and provide such guidance in real time or on-the-fly as a video is being generated in embodiments.

Additionally, even when a video as a whole meets quality criteria, some frames of that video may still fail to meet the quality criteria. In such instances, the video capture logic is able to detect those videos that fail to satisfy quality criteria and determine how to present such frames and/or what to present instead of such frames.

FIG. 14 illustrates a flow diagram for a method 1400 of providing guidance for capture of a video of a face, in accordance with an embodiment. At block 1402 of method 1400, processing logic outputs a notice of one or more quality criteria or constraints that videos should comply with. Examples of such constraints include a head pose constraint, a head movement speed constraint, a head position in frame constraint (e.g., that requires a face to be visible and/or approximately centered in a frame), a camera movement constraint, a camera stability constraint, a camera focus constraint, a mouth position constraint (e.g., for the mouth to be open), a jaw position constraint, a lighting conditions constraint, and so on. The capture constraints may have a characteristics that they are intuitively assessable by non-technical users and/or can be easily explained. For example, prior to capture of a video of a face an example ideal face video may be presented, with a graphical overlay showing one or more constraints and how they are or are not satisfied with each frame of the video. Accordingly, before a video is captured the constraints may be explained to the user by giving examples and clear instructions. Examples of instructions include look towards the camera, open mouth, smile, position head in a target position, and so on.

At block 1405, processing logic captures a video comprising a plurality of frames of an individual's face. At block 1410, processing logic determines one or more quality metric values for frames of the video. The quality metric values may include, for example, a head pose value, a head movement speed value, a head position in frame value, a camera movement value, a camera stability value, a camera focus value, a mouth position value, a jaw position value, a lighting conditions value, and so on. In at least one embodiment, multiple techniques may be used to assess quality metric values for frames of the video.

In one embodiment, frames of the video are input into a trained machine learning model that determines landmarks (e.g., facial landmarks) of the frames, and/or performs face detection. Based on such facial landmarks determined for a single frame or for a sequence of frames, processing logic determines one or more of a head pose, a head movement speed, a head position, a mouth position and jaw position, and so on. Each of these determined properties may then be compared to a constraint or quality criterion or rule. For example, a head pose constraint may require that a head have a head pose that is within a range of head poses. In another example, a head movement speed constraint may require that a head movement speed be below a movement speed threshold.

In one embodiment, an optical flow is computed between frames of the video. The optical flow can then be used to assess frame stability, which is usable to then estimate a camera stability score or value.

In one embodiment, one or more frames of the video are input into a trained machine learning model that outputs a blurriness score for the frame or frames. The trained machine learning model may output, for example, a motion blur value and/or a camera defocus value.

In one embodiment, one or more frames of the video are input into a trained machine learning model that outputs a lighting estimation.

At block 1415, processing logic determines whether the video satisfies one or more quality criteria (also referred to as quality metric criteria and constraints). If all quality criteria are satisfied by the video, the method proceeds to block 1440 and an indication is provided that the video satisfies the quality criteria (and is usable for processing by a video processing pipeline as described above). If one or more quality criteria are not satisfied by the video, or a threshold number of quality criteria are not satisfied by the video, the method continues to block 1420.

At block 1420, processing logic determines which of the quality criteria were not satisfied. At block 1425, processing logic then determines reasons that the quality criteria were not satisfied and/or a degree to which a quality metric value deviates from a quality criterion. At block 1430, processing logic determines how to cause the quality criteria to be satisfied. At block 1432, processing logic outputs a notice of one or more failed quality criteria and why the one or more quality criteria were not satisfied. At block 1435, processing logic may provide guidance of one or more actions to be performed by the individual being imaged to cause an updated video to satisfy the one or more quality criteria.

At block 1438, processing logic may capture an updated video comprising a plurality of frames of the individual's face. The updated video may be captured after the individual has made one or more corrections. The method may then return to block 1410 to begin assessment of the updated video. In one embodiment, processing logic provides live feedback on which constraints are met or not in a continuous fashion to a user capturing a video. In at least one embodiment, the amount of time that it will take for a subject to respond and act after feedback is provided is taken into consideration. Accordingly, in some embodiments feedback to correct one or more issues is provided before quality metric values are outside of bounds of associated quality criteria. In one embodiment, there are upper and lower thresholds for each of the quality criteria. Recommendations may be provided once a lower threshold is passed, and a frame of a video may no longer be usable once an upper threshold is passed in an embodiment.

The provided feedback may include providing an overlay or visualizations that take advantage of color coding, error bars, etc. and/or of providing sound or audio signals. In one example, a legend may be provided showing different constraints with associated values and/or color codes indicating whether or not those constraints are presently being satisfied by a captured video (e.g., which may be a video being captured live). In one embodiment, a green color indicates that a quality metric value is within bounds of an associated constraint, a yellow color indicates that a quality metric value is within bounds of an associated constraint, and a red color indicates that a quality metric value is outside of the bounds of an associated constraint. In one embodiment, constraints are illustrated together with error bars, where a short error bar may indicate that a constraint is satisfied and a longer error bar may indicate an aspect or constraint that an individual should focus on (e.g., that the individual should perform one or more actions to improve). In one embodiment, a louder and/or higher frequency sound is used to indicate that one or more quality criteria are not satisfied, and a softer and/or lower frequency sound is used to indicate that all quality criteria are satisfied or are close to being satisfied.

In at least one embodiment, processing logic can additionally learn from behavior of a patient. For example, provided instructions may be “turn your head to the left”, followed by “turn your head to the right”. If the subject moves their head too fast to the left, then the subsequent instructions for turning the head to the right could be “please move your head to the right, but not as fast as you just did”.

In at least one embodiment, for constraints based on the behavior of the patient processing logic can also anticipate a short set of future frames. For example, a current frame and/or one or more previous frames may be input into a generative model (e.g., a GAN), which can output estimated future frames and/or quality metric values for the future frames. Processing logic may determine whether any of the quality metric values for the future frames will fail to satisfy one or more quality criteria. If so, then recommendations may be output for changes for the subject to make even though the current frame might not violate any constraints. In an example, a range of natural acceleration of human head movements may be possible. With that information, instructions can be provided before constraints are close to being broken because the system can anticipate that the patient will not be able to stop a current action before a constraint is violated.

In at least one embodiment, processing logic does not impose any hard constraints on the video recording to improve usability. One drawback of this approach is that the video that is processed may include parts (e.g., sequences of frames) that do not meet all of the constraints, and will have to be dealt with differently than those parts that do satisfy the constraints.

In at least one embodiment, processing logic begins processing frames of a captured video using one or more components of the video processing workflow of FIG. 3A. One or more of the components in the workflow include trained machine learning models that may output a confidence score that accompanies a primary output (e.g., of detected landmarks, segmentation information, etc.). The confidence score may indicate a confidence of anywhere from 0% confidence to 100% confidence. In at least one embodiment, the confidence score may be used as a heuristic for frame quality.

In at least one embodiment, one or more discriminator networks (e.g., similar to a discriminator network of a GAN) may be trained to distinguish between training data and test data or live data. Such discriminators can evaluate how close the test or live data is to the training data. If the test data is considered to be different from data in a training set, the ability of trained ML models to operate on the test data is likely to be of a lower quality. Accordingly, such a discriminator may output an indication of whether test data (e.g., current video data) is part of a training dataset, and optionally a confidence of such a determination. If the discriminator outputs an indication that the test data is not part of the training set and with a high confidence, this may be used as a low quality metric score that fails to meet a quality metric criterion.

In at least one embodiment, classifiers can be trained with good and bad labels to identify a segment of frames with bad predictions directly without any intermediate representation on aspects like head pose. Such a determination may be made based on the assumption that a similar set of input frames always leads to bad results, and other similar input frames lead to good results.

In at least one embodiment, high inconsistency between predictions of consecutive frames can also help to identify difficult parts in a video. For this, optical flow could be run on the output frames and a consistency value may be calculated from the optical flow. The consistency value may be compared to a consistency threshold. A consistency value that meets or exceeds the consistency threshold may pass an associated quality criterion.

In at least one embodiment, quality metric values may be determined for each frame of a received video. Additionally, or alternatively, in some embodiments confidence scores are determined for each frame of a received video by processing the video by one or more trained machine learning models of video processing workflow 305. The quality metric values and/or confidence scores may be smoothed between frames in embodiments. The quality metric values and/or confidence scores may then be compared to one or more quality criteria after the smoothing.

In at least one embodiment, combined quality metric values and/or confidence scores are determined for a sequence of frames of a video. A moving window may be applied to the video to determine whether there are any sequences of frames that together fail to satisfy one or more quality criteria.

In at least one embodiment, if fewer than a threshold number of frames have bad quality like motion blur (e.g., have one or more quality metric values that fail to satisfy an associated quality criterion), then before and after frames with good quality (e.g., that do satisfy the associated quality criterion) can be used to generate intermediate frames with generative models such as GANs.

In at least one embodiment, if a small number of frames fail to match the constraints (e.g., fail to satisfy the quality criteria), a frame that did satisfy the quality criteria that was immediately before the frame or frames that failed to satisfy the quality criteria may be shown instead of the frame that failed to satisfy the quality criteria. Accordingly, in some embodiments, a bad frame may be replaced with a nearby good frame, such that the good frame may be used for multiple frames of the video.

In at least one embodiment, textual messages like “Face angle out of bounds” can be output in the place of frames that failed to satisfy the quality criteria. The textual messages may explain to the user why no processing result is available.

In at least one embodiment, intermediate quality scores can be used to alpha blend between input and output. This would ensure a smooth transition between processed and unprocessed frames.

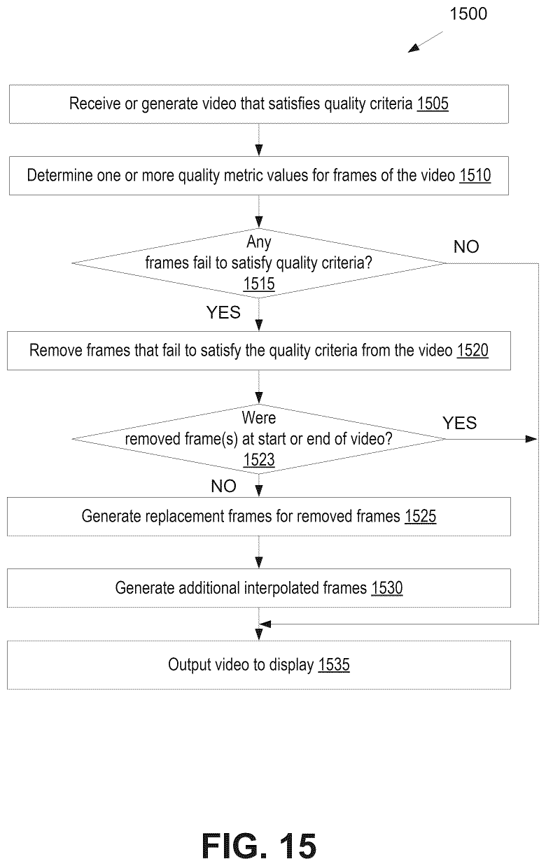

FIG. 15 illustrates a flow diagram for a method 1500 of editing a video of a face, in accordance with an embodiment. In at least one embodiment, method 1500 is performed on a video after the video has been assessed as having sufficient quality (e.g., after processing the video according to method 1400) and before processing the video using video processing workflow 305 of FIG. 3A.

At block 1505 of method 1500, processing logic receives or generates a video that satisfies one or more quality criteria. At block 1510, processing logic determines one or more quality metric values for each frame of the video. The quality metric values may be the same quality metric values discussed with relation to method 1400. At block 1515, processing logic determines whether any of the frames of the video fail to satisfy the quality criteria. If no frames fail to satisfy the quality criteria, the method proceeds to block 1535. If any frame fails to satisfy the quality criteria, the method continues to block 1520.

At block 1520, processing logic removes those frames that fail to satisfy the quality criteria. This may include removing a single frame at a portion of the video and/or removing a sequence of frames of the video.

At block 1523, processing logic may determine whether the removed low quality frame or frames were at the beginning or end of the video. If so, then those frames may be cut without replacing the frames since the frames can be cut without a user noticing any skipped frames. If all of the removed frames were at a beginning and/or end of the video then the method proceeds to block 1535. If one or more of the removed frames were between other frames of the video that were not also removed, then the method continues to block 1525.

In at least one embodiment, processing logic defines a minimum length video and determines if there is a set of frames/part of the video that satisfies the quality criteria. If a set of frames that is at least the minimum length satisfies the quality criteria, then a remainder of the video may be cut, leaving the set of frames that satisfied the quality criteria. The method may then proceed to block 1535. For example, a 30 second video may be recorded. An example minimum length video parameter is 15 seconds. Assume that there are frames that don't meet the criteria at second 19. This is still in the middle, but processing logic can return only seconds 1-18 (>15) and meet a minimum length video. In such an instance, processing logic may then proceed to block 1535.

At block 1525, processing logic generates replacement frames for the removed frames that were not at the beginning or end of the video. This may include inputting frames on either end of the removed frame (e.g., a before frame and an after frame) into a generative model, which may output one or more interpolated frames that replace the removed frame or frames. At block 1530, processing logic may generate one or more additional interpolated frames, such as by inputting a previously interpolated frame and the before or after frame (or two previously interpolated frames) into the generative model to generate one or more additional interpolated frames. This process may be performed, for example, to increase a frame rate of the video and/or to fill in sequences of multiple removed frames.

At block 1535, processing logic outputs the updated video to a display. Additionally, or alternatively, processing logic may input the updated video to video processing pipeline 305 of FIG. 3A for further processing.

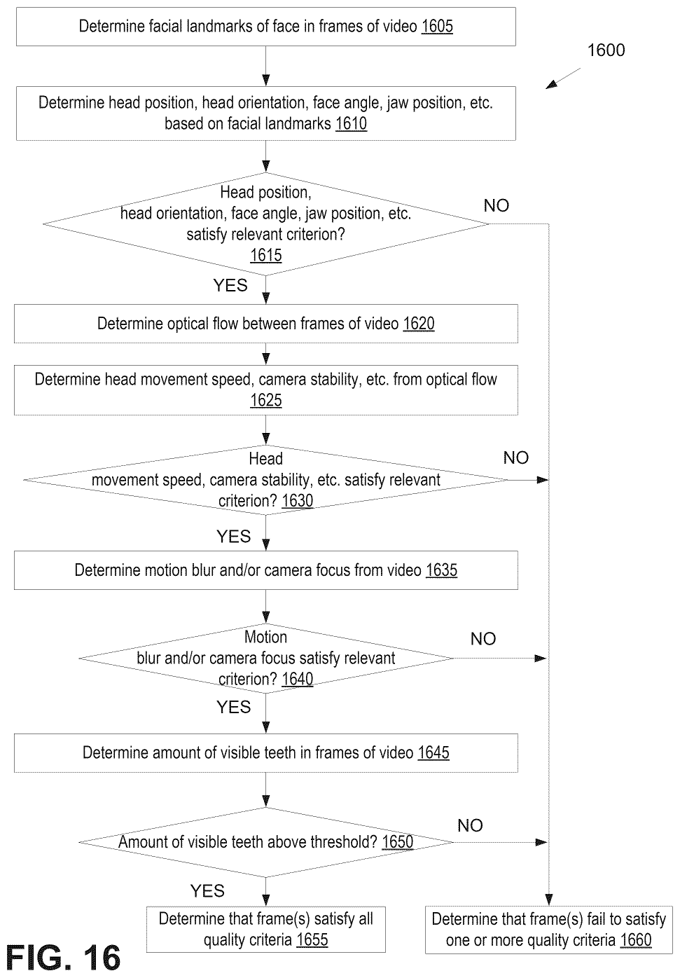

FIG. 16 illustrates a flow diagram for a method 1600 of assessing quality of one or more frames of a video of a face, in accordance with an embodiment. Method 1600 may be performed, for example, at blocks 1410-1415 of method 1400 and/or at blocks 1510-1515 of method 1500 in embodiments.

In one embodiment, at block 1605 processing logic determines facial landmarks in frames of a video, such as by inputting the frames of the video into a trained machine learning model (e.g., a deep neural network) trained to identify facial landmarks in images of faces. At block 1610, processing logic determines multiple quality metric values, such as for a head position, head orientation, face angle, jaw position, etc. based on the facial landmarks. In one embodiment, one or more layers of the trained machine learning model that performs the landmarking determine the head position, head orientation, face angle, jaw position, and so on.

At block 1615, processing logic may determine whether the head position is within bounds of a head position constraint/criterion, whether the head orientation is within bounds of a head orientation constraint/criterion, whether the face angle is within bounds of a face angle constraint/criterion, whether the jaw position is within bounds of a jaw position constraint/criterion, and so on. If the head position, head orientation, face angle, jaw position, etc. satisfy the relevant criteria, then the method may continue to block 1620. If any or optionally a threshold number of the determined quality metric values fail to satisfy the relevant criteria, then at block 1660 processing logic may determine that the frame or frames fail to satisfy one or more quality criteria.

At block 1620, processing logic may determine an optical flow between frames of the video. At block 1625, processing logic may determine head movement speed, camera stability, etc. based on the optical flow.

At block 1630, processing logic may determine whether the head movement speed is within bounds of a head motion speed constraint/criterion, whether the camera stability is within bounds of a camera stability constraint/criterion, and so on. If the head movement speed, camera stability, etc. satisfy the relevant criteria, then the method may continue to block 1635. If any or optionally a threshold number of the determined quality metric values fail to satisfy the relevant criteria, then at block 1660 processing logic may determine that the frame or frames fail to satisfy one or more quality criteria.

At block 1635, processing logic may determine a motion blur and/or camera focus from the video. In one embodiment, the motion blur and/or camera focus are determined by inputting one or more frames into a trained machine learning model that outputs a motion blur score and/or a camera focus score.

At block 1640, processing logic may determine whether the motion blur is within bounds of a motion blur constraint/criterion, whether the camera focus is within bounds of a camera focus constraint/criterion, and so on. If the motion blur, camera focus, etc. satisfy the relevant criteria, then the method may continue to block 1645. If any or optionally a threshold number of the determined quality metric values fail to satisfy the relevant criteria, then at block 1660 processing logic may determine that the frame or frames fail to satisfy one or more quality criteria.

At block 1645, processing logic may determine an amount of visible teeth in one or more frames of the video. The amount of visible teeth in a frame may be determined by inputting the frame into a trained machine learning model that has been trained to identify teeth in images, and determining a size of a region classified as teeth. In one embodiment, an amount of visible teeth is estimated using landmarks determined at block 1605. For example, landmarks for an upper lip and landmarks for a lower lip may be identified, and a distance between the landmarks for the upper lip and the landmarks for the lower lip may be computed. The distance may be used to estimate an amount of visible teeth in the frame. Additionally, the distance may be used to determine a mouth opening value, which may also be another constraint.

If the amount of visible teeth is above a threshold (and/or a distance between upper and lower teeth is above a threshold), then processing logic may determine that a visible teeth criterion is satisfied, and the method may continue to block 1655. Otherwise the method may continue to block 1660.

At block 1655, processing logic determines that one or more processed frames of the video (e.g., all processed frames of the video) satisfy all quality criteria. At block 1660, processing logic determines that one or more processed frames of the video fail to satisfy one or more quality criteria. Note that in embodiments, the quality checks associated with blocks 1630, 1640, 1650, etc. are made for a given frame regardless of whether or not that frame passed one or more previous quality checks. Additionally, the quality checks of blocks 1615, 1630, 1640, 1650 may be performed in a different order or in parallel.

The preceding description has focused primarily on the capture and modification of videos of faces in order to show estimated future conditions of subject's teeth in the videos. However, the techniques and embodiments described with reference to faces and teeth also apply to many other fields and subjects. The same or similar techniques may also be applied to modify videos of other types of subjects to modify a condition of one or more aspects or features of the subjects to show how those aspects or features might appear in the future. For example, a video of a landscape, cityscape, forest, desert, ocean, shorefront, building, etc. may be processed according to described embodiments to replace a current condition of one or more subjects in the video of the landscape, cityscape, forest, desert, ocean, shorefront, building, etc. with an estimated future condition of the one or more subjects. In another example, a current video of a person or face may be modified to show what the person or face might look like if they gained weight, lost weight, aged, suffered from a particular ailment, and so on.

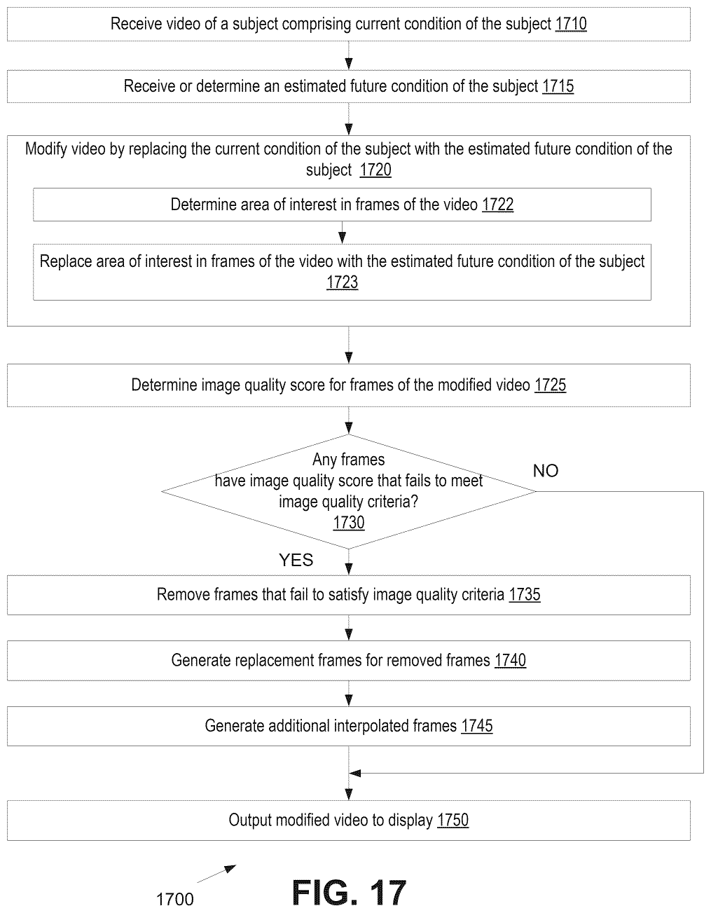

There are at least two options on how to combine video simulation and criteria checking on videos in embodiments described herein. In a first option, processing logic runs a video simulation on a full video, and then selects a part of the simulated video that meets quality criteria. Such an option is described below with reference to FIG. 17. In a second option, a part of a video that meets quality criteria is first selected, and then video simulation is run on the selected part of the video. In at least one embodiment, option 1 and option 2 are combined. For example, portions of an initial video meeting quality criteria may be selected and processed to generate a simulated video, and then a portion of the simulated video may be selected for showing to a user.

FIG. 17 illustrates a flow diagram for a method 1700 of generating a video of a subject with an estimated future condition of the subject (or an area of interest of the subject), in accordance with an embodiment. At block 1710 of method 1700, processing logic receives a video of a subject comprising a current condition of the subject (e.g., a current condition of an area of interest of the subject). At block 1715, processing logic receives or determines an estimated future condition of the subject (e.g., of the area of interest of the subject). This may include, for example, receiving a 3D model of a current condition of the subject and/or a 3D model of an estimated future condition of the subject.

At block 1720, processing logic modifies the received video by replacing the current condition of the subject with the estimated future condition of the subject. This may include at block 1722 determining an area of interest of the subject in frames of the video, and then replacing the area of interest in each of the frames with the estimated future condition of the area of interest at block 1723. In at least one embodiment, a generative model receives data from a current frame and optionally one or more previous frames and data from the 3D model of the estimated future condition of the subject, and outputs a synthetic or modified version of the current frame in which the original area of interest has been replaced with the estimated future condition of the area of interest.

In one embodiment, at block 1725 processing logic determines an image quality score for frames of the modified video. At block 1730, processing logic determines whether any of the frames have an image quality score that fails to meet an image quality criteria. In one embodiment, processing logic determines whether there are any sequences of consecutive frames in the modified video in which each of the frames of the sequence fails to satisfy the image quality criteria. If one or more frames (or a sequence of frames including at least a threshold number of frames) is identified that fails to meet the image quality criteria, the method may continue to block 1735. If all of the frames meet the image quality criteria (or no sequence of frames including at least a threshold number of frames fails to meet the image quality criteria), the method proceeds to block 1750.

At block 1735, processing logic removes one or more frames (e.g., a sequence of frames) that failed to satisfy the image quality criteria. Removing a sequence of frames may cause the modified video to become jumpy or jerky between some remaining frames. Accordingly, in one embodiment at block 1740 processing logic generates replacement frames for the removed frames. The replacement frames may be generated, for example, by inputting remaining frames before and after the removed frames into a generative model, which may output one or more interpolated intermediate frames. In one embodiment, processing logic determines an optical flow between a pair of frames that includes a first frame that occurs before the removed sequence of frames (or individual frame) and a second frame that occurs after the removed sequence of frames (or individual frame). In one embodiment, the generative model determines optical flows between the first and second frames and uses the optical flows to generate replacement frames that show an intermediate state between the pair of input frames. In one embodiment, the generative model includes a layer that generates a set of features in a feature space for each frame in a pair of frames, and then determines an optical flow between the set of features in the feature space and uses the optical flow in the feature space to generate a synthetic frame or image.

In one embodiment, at block 1745 one or more additional synthetic or interpolated frames may also be generated by the generative model described with reference to block 1740. In one embodiment, processing logic determines, for each pair of sequential frames (which may include a received frame and/or a simulated frame), a similarity score and/or a movement score. Processing logic may then determine whether the similarity score and/or movement score satisfies a stopping criterion. If for any pair of frames a stopping criterion is not met, one or more additional simulated frames are generated.

At block 1750, processing logic outputs a modified video showing the subject with the estimated future condition of the area of interest rather than the current condition of the dental site. The frames in the modified video may be temporally stable and consistent.

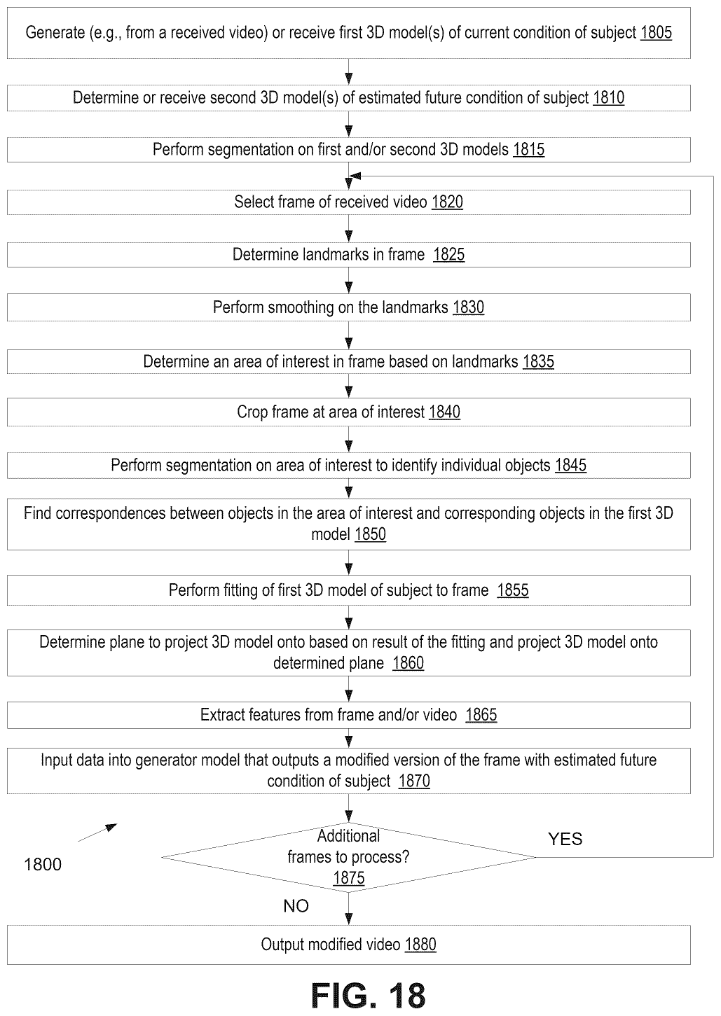

FIG. 18 illustrates a flow diagram for a method 1800 of generating a video of a subject with an estimated future condition of the subject, in accordance with an embodiment. Method 1800 may be performed, for example, at block 1720 of method 1700. At block 1805 of method 1800, processing logic may generate or receive a first 3D model of a current condition of a subject. The first 3D models may be generated, for example, based on generating 3D images of the subject, such as with the use of stereo camera, structured light projection, and/or other 3D imaging techniques.

At block 1810, processing logic determines or receives second 3D models of the subject showing an estimated future condition of the subject (e.g., an estimated future condition of one or more areas of interest of the subject).

At block 1815, processing logic performs segmentation on the first and/or second 3D models. The segmentation may be performed, for example, by inputting the 3D models or projections of the 3D models onto a 2D plane into a trained machine learning model trained to perform segmentation.

At block 1820, processing logic selects a frame from a received video of the subject. At block 1825, processing logic processes the selected frame determine landmarks in the frame. In one embodiment, a trained machine learning model is used to determine the landmarks. In one embodiment, at block 1830 processing logic performs smoothing on the landmarks. Smoothing may be performed to improve continuity of landmarks between frames of the video. In one embodiment, determined landmarks from a previous frame are input into a trained machine learning model as well as the current frame for the determination of landmarks in the current frame.

At block 1835, processing logic determines an area of interest of the subject based on the landmarks. In one embodiment, the frame and/or landmarks are input into a trained machine learning model, which outputs a mask identifying, for each pixel in the frame, whether or not that pixel is a part of the area of interest. In one embodiment, the area of interest is determined based on the landmarks without use of a further machine learning model.

At block 1840, processing logic may crop the frame at the determined area of interest. At block 1845, processing logic performs segmentation of the area of interest (e.g., of the cropped frame that includes only the area of interest) to identify objects within the area of interest. In at least one embodiment, the segmentation is performed by a trained machine learning model. The segmentation may result in the generation of one or more masks that provide useful information for generation of a synthetic image that will show an estimated future condition of an area of interest of a subject together with a remainder of a frame of a video.

At block 1850, processing logic finds correspondences between the segmented objects in the area of interest and the segmented objects in the first 3D model. At block 1855, processing logic performs fitting of the first 3D model of the subject to the frame based on the determined correspondences. The fitting may be performed to minimize one or more cost terms of a cost function, as described in greater detail above. A result of the fitting may be a position and orientation of the first 3D model relative to the frame that is a best fit (e.g., a 6D parameter that indicates rotation about three axes and translation along three axes).

At block 1860, processing logic determines a plane to project the second 3D model onto based on a result of the fitting. Processing logic then projects the second 3D model onto the determined plane, resulting in a sketch in 2D showing the contours of the objects in the area of interest from the second 3D model (e.g., the estimated future condition of the area of interest from the same camera perspective as in the frame). A 3D virtual model showing the estimated future condition of area of interest may be oriented such that the mapping of the 3D virtual model into the 2D plane results in a simulated 2D sketch of the area of interest from a same perspective from which the frame was taken.

At block 1865, processing logic extracts one or more features of the frame. Such extracted features may include, for example, a color map including colors of the objects in the area of interest without any contours of the objects. In one embodiment, each object is identified (e.g., using the segmentation information of the cropped frame), and color information is determined separately for each object. For example, an average color may be determined for each object and applied to an appropriate region occupied by the respective object. The average color for an object may be determined, for example, based on Gaussian smoothing the color information for each of the pixels that represents that object.

In at least one embodiment, optical flow is determined between the estimated future condition of the object or subject for the current frame and a previously generated frame (that also includes the estimated future condition of the object or subject). The optical flow may be determined in the image space or in a feature space.

At block 1870, processing logic inputs data into a generative model that then outputs a modified version of the current frame with the estimated future condition of the area of interest for the subject. The input data may include, for example, the current frame, one or more generated or synthetic previous frames, a mask of the area of interest for the current frame, a determined optical flow, a color map, a normals map, a sketch of the estimated future condition of the subject and/or area of interest (e.g., objects in the area of interest), and so on. A representation of the area of interest and/or subject in the new simulated frame may be based on the sketch of the estimated future condition of the subject/area of interest and a color of the subject/area of interest may be based on the color map.

At block 1875, processing logic determines whether there are additional frames of the video to process. If there are additional frames to process, then the method returns to block 1820 and a next frame is selected. If there are no further frames to process, the method proceeds to block 1880 and a modified video showing the estimated future condition of the subject/area of interest is output.

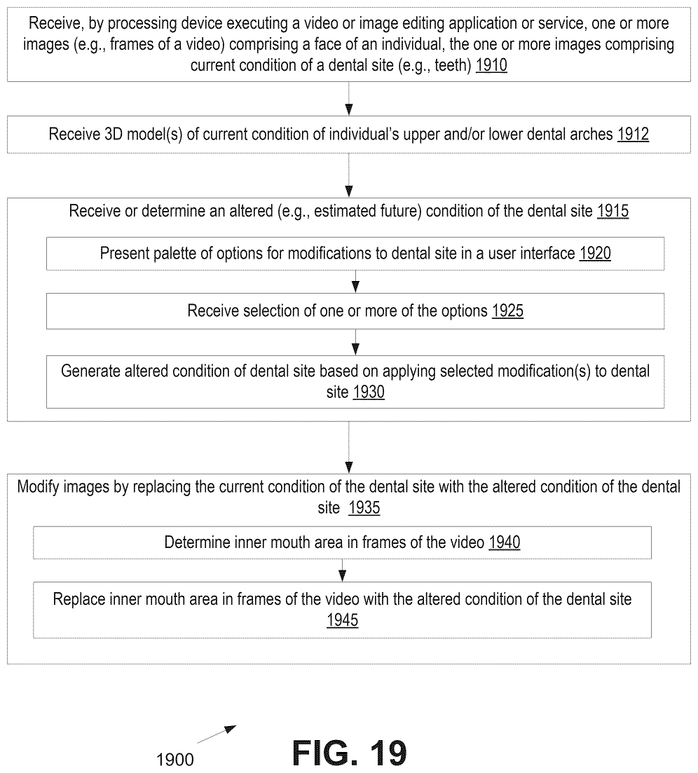

FIG. 19 illustrates a flow diagram for a method 1900 of generating images and/or video having one or more subjects with altered dentition using a video or image editing application or service, in accordance with an embodiment. Method 1900 may be performed, for example, by a processing device executing a video or image editing application on a client device. Method 1900 may also be performed by a service executing on a server machine or cloud-based infrastructure. Embodiments have largely been described with reference to generating modified videos. However, many of the techniques described herein may also be used to generate modified images. The generation of modified images is much simpler than the generation of modified videos. Accordingly, many of the operations described herein with reference to generating modified videos may be omitted in the generation of modified images.

In one embodiment, at block 1910 of method 1900 processing logic receives one or more images (e.g., frames of a video) comprising a face of an individual. The images or frames may include a face of an individual showing a current condition of a dental site (e.g., teeth) of the individual. The images or frames may be of the face, or may be of a greater scene that also includes the individual. In an example, a received video may be a movie that is to undergo post-production to modify the dentition of one or more characters in and/or actors for the movie. A received video or image may also be, for example, a home video or personal image that may be altered for an individual, such as for uploading to a social media site. In one embodiment, at block 1912 processing logic receives 3D models of the upper and/or lower dental arch of the individual. Alternatively, processing logic may generate such 3D models based on received intraoral scans and/or images (e.g., of smiles of the individual). In some cases, the 3D models may be generated from the images or frames received at block 1910.

If method 1900 is performed by a dentition alteration service, then the 3D models, images and/or frames (e.g., video) may be received from a remote device over a network connection. If method 1900 is performed by an image or video editing application executing on a computing device, then the 3D models, images and/or frames may be read from storage of the computing device or may be received from a remote device.

At block 1915, processing logic receives or determines an altered condition of the dental site. The altered condition of the dental site may be an estimated future condition of the dental site (e.g., after performance of orthodontic or prosthodontic treatment, or after failure to address one or more dental conditions) or some other altered condition of the dental site. Altered conditions of the dental site may include deliberate changes to the dental site that are not based on reality, any treatment, or any lack of treatment. For example, altered conditions may be to apply buck teeth the dental site, to apply a degraded state of the teeth, to file down the teeth to points, to replace the teeth with vampire teeth, to replace the teeth with tusks, to replace the teeth with shark teeth or monstrous teeth, to add caries to teeth, to remove teeth, to add rotting to teeth, to change a coloration of teeth, to crack or chip teeth, to apply malocclusion to teeth, and so on.

In one embodiment, processing logic provides a user interface for altering a dental site. For example, processing logic load the received or generated 3D models of the upper and/or lower dental arches and present the 3D models in the user interface. A user may then select individual teeth or groups of teeth and may move the one or more selected teeth (e.g., by dragging a mouse), may rotate the one or more selected teeth, may change one or more properties of the one or more selected teeth (e.g., changing a size, shape, color, presence of dental conditions such as caries, cracks, wear, stains, etc.), or perform other alterations to the selected one or more teeth. A user may also select to remove one or more selected teeth.

In one embodiment, at block 1920 processing logic provides a palette of options for modifications to the dental site (e.g., to the one or more dental arches) in the user interface. At block 1925 processing logic may receive selection of one or more modification to the dental site. At block 1930, processing logic may generate an altered condition of the dental site based on applying the selected one or more modifications to the dental site.

In one embodiment, a drop-down menu may include options for making global modifications to teeth without a need for the user to manually adjust the teeth. For example, a user may select to replace the teeth with the teeth of a selected type of animal (e.g., cat, dog, bat, shark, cow, walrus, etc.) or fantastical creature (e.g., vampire, ogre, orc, dragon, etc.). A user may alternatively or additionally select to globally modify the teeth by adding generic tooth rotting, caries, gum inflammation, edentulous dental arches, and so on. Responsive to user inputs selecting how to modify the teeth at the dental site (e.g., on the dental arches), processing logic may determine an altered state of the dental site and present the altered state on a display for user approval. Responsive to receiving approval of the altered dental site, the method may proceed to block 1935.

In one embodiment, a local video or image editing application is used on a client device to generate an altered condition of the dental site, and the altered condition of the dental site (e.g., 3D models of an altered state of an individual's upper and/or lower dental arches) is provided to an image or video editing service along with a video or image. In one embodiment, a client device interacts with a remote image or video editing service to update the dental site.

At block 1935, processing logic modifies the images and/or video by replacing the current condition of the dental site with the altered condition of the dental site. The modification of the images/video may be performed in the same manner described above in embodiments. In one embodiment, at block 1940 processing logic determines an inner mouth area in frames of the received video (or images), and at block 1945 processing logic replaces the inner mouth area in the frames of the received video (or images) with the altered condition of the dental site.

Once the altered image or video is generated, it may be stored, transmitted to a client device (e.g., if method 1900 is performed by a service executing on a server), output to a display, and so on.

In at least one embodiment, method 1900 is performed as part of, or as a service for, a video chat application or service. For example, any participant of a video chat meeting may choose to have their teeth altered, such as to correct their teeth or make any other desired alterations to their teeth. During the video chat meeting, processing logic may receive a stream of frames or images generated by a camera of the participant, may modify the received images as described, and may then provide the modified images to a video streaming service for distribution to other participants or may directly stream the modified images to the other participants (and optionally back to the participant whose dentition is being altered). This same functionality may also apply to avatars of participants. For example, avatars of participants may be generated based on an appearance of the participants, and the dentition for the avatars may be altered in the manner described herein.

In at least one embodiment, method 1900 is performed in a clinical setting to generate clinically-accurate post-treatment images and/or video of a patient's dentition. In other embodiments, method 1900 is performed in a non-clinical setting (e.g., for movie post-production, for end users of image and/or video editing software, for an image or video uploaded to a social media site, and so on). For such non-clinical settings, the 3D models of the current condition of the individual's dental arches may be generated using consumer grade intraoral scanners rather than medical grade intraoral scanners. Alternatively, for non-clinical settings the 3D models may be generated from 2D images as earlier described.

In at least one embodiment, method 1900 is performed as a service at a cost. Accordingly, a user may request to modify a video or image, and the service may determine a cost based, for example, on a size of the video or image, an estimated amount of time or resources to modify the video or image, and so on. A user may then be presented with payment options, and may pay for generation of the modified video or image. Subsequently, method 1900 may be performed. In at least one embodiment, impression data (e.g., 3D models of current and/or altered versions of dental arches of an individual) may be stored and re-used for new videos or photos taken or generated at a later time.

Method 1900 may be applied, for example, for use cases of modifying television, modifying videos, modifying movies, modifying 3D video (e.g., for augmented reality (AR) and/or virtual reality (VR) representations), and so on. For example, directors, art directors, creative directors, etc. for movies or videos or photos, etc. production may want to change the dentition of actors or people that shall appear in such a production. In at least one embodiment, method 1900 or other methods and/or techniques described herein may be applied to change the dentition of the one or more actors, people, etc. and cause that change to apply uniformly across the frames of the video or movie. This gives production companies more choices, for example, in selecting actors without caring about their dentition. Method 1900 may additionally or alternatively be applied for the editing of public and/or private images and/or videos, for a smile, aesthetic, facial and/or makeup editing system, and so on.

In treatment planning software, the position of the jaw pair (e.g., the 3D models of the upper and lower dental arches) is manually controlled by a user. 3D controls for viewing the 3D models is not intuitive, and can be cumbersome and difficult to use. In at least one embodiment, viewing of 3D models of a patient's jaw pair may be controlled based on selection of images and/or video frames. Additionally, selection and viewing of images and/or video frames may be controlled based on user manipulation of the 3D models of the dental arches. For example, a user may select a single frame that causes an orientation or pose of 3D models of both an upper and lower dental arch to be updated to match the orientation or pose of the patient's jaws in the selected image. In another example, a user may select a first frame or image that causes an orientation or pose of a 3D model of an upper dental arch to be updated to match the orientation of the upper jaw in the first frame or image, and may select a second frame or image that causes an orientation or pose of a 3D model of a lower dental arch to be updated to match the orientation of the lower jaw in the second frame or image.

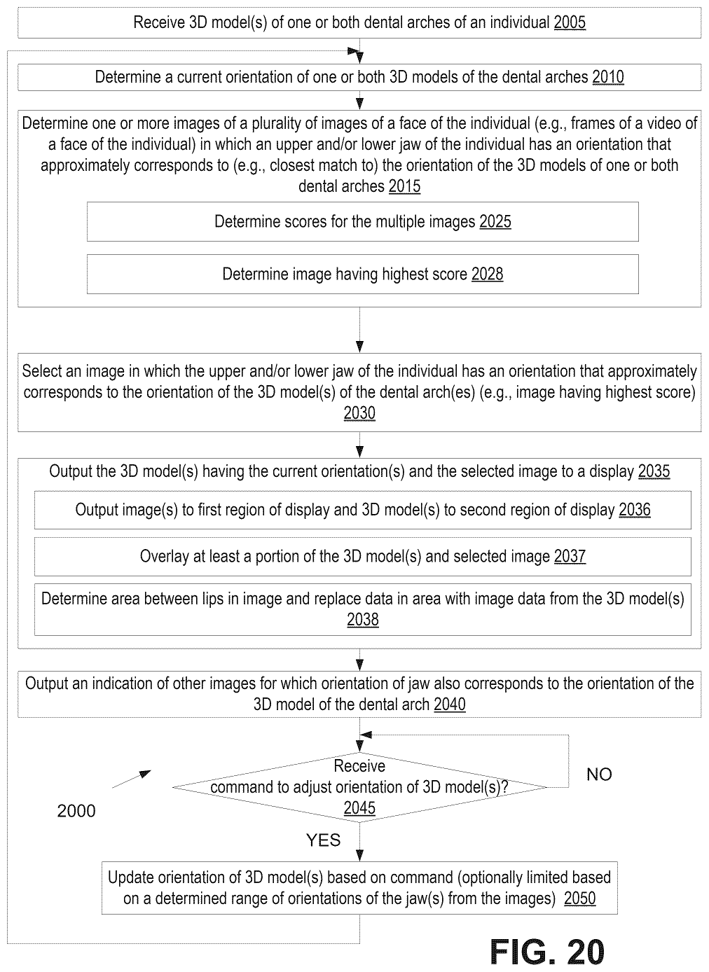

FIG. 20 illustrates a flow diagram for a method 2000 of selecting an image or frame of a video comprising a face of an individual based on an orientation of one or more 3D models of one or more dental arches, in accordance with an embodiment. Method 2000 may be performed by a processing logic that may comprise hardware (e.g., circuitry, dedicated logic, programmable logic, microcode, etc.), software (e.g., instructions run on a processing device), or a combination thereof. Various embodiments may be performed by a computing device 205 as described with reference to FIG. 2, client device 120 or image generation system 110 as described in connection with FIG. 1A, and/or by a computing device 3800 as shown in FIG. 38.

At block 2005 of method 2000, processing logic receives a 3D model of a patient's upper dental arch and/or a 3D model of the patient's lower dental arch. At block 2010, processing logic determines a current orientation of one or more 3D models of the dental arches. The orientation may be determined, for example, as one or more angles between a vector normal to a plane of a display in which the 3D model(s) are shown and a vector extending from a front of the dental arch(es). In one embodiment, a first orientation is determined for the 3D model of the upper dental arch and a second orientation is determined for the 3D model of the lower dental arch. For example, the bite relation between the upper and lower dental arch may be adjusted, causing the relative orientations of the 3D models for the upper and lower dental arches to change.

At block 2015, processing logic determines one or more images of a plurality of images of a face of the individual (e.g., frames of a video of a face of the individual) in which an upper and/or lower jaw (also referred to an upper and/or lower dental arches) of the individual has an orientation that approximately corresponds to (e.g., is a closest match to) the orientation of the 3D models of one or both dental arches. In at least one embodiment, processing logic may determine the orientations of the patient's upper and/or lower jaws in each image or frame in a pool of available images or frames of a video. Such orientations of the upper and lower jaws in images/frames may be determined by processing the images/frames to determine facial landmarks of the individual's face as described above. Properties such as head position, head orientation, face angle, upper jaw position, upper jaw orientation, upper jaw angle, lower jaw position, lower jaw orientation, lower jaw angle, etc. may be determined based on the facial landmarks. The orientations of the upper and/or lower jaw for each of the images may be compared to the orientations of the 3D model of the upper and/or lower dental arches. One or more matching scores may be determined for each comparison of the orientation of one or both jaws in an image and the orientation of the 3D model(s) at block 2025. An image (e.g., frame of a video) having a highest matching score may then be identified.

In an example, processing logic may determine for at least two frames of a video that the jaw has an orientation that approximately corresponds to the orientation of a 3D model of a dental arch (e.g., that have equivalent matchings scores of about a 90% match, above a 95% match, above a 99% match, etc.). Processing logic may further determine a time stamp of a previously selected frame of the video (e.g., for which the orientation of the jaw matched a previous orientation of the 3D model). Processing logic may then select from the at least two frames a frame having a time stamp that is closest to the timestamp associated with the previous selected frame.

In at least one embodiment, additional criteria may also be used to determine scores for images. For example, images may be scored based on parameters such as lighting conditions, facial expression, level of blurriness, time offset between the frame of a video and a previously selected frame of the video, and/or other criteria in addition to difference in orientation of the jaws between the image and the 3D model(s). For example, higher scores may be assigned to images having a greater average scene brightness or intensity, to images having a lower level of blurriness, and/or to frames having a smaller time offset as compared to a time of a previously selected frame. In at least one embodiment, these secondary criteria are used to select between images or frames that otherwise have approximately equivalent matching scores based on angle or orientation.

At block 2030, processing logic selects an image in which the upper and/or lower jaw of the individual has an orientation that approximately corresponds to the orientation(s) of the 3D model(s) of the upper and/or lower dental arches. This may include selecting the image (e.g., video frame) having the highest determined score.

In some instances, there may be no image for which the orientation of the upper and/or lower jaws match the orientation of the 3D models of the upper and/or lower dental arches. In such instances, a closest match may be selected. Alternatively, in some instances processing logic may generate a synthetic image corresponding to the current orientation of the 3D models of the upper and/or lower dental arches, and the synthetic image may be selected. In at least one embodiment, a generative model may be used to generate a synthetic image. Examples of generative models that may be used include a generative adversarial network (GAN), a neural radiance field (Nerf), an image diffuser, a 3D gaussian splatting model, a variational autoencoder, or a large language model. A user may select whether or not to use synthetic images in embodiments. In at least one embodiment, processing logic determines whether any image has a matching score that is above a matching threshold. If no image has a matching score above the matching threshold, then a synthetic image may be generated.

The generation of a synthetic image may be performed using any of the techniques described hereinabove, such as by a generative model and/or by performing interpolation between two existing images. For example, processing logic may identify a first image in which the upper jaw of the individual has a first orientation and a second image in which the upper jaw of the individual has a second orientation, and perform interpolation between the first and second image to generate a new image in which the orientation of the upper jaw approximately matches the orientation of the 3D model of the upper dental arch.

At block 2035, processing logic outputs the 3D models having the current orientation(s) and the selected image to a display. In one embodiment, at block 2036 the image is output to a first region of the display and the 3D models are output to a second region of the display. In one embodiment, at block 2037 at least a portion of the 3D models is overlaid with the selected image. This may include overlaying the image over the 3D models, but showing the 3D image with some level of transparency so that the 3D models are still visible. This may alternatively include overlaying the 3D models over the image, but showing the 3D models with some level of transparency so that the underlying image is still visible. In either case, the mouth region of the individual may be determined in the image as previously described, and may be registered with the 3D model so that the 3D model is properly positioned relative to the image. In another embodiment, processing logic may determine the mouth region in the image, crop the mouth region, then update the mouth region by filling it in with a portion of the 3D model(s).

In some instances, there may be multiple images that have a similar matching score to the 3D models of the upper and/or lower dental arches. In such instances, processing logic may provide some visual indication or mark to identify those other images that were not selected but that had similar matching scores to the selected image. A user may then select on any of those other images (e.g., from thumbnails of the images or from highlighted points on a scroll bar or time bar indicating time stamps of those images in a video), responsive to which the newly selected image may be shown (e.g., may replace the previously selected image).

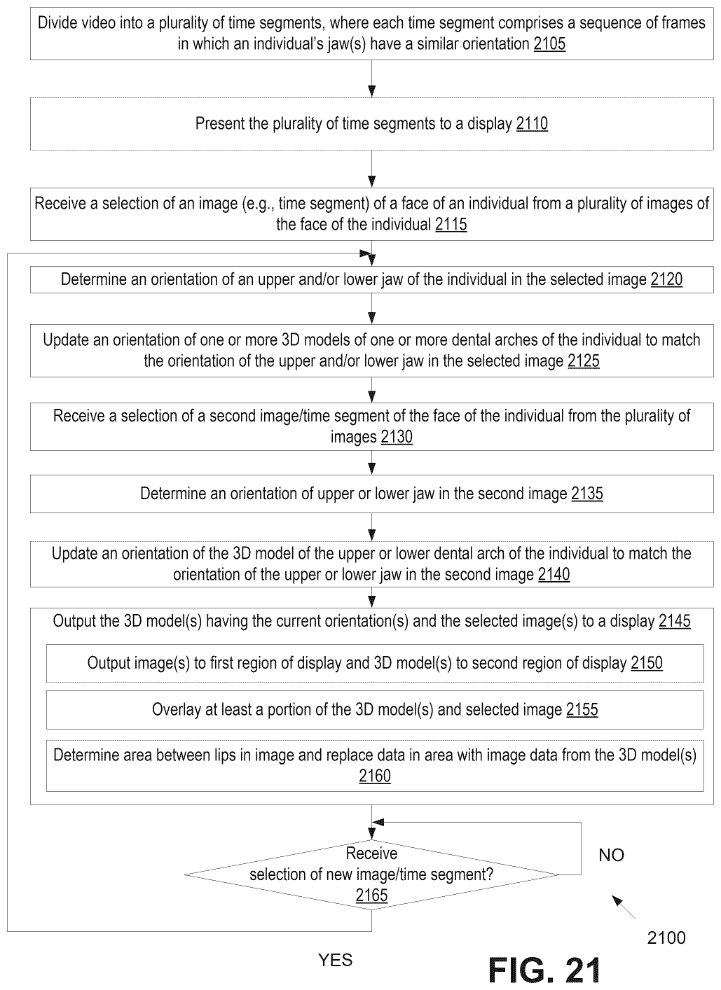

In at least one embodiment, processing logic divides a video into a plurality of time segments, where each time segment comprises a sequence of frames in which the upper and/or lower jaw of the individual has an orientation that deviates by less than a threshold amount (e.g., frames in which the jaw orientation deviates by less than 1 degree). Alternatively, or additionally, time segments may be divided based on time. For example, each time segment may contain all of the frames within a respective time interval (e.g., a first time segment for 0-10 seconds, a second time segment for 11-20 seconds, and so on). The multiple time segments may then be displayed. For example, the different time segments may be shown in a progress bar of the video. A user may select a time segment. Processing logic may receive the selection, determine an orientation of the upper and/or lower jaw in the time segment, and update an orientation of the 3D model of the dental arch to match the orientation of the jaw in the selected time segment. A similar sequence of operations is described below with reference to FIG. 21.

At block 2045, processing logic may receive a command to adjust an orientation of one or both 3D models of the dental arches. If no such command is received, the method may return to block 2045. If a command to adjust the orientation of the 3D model of the upper and/or lower dental arch is received, the method continues to block 2050.

At block 2050, processing logic updates an orientation of one both 3D models of the dental arches based on the command. In at least one embodiment, processing logic may have processed each of the available images (e.g., all of the frames of a video), and determined one or more orientation or angle extremes (e.g., rotational angle extremes about one or more axes) based on the orientations of the upper and/or lower jaws in the images. In at least one embodiment, processing logic may restrict the possible orientations that a user may update the 3D models to based on the determined extremes. This may ensure that there will be an image having a high matching score to any selected orientation of the upper and/or lower dental arches. Responsive to updating the orientation of the 3D model or models of the upper and/or lower dental arches, the method may return to block 2010 and the operations of blocks 2010-2045 may be repeated.

FIG. 21 illustrates a flow diagram for a method 2100 of adjusting an orientation of one or more 3D models of one or more dental arches based on a selected image or frame of a video comprising a face of an individual, in accordance with an embodiment. Method 2100 may be performed by a processing logic that may comprise hardware (e.g., circuitry, dedicated logic, programmable logic, microcode, etc.), software (e.g., instructions run on a processing device), or a combination thereof. Various embodiments may be performed by a computing device 205 as described with reference to FIG. 2, one or more devices described in connection with FIG. 1A, and/or by a computing device 3800 as shown in FIG. 38.

In at least one embodiment, at block 2105 of method 2100 processing logic divides a video into a plurality of time segments, where each time segment comprises a sequence of frames in which an individual's upper and/or lower jaw have a similar orientation. In such an embodiment, different time segments may have different lengths. For example, one time segment may be 5 seconds long and another time segment may be 10 seconds long. Alternatively, or additionally, the video may be divided into time segments based on a time interval (e.g., a time segment may be generated for every 10 seconds of the video, for every 5 seconds of the video, etc.). In other embodiments, time segments may not be implemented, and each frame is treated separately. For example, individual frames of a video may be selected rather than time segments. In another example, as a video plays, 3D mesh or model orientations of the upper and/or lower dental arches update continuously in accordance with the orientations of the upper and/or lower jaw in the individual frames of the video. At block 2110, the different time segments may be presented to a display. For example, a time slider for a movie may be output, and the various time segments may be shown in the time slider.

At block 2115, processing logic receives a selection of an image (e.g., a video frame) of a face of an individual from a plurality of available images. This may include receiving a selection of a frame of a video. For example, a user may watch or scroll through a video showing a face of an individual until the face (or an upper and/or lower jaw of the face) has a desired viewing angle (e.g., orientation). For example, a user, may select a point on a time slider for a video, and the video frame at the selected point on the time slider may be selected. In some cases, a user may select a time segment (e.g., by clicking on the time segment from the time slider for a video) rather than selecting an individual image or frame. Responsive to receiving a selection of a time segment, processing logic may select a frame representative of the time segment. The selected frame may be a frame in the middle of the time segment, a frame from the time segment having a highest score, or a frame that meets some other criterion.

At block 2120, processing logic determines an orientation (e.g., viewing angle) of an upper dental arch or jaw, a lower dental arch or jaw, or both an upper dental arch and a lower dental arch in the selected image or frame. At block 2125, processing logic updates an orientation of a 3D model of an upper dental arch based on the orientation of the upper jaw in the selected image, updates an orientation of a 3D model of a lower dental arch based on the orientation of the lower jaw in the selected image, updates the orientation of the 3D models of both the upper and lower dental arch based on the orientation of the upper jaw in the image, updates the orientation of the 3D models of both the and lower dental arch based on the orientation of the lower jaw in the image, or updates the orientation of the 3D model of the upper dental arch based on the orientation of the upper jaw in the image and updates the orientation of the 3D model of the lower dental arch based on the orientation of the lower jaw in the image. In at least one embodiment, a user may select which 3D models they want to update based on the selected image and/or whether to update the orientations of the 3D models based on the orientation of the upper and/or lower jaw in the image. In at least one embodiment, processing logic may provide an option to automatically update the orientations of one or both 3D models of the dental arches based on the selected image. Processing logic may also provide an option to update the orientation (e.g., viewing angle) of the 3D model or models responsive to the user pressing a button or otherwise actively providing an instruction to do so.

In at least one embodiment, processing logic may additionally control a position (e.g., center or view position) of one or both 3D models of dental arches, zoom settings (e.g., view size) of one or both 3D models, etc. based on a selected image. For example, the 3D models may be scaled based on the size of the individual's jaw in the image.

In an embodiment, at block 2130 processing logic receives a selection of a second image or time segment of the face of the individual. At block 2135, processing logic determines an orientation of the upper and/or lower jaw of the individual in the newly selected image. At block 2140, processing logic may update an orientation of the 3D model of the upper dental arch and/or an orientation of the 3D model of the lower dental arch to match the orientation of the upper and/or lower jaw in the selected first image.

In an example, for blocks 2115, 2120 and 2125, a user may have selected to update an orientation of just the upper dental arch, and the orientation of the 3D model for the upper dental arch may be updated based on the selected image. Then for blocks 2130, 2135 and 2140 a user may have selected to update an orientation of just the lower dental arch, and the orientation of the 3D model for the lower dental arch may be updated based on the selected second image.

In an example, processing logic may provide an option to keep one jaw/dental arch fixed on the screen, and may only apply a relative movement to the other jaw based on a selected image. This may enable a doctor or patient to focus on a specific jaw for a 3D scene fixed on a screen and observe how the other jaw moves relative to the fixed jaw. For example, processing logic may provide functionality of a virtual articulator model or jaw motion device, where a movement trajectory is dictated by the selected images.

At block 2145, processing logic outputs the 3D models having the current orientation(s) and the selected image to a display. In one embodiment, at block 2150 the image is output to a first region of the display and the 3D models are output to a second region of the display. In one embodiment, at block 2155 at least a portion of the 3D models is overlaid with the selected image. This may include overlaying the image over the 3D models, but showing the 3D image with some level of transparency so that the 3D models are still visible. This may alternatively include overlaying the 3D models over the image, but showing the 3D models with some level of transparency so that the underlying image is still visible. In either case, the mouth region of the individual may be determined in the image as previously described, and may be registered with the 3D model so that the 3D model is properly positioned relative to the image. In another embodiment, processing logic may determine the mouth region in the image, crop the mouth region, then update the mouth region by filling it in with a portion of the 3D model(s). In at least one embodiment, processing logic determines other frames of a video in which the orientation (e.g., camera angle) for the upper and/or lower jaw match or approximately match the orientation for the upper and/or lower jaw in the selected frame. Processing logic may then output indications of the other similar frames, such as at points on a time slider for a video. In at least one embodiment, a user may scroll through the different similar frames and/or quickly select one of the similar frames.

At block 2165, processing logic may determine whether a selection of a new image or time segment has been received. If no new image or time segment has been received, the method may repeat block 2165. If a new image (e.g., frame of a video) or time segment is received, the method may return to block 2120 or 2135 for continued processing. This may include playing a video, and continuously updating the orientations of the 3d models for the upper and/or lower dental arches based on the frames of the video as the video plays.

In at least one embodiment, method 2000 and 2100 may be used together by, for example, treatment planning logic 220 and/or dentition viewing logic 222. Accordingly, a user interface may enable a user to update image/frame selection based on manipulating 3D models of dental arches, and may additionally enable a user to manipulate 3D models of dental arches based on selection of images/frames. The operations of methods 2000 and 2100 may be performed online or in real time during development of a treatment plan. This allows users to use the input video as an additional asset in designing treatment plans.

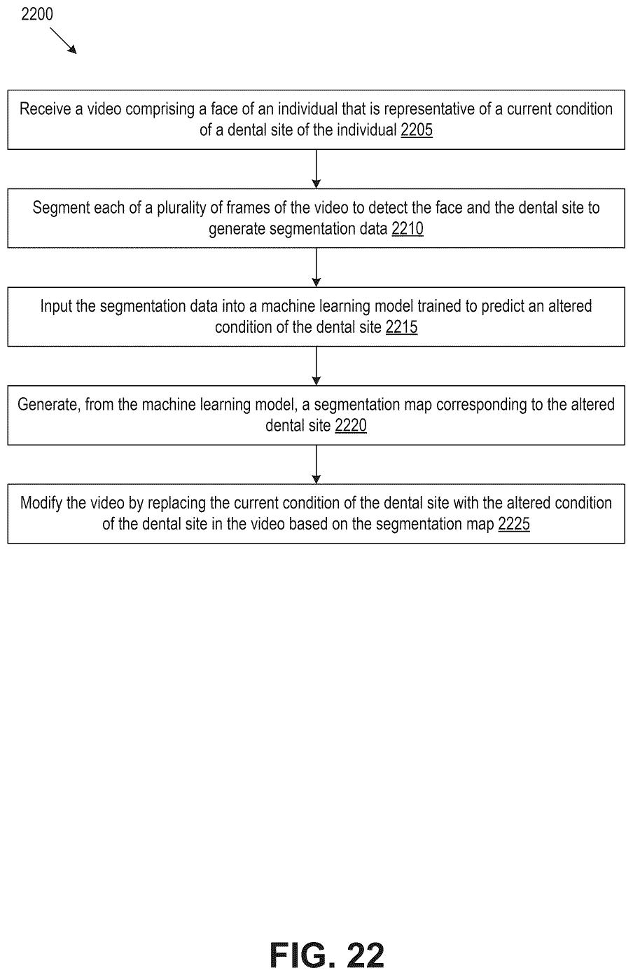

FIG. 22 illustrates a flow diagram for a method 2200 of modifying a video to include an altered condition of a dental site, in accordance with an embodiment. At block 2205 of method 2200, processing logic receives a video comprising a face of an individual that is representative of a current condition of a dental site of the individual (e.g., a current condition of the individual's teeth). For example, the individual may be a patient who desires to see a prediction of how their teeth may look after undergoing a dental treatment plan. In at least one embodiment, the video is captured by a mobile device of the individual. In at least one embodiment, the processing logic may be implemented locally on the individual's mobile device, which receives and processes the captured video. In other embodiments, the processing logic is implemented by a different device that the individual's mobile device, but receives the captured video from the individual's mobile device.

At block 2210, processing logic generates segmentation data by performing segmentation (e.g., via segmenter 318 of FIG. 3A) on each of a plurality of frames of the video to detect the face and the dental site. Each tooth in the dental site may be identified as a separate object and labeled. Additionally, upper and/or lower gingiva may also be identified and labeled. In at least one embodiment, an inner mouth area (e.g., a mouth area between upper and lower lips of an open mouth) is also determined by the segmentation. In at least one embodiment, a space between upper and lower teeth is also determined by the segmentation. In at least one embodiment, the segmentation is performed by a trained machine learning model. The segmentation may result in the generation of one or more masks that provide useful information for generation of a synthetic image that will show an estimated future condition of a dental site together with a remainder of a frame of a video. Generated masks may include an inner mouth area mask that includes, for each pixel of the frame, an indication as to whether that pixel is part of an inner mouth area. Generated masks may include a map that indicates the space within an inner mouth area that shows the space between teeth in the upper and lower dental arch. Other maps may also be generated. Each map may include one or more sets of pixel locations (e.g., x and y coordinates for pixel locations), where each set of pixel locations may indicate a particular class of object or a type of area.

In at least one embodiment, the plurality of frames are selected for segmentation via periodically sampling frames of the video, for example, to improve the speed at which segmentation data is generated. For example, periodically sampling the frames comprises selecting every 2nd to 10th frame.

At block 2215, processing logic inputs the segmentation data into a machine learning model trained to predict an altered condition of the dental site. In at least one embodiment, the altered condition of the dental site comprises a deteriorated condition of the dental site that is expected if no treatment is performed. In at least one embodiment, the altered condition is an estimated future condition of the dental site. In at least one embodiment, the a machine learning model comprises a GAN, an autoencoder, a variational autoencoder, or a combination thereof. For example, the machine learning model may utilize an autoencoder using similar operations as described in U.S. Provisional Patent Application No. 63/535,502, filed Aug. 30, 2023, the disclosure of which is hereby incorporated by reference herein in its entirety. In at least one embodiment, the altered condition of the dental site corresponds to a post-treatment condition of one or more teeth of the dental site. The post-treatment condition may be clinically accurate and may be, in some embodiments, determined based on input from a dental practitioner. In at least one embodiment, the machine learning model can be trained with RGB images, contour maps, other modality maps, or a combination thereof.

At block 2220, processing logic generates, from the trained machine learning model, a segmentation map corresponding to the altered dental site. As used herein, the term “segmentation map” refers to data descriptive of a transformation from a segmented image to a modified segmented image such that modified features will be present in the resulting modified segmented images for different inputted segmented images.

In at least one embodiment, the machine learning model may be trained based on images of patients' dental sites before and after a dental treatment plan. Training may additionally include, for example, receiving a treatment plan that includes 3D models of a current condition of a patient's dental arches and 3D models of a future condition of the patient's dental arches as they are expected to be after treatment. This may additionally or alternatively include receiving intraoral scans and using the intraoral scans to generate 3D models of a current condition of the patient's dental arches. The 3D models of the current condition of the patient's dental arches may then be used to generate post-treatment 3D models or other altered 3D models of the patient's dental arches. Additionally, or alternatively, a rough estimate of a 3D model of an individual's current dental arches may be generated based on the received video itself. Treatment planning estimation software or other dental alteration software may then process the generated 3D models to generate additional 3D models of an estimated future condition or other altered condition of the individual's dental arches. In one embodiment, the treatment plan is a detailed and clinically accurate treatment plan generated based on a 3D model of a patient's dental arches as produced based on an intraoral scan of the dental arches. Such a treatment plan may include 3D models of the dental arches at multiple stages of treatment. In one embodiment, the treatment plan is a simplified treatment plan that includes a rough 3D model of a final target state of a patient's dental arches. In various embodiments, one or more 2D images may be rendered from the 3D models and used as training data. In at least one embodiment, the machine learning model is trained to disentangle pose information and dental site information from each frame, and may be trained to process the segmentation data in image space, segmentation space, or a combination thereof.

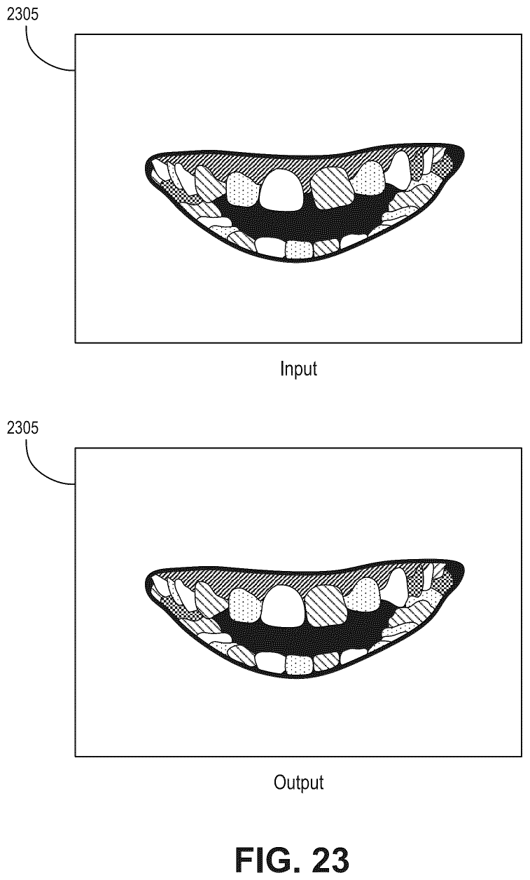

FIG. 23 illustrates an input segmented image 2305 corresponding to the current condition of the individual's dental site. In at least one embodiment, pixels of the mouth area represented by the segmented image 2305 may be classified as inner mouth area and outer mouth area, and may further be classified as a particular tooth or an upper or lower gingiva. Separate teeth may each be identified and be assigned a unique tooth identifier in one or more embodiments. Processing logic may utilize the segmentation map to produce an output segmented image 2310 for which features of the dental site are modified, for example, to correspond to a modified condition of the dental site.

Referring back to FIG. 22, at block 2225, processing logic modifies the received video by replacing the current condition of the dental site with the altered condition (e.g., the estimated future condition) of the dental site in the video based on the segmentation map. This may include, in at least one embodiment, determining the inner mouth area in frames of the video, and then replacing the inner mouth area in each of the frames with the altered condition of the dental site. In at least one embodiment, a generative model receives data from a current frame and optionally one or more previous frames and data from the 3D models of the estimated future condition or other altered condition of the dental arches, and outputs a synthetic or modified version of the current frame in which the original dental site has been replaced with the altered condition of the dental site.

In at least one embodiment, processing logic determines an image quality score for frames of the modified video, and whether any of the frames have an image quality score that fails to meet an image quality criteria. In at least one embodiment, processing logic determines whether there are any sequences of consecutive frames in the modified video in which each of the frames of the sequence fails to satisfy the image quality criteria. If one or more frames (or a sequence of frames including at least a threshold number of frames) is identified that fails to meet the image quality criteria, the one or more identified frames may be removed. If all of the frames meet the image quality criteria (or no sequence of frames including at least a threshold number of frames fails to meet the image quality criteria), the modified video may be deemed suitable for displaying to the individual via their mobile device or other display device.

In at least one embodiment, processing logic removes one or more frames (e.g., a sequence of frames) that failed to satisfy the image quality criteria. Removing a sequence of frames may cause the modified video to become jumpy or jerky between some remaining frames. Accordingly, in at least one embodiment, processing logic generates replacement frames for the removed frames. The replacement frames may be generated, for example, by inputting remaining frames before and after the removed frames into a generative model (e.g., a generator of a GAN), which may output one or more interpolated intermediate frames. In one embodiment, processing logic determines an optical flow between a pair of frames that includes a first frame that occurs before the removed sequence of frames (or individual frame) and a second frame that occurs after the removed sequence of frames (or individual frame). In one embodiment, the generative model determines optical flows between the first and second frames and uses the optical flows to generate replacement frames that show an intermediate state between the pair of input frames. In one embodiment, the generative model includes a layer that generates a set of features in a feature space for each frame in a pair of frames, and then determines an optical flow between the set of features in the feature space and uses the optical flow in the feature space to generate a synthetic frame or image. In one embodiment, one or more additional synthetic or interpolated frames may also be generated by the generative model. In at least one embodiment, processing logic determines, for each pair of sequential frames (which may include a received frame and/or a simulated frame), a similarity score and/or a movement score. Processing logic may then determine whether the similarity score and/or movement score satisfies a stopping criterion. If for any pair of frames a stopping criterion is not met, one or more additional simulated frames are generated.

In at least one embodiment, processing logic further determines color information for an inner mouth area in at least one frame of the plurality of frames and/or determines contours of the altered condition of the dental site. The color information, the determined contours, the at least one frame, information on the inner mouth area, or a combination thereof, may be input into a generative model configured to output an altered version of the at least one frame. In at least one embodiment, an altered version of a prior frame is further into the generative model to enable the generative model to output a post-treatment version of the at least one frame that is temporally stable with the prior frame. In at least one embodiment, processing logic transforms the prior from and the at least one frame into a feature space, and determines an optical flow between the prior frame and the at least one frame in the feature space. The generative model may further use the optical flow in the feature space to generate the altered version of the at least one frame.

In at least one embodiment, processing logic outputs a modified video showing the individual's face with an altered condition (e.g., estimated future condition) of the dental site rather than the current condition of the dental site. The frames in the modified video may be temporally stable and consistent with one or more previous frames (e.g., one or more teeth in the modified video are different from the one or more teeth in an original version of the video and are temporally stable and consistent between frames of the modified video). In at least one embodiment, modifying the video comprises, for at least one frame of the video, determining an area of interest corresponding to a dental condition in the at least one frame, and replacing initial data for the area of interest with replacement data determined from the altered condition of the dental site.

In at least one embodiment, processing logic, if implemented locally on the individual's mobile device, causes the mobile device to present the modified video for display. In such embodiments, the modified video may be displayed adjacent to the original video and synchronized with the original video, displayed as an overlay or underlay for which the individual can adjust and transition between the original video and the modified video, or displayed in any other suitable fashion. In at least one embodiment, if processing logic is implemented remotely from the mobile device, processing logic transmits the modified video to the mobile device for display.

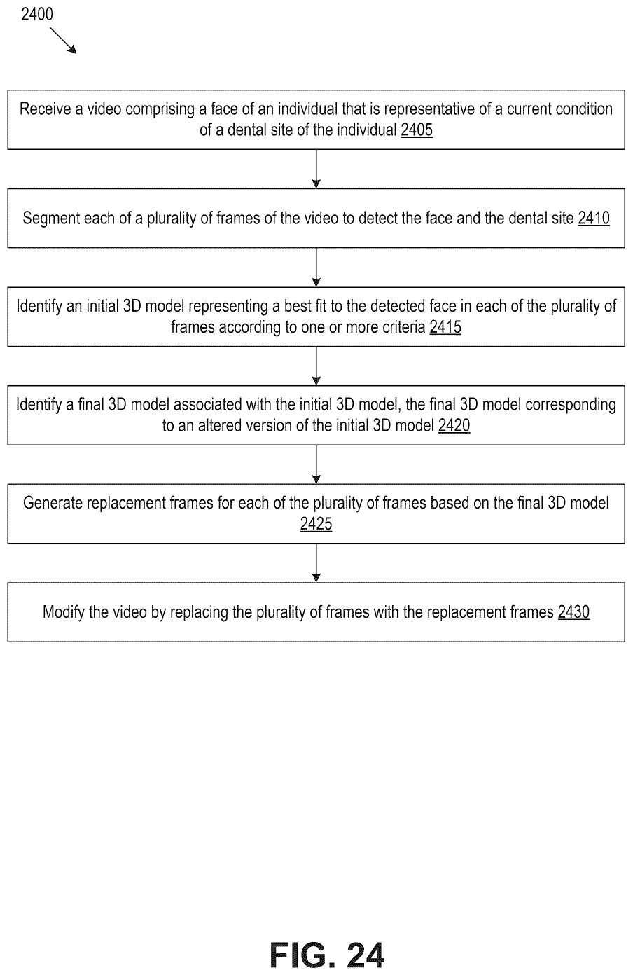

FIG. 24 illustrates a flow diagram for a method 2400 of modifying a video based on a 3D model fitting approach to include an altered condition of a dental site, in accordance with an embodiment. At block 2405 of method 2400, processing logic receives a video comprising a face of an individual that is representative of a current condition of a dental site of the individual (e.g., a current condition of the individual's teeth). For example, the individual may be a patient who desires to see a prediction of how their teeth may look after undergoing a dental treatment plan. In at least one embodiment, the video is captured by a mobile device of the individual. In at least one embodiment, the processing logic may be implemented locally on the individual's mobile device, which receives and processes the captured video. In other embodiments, the processing logic is implemented by a different device that the individual's mobile device, but receives the captured video from the individual's mobile device.

At block 2410, processing logic generates segmentation data by performing segmentation (e.g., via segmenter 318 of FIG. 3A) on each of a plurality of frames of the video to detect the face and the dental site. Each tooth in the dental site may be identified as a separate object and labeled. Additionally, upper and/or lower gingiva may also be identified and labeled. In at least one embodiment, an inner mouth area (e.g., a mouth area between upper and lower lips of an open mouth) is also determined by the segmentation. In at least one embodiment, a space between upper and lower teeth is also determined by the segmentation. In at least one embodiment, the segmentation is performed by a trained machine learning model. The segmentation may result in the generation of one or more masks that provide useful information for generation of a synthetic image that will show an estimated future condition of a dental site together with a remainder of a frame of a video. Generated masks may include an inner mouth area mask that includes, for each pixel of the frame, an indication as to whether that pixel is part of an inner mouth area. Generated masks may include a map that indicates the space within an inner mouth area that shows the space between teeth in the upper and lower dental arch. Other maps may also be generated. Each map may include one or more sets of pixel locations (e.g., x and y coordinates for pixel locations), where each set of pixel locations may indicate a particular class of object or a type of area.

In at least one embodiment, the plurality of frames are selected for segmentation via periodically sampling frames of the video, for example, to improve the speed at which segmentation data is generated. For example, periodically sampling the frames comprises selecting every 2nd to 10th frame.

At block 2415, processing logic identifies, within a 3D model library, an initial 3D model representing a best fit to the detected face in each of the plurality of frames according to one or more criteria. The 3D model library (e.g., stored in the data store 210) may include a plurality of 3D models generated from 3D facial scans, with each 3D model further comprising a 3D representation of a dental site corresponding to intraoral scan data. In at least one embodiment, each of the 3D models of the model library comprises a representation of a jaw with dentition. For example, intraoral scan data may be registered to a 3D facial scan corresponding to the same patient from which the intraoral scan data was obtained.

In at least one embodiment, identifying the initial 3D model representing the best fit to the detected face comprises applying a rigid fitting algorithm, a non-rigid fitting algorithm, or a combination of both. Processing logic may perform the fitting of candidate 3D models, for example, by identifying facial landmarks in a frame of the video, and determines a pose of the face based on the landmarks. In at least one embodiment, processing logic applies an initialization step based on an optimization that minimizes the distance between the centers of 2D tooth segmentations and the centers 2D projections of the 3D tooth models. In at least one embodiment, processing logic determines a relative position of a 3D model of the upper dental arch to the frame based at least in part on the determined pose of the face, determined correspondences between teeth in the 3D model of the upper dental arch and teeth in an inner mouth area of the frame, and information on fitting of the 3D model(s) to the previous frame or frames. The upper dental arch may have a fixed position relative to certain facial features for a given individual. Accordingly, it may be much easier to perform fitting of the 3D model of the upper dental arch to the frame than to perform fitting of the lower dental arch to the frame. As a result, the 3D model of the upper dental arch may first be fit to the frame before the 3D model of the lower dental arch is fit to the frame. The fitting may be performed by minimizing a cost function that includes multiple cost terms, as is described in detail herein above.

In at least one embodiment, processing logic determines a chin position of the face based on the determined facial landmarks. In at least one embodiment, processing logic receives an articulation model that constrains the possible positions of the lower dental arch to the upper dental arch. In at least one embodiment, processing logic determines a relative position of the 3D model of the lower dental arch to the frame based at least in part on the determined position of the upper dental arch, correspondences between teeth in the 3D model of the lower dental arch and teeth in the inner mouth area of the frame, information on fitting of the 3D models to the previous frame, the determined chin position, and/or the articulation model. The fitting may be performed by minimizing a cost function that includes multiple cost terms.

In at least one embodiment, applying a non-rigid fitting algorithm comprises applying one or more non-rigid adjustments to the initial 3D model. Such non-rigid adjustments may include, without limitation: jaw level adjustments based on one or more of a jaw height, a jaw width, or a jaw depth; and/or tooth level adjustments based on one or more of a jaw height, a jaw width, or a sharpness of tooth curves.

At block 2420, processing logic identifies, within the 3D model library, a final 3D model associated with the initial 3D model, the final 3D model corresponding to a version of the initial 3D model representing an altered condition of the dental site. In at least one embodiment, the altered condition of the dental site corresponds to a post-treatment condition of one or more teeth of the dental site. In at least one embodiment, the post-treatment condition is clinically accurate and was determined based on input from a dental practitioner. In at least one embodiment, each model in the 3D library may have one or more associated versions of that model that has been modified in some way, for example, to reflect changes to the dentition as a result of implementing a treatment plan. For example, each final 3D model corresponds to a scan of a patient after undergoing orthodontic treatment and the associated initial 3D model corresponds to a scan of the patient prior to undergoing the orthodontic treatment. The final 3D model selected may correspond to a modified version that depends on the output that the individual desires to see (e.g., the individual wishes to see the results of a treatment plan, the results of non-treatment, etc.). In at least one embodiment, one or more of the final 3D models may have been generated previously based on modifications to an initial 3D model based a predicted outcome of a dental treatment plan, as discussed elsewhere in this disclosure.

At block 2425, processing logic generates replacement frames for each of the plurality of frames based on the final 3D model. In at least one embodiment, processing logic generates the replacement frames by modifying each frame to include a rendering of the dental site of the predicted 3D model. In at least one embodiment, segmentation data previously generated may be used to mask or select only the portions of the rendered 3D model that correspond to the altered representation of the dental site.

At block 2430, processing logic modifies the received video by replacing the plurality of frames with the replacement frames. In at least one embodiment, processing logic determines an image quality score for frames of the modified video, and whether any of the frames have an image quality score that fails to meet an image quality criteria. In at least one embodiment, processing logic determines whether there are any sequences of consecutive frames in the modified video in which each of the frames of the sequence fails to satisfy the image quality criteria. If one or more frames (or a sequence of frames including at least a threshold number of frames) is identified that fails to meet the image quality criteria, the one or more identified frames may be removed. If all of the frames meet the image quality criteria (or no sequence of frames including at least a threshold number of frames fails to meet the image quality criteria), the modified video may be deemed suitable for displaying to the individual via their mobile device or other display device.

In at least one embodiment, processing logic removes one or more frames (e.g., a sequence of frames) that failed to satisfy the image quality criteria. Removing a sequence of frames may cause the modified video to become jumpy or jerky between some remaining frames. Accordingly, in at least one embodiment, processing logic generates replacement frames for the removed frames. The replacement frames may be generated, for example, by inputting remaining frames before and after the removed frames into a generative model (e.g., a generator of a GAN), which may output one or more interpolated intermediate frames. In one embodiment, processing logic determines an optical flow between a pair of frames that includes a first frame that occurs before the removed sequence of frames (or individual frame) and a second frame that occurs after the removed sequence of frames (or individual frame). In one embodiment, the generative model determines optical flows between the first and second frames and uses the optical flows to generate replacement frames that show an intermediate state between the pair of input frames. In one embodiment, the generative model includes a layer that generates a set of features in a feature space for each frame in a pair of frames, and then determines an optical flow between the set of features in the feature space and uses the optical flow in the feature space to generate a synthetic frame or image. In one embodiment, one or more additional synthetic or interpolated frames may also be generated by the generative model. In at least one embodiment, processing logic determines, for each pair of sequential frames (which may include a received frame and/or a simulated frame), a similarity score and/or a movement score. Processing logic may then determine whether the similarity score and/or movement score satisfies a stopping criterion. If for any pair of frames a stopping criterion is not met, one or more additional simulated frames are generated.

In at least one embodiment, processing logic further determines color information for an inner mouth area in at least one frame of the plurality of frames and/or determines contours of the altered condition of the dental site. The color information, the determined contours, the at least one frame, information on the inner mouth area, or a combination thereof, may be input into a generative model configured to output an altered version of the at least one frame. In at least one embodiment, an altered version of a prior frame is further into the generative model to enable the generative model to output a post-treatment version of the at least one frame that is temporally stable with the prior frame. In at least one embodiment, processing logic transforms the prior from and the at least one frame into a feature space, and determines an optical flow between the prior frame and the at least one frame in the feature space. The generative model may further use the optical flow in the feature space to generate the altered version of the at least one frame.

In at least one embodiment, processing logic outputs a modified video showing the individual's face with an altered condition (e.g., estimated future condition) of the dental site rather than the current condition of the dental site. The frames in the modified video may be temporally stable and consistent with one or more previous frames (e.g., one or more teeth in the modified video are different from the one or more teeth in an original version of the video and are temporally stable and consistent between frames of the modified video). In at least one embodiment, modifying the video comprises, for at least one frame of the video, determining an area of interest corresponding to a dental condition in the at least one frame, and replacing initial data for the area of interest with replacement data determined from the altered condition of the dental site.

In at least one embodiment, processing logic, if implemented locally on the individual's mobile device, causes the mobile device to present the modified video for display. In such embodiments, the modified video may be displayed adjacent to the original video and synchronized with the original video, displayed as an overlay or underlay for which the individual can adjust and transition between the original video and the modified video, or displayed in any other suitable fashion. In at least one embodiment, if processing logic is implemented remotely from the mobile device, processing logic transmits the modified video to the mobile device for display.

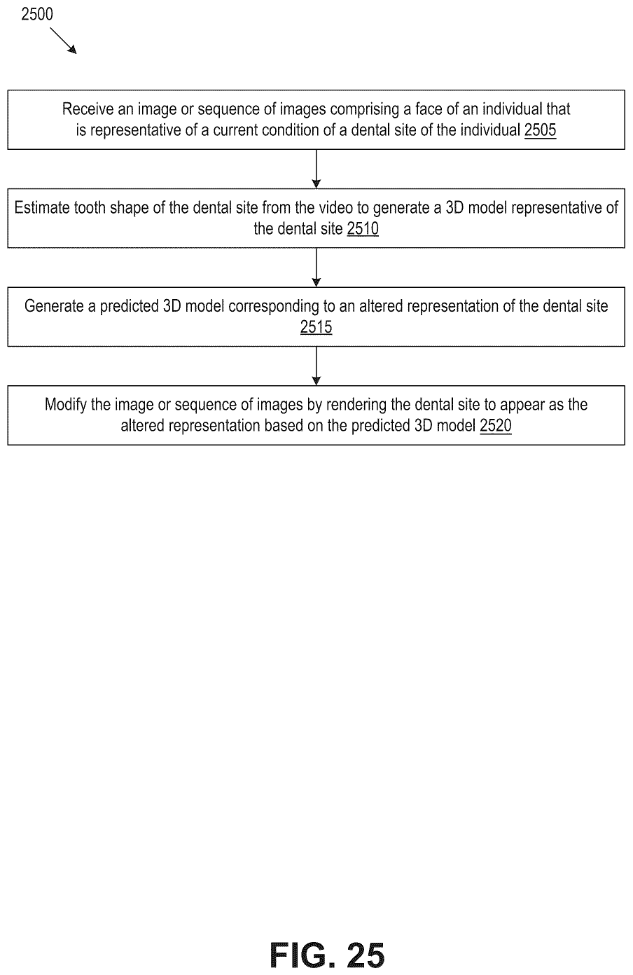

FIG. 25 illustrates a flow diagram for a method 2500 of modifying a video based on a non-rigid 3D model fitting approach to include an altered condition of a dental site, in accordance with an embodiment. At block 2505 of method 2500, processing logic receives an image or sequence of images (e.g., a video) comprising a face of an individual that is representative of a current condition of a dental site of the individual (e.g., a current condition of the individual's teeth). For example, the individual may be a patient who desires to see a prediction of how their teeth may look after undergoing a dental treatment plan. In at least one embodiment, the video is captured by a mobile device of the individual. In at least one embodiment, the processing logic may be implemented locally on the individual's mobile device, which receives and processes the captured video. In other embodiments, the processing logic is implemented by a different device that the individual's mobile device, but receives the captured video from the individual's mobile device.

At block 2510, processing logic estimates tooth shape of the dental site from the image or sequence of images to generate a 3D model representative of the dental site.

In at least one embodiment, the 3D model may be selected from a 3D model library (e.g., a library of 3D models representative of intraoral scan data), using similar methodologies as described above with respect to method 2400. In at least one embodiment, the 3D model may correspond to a model of the teeth only (e.g., a model obtained from an intraoral scan), which may correspond to a scan of the individual or a scan of a different individual.

In at least one embodiment, processing logic segments (e.g., via segmenter 318 of FIG. 3A) the image or sequence of images to identify teeth within the image or sequence of images to generate segmentation data. The segmentation data may contain data descriptive of shape and position of each identified tooth, and each tooth may be identified as a separate object and labeled. Additionally, upper and/or lower gingiva may also be identified and labeled. In at least one embodiment, an inner mouth area (e.g., a mouth area between upper and lower lips of an open mouth) is also determined by the segmentation. In at least one embodiment, a space between upper and lower teeth is also determined by the segmentation. In at least one embodiment, the segmentation is performed by a trained machine learning model. The segmentation may result in the generation of one or more masks that provide useful information for generation of a synthetic image that will show an estimated future condition of a dental site together with a remainder of a frame of a video.

In at least one embodiment, processing logic fits the 3D model to the image or sequence of images (or subset thereof) based on the segmentation data. In at least one embodiment, processing logic fits the 3D model to the image or sequence of images (or subset thereof) based on the segmentation data by applying a non-rigid fitting algorithm. The non-rigid fitting algorithm may, for example, comprise a contour-based optimization to fit the teeth of the 3D model to the teeth identified in the segmentation data.

At block 2515, processing logic generates a predicted 3D model corresponding to an altered representation of the dental site. In at least one embodiment, the altered condition of the dental site corresponds to a post-treatment condition of one or more teeth of the dental site. In at least one embodiment, the post-treatment condition is clinically accurate and was determined based on input from a dental practitioner.

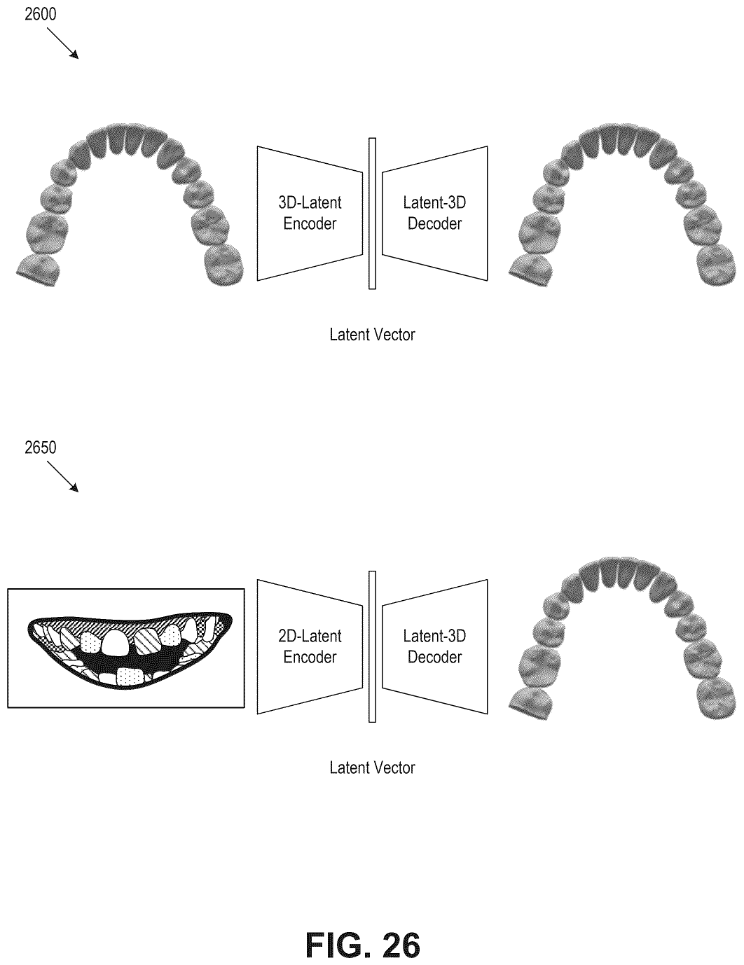

In at least one embodiment, processing logic may utilize a machine learning model (e.g., a variational autoencoder) that is trained to predict a post-treatment condition of a dental site using an encoded latent space vector representative of the current condition of the dental site, using similar methodologies for encoding latent space representations as described U.S. Provisional Patent Application No. 63/535,502, filed Aug. 30, 2023. Processing logic may be configured to encode a 2D image and a 3D model into a latent space vector as input to the machine learning model, and decode the output from latent space back into the corresponding image or 3D model space. In at least one embodiment, processing logic is configured to implement a 3D latent encoder to encode a 3D dentition model into a latent vector and decode the latent vector back into 3D model space, as illustrated by encoder/decoder 2600 of FIG. 26. In at least one embodiment, processing logic is configured to implement a 2D latent encoder to encode a 2D image (e.g., 2D segmentation data) into a latent vector and decode the latent vector back into 3D model space, as illustrated by encoder/decoder 2650 of FIG. 26. In at least one embodiment, the 2D latent encoder can take multiple images or multiple types of images, including RGB images, segmentation images, contour images, other types of images, or combinations thereof. One or more of the multiple images may correspond to various frames from a sequence of images from different points in the time dimension.

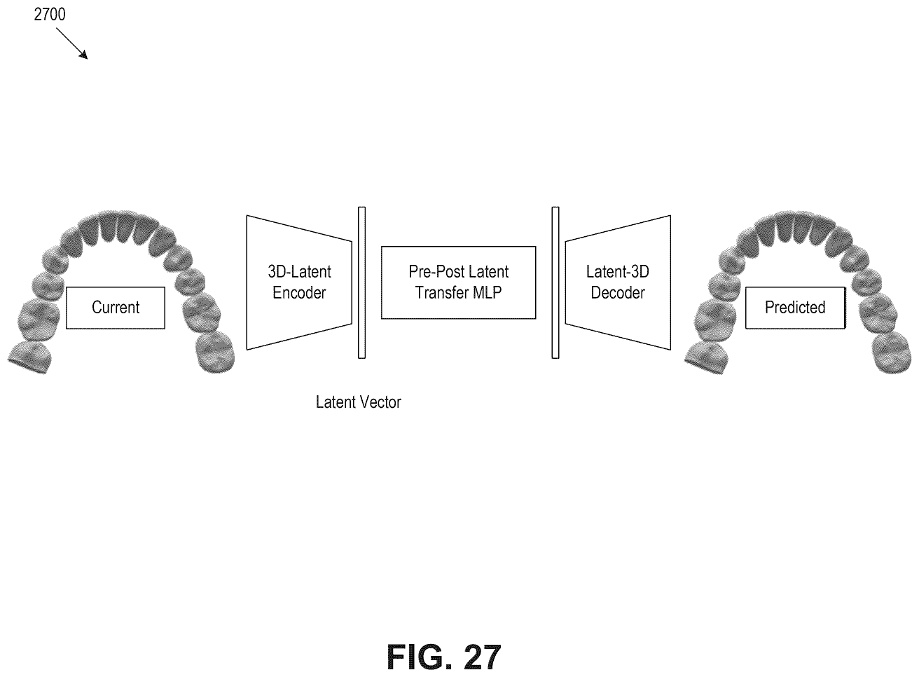

FIG. 27A illustrates a pipeline 2700 for predicting treatment outcomes of a 3D dentition model, in accordance with an embodiment. In at least one embodiment, the prediction is computed in latent space by the trained machine learning model, using a 3D latent encoder to encode a 3D dentition model as input, and using a 3D latent decoder to decode a latent vector corresponding to the predicted 3D dentition into 3D space. In at least one embodiment, the machine learning model comprises a transfer learning multi-layer perceptron.

In at least one embodiment, a 3D dentition can be predicted directly from images of a patient's mouth/dentition. For example, one or more algorithms may be utilized to generate an initial 3D dentition. Such algorithms may include, but are not limited to, ReconFusion, Hunyuan3D, DreamGaussian4D, and structure from motion (SfM). A machine learning model (e.g., a transformer-based architecture) may receive images of a mouth/dentition as input, and generate an initial 3D dentition based on, for example, one of the aforementioned algorithms. The model can be trained and updated based on a data set comprising actual patient data. In at least one embodiment, the data set comprises patient records each comprising one or more full face images, one or more cropped images corresponding to the mouth, and an associated 3D dentition representing a ground truth. Training inputs to the model include full face images and/or cropped images of the mouth for a given patient record. The generated 3D dentition is then aligned with the ground truth 3D dentition for that patient, and a loss function is calculated. In at least one embodiment, the model is iteratively updated to minimize the loss function. The trained model can then utilize facial images as inputs to directly predict 3D dentitions, which may be used as inputs to a machine learning model to predict treatment, as described with respect to various embodiments herein. In at least one embodiment, an SfM algorithm is used to first generate the initial 3D dentition, and an MVS algorithm may be used to generate a dense reconstruction of the initial 3D dentition.

Typically, treatment prediction and visualization requires a full intraoral scan to be captured for a patient, while other methods that rely on images captured by phone lack accuracy and medical basis. The aforementioned methodologies that utilize solely images as inputs to generate a predicted 3D dentition advantageously overcome these limitations, and in may some cases can avoid the need for intraoral scanning. For example, patients may be able to utilize images captured by their own mobile device to generate predicted visualizations of treatment outcomes for the purposes of doctor-patient communication and treatment plan options, as well as provide the patient with estimates of total treatment duration. The treatment plan options might be customized by users using 3D modification tools or other personalization tools. The results may also be utilized in combination with smile simulation methodologies, for example, as described in U.S. Publication No. 2024/0185518, filed Nov. 30, 2023, the disclosure of which is hereby incorporated by reference herein in its entirety. Such embodiments are advantageous, for example, for use by dental practices for which intraoral scanning technology is unavailable or unaffordable.

Such embodiments may also be used, for example, as a quality check for the production of dental impressions, which can be prone to distortion based on the level of experience by the individual obtaining the impressions. For example, in at least one embodiment, reconstructions of 3D dentition from images of a patient's dental arch can be used to estimate the quality of the impression by comparing the 3D dentition to a dentition model determined from the impression. In at least one embodiment, 3D dentitions computed solely from facial images can be used as a quality check to compute error rates in aligner manufacturing.

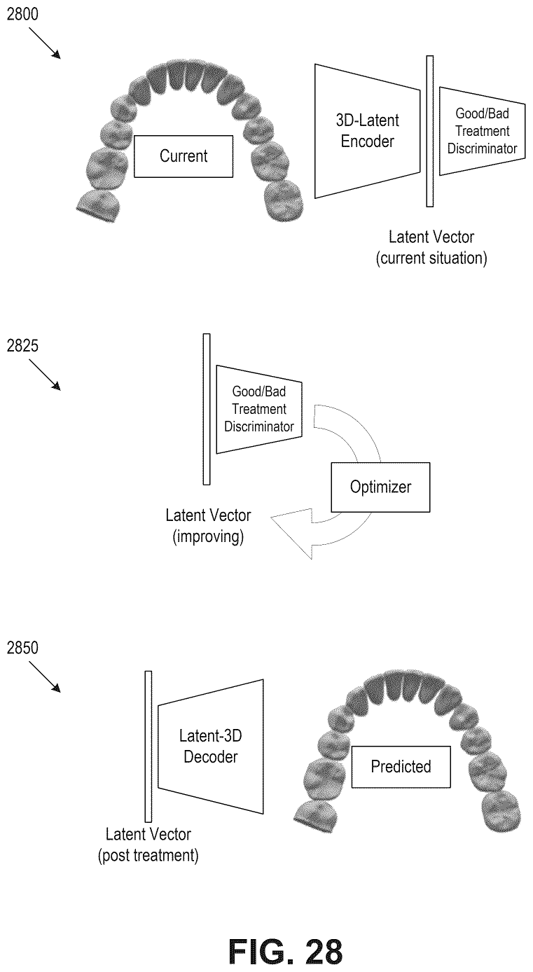

FIG. 28 illustrates an approach for optimizing latent space vectors, in accordance with at least one embodiment. Training data may comprise a set of pre-treatment situations and post-treatment situations for a plurality of 3D dentition models. Each situation may be encoded into latent space, and the machine learning model may be trained to discriminate situations as pre-treatment or post-treatment, which may comprise generating a score that rates the quality of a dental situation. Pipeline 2800 illustrates a situation where an encoded latent vector may be evaluated based on this discriminator model. This approach can be improved by pipeline 2825, by further including an optimizer to improve the latent space vector to achieve a positive score. The improved vector can then be decoded, as shown in pipeline 2850, resulting in a predicted post-treatment 3D dentition.

Referring once again to FIG. 25, at block 2520, processing logic modifies the image or sequence of images by rendering the dental site to appear as the altered representation based on the predicted 3D model. In at least one embodiment, processing logic generates a photorealistic deformable 3D model of the individual's head by applying near radiance field (NeRF) modeling to a volumetric mesh based on the predicted 3D model. In at least one embodiment, a portion of the photorealistic deformable 3D model corresponding to the dental site is rendered and used to modify the dental site to appear as the altered representation, for example, by matching of dense set of pixels from volumetric data to a masked region of the dental site described in the segmentation data.

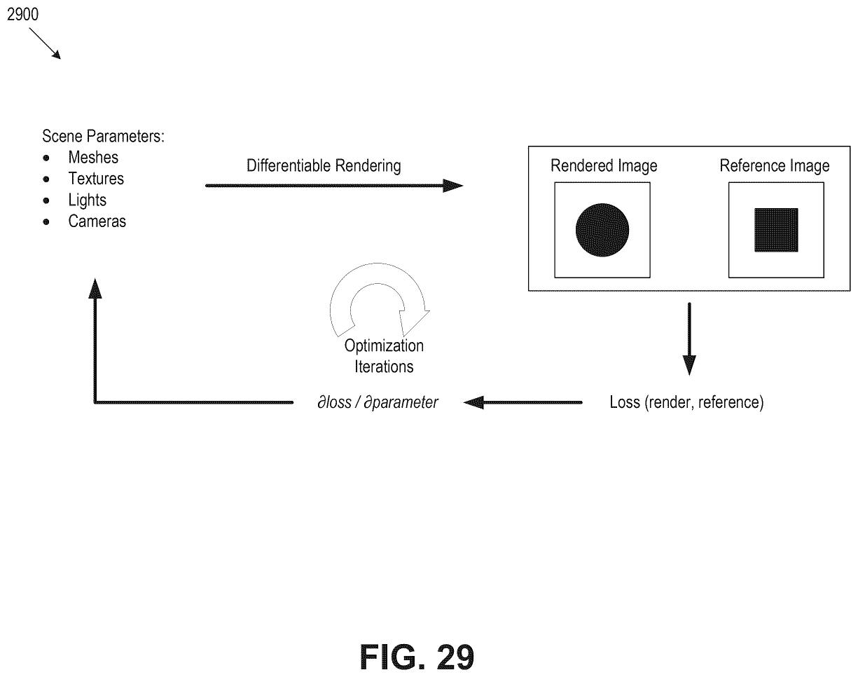

FIGS. 29-31 illustrates a differentiable rendering pipeline for generating photorealistic renderings of a predicted dental site, according to an embodiment. In an exemplary pipeline, scene parameters, such as meshes, textures, lights, cameras, etc., are used as inputs into the pipeline to generate a rendered image. The rendered image is compared to a reference image using a loss function. Scene parameters are then optimized in order to minimize the loss, resulting in a highly realistic rendered image.

Referring to FIG. 29, differentiable rendering may take into account various optimization parameters, including, but not limited to tooth midpoint, tooth silhouette, tooth edges (e.g., Sobol filter), regularizers, normal maps, and depth maps. In at least one embodiment, optimizations may be applied to a latent space representation of the dentition rather than a model space representation, resulting in an improved reconstruction of the dentition at the decoding stage and improved image-model alignment. In at least one embodiment, the inputs into the encoder (as described with respect to FIG. 26) may be images, which generates a prediction of the dentition represented in latent space, to which differentiable rendering optimization is applied. Optimization make take into account a single image or multiple images from a dynamical view of the patient's dentition (e.g., extracted from a video of the patient's jaw). In at least one embodiment, midpoint data may be generated for each tooth by identifying the middle of each tooth from a segmentation map, which is used in the optimization to improve the accuracy of tooth location. In at least one embodiment, tooth silhouette data describes the contours of individual teeth, which may be used in the optimization to improve the accuracy of tooth orientation. As part of the optimization, the decoded mesh representing the dentition can be compared to the segmentation data to compute a loss function over multiple cycles. For example, the loss function may be computed by comparing predicted depth maps or normal maps to rendered depth maps or surface normals from the differentiable rendering of the decoded mesh.

FIG. 30 illustrates an exemplary pipeline 3000 for generating photorealistic and deformable NeRF models, in accordance with at least one embodiment. As illustrated, the pipeline receives original images 3002 as input (which may correspond to frames from the video captured with the mobile device), from which facial images 3004 are generated via background removal. In at least one embodiment, the original images are directly used as the facial images, where the background can later be removed by constraining the scene depth. In at least one embodiment, the original images 3002 are preprocessed to eliminate the background before initiating training of the volumetric radiance field learning model, which can be achieved, for example, using a green screen during image capture of through deep learning-based segmentation. In an exemplary use case, approximately one hundred images are captured using a smartphone, taken at angles ranging from −45 to +45 degrees from the center of the patient's face, though other angles, numbers of images, and camera hardware are contemplated.

In at least one embodiment, a 3D facial mesh is computed from the facial images 3002, for example, using photogrammetry. This constructed mesh is then fitted with a parametric head mesh 1006 (e.g., a FLAME mesh as described in Li et al., “Learning a model of facial shape and expression from 4D scans,” ACM Trans. Graph. 36.6 (2017): 194-1). Subsequently, the parametric head mesh 3006 is used to build a deformable mesh space. In at least one embodiment, the deformable mesh space is based on an FEM simulator with multiple input dimensions, based on a linear combination of blendshapes, or based on a one-dimensional mesh sequence where the parametric head mesh 1006 is used as the initial state.

In at least one embodiment, a photorealistic NeRF 3020 is trained based on the facial images 3004 to obtain a photorealistic representation of the patient's face. In cases where the facial images 3004 include a background, photorealistic NeRF 3020 can be trained with additional module that learns to represent the background on a sphere. The MLP of the photorealistic NeRF 3020 is queried by intersecting a ray with a surrounding sphere, determining the location on the sphere, and subsequently producing a color. For the final visualization, this background model can be disregarded and substituted with white. For example, areas with a transparent background are masked and replaced with a white background.

The parametric head mesh 3006 (which is based on the facial images 3004) is used to generate training data for deformation NeRF 3010. To ensure a precise alignment of the photorealistic NeRF representation with the parametric head mesh 3006 in its initial state (before deformation), the parametric head mesh 3006 is aligned with a NeRF model extracted from the photorealistic NeRF 3020 (NeRF extracted mesh 3008). In at least one embodiment, the NeRF extracted mesh 3008 is generated by running a marching cubes algorithm inside an axis-aligned bounding box that contains the face of the subject.

In at least one embodiment, an iterative closest point method is used to scale, rotate, and position the NeRF extracted mesh 3008 to ensure alignment with the parametric head mesh 3006. With this alignment, the deformation space can be learned by continuously rendering small batches of images of the deformed parametric head mesh 3006 from various angles and using different deformation parameters. Once the deformation NeRF 3010 is trained, the learned deformation can be transferred to the photorealistic NeRF 3020, given the alignment of both representations. The final NeRF model can then visualize the learned deformation space on a photorealistic rendition of the patient's face. In at least one embodiment, the NeRF architecture of the pipeline 3000 is based on Instant-NGP.

In at least one embodiment, to convert deformation space into a NeRF model, multiple batches of frames (e.g., 50 frames) are continuously rendered, which the deformation NeRF 3010 encounters every few epochs. These frames may utilize randomly sampled camera positions from a section of a hemisphere, which also has a randomly sampled radius, encompassing the frontal part of the patient's face. In at least one embodiment, n dimensions of the deformation space are randomly sampled. These sampled dimensions can range between zero and one, with zero indicating no deformation for that specific dimension. For 1D deformation spaces, such as those based on time, the sampled times can be rounded to the nearest frame. In at least one embodiment, the deformation NeRF 3010 can be trained to display the entire deformation space.

Generally, the deformation NeRF 3010 operates independently from the photorealistic NeRF 3020. The deformation NeRF 3010 produces an XYZ displacement of space, which can then be applied to the input sample position of another density network. The deformation can be learned based on the NeRF model (which encompasses deformation, density, and color) that was originally used to capture the deformation space (e.g., the NeRF extracted mesh 3008) of the parametric head mesh 3006. By applying this learned deformation to the input of the photorealistic NeRF 3020, a resulting photorealistic NeRF model is deformable and can enable visualization of the deformation space associated with it.

A one-dimensional (1D) deformation space is exemplified by the pipeline 3000, which is represented as a time-based sequence of meshes. To construct an N-dimensional deformation space, distinct blendshapes can be created to allow for adjustment of facial features like the curvature of a smile or the position of the eyebrows. Each blendshape can be controlled by a single parameter, allowing for linear interpolation between blendshapes to generate a range of deformations. This approach can serve as the basis for the deformation space in various embodiments.

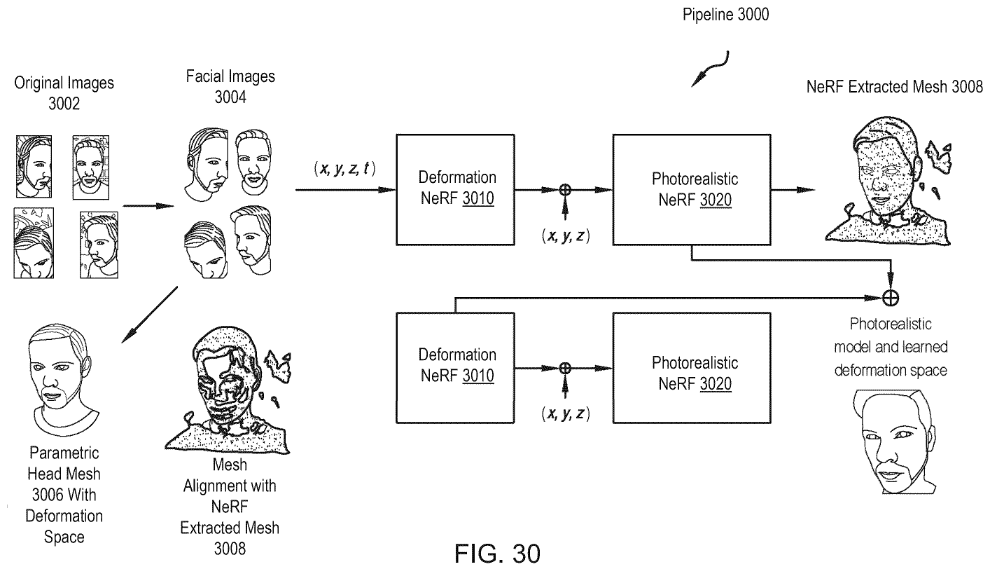

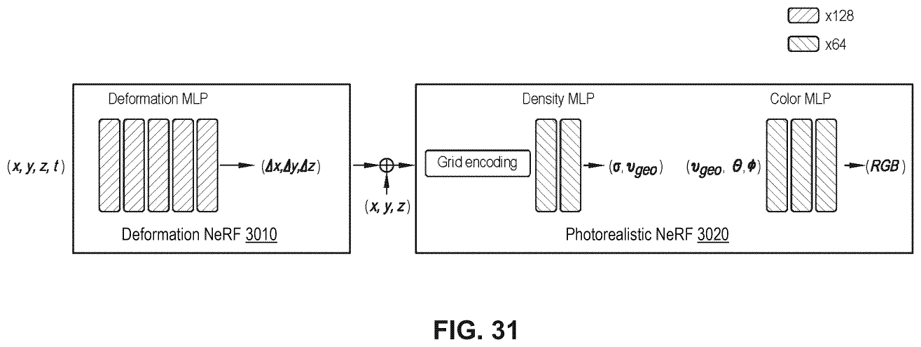

FIG. 31 illustrates the components of an exemplary NeRF architecture, in accordance with at least one embodiment. As illustrated, the NeRF architecture includes three MLPs: a deformation MLP (deformation NeRF 3010), and density and color MLPs (photorealistic NeRF 3020). In at least one embodiment, this same NeRF architecture throughout the entire pipeline 3000, though other architectures are contemplated. The initial MLP of deformation NeRF 3010 serves as a deformation network, which takes the sample's position as input, along with n additional dimensions. For a 1D scenario, the additional dimension could represent time. In at least one embodiment, the deformation NeRF 3010 captures the deformation space influenced by the blendshapes or other deformation sources on the parametric head mesh 3006. Additionally, in the context of the photorealistic NeRF, the deformation NeRF 3010 discerns subtle deformations present in the patient's images. In at least one embodiment, the inputs undergo frequency encoding across ten levels to capture finer deformations.

Following the deformation MLP, the density MLP accepts the sample position, which is displaced on the x, y, and z axes based on the output from deformation NeRF 3010. In at least one embodiment, the output of the density MLP comprises a density value and a geometric feature vector, which provides information about a point's location within the density. In at least one embodiment, grid encoding (e.g. tiled grid-based encoding) is performed on the input to the density MLP to improve training speed and approximation quality.

In at least one embodiment, the color MLP receives view direction and the geometric feature vector as inputs, and generates an RGB color as its output. In at least one embodiment, final pixel color is computed based on volumetric rendering. In at least one embodiment, the photorealistic NeRF 3020 is trained using mean squared error against ground truth images. In at least one embodiment, a regularization loss is incorporated into the training to encourage the deformation network to default to zero output to mitigate deformation artifacts.

Referring once again to FIG. 25, in at least one embodiment, processing logic removes one or more frames (e.g., a sequence of frames) that failed to satisfy the image quality criteria. Removing a sequence of frames may cause the modified video to become jumpy or jerky between some remaining frames. Accordingly, in at least one embodiment, processing logic generates replacement frames for the removed frames. The replacement frames may be generated, for example, by inputting remaining frames before and after the removed frames into a generative model (e.g., a generator of a GAN), which may output one or more interpolated intermediate frames. In one embodiment, processing logic determines an optical flow between a pair of frames that includes a first frame that occurs before the removed sequence of frames (or individual frame) and a second frame that occurs after the removed sequence of frames (or individual frame). In one embodiment, the generative model determines optical flows between the first and second frames and uses the optical flows to generate replacement frames that show an intermediate state between the pair of input frames. In one embodiment, the generative model includes a layer that generates a set of features in a feature space for each frame in a pair of frames, and then determines an optical flow between the set of features in the feature space and uses the optical flow in the feature space to generate a synthetic frame or image. In one embodiment, one or more additional synthetic or interpolated frames may also be generated by the generative model. In at least one embodiment, processing logic determines, for each pair of sequential frames (which may include a received frame and/or a simulated frame), a similarity score and/or a movement score. Processing logic may then determine whether the similarity score and/or movement score satisfies a stopping criterion. If for any pair of frames a stopping criterion is not met, one or more additional simulated frames are generated.

In at least one embodiment, processing logic further determines color information for an inner mouth area in at least one frame of the plurality of frames and/or determines contours of the altered condition of the dental site. The color information, the determined contours, the at least one frame, information on the inner mouth area, or a combination thereof, may be input into a generative model configured to output an altered version of the at least one frame. In at least one embodiment, an altered version of a prior frame is further into the generative model to enable the generative model to output a post-treatment version of the at least one frame that is temporally stable with the prior frame. In at least one embodiment, processing logic transforms the prior from and the at least one frame into a feature space, and determines an optical flow between the prior frame and the at least one frame in the feature space. The generative model may further use the optical flow in the feature space to generate the altered version of the at least one frame.

In at least one embodiment, processing logic outputs a modified video showing the individual's face with an altered condition (e.g., estimated future condition) of the dental site rather than the current condition of the dental site. The frames in the modified video may be temporally stable and consistent with one or more previous frames (e.g., one or more teeth in the modified video are different from the one or more teeth in an original version of the video and are temporally stable and consistent between frames of the modified video). In at least one embodiment, modifying the video comprises, for at least one frame of the video, determining an area of interest corresponding to a dental condition in the at least one frame, and replacing initial data for the area of interest with replacement data determined from the altered condition of the dental site.

In at least one embodiment, processing logic, if implemented locally on the individual's mobile device, causes the mobile device to present the modified video for display. In such embodiments, the modified video may be displayed adjacent to the original video and synchronized with the original video, displayed as an overlay or underlay for which the individual can adjust and transition between the original video and the modified video, or displayed in any other suitable fashion. In at least one embodiment, if processing logic is implemented remotely from the mobile device, processing logic transmits the modified video to the mobile device for display.

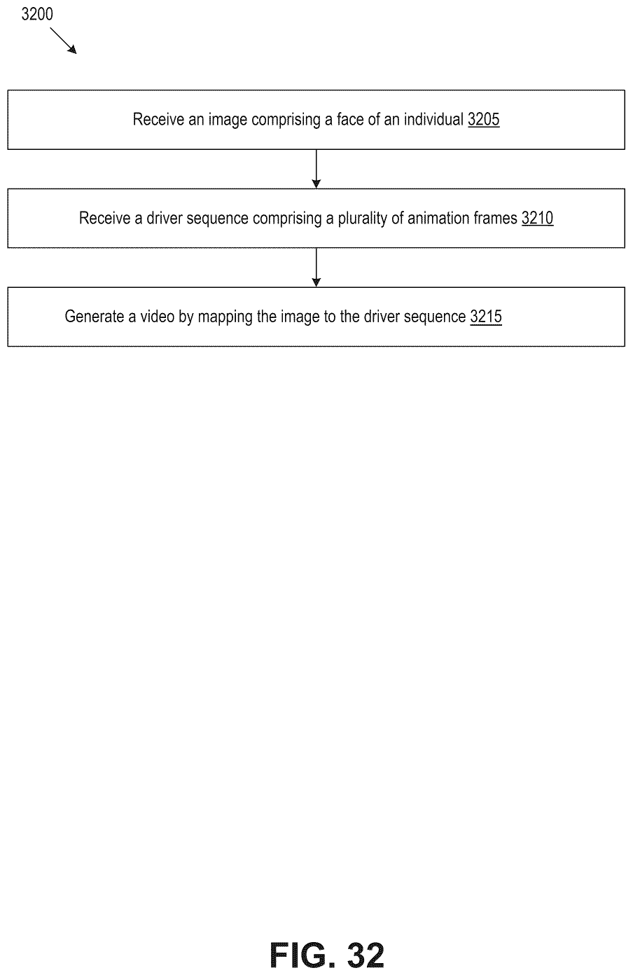

FIG. 32 illustrates a flow diagram for a method 3200 of animating a 2D image, in accordance with an embodiment. At block 3205 of method 3200, processing logic receives an image comprising a face of an individual. In at least one embodiment, the image may correspond to a frame of a video. The image may correspond to a current image of the individual (e.g., prior to undergoing a dental treatment plan), or an image that includes a prediction of an altered condition of the dental site (e.g., after undergoing a dental treatment plan). For example, the individual may be a patient who desires to see a prediction of how their teeth may look after undergoing a dental treatment plan in the form of an animation (e.g., talking, moving the head, smiling, etc.) rather than as a static image. In at least one embodiment, the image is captured by a mobile device of the individual. In at least one embodiment, the processing logic may be implemented locally on the individual's mobile device, which receives and processes the captured video. In other embodiments, the processing logic is implemented by a different device that the individual's mobile device, but receives the captured video from the individual's mobile device. In at least one embodiment, the image is generated at least in part from any of the methods 2200, 2400, 2500, or 3400.

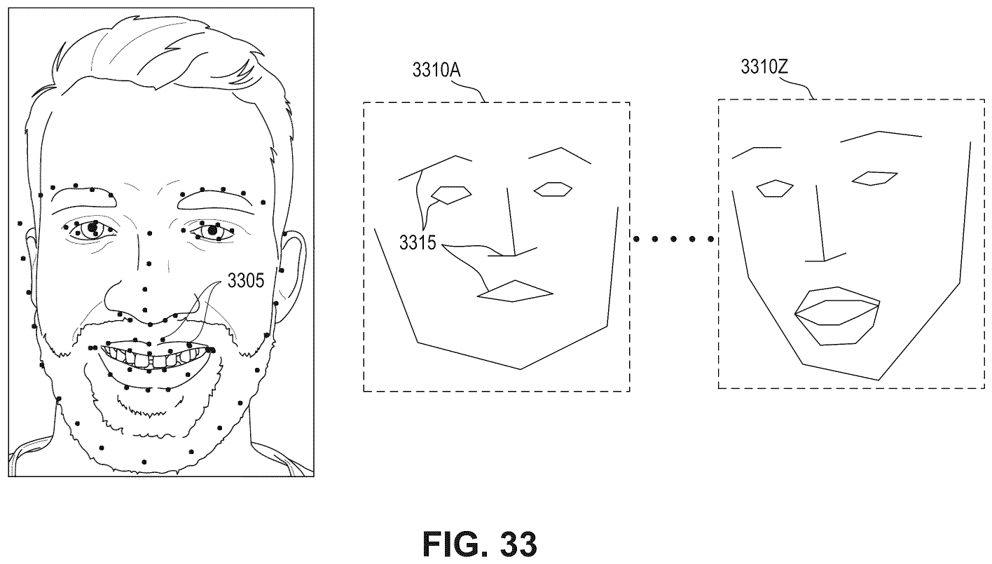

At block 3210, processing logic receives a driver sequence comprising a plurality of animation frames, each frame comprising a representation that defines the position, orientation, shape, and expression of the face, such as facial landmarks. As used herein, a “driver sequence” refers to a series of frames that each comprises a plurality of features corresponding to physical locations or landmarks of an object such that the features evolve temporally from frame-to-frame to create a fluid animation. FIG. 33 illustrates frames 3310A-3310Z of a driver sequence, in accordance with an embodiment. Features 3315 are indicated, which may comprise various shapes representative of facial landmarks. For example, in at least one embodiment, each feature may be represented as a set of connected vertices. Each vertex may map to a specific landmark of a face, such as parts of the nose, the perimeters of the eyes, eyebrows, mouth, teeth, jawline, etc. Vertices may also have corresponding depth values, which may be used to estimate an orientation of the face that can be used in mapping the features 3315 to the facial landmarks.

Referring back to FIG. 32, at block 3215, processing logic generates a video by mapping the image to the driver sequence. In at least one embodiment, processing logic segments (e.g., via segmenter 318) the image to detect the face and a plurality of landmarks to generate segmentation data. Each landmark may be identified as separate objects and labeled. For example, landmarks 3305 of FIG. 33 may correspond to facial landmarks identified via the segmentation. In at least one embodiment, an inner mouth area (e.g., a mouth area between upper and lower lips of an open mouth) is also determined by the segmentation. In at least one embodiment, a space between upper and lower teeth is also determined by the segmentation. In at least one embodiment, the segmentation is performed by a trained machine learning model. Other maps may also be generated. Each map may include one or more sets of pixel locations (e.g., x and y coordinates for pixel locations), where each set of pixel locations may indicate a particular class of object or a type of area.

In at least one embodiment, mapping the image to the driver sequence comprises mapping each of the plurality of facial landmarks of the segmentation data to facial landmarks of the driver sequence for each frame of the driver sequence. For example, as shown in FIG. 33, a plurality of landmark features 3305 of the image can be mapped to driver sequence features 3315 for each of frames 3310A-3310Z of the driver sequence.

In at least one embodiment, processing logic outputs a modified video showing the individual's face with an altered condition (e.g., estimated future condition) of the dental site rather than the current condition of the dental site. The frames in the modified video may be temporally stable and consistent with one or more previous frames (e.g., one or more teeth in the modified video are different from the one or more teeth in an original version of the video and are temporally stable and consistent between frames of the modified video). In at least one embodiment, modifying the video comprises, for at least one frame of the video, determining an area of interest corresponding to a dental condition in the at least one frame, and replacing initial data for the area of interest with replacement data determined from the altered condition of the dental site.

In at least one embodiment, processing logic, if implemented locally on the individual's mobile device, causes the mobile device to present the modified video for display. In such embodiments, the modified video may be displayed adjacent to the original video and synchronized with the original video, displayed as an overlay or underlay for which the individual can adjust and transition between the original video and the modified video, or displayed in any other suitable fashion. In at least one embodiment, if processing logic is implemented remotely from the mobile device, processing logic transmits the modified video to the mobile device for display.

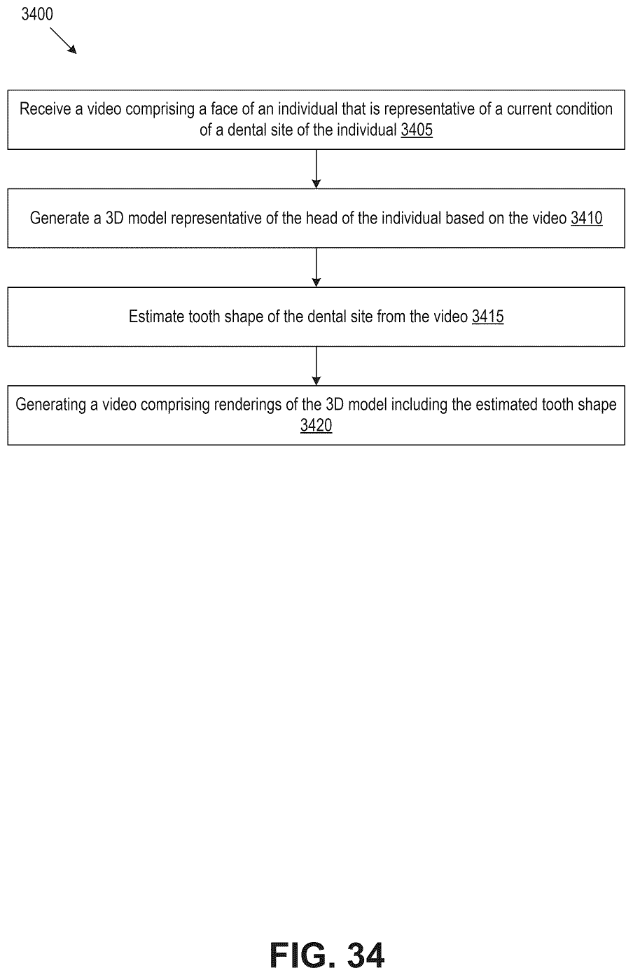

FIG. 34 illustrates a flow diagram for a method 3400 of estimating altered condition of a dental site from a video of a face of an individual, in accordance with an embodiment. At block 3405 of method 3400, processing logic receives the video comprising a face of the individual that is representative of a current condition of a dental site of the individual (e.g., a current condition of the individual's teeth). For example, the individual may be a patient who desires to see a prediction of how their teeth may look after undergoing a dental treatment plan. In at least one embodiment, the video is captured by a mobile device of the individual. In at least one embodiment, the processing logic may be implemented locally on the individual's mobile device, which receives and processes the captured video. In other embodiments, the processing logic is implemented by a different device that the individual's mobile device, but receives the captured video from the individual's mobile device.

At block 3410, processing logic generates a 3D model representative of the head of the individual based on the video. For example, in at least one embodiment, processing logic generates the 3D model using NeRF modeling with the video as input, for example, using similar a similar methodology as described with respect to FIGS. 29-32.

At block 3415, processing logic estimates tooth shape of the dental site from the video. In at least one embodiment, the 3D model may be modified to include a 3D representation of a current state of the individual's dental site. This may be done, for example, by registering intraoral scan data to the jaw area of the 3D model. As another example, processing logic may utilize a segmentation-based approach to generate a representation of the current condition of the dental site within the 3D model. In at least one embodiment, processing logic segments (e.g., via segmenter 318 of FIG. 3A) one or more frames of the video to identify teeth within the image or sequence of images to generate segmentation data. The segmentation data may contain data descriptive of shape and position of each identified tooth, and each tooth may be identified as a separate object and labeled. Additionally, upper and/or lower gingiva may also be identified and labeled. In at least one embodiment, an inner mouth area (e.g., a mouth area between upper and lower lips of an open mouth) is also determined by the segmentation. In at least one embodiment, a space between upper and lower teeth is also determined by the segmentation. In at least one embodiment, the segmentation is performed by a trained machine learning model. The segmentation may result in the generation of one or more masks that provide useful information for generation of a synthetic image that will show an estimated future condition of a dental site together with a remainder of a frame of a video. In at least one embodiment, the processing logic fits the 3D model to the one or more frames of the video based on the segmentation data. In at least one embodiment, processing logic fits the 3D model to the image or sequence of images (or subset thereof) based on the segmentation data by applying a non-rigid fitting algorithm. The non-rigid fitting algorithm may, for example, comprise a contour-based optimization to fit the teeth of the 3D model to the teeth identified in the segmentation data. In at least one embodiment, applying a non-rigid fitting algorithm comprises applying one or more non-rigid adjustments to the initial 3D model. Such non-rigid adjustments may include, without limitation: jaw level adjustments based on one or more of a jaw height, a jaw width, or a jaw depth; and/or tooth level adjustments based on one or more of a jaw height, a jaw width, or a sharpness of tooth curves.

At block 3420, processing logic generates a predicted video comprising renderings of the 3D model or the predicted 3D model including the estimated tooth shape, for example, by generating frames of the video from renderings of the 3D model or the predicted 3D model. Prior to generating the predicted video, in at least one embodiment, processing logic generates a predicted 3D model corresponding to an altered representation of the dental site by modifying the 3D model to alter the representation of the dental site. In at least one embodiment, the altered condition of the dental site corresponds to a post-treatment condition of one or more teeth of the dental site. In at least one embodiment, the post-treatment condition is clinically accurate and was determined based on input from a dental practitioner. In at least one embodiment, processing logic encodes the 3D model into a latent space vector via a trained machine learning model (e.g., a variational autoencoder). For example, the trained machine learning model may be trained to predict post-treatment modification of the 3D model and generate the predicted 3D model from the predicted post-treatment modification.

In at least one embodiment, processing logic receives a driver sequence comprising a plurality of animation frames, each frame comprising a representation of facial landmarks of a face and an orientation of the face (e.g., as described with respect to the method 3200). Processing logic may animate the 3D model or the predicted 3D model based on the driver sequence, and generate a video for display based on the animated 3D model, for example, by rendering frames of video from the animated 3D model. For example, landmarks associated with the 3D model may be mapped to the features of the driver sequence, similar to the mapping discussed with respect to FIG. 33.

In at least one embodiment, processing logic generates a photorealistic deformable 3D model of the individual's head by applying NeRF modeling to a volumetric mesh based on the 3D model or the predicted 3D model, for example, as discussed above with respect to the method 2500.

In at least one embodiment, processing logic, if implemented locally on the individual's mobile device, causes the mobile device to present the estimated video for display. In such embodiments, the estimated video may be displayed adjacent to the original video and synchronized with the original video, displayed as an overlay or underlay for which the individual can adjust and transition between the original video and the estimated video, or displayed in any other suitable fashion. In at least one embodiment, if processing logic is implemented remotely from the mobile device, processing logic transmits the estimated video to the mobile device for display.

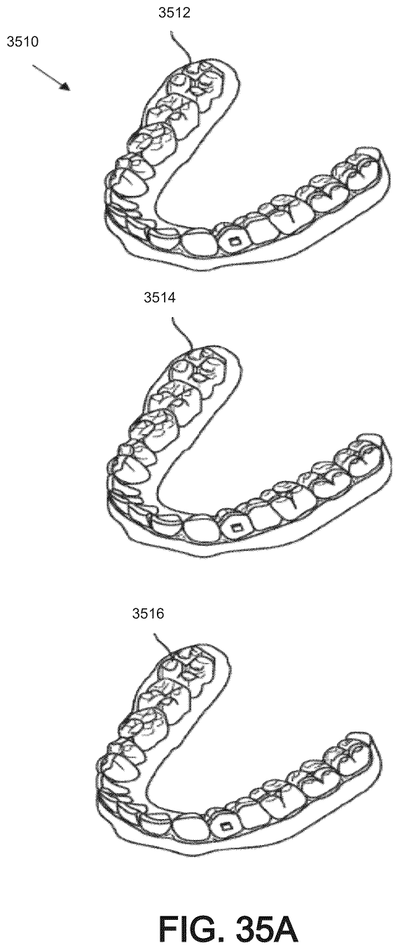

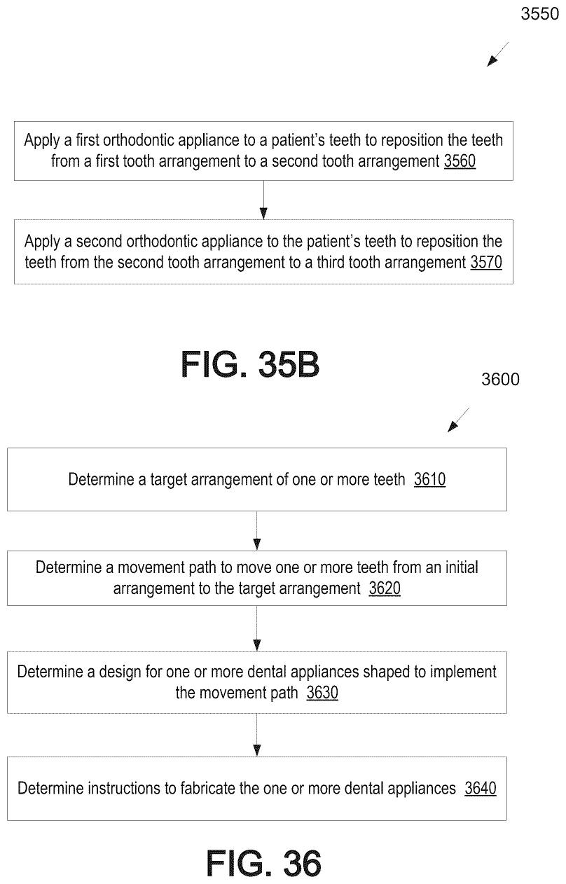

FIGS. 35A-37 and the accompanying descriptions are related to dental treatments that may be improved by extracting or generating images of dental patients based on input video data. FIG. 35A illustrates a tooth repositioning system 3510 including a plurality of appliances 3512, 3514, 3516. The appliances 3512, 3514, 3516 can be designed based on generation of a sequence of 3D models of dental arches. The appliances 3512, 3514, and 3516 may be designed to perform a dental treatment over a series of stages. Methods of the present disclosure may be performed to generate dental patient images, which may be utilized for designing a treatment plan, designing the appliances, predicting positions of one or more teeth after a stage of treatment, predicting positions of one or more teeth after completing dental treatment, etc. Any of the appliances described herein can be designed and/or provided as part of a set of a plurality of appliances used in a tooth repositioning system, and may be designed in accordance with an orthodontic treatment plan generated with the use of dental patient images, generating in accordance with embodiments of the present disclosure.

Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 3510 can include a first appliance 3512 corresponding to an initial tooth arrangement, one or more intermediate appliances 3514 corresponding to one or more intermediate arrangements, and a final appliance 3516 corresponding to a target arrangement. A target tooth arrangement can be a planned final tooth arrangement selected for the patient's teeth at the end of all planned orthodontic treatment, as optionally output using a trained machine learning model. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

In some embodiments, the appliances 3512, 3514, 3516 (or portions thereof) can be produced using indirect fabrication techniques, such as by thermoforming over a positive or negative mold. Indirect fabrication of an orthodontic appliance can involve producing a positive or negative mold of the patient's dentition in a target arrangement (e.g., by rapid prototyping, milling, etc.) and thermoforming one or more sheets of material over the mold in order to generate an appliance shell.

In an example of indirect fabrication, a mold of a patient's dental arch may be fabricated from a digital model of the dental arch generated by a trained machine learning model as described above, and a shell may be formed over the mold (e.g., by thermoforming a polymeric sheet over the mold of the dental arch and then trimming the thermoformed polymeric sheet). The fabrication of the mold may be performed by a rapid prototyping machine (e.g., a stereolithography (SLA) 3D printer). The rapid prototyping machine may receive digital models of molds of dental arches and/or digital models of the appliances 3512, 3514, 3516 after the digital models of the appliances 3512, 3514, 3516 have been processed by processing logic of a computing device, such as the computing device in FIG. 38. The processing logic may include hardware (e.g., circuitry, dedicated logic, programmable logic, microcode, etc.), software (e.g., instructions executed by a processing device), firmware, or a combination thereof. One or more dental images used in treatment design may be generated by a processing device executing dental image data generator 369 of FIG. 3B.

To manufacture the molds, a shape of a dental arch for a patient at a treatment stage is determined based on a treatment plan. In the example of orthodontics, the treatment plan may be generated based on an intraoral scan of a dental arch to be modeled. The intraoral scan of the patient's dental arch may be performed to generate a three dimensional (3D) virtual model of the patient's dental arch (mold). For example, a full scan of the mandibular and/or maxillary arches of a patient may be performed to generate 3D virtual models thereof. The intraoral scan may be performed by creating multiple overlapping intraoral images from different scanning stations and then stitching together the intraoral images or scans to provide a composite 3D virtual model. In other applications, virtual 3D models may also be generated based on scans of an object to be modeled or based on use of computer aided drafting techniques (e.g., to design the virtual 3D mold). Alternatively, an initial negative mold may be generated from an actual object to be modeled (e.g., a dental impression or the like). The negative mold may then be scanned to determine a shape of a positive mold that will be produced.

Once the virtual 3D model of the patient's dental arch is generated, a dental practitioner may determine a desired treatment outcome, which includes final positions and orientations for the patient's teeth. In one embodiment, dental image data generator 369 outputs an image of a dental patient, which may be utilized by further systems (e.g., further trained machine learning models) to output data related to desired treatment outcomes based on processing the image of the dental patient. Processing logic may then determine a number of treatment stages to cause the teeth to progress from starting positions and orientations to the target final positions and orientations. The shape of the final virtual 3D model and each intermediate virtual 3D model may be determined by computing the progression of tooth movement throughout orthodontic treatment from initial tooth placement and orientation to final corrected tooth placement and orientation. For each treatment stage, a separate virtual 3D model of the patient's dental arch at that treatment stage may be generated. In one embodiment, for each treatment stage, one or more dental patient images generated by dental image data generator 369 are used to generate further outputs including predicted treatment results, e.g., a different 3D model of the dental arch. The shape of each virtual 3D model will be different. The original virtual 3D model, the final virtual 3D model and each intermediate virtual 3D model is unique and customized to the patient.

Accordingly, multiple different virtual 3D models (digital designs) of a dental arch may be generated for a single patient. A first virtual 3D model may be a unique model of a patient's dental arch and/or teeth as they presently exist, and a final virtual 3D model may be a model of the patient's dental arch and/or teeth after correction of one or more teeth and/or a jaw. Multiple intermediate virtual 3D models may be modeled, each of which may be incrementally different from previous virtual 3D models.

Each virtual 3D model of a patient's dental arch may be used to generate a unique customized physical mold of the dental arch at a particular stage of treatment. The shape of the mold may be at least in part based on the shape of the virtual 3D model for that treatment stage. The virtual 3D model may be represented in a file such as a computer aided drafting (CAD) file or a 3D printable file such as a stereolithography (STL) file. The virtual 3D model for the mold may be sent to a third party (e.g., clinician office, laboratory, manufacturing facility or other entity). The virtual 3D model may include instructions that will control a fabrication system or device in order to produce the mold with specified geometries.

A clinician office, laboratory, manufacturing facility or other entity may receive the virtual 3D model of the mold, the digital model having been created as set forth above. The entity may input the digital model into a 3D printer. 3D printing includes any layer-based additive manufacturing processes. 3D printing may be achieved using an additive process, where successive layers of material are formed in proscribed shapes. 3D printing may be performed using extrusion deposition, granular materials binding, lamination, photopolymerization, continuous liquid interface production (CLIP), or other techniques. 3D printing may also be achieved using a subtractive process, such as milling.

In some instances, stereolithography (SLA), also known as optical fabrication solid imaging, is used to fabricate an SLA mold. In SLA, the mold is fabricated by successively printing thin layers of a photo-curable material (e.g., a polymeric resin) on top of one another. A platform rests in a bath of a liquid photopolymer or resin just below a surface of the bath. A light source (e.g., an ultraviolet laser) traces a pattern over the platform, curing the photopolymer where the light source is directed, to form a first layer of the mold. The platform is lowered incrementally, and the light source traces a new pattern over the platform to form another layer of the mold at each increment. This process repeats until the mold is completely fabricated. Once all of the layers of the mold are formed, the mold may be cleaned and cured.

Materials such as a polyester, a co-polyester, a polycarbonate, a polycarbonate, a thermopolymeric polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate, a styrenic block copolymer (SBC), a silicone rubber, an elastomeric alloy, a thermopolymeric elastomer (TPE), a thermopolymeric vulcanizate (TPV) elastomer, a polyurethane elastomer, a block copolymer elastomer, a polyolefin blend elastomer, a thermopolymeric co-polyester elastomer, a thermopolymeric polyamide elastomer, or combinations thereof, may be used to directly form the mold. The materials used for fabrication of the mold can be provided in an uncured form (e.g., as a liquid, resin, powder, etc.) and can be cured (e.g., by photopolymerization, light curing, gas curing, laser curing, crosslinking, etc.). The properties of the material before curing may differ from the properties of the material after curing.

Appliances may be formed from each mold and when applied to the teeth of the patient, may provide forces to move the patient's teeth as dictated by the treatment plan. The shape of each appliance is unique and customized for a particular patient and a particular treatment stage. In an example, the appliances 3512, 3514, 3516 can be pressure formed or thermoformed over the molds. Each mold may be used to fabricate an appliance that will apply forces to the patient's teeth at a particular stage of the orthodontic treatment. The appliances 3512, 3514, 3516 each have teeth-receiving cavities that receive and resiliently reposition the teeth in accordance with a particular treatment stage.

In one embodiment, a sheet of material is pressure formed or thermoformed over the mold. The sheet may be, for example, a sheet of polymeric (e.g., an elastic thermopolymeric, a sheet of polymeric material, etc.). To thermoform the shell over the mold, the sheet of material may be heated to a temperature at which the sheet becomes pliable. Pressure may concurrently be applied to the sheet to form the now pliable sheet around the mold. Once the sheet cools, it will have a shape that conforms to the mold. In one embodiment, a release agent (e.g., a non-stick material) is applied to the mold before forming the shell. This may facilitate later removal of the mold from the shell. Forces may be applied to lift the appliance from the mold. In some instances, a breakage, warpage, or deformation may result from the removal forces. Accordingly, embodiments disclosed herein may determine where the probable point or points of damage may occur in a digital design of the appliance prior to manufacturing and may perform a corrective action.

Additional information may be added to the appliance. The additional information may be any information that pertains to the appliance. Examples of such additional information includes a part number identifier, patient name, a patient identifier, a case number, a sequence identifier (e.g., indicating which appliance a particular liner is in a treatment sequence), a date of manufacture, a clinician name, a logo and so forth. For example, after determining there is a probable point of damage in a digital design of an appliance, an indicator may be inserted into the digital design of the appliance. The indicator may represent a recommended place to begin removing the polymeric appliance to prevent the point of damage from manifesting during removal in some embodiments.

After an appliance is formed over a mold for a treatment stage, the appliance is removed from the mold (e.g., automated removal of the appliance from the mold), and the appliance is subsequently trimmed along a cutline (also referred to as a trim line). The processing logic may determine a cutline for the appliance. The determination of the cutline(s) may be made based on the virtual 3D model of the dental arch at a particular treatment stage, based on a virtual 3D model of the appliance to be formed over the dental arch, or a combination of a virtual 3D model of the dental arch and a virtual 3D model of the appliance. The location and shape of the cutline can be important to the functionality of the appliance (e.g., an ability of the appliance to apply desired forces to a patient's teeth) as well as the fit and comfort of the appliance. For shells such as orthodontic appliances, orthodontic retainers and orthodontic splints, the trimming of the shell may play a role in the efficacy of the shell for its intended purpose (e.g., aligning, retaining or positioning one or more teeth of a patient) as well as the fit of the shell on a patient's dental arch. For example, if too much of the shell is trimmed, then the shell may lose rigidity and an ability of the shell to exert force on a patient's teeth may be compromised. When too much of the shell is trimmed, the shell may become weaker at that location and may be a point of damage when a patient removes the shell from their teeth or when the shell is removed from the mold. In some embodiments, the cut line may be modified in the digital design of the appliance as one of the corrective actions taken when a probable point of damage is determined to exist in the digital design of the appliance.

On the other hand, if too little of the shell is trimmed, then portions of the shell may impinge on a patient's gums and cause discomfort, swelling, and/or other dental issues. Additionally, if too little of the shell is trimmed at a location, then the shell may be too rigid at that location. In some embodiments, the cutline may be a straight line across the appliance at the gingival line, below the gingival line, or above the gingival line. In some embodiments, the cutline may be a gingival cutline that represents an interface between an appliance and a patient's gingiva. In such embodiments, the cutline controls a distance between an edge of the appliance and a gum line or gingival surface of a patient.

Each patient has a unique dental arch with unique gingiva. Accordingly, the shape and position of the cutline may be unique and customized for each patient and for each stage of treatment. For instance, the cutline is customized to follow along the gum line (also referred to as the gingival line). In some embodiments, the cutline may be away from the gum line in some regions and on the gum line in other regions. For example, it may be desirable in some instances for the cutline to be away from the gum line (e.g., not touching the gum) where the shell will touch a tooth and on the gum line (e.g., touching the gum) in the interproximal regions between teeth. Accordingly, it is important that the shell be trimmed along a predetermined cutline.

FIG. 35B illustrates a method 3550 of orthodontic treatment using a plurality of appliances, in accordance with embodiments. The method 3550 can be practiced using any of the appliances or appliance sets described herein. At block 3560, a first orthodontic appliance is applied to a patient's teeth in order to reposition the teeth from a first tooth arrangement to a second tooth arrangement. At block 3570, a second orthodontic appliance is applied to the patient's teeth in order to reposition the teeth from the second tooth arrangement to a third tooth arrangement. The method 3550 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

In connection with method 3550, predictions of target, intermediate, and/or final tooth positions may be based on images of the dental patient, e.g., images before treatment may be utilized to determine predictions of post-treatment. In some embodiments, a treatment plan may be generated based on predicted images, which may be generated based on image extraction/generation techniques of the current disclosure. For example, a dental patient may choose between a set of potential final positions, each final position prediction generated based on one or more dental patient images generated by dental image data generator 369.

FIG. 36 illustrates a method 3600 for designing an orthodontic appliance to be produced by direct or indirect fabrication, in accordance with embodiments. The method 3600 can be applied to any embodiment of the orthodontic appliances described herein, and may be performed using one or more trained machine learning models in embodiments. Some or all of the blocks of the method 3600 can be performed by any suitable data processing system or device, e.g., one or more processors configured with suitable instructions.

At block 3610 a target arrangement of one or more teeth of a patient may be determined. The target arrangement of the teeth (e.g., a desired and intended end result of orthodontic treatment) can be received from a clinician in the form of a prescription, can be calculated from basic orthodontic principles, can be extrapolated computationally from a clinical prescription, and/or can be generated by a trained machine learning model based on initial dental patient images generated by dental image data generator 369 of FIG. 3B. With a specification of the desired final positions of the teeth and a digital representation of the teeth themselves, the final position and surface geometry of each tooth can be specified to form a complete model of the tooth arrangement at the desired end of treatment.

At block 3620, a movement path to move the one or more teeth from an initial arrangement to the target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. An initial arrangement may be estimated by projecting some measurement of the patient's teeth to a latent space, and obtaining from the latent space a representation of the initial arrangement. From the obtained data, a digital data set such as a 3D model of the patient's dental arch or arches can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, optionally including measured or extrapolated hidden surfaces and root structures, as well as surrounding bone and soft tissue.

Having both an initial position and a target position for each tooth, a movement path can be defined for the motion of each tooth. Determining the movement path for one or more teeth may include identifying a plurality of incremental arrangements of the one or more teeth to implement the movement path. In some embodiments, the movement path implements one or more force systems on the one or more teeth (e.g., as described below). In some embodiments, movement paths are determined by a trained machine learning model. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In some embodiments, a force system to produce movement of the one or more teeth along the movement path is determined. In one embodiment, the force system is determined by a trained machine learning model. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be considered. In other embodiments, the treating professional can select an appropriate treatment based on physiological characteristics of the patient. For example, the properties of the palate may also be estimated based on factors such as the patient's age—for example, young juvenile patients will typically require lower forces to expand the suture than older patients, as the suture has not yet fully formed.

At block 3630, a design for one or more dental appliances shaped to implement the movement path is determined. In one embodiment, the one or more dental appliances are shaped to move the one or more teeth toward corresponding incremental arrangements. In some embodiments, results of one or more stages of treatment may be predicted based on images generated by dental image data generator 369 of FIG. 3B. Determination of the one or more dental or orthodontic appliances, appliance geometry, material composition, and/or properties can be performed using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

At block 3640, instructions for fabrication of the one or more dental appliances are determined or identified. In some embodiments, the instructions identify one or more geometries of the one or more dental appliances. In some embodiments, the instructions identify slices to make layers of the one or more dental appliances with a 3D printer. In some embodiments, the instructions identify one or more geometries of molds usable to indirectly fabricate the one or more dental appliances (e.g., by thermoforming plastic sheets over the 3D printed molds). The dental appliances may include one or more of aligners (e.g., orthodontic aligners), retainers, incremental palatal expanders, attachment templates, and so on.

In one embodiment, instructions for fabrication of the one or more dental appliances are generated by a trained model. In some embodiments, predictions of treatment progression and/or treatment appliances may be performed and/or aided by dental image data generator 369 of FIG. 3B. The instructions can be configured to control a fabrication system or device in order to produce the orthodontic appliance with the specified orthodontic appliance. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by 3D printing a mold and thermoforming a plastic sheet over the mold.

Method 3600 may comprise additional blocks: 1) The upper arch and palate of the patient is scanned intraorally to generate three dimensional data of the palate and upper arch; 2) The three dimensional shape profile of the appliance is determined to provide a gap and teeth engagement structures as described herein.

Although the above blocks show a method 3600 of designing an orthodontic appliance in accordance with some embodiments, a person of ordinary skill in the art will recognize some variations based on the teaching described herein. Some of the blocks may comprise sub-blocks. Some of the blocks may be repeated as often as desired. One or more blocks of the method 3600 may be performed with any suitable fabrication system or device, such as the embodiments described herein. Some of the blocks may be optional, and the order of the blocks can be varied as desired.

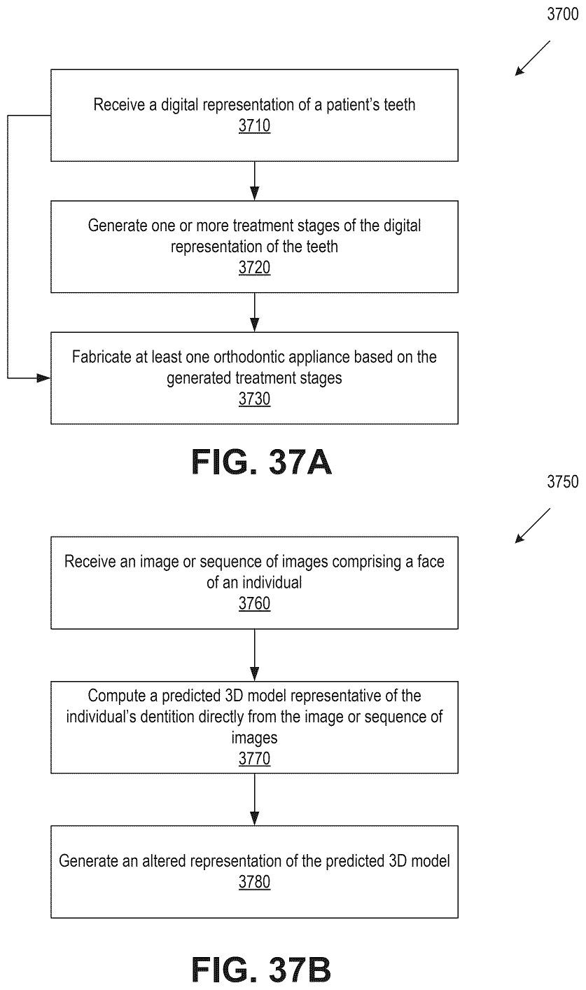

FIG. 37A illustrates a method 3700 for digitally planning an orthodontic treatment and/or design or fabrication of an appliance, in accordance with embodiments. The method 3700 can be applied to any of the treatment procedures described herein and can be performed by any suitable data processing system.

At block 3710, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

At block 3720, one or more treatment stages are generated based on the digital representation of the teeth. In some embodiments, the one or more treatment stages are generated based on processing of input dental arch data by a trained machine learning model, such as input data generated by dental image data generator 369. Each treatment stage may include a generated 3D model of a dental arch at that treatment stage. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

At block 3730, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired. The fabrication of the appliance may include automated removal of the appliance from a mold (e.g., automated removal of an untrimmed shell from mold a using a shell removal device).

In some instances, staging of various arrangements or treatment stages may not be necessary for design and/or fabrication of an appliance. As illustrated by the dashed line in FIG. 37, design and/or fabrication of an orthodontic appliance, and perhaps a particular orthodontic treatment, may include use of a representation of the patient's teeth (e.g., receive a digital representation of the patient's teeth at block 3710), followed by design and/or fabrication of an orthodontic appliance based on a representation of the patient's teeth in the arrangement represented by the received representation.

FIG. 37B illustrates a method 3750 for generating predicted 3D model based on an image or sequence of images, in accordance with embodiments. The method 3750 can be applied to any of the treatment procedures described herein and can be performed by any suitable data processing system.

At block 3760, an image or a sequence of images (e.g., a video) is received. The image or sequence of images may contain a face of an individual representative of a current condition of the individual's dental site.

At block 3770, a predicted 3D model representative of the individual's dentition is computed directly from the image or sequence of images using, for example, a trained machine learning model. In at least one embodiment, the trained machine learning model utilizes an algorithm to generate a 3D dentition from the image or sequence of images. The algorithm may include, for example, ReconFusion, Hunyuan3D, DreamGaussian4D, or SfM.

At block 3780, an altered representation of the predicted 3D model is generated. In at least one embodiment, the altered representation is representative of the predicted or desired results of a treatment plan. In at least one embodiment, any one of the methods 1900 or 2000 or other methodologies described herein may be utilized to generate the altered representation based on the predicted 3D model or using the predicted 3D model as input. In at least one embodiment, the predicted 3D model is compared to a 3D model computed based on a dental impression (or dental appliance) to determine a quality parameter of the dental impression (or dental appliance).

In at least one embodiment, the trained machine learning model corresponds to a machine learning model that is trained based on a training data sets corresponding to plurality of patient records, each patient record comprising at least one image of the patient's mouth and an associated 3D model representing the patient's dentition.

In at least one embodiment, training the machine learning model based on the training data sets comprises, for each patient record, iteratively updating the model to minimize a loss function by comparing a predicted 3D model generated by the model to a 3D model representative of a patient's dentition of the patient record.

FIG. 38 is a block diagram illustrating a computer system 3800, according to some embodiments. In some embodiments, computer system 3800 may be connected (e.g., via a network, such as a Local Area Network (LAN), an intranet, an extranet, or the Internet) to other computer systems. Computer system 3800 may operate in the capacity of a server or a client computer in a client-server environment, or as a peer computer in a peer-to-peer or distributed network environment. Computer system 3800 may be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 3800 may include a processing device 3802, a volatile memory 3804 (e.g., Random Access Memory (RAM)), a non-volatile memory 3806 (e.g., Read-Only Memory (ROM) or Electrically-Erasable Programmable ROM (EEPROM)), and a data storage device 3818, which may communicate with each other via a bus 3808.

Processing device 3802 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor.

Computer system 3800 may further include a network interface device 3822 (e.g., coupled to network 3874). Computer system 3800 also may include a video display unit 3810 (e.g., an LCD), an alphanumeric input device 3812 (e.g., a keyboard), a cursor control device 3814 (e.g., a mouse), and a signal generation device 3820.

In some embodiments, data storage device 3818 may include a non-transitory computer-readable storage medium 3824 (e.g., non-transitory machine-readable medium) on which may store instructions 3826 encoding any one or more of the methods or functions described herein, including instructions encoding components of FIG. 1A and/or FIG. 2 (e.g., image generation component 114, action component 122, model 190, video processing logic 208, video capture logic 212, dental adaptation logic 214, treatment planning logic 220, dentition viewing logic 222, video/image editing logic 224, etc.) and for implementing methods described herein.

Instructions 3826 may also reside, completely or partially, within volatile memory 3804 and/or within processing device 3802 during execution thereof by computer system 3800, hence, volatile memory 3804 and processing device 3802 may also constitute machine-readable storage media.

While computer-readable storage medium 3824 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” “reducing,” “generating,” “correcting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The following exemplary embodiments are now described:

Embodiment 1: A computer-implemented method comprising: receiving a video comprising a face of an individual that is representative of a current condition of a dental site of the individual; segmenting each of a plurality of frames of the video to detect the face and the dental site of the individual to generate segmentation data; inputting the segmentation data into a machine learning model trained to predict an altered condition of the dental site; and generating, from the machine learning model, a segmentation map corresponding to the altered condition of the dental site.

Embodiment 2: The method of Embodiment 1, wherein receiving the video of the face of the individual comprises receiving the video from a mobile device of the individual that captured the video.

Embodiment 3: The method of any one of the preceding Embodiments, wherein the machine learning model is trained to disentangle pose information and dental site information from each frame.

Embodiment 4: The method of any one of the preceding Embodiments, wherein the machine learning model is trained to process the segmentation data in image space.

Embodiment 5: The method of any one of the preceding Embodiments, wherein the machine learning model is trained to process the segmentation data in segmentation space.

Embodiment 6: The method of any one of the preceding Embodiments, wherein the plurality of frames are selected for segmentation via periodically sampling frames of the video.

Embodiment 7: The method of Embodiment 6, wherein periodically sampling the frames comprises selecting every 2nd to 10th frame.

Embodiment 8: The method of any one of the preceding Embodiments, further comprising modifying the video by replacing the current condition of the dental site with the altered condition of the dental site in the video based on the segmentation map.

Embodiment 9: The method of Embodiment 8, further comprising transmitting the modified video to a mobile device of the individual for display.

Embodiment 10: The method of Embodiment 8, wherein the dental site comprises one or more teeth, and wherein the one or more teeth in the modified video are different from the one or more teeth in an original version of the video and are temporally stable and consistent between frames of the modified video.

Embodiment 11: The method of Embodiment 8, further comprising: identifying one or more frames of the modified video that fail to satisfy one or more image quality criteria; and removing the one or more frames of the modified video that failed to satisfy the one or more image quality criteria.

Embodiment 12: The method of Embodiment 11, further comprising generating replacement frames for the removed one or more frames of the modified video.

Embodiment 13: The method of Embodiment 12, wherein each replacement frame is generated based on a first frame preceding a removed frame and a second frame following the removed frame and comprises an intermediate state of the dental site between a first state of a first frame and a second state of the second frame.

Embodiment 14: The method of any one of the preceding Embodiments, wherein the altered condition of the dental site corresponds to a post-treatment condition of one or more teeth of the dental site.

Embodiment 15: The method of Embodiment 14, wherein the post-treatment condition is clinically accurate and was determined based on input from a dental practitioner.

Embodiment 16: The method of any one of the preceding Embodiments, further comprising determining an optical flow between at least one frame and one or more previous frames of the plurality of frames, wherein segmenting each of a plurality of frames of the video comprises segmenting the plurality of frames in a manner that is temporally consistent with the one or more previous frames.

Embodiment 17: The method of any one of the preceding Embodiments, further comprising: determining color information for an inner mouth area in at least one frame of the plurality of frames; determining contours of the altered condition of the dental site; and inputting at least one of the color information, the determined contours, the at least one frame or information on the inner mouth area into a generative model, wherein the generative model outputs an altered version of the at least one frame.

Embodiment 18: The method of Embodiment 17, wherein an altered version of a prior frame is further into the generative model to enable the generative model to output a post-treatment version of the at least one frame that is temporally stable with the prior frame.

Embodiment 19: The method of Embodiment 18, further comprising: transforming the prior frame and the at least one frame into a feature space; and determining an optical flow between the prior frame and the at least one frame in the feature space, wherein the generative model further uses the optical flow in the feature space to generate the altered version of the at least one frame.

Embodiment 20: The method of Embodiment 19, wherein the generative model comprises a generator of a generative adversarial network (GAN).

Embodiment 21: The method of Embodiment 1, wherein modifying the video comprises performing the following for at least one frame of the video: determining an area of interest corresponding to a dental condition in the at least one frame; and replacing initial data for the area of interest with replacement data determined from the altered condition of the dental site.

Embodiment 22: The method of any one of the preceding Embodiments, wherein the a machine learning model comprises a GAN, an autoencoder, a variational autoencoder, or a combination thereof.

Embodiment 23: The method of Embodiment 22, wherein the machine learning model comprises a GAN.

Embodiment 24: The method of any one of the preceding Embodiments, wherein the altered condition of the dental site comprises a deteriorated condition of the dental site that is expected if no treatment is performed.

Embodiment 25: The method of any one of the preceding Embodiments, wherein the altered condition is an estimated future condition of the dental site.

Embodiment 26: A computer-implemented method comprising: receiving a video comprising a face of an individual that is representative of a current condition of a dental site of the individual; segmenting each of a plurality of frames of the video to detect the face and a dental site of the individual; identifying, within a 3D model library, an initial 3D model representing a best fit to the detected face in each of the plurality of frames according to one or more criteria; identifying, within the 3D model library, a final 3D model associated with the initial 3D model, the final 3D model corresponding to a version of the initial 3D model representing an altered condition of the dental site; and generating replacement frames for each of the plurality of frames based on the final 3D model.

Embodiment 27: The method of Embodiment 26, wherein the initial 3D model comprises a representation of a jaw with dentition.

Embodiment 28: The method of either Embodiment 26 or Embodiment 27, wherein the plurality of frames are selected for segmentation via periodically sampling frames of the video.

Embodiment 29: The method of Embodiment 28, wherein each final 3D model corresponds to a scan of a patient after undergoing orthodontic treatment and the associated initial 3D model corresponds to a scan of the patient prior to undergoing the orthodontic treatment.

Embodiment 30: The method of any one of Embodiments 26-29, wherein the 3D model library comprises a plurality of 3D models generated from 3D facial scans, and wherein each 3D model further comprises a 3D representation of a dental site corresponding to intraoral scan data.

Embodiment 31: The method of Embodiment 30, wherein, for each 3D model, the intraoral scan data is registered to its corresponding 3D facial scan.

Embodiment 32: The method of any one of Embodiments 26-31, wherein identifying the initial 3D model representing the best fit to the detected face comprises applying a rigid fitting algorithm.

Embodiment 33: The method of any one of Embodiments 26-32, wherein identifying the initial 3D model representing the best fit to the detected face comprises applying a non-rigid fitting algorithm.

Embodiment 34: The method of Embodiment 33, wherein applying the non-rigid fitting algorithm comprises applying one or more non-rigid adjustments to the initial 3D model.

Embodiment 35: The method of Embodiment 34, wherein the one or more non-rigid adjustments comprise: jaw level adjustments based on one or more of a jaw height, a jaw width, or a jaw depth; or tooth level adjustments based on one or more of a jaw height, a jaw width, or a sharpness of tooth curves.

Embodiment 36: The method of any one of Embodiments 26-35, wherein receiving the video of the face of the individual comprises receiving the video from a mobile device of the individual that captured the video.

Embodiment 37: The method of any one of Embodiments 26-36, further comprising: transmitting modified video comprising the replacement frames to a mobile device of the individual for display.

Embodiment 38: The method of Embodiment 37, wherein the dental site comprises one or more teeth, and wherein the one or more teeth in the modified video are different from the one or more teeth in an original version of the video and are temporally stable and consistent between frames of the modified video.

Embodiment 39: The method of Embodiment 37, further comprising: identifying one or more frames of the modified video that fail to satisfy one or more image quality criteria; and removing the one or more frames of the modified video that failed to satisfy the one or more image quality criteria.

Embodiment 40: The method of Embodiment 39, further comprising: generating replacement frames for the removed one or more frames of the modified video.

Embodiment 41: The method of Embodiment 40, wherein each replacement frame is generated based on a first frame preceding a removed frame and a second frame following the removed frame and comprises an intermediate state of the dental site between a first state of a first frame and a second state of the second frame.

Embodiment 42: The method of any one of Embodiments 26-41, wherein the altered condition of the dental site corresponds to a post-treatment condition of one or more teeth of the dental site.

Embodiment 43: The method of Embodiment 42, wherein the post-treatment condition is clinically accurate and was determined based on input from a dental practitioner.

Embodiment 44: The method of any one of Embodiments 26-43, further comprising: determining an optical flow between at least one frame and one or more previous frames of the plurality of frames, wherein segmenting each of a plurality of frames of the video comprises segmenting the plurality of frames in a manner that is temporally consistent with the one or more previous frames.

Embodiment 45: The method of any one of Embodiments 26-44, further comprising: determining color information for an inner mouth area in at least one frame of the plurality of frames; determining contours of the altered condition of the dental site; and inputting at least one of the color information, the determined contours, the at least one frame or information on the inner mouth area into a generative model, wherein the generative model outputs an altered version of the at least one frame.

Embodiment 46: The method of Embodiment 45, wherein an altered version of a prior frame is further into the generative model to enable the generative model to output a post-treatment version of the at least one frame that is temporally stable with the prior frame.

Embodiment 47: The method of Embodiment 46, further comprising: transforming the prior frame and the at least one frame into a feature space; and determining an optical flow between the prior frame and the at least one frame in the feature space, wherein the generative model further uses the optical flow in the feature space to generate the altered version of the at least one frame.

Embodiment 48: The method of Embodiment 47, wherein the generative model comprises a generator of a generative adversarial network (GAN).

Embodiment 49: The method of any one of Embodiments 26-48, wherein modifying the video comprises performing the following for at least one frame of the video: determining an area of interest corresponding to a dental condition in the at least one frame; and replacing initial data for the area of interest with replacement data determined from the altered condition of the dental site.

Embodiment 50: The method of any one of Embodiments 26-49, wherein the altered condition of the dental site comprises a deteriorated condition of the dental site that is expected if no treatment is performed or an estimated future condition of the dental site.

Embodiment 51: A computer-implemented method comprising: receiving an image or sequence of images comprising a face of an individual that is representative of a current condition of a dental site of the individual; estimating tooth shape of the dental site from the image or sequence of images to generate a 3D model representative of the dental site; generating a predicted 3D model corresponding to an altered representation of the dental site; and modifying the image or sequence of images by rendering the dental site to appear as the altered representation based on the predicted 3D model.

Embodiment 52: The method of Embodiment 51, further comprising: receiving an initial 3D model representative of the individual's teeth, the 3D model corresponding to the upper jaw, the lower jaw, or both.

Embodiment 53: The method of Embodiment 52, further comprising: encoding the initial 3D model into a latent space vector via a trained machine learning model.

Embodiment 54: The method of Embodiment 53, wherein the trained machine learning model is a variational autoencoder.

Embodiment 55: The method of Embodiment 53, wherein the trained machine learning model is trained to predict post-treatment modification of the initial 3D model and generate the predicted 3D model from the predicted post-treatment modification.

Embodiment 56: The method of Embodiment 52, further comprising segmenting the image or sequence of images to identify teeth within the image or sequence of images to generate segmentation data, wherein the segmentation data is representative of shape and position of each identified tooth.

Embodiment 57: The method of Embodiment 56, further comprising fitting the 3D model to the image or sequence of images based on the segmentation data by applying a non-rigid fitting algorithm.

Embodiment 58: The method of Embodiment 57, wherein the non-rigid fitting algorithm comprises contour-based optimization to fit the teeth of the 3D model to the teeth identified in the segmentation data.

Embodiment 59: The method of Embodiment 56, encoding the segmentation data into a latent space vector via a trained machine learning model, wherein the trained machine learning model is trained to map a latent space vector representation of the segmentation data to a latent space 3D model and decode the latent space 3D model into the 3D model representative of the dental site.

Embodiment 60: The method of any one of Embodiments 51-59, further comprising generating a photorealistic deformable 3D model of the individual's head by applying near radiance field (NeRF) modeling to a volumetric mesh based on the predicted 3D model.

Embodiment 61: The method of any one of Embodiments 51-59, wherein

receiving the image or sequence of images comprises receiving the image or sequence of images from a mobile device of the individual that captured the image or sequence of images.

Embodiment 62: The method of any one of Embodiments 51-59, further comprising transmitting the modified image or sequence of images to a mobile device of the individual for display.

Embodiment 63: The method of any one of Embodiments 51-59, wherein the image or sequence of images is in the form of a video received from a device of the individual, and wherein modifying the image or sequence of images results in a modified video.

Embodiment 64: The method of Embodiment 63, wherein the dental site comprises one or more teeth, and wherein the one or more teeth in the modified video are different from the one or more teeth in an original version of the video and are temporally stable and consistent between frames of the modified video.

Embodiment 65: The method of Embodiment 63, further comprising: identifying one or more frames of the modified video that fail to satisfy one or more image quality criteria; and removing the one or more frames of the modified video that failed to satisfy the one or more image quality criteria.

Embodiment 66: The method of Embodiment 65, further comprising generating replacement frames for the removed one or more frames of the modified video.

Embodiment 67: The method of Embodiment 66, wherein each replacement frame is generated based on a first frame preceding a removed frame and a second frame following the removed frame and comprises an intermediate state of the dental site between a first state of a first frame and a second state of the second frame.

Embodiment 68: The method of any one of Embodiments 51-59, wherein the altered condition of the dental site corresponds to a post-treatment condition of one or more teeth of the dental site.

Embodiment 69: The method of Embodiment 68, wherein the post-treatment condition is clinically accurate and was determined based on input from a dental practitioner.

Embodiment 70: The method of Embodiment 68, further comprising determining an optical flow between at least one frame and one or more previous frames of the plurality of frames, wherein segmenting each of a plurality of frames of the video comprises segmenting the plurality of frames in a manner that is temporally consistent with the one or more previous frames.

Embodiment 71: The method of Embodiment 70, further comprising: determining color information for an inner mouth area in at least one frame of the plurality of frames; determining contours of the altered condition of the dental site; and inputting at least one of the color information, the determined contours, the at least one frame or information on the inner mouth area into a generative model, wherein the generative model outputs an altered version of the at least one frame.

Embodiment 72: The method of Embodiment 71, wherein an altered version of a prior frame is further into the generative model to enable the generative model to output a post-treatment version of the at least one frame that is temporally stable with the prior frame.

Embodiment 73: The method of Embodiment 72, further comprising: transforming the prior frame and the at least one frame into a feature space; and determining an optical flow between the prior frame and the at least one frame in the feature space, wherein the generative model further uses the optical flow in the feature space to generate the altered version of the at least one frame.

Embodiment 74: The method of Embodiment 65, wherein modifying the video comprises performing the following for at least one frame of the video: determining an area of interest corresponding to a dental condition in the at least one frame; and replacing initial data for the area of interest with replacement data determined from the altered condition of the dental site.

Embodiment 75: The method of any one of Embodiments 51-59, wherein the altered condition of the dental site comprises a deteriorated condition of the dental site that is expected if no treatment is performed or an estimated future condition of the dental site.

Embodiment 76: A computer-implemented method comprising: receiving an image comprising a face of an individual; receiving a driver sequence comprising a plurality of animation frames, each frame comprising a representation of facial landmarks of a face and an orientation of the face; and generating a video by mapping the image to the driver sequence.

Embodiment 77: The method of Embodiment 76, further comprising segmenting each of a plurality of frames of the video to detect the face and a plurality of facial landmarks to generate segmentation data.

Embodiment 78: The method of Embodiment 77, wherein mapping the image to the driver sequence comprises mapping each of the plurality of facial landmarks of the segmentation data to facial landmarks of the driver sequence for each frame of the driver sequence.

Embodiment 79: The method of Embodiment 77, wherein the plurality of facial landmarks comprises a dental site of the individual, the dental site comprising teeth of the individual.

Embodiment 80: The method of any one of Embodiments 76-79, wherein the image is generated at least in part from the method of any one of Embodiments 1-75.

Embodiment 81: A computer-implemented method comprising: receiving a video comprising a face of an individual that is representative of a current condition of a dental site of the individual; generating a 3D model representative of the head of the individual based on the video; and estimating tooth shape of the dental site from the video, wherein the 3D model comprises a representation of the dental site based on the tooth shape estimation.

Embodiment 82: The method of Embodiment 81, further comprising generating a predicted 3D model corresponding to an altered representation of the dental site by modifying the 3D model to alter the representation of the dental site.

Embodiment 83: The method of Embodiment 82, further comprising encoding the 3D model into a latent space vector via a trained machine learning model, wherein the trained machine learning model is a variational autoencoder.

Embodiment 84: The method of Embodiment 83, wherein the trained machine learning model is trained to predict post-treatment modification of the 3D model and generate the predicted 3D model from the predicted post-treatment modification.

Embodiment 85: The method of any one of Embodiments 81-84, further comprising segmenting one or more of a plurality of frames of the video to detect teeth of the individual's dental site, wherein estimating tooth shape comprises applying a non-rigid fitting algorithm comprising contour-based optimization to fit the teeth of the 3D model to the teeth identified in the segmentation.

Embodiment 86: The method of Embodiment 82, further comprising generating a video comprising renderings of the predicted 3D model.

Embodiment 87: The method of any one of Embodiments 81-86, further comprising generating a video comprising renderings of the 3D model.

Embodiment 88: The method of either Embodiment 83 or Embodiment 84, further comprising: receiving a driver sequence comprising a plurality of animation frames, each frame comprising a representation that defines the position, orientation, shape, and expression of a face; animating the 3D model or the predicted 3D model based on the driver sequence; and generating a video for display based on the animated 3D model.

Embodiment 89: The method of any one of Embodiments 86-88, further comprising transmitting the video to a mobile device of the individual for display.

Embodiment 90: The method of any one of Embodiments 81-89, further comprising generating a photorealistic deformable 3D model of the individual's head by applying near radiance field (NeRF) modeling to a volumetric mesh based on the 3D model.

Embodiment 91: A method comprising: obtaining, by a processing device, video data of a dental patient comprising a plurality of frames; obtaining an indication of first selection criteria in association with the video data, wherein the first selection criteria comprise one or more conditions related to a target dental treatment of the dental patient; performing an analysis procedure on the video data, wherein performing the analysis procedure comprises: determining a respective first score for each of the plurality of frames based on the first selection criteria, and determining that a first frame of the plurality of frames satisfies a first threshold condition based on the first score; and selecting the first frame responsive to determining that the first frame satisfies the first threshold condition.

Embodiment 92: The method of Embodiment 91, wherein the analysis procedure further comprises: determining that a second frame of the plurality of frames satisfies a first criterion of the first selection criteria; determining that a third frame of the plurality of frames satisfies a second criterion of the first selection criteria; and generating the first frame based on a portion of the second frame associated with the first criterion and a portion of the third frame associated with the second criterion.

Embodiment 93: The method of either Embodiment 91 or Embodiment 92, wherein the analysis procedure further comprises: determining that a second frame of the plurality of frames satisfies a first criterion of the first selection criteria; determining that the second frame does not satisfy a second criterion of the first selection criteria; providing the second frame to a trained machine learning model; and obtaining the first frame from the trained machine learning model, wherein the first frame is based on the second frame, satisfies the first criterion, and satisfies the second criterion.

Embodiment 94: The method of any one of Embodiments 91-93, wherein the analysis procedure further comprises: generating, based on the video data, a three-dimensional model of the dental patient; and rendering the first frame based on the three-dimensional model.

Embodiment 95: The method of any one of Embodiments 91-94, wherein the indication of the first selection criteria comprises a reference image, wherein a score of the reference image in association with the first selection criteria satisfies the first threshold condition.

Embodiment 96: The method of any one of Embodiments 91-95, further comprising: obtaining an indication of second selection criteria; wherein the analysis procedure further comprises: determining a respective second score for each of the plurality of frames based on the second selection criteria; and determining that a second frame satisfies a second threshold condition based on the second score; and selecting the second frame responsive to determining that the second frame satisfies the second threshold condition.

Embodiment 97: The method of any one of Embodiments 91-96, wherein the first selection criteria comprise values associated with one or more of: head orientation; visible tooth identities; visible tooth area; bite position; emotional expression, or gaze direction.

Embodiment 98: The method of any one of Embodiments 91-97, wherein the video data comprises a first portion obtained at a first time and a second portion obtained at a second time, the second portion comprising the first frame, and wherein the analysis procedure further comprises: determining that scores associated with each of the frames of the first portion do not satisfy the first threshold; and providing an alert to a user indicating one or more criteria of the first selection criteria to be included in the second portion.

Embodiment 99: The method of any one of Embodiments 91-98, wherein determining the respective first score for each of the plurality of frames comprises: providing the video data to a trained machine learning model configured to determine the first score in association with the first selection criteria; and obtaining from the trained machine learning model the first score.

Embodiment 100: The method of Embodiment 99, wherein determining the first score further comprises providing an indication of the first selection criteria to the trained machine leaning model, wherein the trained machine learning model is configured to generate output based on a target selection criteria of a plurality of selection criteria.

Embodiment 101: A method, comprising: obtaining a plurality of data comprising images of dental patients; obtaining a first plurality of classifications of the images based on first selection criteria; and training a machine learning model to generate a trained machine learning model using the plurality of data and the first plurality of classifications based on the first criteria, wherein the trained machine learning model is configured to determine whether an input image of a dental patient satisfies a first threshold condition in connection with the first selection criteria.

Embodiment 102: The method of Embodiment 101, further comprising: obtaining a second plurality of classifications of the images based on second selection criteria, wherein the trained machine learning model is further configured to determine whether the input image of the dental patient satisfies a second threshold condition in connection with the second selection criteria.

Embodiment 103: The method of either Embodiment 101 or Embodiment 102, wherein the first selection criteria comprise a set of conditions for a target image of a dental patient in connection with a dental treatment.

Embodiment 104: The method of Embodiment 103, wherein the target image comprises one of: a social smile; a profile including teeth; or exposure of a target set of teeth.

Embodiment 105: The method of any one of Embodiments 101-104, wherein the first selection criteria comprise one or more of: head orientation; teeth visibility; emotion; bite opening; or gaze direction.

Embodiment 106: The method of any one of Embodiments 101-105, wherein obtaining the data of images of dental patients comprises providing a plurality of frames of a video to a model, and obtaining from the model facial key points in association with each of the plurality of frames.

Embodiment 107: A method comprising: obtaining, by a processing device, video data of a dental patient comprising a plurality of frames; obtaining an indication of first selection criteria in association with the video data, wherein the first selection criteria comprise one or more conditions related to a target dental treatment of the dental patient; performing an analysis procedure on the video data, wherein performing the analysis procedure comprises: determining a first set of scores for each of the plurality of frames based on the first selection criteria, determining that a first frame of the plurality of frames satisfies a first condition based on the first set of scores, and does not satisfy a second condition based on the first set of scores, providing the first frame as input to an image generation model, providing instructions based on the second condition to the image generation model, and obtaining, as output from the image generation model, a first generated image that satisfies the first condition and the second condition; and providing the first generated image as output of the analysis procedure.

Embodiment 108: The method of Embodiment 107, wherein the image generation model comprises a generative adversarial network.

Embodiment 109: The method of either Embodiment 107 or Embodiment 108, wherein the indication of the first selection criteria comprises a reference image, wherein a score of the reference image in association with the first selection criteria satisfies the first condition.

Embodiment 110: The method of any one of Embodiments 107-109, further comprising: obtaining an indication of second selection criteria in association with the video data; determining that a second frame of the plurality of frames does not satisfy a third condition in association with the second selection criteria; providing the second frame as input to the image generation model; and obtaining, as output from the image generation model, a second generated image that satisfies the third condition in association with the second selection criteria.

Embodiment 111: The method of any one of Embodiments 107-110, wherein the first selection criteria comprise values associated with one or more of: head orientation; visible tooth identities; visible teeth area; bite; emotional expression, or gaze direction.

Embodiment 112: The method of any one of Embodiments 107-111, wherein determining the first set of scores comprises: providing the video data to a trained machine learning model configured to determine the first set of scores in association with the first selection criteria; and obtaining from the trained machine learning model the first set of scores.

Embodiment 113: A computer-implemented method comprising: receiving an image or sequence of images comprising a face of an individual that is representative of a current condition of a dental site of the individual; and computing a predicted 3D model representative of the individual's dentition directly from the image or sequence of images, based on a trained machine learning model.

Embodiment 114: The method of Embodiment 113, wherein the predicted 3D model is computed based at least partially on a structure from motion algorithm.

Embodiment 115: The method of either Embodiment 113 or Embodiment 114, further comprising: generating, based on a trained machine learning model, an altered representation of the predicted 3D model representative of a dental treatment plan.

Embodiment 116: The method of any one of Embodiments 113-115, further comprising: comparing the predicted 3D model to a 3D model computed based on a dental impression to determine a quality parameter of the dental impression.

Embodiment 117: The method of any one of Embodiments 113-116, wherein the trained machine learning model corresponds to a machine learning model that is trained based on a training data sets corresponding to plurality of patient records, each patient record comprising at least one image of the patient's mouth and an associated 3D model representing the patient's dentition.

Embodiment 118: The method of Embodiment 117, wherein training the machine learning model based on the training data sets comprises, for each patient record, iteratively updating the model to minimize a loss function by comparing a predicted 3D model generated by the model to a 3D model representative of a patient's dentition of the patient record.

Embodiment 119: A system comprising: a memory; and a processing device operatively coupled to the memory, wherein the processing device is configured to perform the method of any one of Embodiments 1-118.

Embodiment 120: A non-transitory machine-readable medium having instructions encoded thereon that, when executed by a processing device, cause the processing device to perform the method of any one of Embodiments 1-118.

The methods and illustrative examples described herein are not inherently related to any particular computer or other apparatus. Various general-purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

Claim language or other language herein reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The above description is intended to be illustrative, and not restrictive. Although the present disclosure has been described with references to specific illustrative examples and embodiments, it will be recognized that the present disclosure is not limited to the examples and embodiments described. The scope of the disclosure should be determined with reference to the following claims, along with the full scope of equivalents to which the claims are entitled.

1-50. (canceled)

51. A computer-implemented method comprising:
receiving an image or sequence of images comprising a face of an individual that is representative of a current condition of a dental site of the individual;
estimating tooth shape of the dental site from the image or sequence of images to generate a 3D model representative of the dental site;
generating a predicted 3D model corresponding to an altered representation of the dental site; and
modifying the image or sequence of images by rendering the dental site to appear as the altered representation based on the predicted 3D model.

52. The method of claim 51, further comprising:
receiving an initial 3D model representative of the individual's teeth, the 3D model corresponding to the upper jaw, the lower jaw, or both.

53. The method of claim 52, further comprising:
encoding the initial 3D model into a latent space vector via a trained machine learning model.

54. The method of claim 53, wherein the trained machine learning model is a variational autoencoder.

55. The method of claim 53, wherein the trained machine learning model is trained to predict post-treatment modification of the initial 3D model and generate the predicted 3D model from the predicted post-treatment modification.

56. The method of claim 52, further comprising:
segmenting the image or sequence of images to identify teeth within the image or sequence of images to generate segmentation data, wherein the segmentation data is representative of shape and position of each identified tooth.

57. The method of claim 56, further comprising:
fitting the 3D model to the image or sequence of images based on the segmentation data by applying a non-rigid fitting algorithm.

58. The method of claim 57, wherein the non-rigid fitting algorithm comprises contour-based optimization to fit the teeth of the 3D model to the teeth identified in the segmentation data.

59-80. (canceled)

81. A computer-implemented method comprising:
receiving a video comprising a face of an individual that is representative of a current condition of a dental site of the individual;
generating a 3D model representative of the head of the individual based on the video; and
estimating tooth shape of the dental site from the video, wherein the 3D model comprises a representation of the dental site based on the tooth shape estimation.

82. The method of claim 81, further comprising:
generating a predicted 3D model corresponding to an altered representation of the dental site by modifying the 3D model to alter the representation of the dental site.

83. The method of claim 82, further comprising:
encoding the 3D model into a latent space vector via a trained machine learning model, wherein the trained machine learning model is a variational autoencoder.

84. The method of claim 83, wherein the trained machine learning model is trained to predict post-treatment modification of the 3D model and generate the predicted 3D model from the predicted post-treatment modification.

85. The method of claim 81, further comprising:
segmenting one or more of a plurality of frames of the video to detect teeth of the individual's dental site, wherein estimating tooth shape comprises applying a non-rigid fitting algorithm comprising contour-based optimization to fit the teeth of the 3D model to the teeth identified in the segmentation.

86. The method of claim 82, further comprising:
generating a video comprising renderings of the predicted 3D model.

87. The method of claim 81, further comprising:
generating a video comprising renderings of the 3D model.

88. The method of claim 84, further comprising:
receiving a driver sequence comprising a plurality of animation frames, each frame comprising a representation that defines the position, orientation, shape, and expression of a face;
animating the 3D model or the predicted 3D model based on the driver sequence; and
generating a video for display based on the animated 3D model.

89. (canceled)

90. (canceled)

91. A method comprising:
obtaining, by a processing device, video data of a dental patient comprising a plurality of frames;
obtaining an indication of first selection criteria in association with the video data, wherein the first selection criteria comprise one or more conditions related to a target dental treatment of the dental patient;
performing an analysis procedure on the video data, wherein performing the analysis procedure comprises:
determining a respective first score for each of the plurality of frames based on the first selection criteria, and
determining that a first frame of the plurality of frames satisfies a first threshold condition based on the first score; and
selecting the first frame responsive to determining that the first frame satisfies the first threshold condition.

92. The method of claim 91, wherein the analysis procedure further comprises:
determining that a second frame of the plurality of frames satisfies a first criterion of the first selection criteria;
determining that a third frame of the plurality of frames satisfies a second criterion of the first selection criteria; and
generating the first frame based on a portion of the second frame associated with the first criterion and a portion of the third frame associated with the second criterion.

93. The method of claim 91, wherein the analysis procedure further comprises:
determining that a second frame of the plurality of frames satisfies a first criterion of the first selection criteria;
determining that the second frame does not satisfy a second criterion of the first selection criteria;
providing the second frame to a trained machine learning model; and
obtaining the first frame from the trained machine learning model, wherein the first frame is based on the second frame, satisfies the first criterion, and satisfies the second criterion.

94. The method of claim 91, wherein the analysis procedure further comprises:
generating, based on the video data, a three-dimensional model of the dental patient; and
rendering the first frame based on the three-dimensional model.

95. The method of claim 91, wherein the indication of the first selection criteria comprises a reference image, wherein a score of the reference image in association with the first selection criteria satisfies the first threshold condition.

96. The method of claim 91, further comprising:
obtaining an indication of second selection criteria;
wherein the analysis procedure further comprises:
determining a respective second score for each of the plurality of frames based on the second selection criteria; and
determining that a second frame satisfies a second threshold condition based on the second score; and
selecting the second frame responsive to determining that the second frame satisfies the second threshold condition.

97. The method of claim 91, wherein the first selection criteria comprise values associated with one or more of:
head orientation;
visible tooth identities;
visible tooth area;
bite position;
emotional expression; or
gaze direction.

98. The method of claim 91, wherein the video data comprises a first portion obtained at a first time and a second portion obtained at a second time, the second portion comprising the first frame, and wherein the analysis procedure further comprises:
determining that scores associated with each of the frames of the first portion do not satisfy the first threshold; and
providing an alert to a user indicating one or more criteria of the first selection criteria to be included in the second portion.

99-118. (canceled)

119. A system comprising:
a memory; and
a processing device operatively coupled to the memory, wherein the processing device is configured to perform the method of claim 51.

120. A non-transitory machine-readable medium having instructions encoded thereon that, when executed by a processing device, cause the processing device to perform the method of claim 51.

121. A system comprising:
a memory; and
a processing device operatively coupled to the memory, wherein the processing device is configured to perform the method of claim 81.

122. A non-transitory machine-readable medium having instructions encoded thereon that, when executed by a processing device, cause the processing device to perform the method of claim 81.

123. A system comprising:
a memory; and
a processing device operatively coupled to the memory, wherein the processing device is configured to perform the method of claim 91.

124. A non-transitory machine-readable medium having instructions encoded thereon that, when executed by a processing device, cause the processing device to perform the method of claim 91.
